(19) United States
(12) Patent Application Publication
(10) Pub. No.: US 2026/0117422 A1
(43) Pub. Date: Apr. 30, 2026

(54) METHODS AND COMPOSITIONS FOR GENOMIC ANALYSIS

(71) Applicant: Twist Bioscience Corporation, South San Francisco, CA (US)

(72) Inventors: Patrick CHERRY, San Francisco, CA (US); Jason CORWIN, South San Francisco, CA (US); Derek MURPHY, South San Francisco, CA (US); Esteban TORO, Fremont, CA (US); Michael BOCEK, Inver Grove Heights, MN (US); Kristin D. BUTCHER, South San Francisco, CA (US); Jean CHALLACOMBE, South San Francisco, CA (US)

(73) Assignee: Twist Bioscience Corporation, South San Francisco, CA (US)

(21) Appl. No.: 19/116,775

(22) PCT Filed: Sep. 29, 2023
(86) PCT No.: PCT/US2023/075579

§ 371 Date: Mar. 28, 2025

Related U.S. Application Data
(60) Provisional application No. 63/377,670, filed on Sep. 29, 2022.
(60) Provisional application No. 63/379,252, filed on Oct. 12, 2022.
(60) Provisional application No. 63/482,253, filed on Jan. 30, 2023.
(60) Provisional application No. 63/458,781, filed on Apr. 12, 2023.

(51) Int. Cl. C40B 40/06

(52) U.S. Cl. CPC C40B 40/06

(57) ABSTRACT

Systems, methods, and compositions for identifying genomic variants and methylation analysis, including synthetic polynucleotide libraries, are provided. The synthetic polynucleotide libraries may comprise a plurality of polynucleotides. The polynucleotides may comprise sequences corresponding to a genetic abnormality in a genome. The stoichiometry of each of the plurality of polynucleotides is controlled. Systems, methods, and compositions described herein may include standards for determining the analytical sensitivity and/or accuracy of instruments configured to measure nucleic acid variant frequencies. Standards may comprise RNA-fusions and/or CNV mutations related to cancer.

### CROSS-REFERENCE TO RELATED APPLICATIONS

This application claims the benefits of priority to U.S. Provisional Patent Application No. 63/458,781, filed Apr. 12, 2023, U.S. Provisional Patent Application No. 63/482,253, filed Jan. 30, 2023, U.S. Provisional Patent Application No. 63/379,252, filed Oct. 12, 2022, and U.S. Provisional Patent Application No. 63/377,670, filed Sep. 29, 2022 the entirety of which are incorporated herein by reference. All publications, patents, and patent applications mentioned in this specification are herein incorporated by reference to the same extent as if each individual publication, patent, or patent application was specifically and individually indicated to be incorporated by reference.

### BACKGROUND

Identification of genomic variants with high fidelity and low cost has a central role in biotechnology and medicine, and in basic bio medical research. While various methods are known for identification of genomic variants in complex nucleic acid samples, these techniques often suffer from scalability, automation, speed, sensitivity, accuracy, and cost.

Molecular biology methods heavily rely on controls in order to fully understand, analyze and interpret results. Widely used applications dependent on these controls range from next generation sequencing (NGS) and quantitative PCR (qPCR) to enzyme engineering and genome editing. Another emerging application dependent on controls is determining methylation patterns found in cancer cells.

### SUMMARY

Provided herein are compositions and methods for determination of genomic variants. Further provided herein are compositions and methods for design and use of genomic variant controls.

Provided herein are synthetic polynucleotide libraries comprising: a plurality of polynucleotides, wherein the polynucleotides comprise sequences corresponding to a genetic abnormality in a genome, and wherein the stoichiometry of each polynucleotide of the plurality of polynucleotides is controlled. Further provided are libraries wherein the plurality of polynucleotides comprise DNA. Further provided are libraries wherein the plurality of polynucleotides comprise at least 100 polynucleotides. Further provided are libraries wherein the plurality of polynucleotides comprise at least 5000 polynucleotides. Further provided are libraries wherein the plurality of polynucleotides comprise at least 50,000 polynucleotides. Further provided are libraries wherein the plurality of polynucleotides corresponds to ctDNA. Further provided are libraries wherein the genetic abnormality is indicative of a disease or condition. Further provided are libraries wherein the disease or condition comprises cancer. Further provided are libraries wherein the disease or condition comprises one or more of breast, ovarian, stomach, bladder, salivary, and lung cancers. Further provided are libraries wherein the genetic abnormality comprises an abnormal CNV for at least one gene. Further provided are libraries wherein the genetic abnormality comprises at least a 2 fold increase in copy number. Further provided are libraries wherein the genetic abnormality comprises at least a 10 fold increase in copy number. Further provided are libraries wherein the plurality of polynucleotides are organized into clusters. Further provided are libraries wherein the plurality of polynucleotides are tiled as 3-10 polynucleotides per cluster. Further provided are libraries wherein a cluster includes a polynucleotide tiled 1 base along the gene. Further provided are libraries wherein the start position for each cluster is 5-10 bases between clusters. Further provided are libraries wherein the library comprises a mean max coverage. Further provided are libraries wherein mean max coverage comprises polynucleotide length*(length covered/(length covered+length skipped)). Further provided are libraries wherein the polynucleotides are substantially free of repetitive elements. Further provided are libraries wherein repetitive elements comprise LINE or SINE. Further provided are libraries wherein the polynucleotides correspond to exonic regions of the at least one gene. Further provided are libraries wherein the at least one gene comprises ERBB2. Further provided are libraries wherein at least 90% of the polynucleotides have an average length of 100-200 bases. Further provided are libraries wherein the polynucleotides have an average length of 150-180 bases. Further provided are libraries wherein at least 90% of the polynucleotide have a length of 150-180 bases. Further provided are libraries wherein the library has a minimum GC content of 20-40%. Further provided are libraries wherein the library has a maximum GC content of 60-80%. Further provided are libraries wherein the library has an average GC content of 50-70%. Further provided are libraries wherein the library has a standard deviation GC content of 0.02-0.06%. Further provided are libraries wherein the library has a standard deviation GC content of no more than 0.06%. Further provided are libraries wherein library further comprises a second library of polynucleotides having sequences corresponding to one or more of copy number variants (CNVs), single nucleotide variations (SNVs), insertion-deletions (INDELs), and structural variants (SVs).

Provided herein are methods for analyzing copy number variation comprising: pooling a library comprising abnormal CNV with a donor background polynucleotide library; and analyzing the pool for the one or more genetic abnormalities. Further provided are methods wherein analyzing comprises use of next generation sequencing, mass spectrometry (e.g., MassARRAY/Agena Bio), or ddPCR. Further provided are methods the library comprising the second library of polynucleotides having sequences corresponding to one or more of copy number variants (CNVs), single nucleotide variations (SNVs), insertion-deletions (INDELs), and structural variants (SVs). Further provided herein are methods where at least 90% of exons in the donor background polynucleotide library have an increased depth of sequencing by 3× to 5× compared to a library without the second library. Further provided are methods wherein step (a) is repeated for various concentrations of the library. Further provided are methods wherein step (a) comprises serial dilutions.

Provided herein are methods for preparing the synthetic library comprising abnormal CNV. Further provided are methods comprising: designing sequences for the library of polynucleotides, where the sequences comprise a primer region; synthesizing the library of polynucleotides; and cleaving the primer region polynucleotides in the library. Further provided are methods further comprising purifying the polynucleotides.

Provided herein are synthetic polynucleotide libraries comprising: a plurality of polynucleotides, wherein the polynucleotides comprise sequences corresponding to one or more genetic abnormalities in a genome, and wherein the stoichiometry of each of the plurality of polynucleotides is controlled. Further provided are libraries wherein the genetic abnormalities are indicative of a disease or condition. Further provided are libraries wherein the disease or condition comprises one or more of Lung Adenocarcinoma, Thyroid Papillary Carcinoma, Leukemia (Acute and Chronic), Prostate Adenocarcinoma, and Ewing's Sarcoma. Further provided are libraries wherein the genetic abnormalities comprises a fusion. Further provided are libraries wherein the library comprises RNA. Further provided are libraries wherein the genetic abnormalities comprises an RNA fusion. Further provided are libraries wherein the polynucleotides comprise sequences within 2000 bases of the fusion junction. Further provided are libraries wherein the polynucleotides comprise sequences within 750 bases of the fusion junction. Further provided are libraries wherein the polynucleotides comprise sequences within 200-2000 bases of the fusion junction. Further provided are libraries wherein the polynucleotides comprise sequences within 2000 bases of the fusion junction relative to the 3′ terminus. Further provided are libraries wherein the polynucleotides comprise sequences within 2000 bases of the fusion junction relative to the 5′ terminus. Further provided are libraries wherein the RNA fusion is found in at least 2 samples from the COSMIC database. Further provided are libraries wherein the RNA fusion is found in at least 10 samples from the COSMIC database. Further provided are libraries wherein the RNA fusion is found in at least 100 samples from the COSMIC database. Further provided are libraries wherein the library comprises polynucleotides corresponding to at least 20 fusions. Further provided are libraries wherein the library comprises polynucleotides corresponding to at least 40 fusions. Further provided are libraries wherein the library comprises polynucleotides corresponding to at least 100 fusions. Further provided are libraries wherein the library comprises polynucleotides corresponding to at least 150 fusions. Further provided are libraries wherein the library comprises polynucleotides corresponding to 20-200 fusions. Further provided are libraries wherein the RNA fusion is 500-2000 bases in length. Further provided are libraries wherein the RNA fusion comprises a fusion from Table 1. Further provided are libraries wherein the RNA fusion comprises a first gene and a second gene. Further provided are libraries wherein the first gene comprises ACTB, ASPSCR1, ATF1, ATIC, BCR, CBFA2T3, CCDC6, CD74, CDH11, CDKN2D, CHCHD7, CLTC, COL1A1, CRTC1, CRTC3, CTNNB1, DHH, DNAJB1, EGFR, EML4, ETV6, EWSR1, EZR, FGFR1, FGFR3, FOXO1, FUS, GOPC, HEY1, HMGA2, JAK2, JAZF1, KIAA1549, KIF5B, KMT2A, LIFR, LPP, MAML2, MET, MN1, MYB, NAB2, NACC2, NCOA4, NPM1, NUP214, PAX3, PAX7, PAX8, PCM1, PLAG1, PML, PRCC, PRKAR1A, PTPRK, RANBP2, RUNX1, SDC4, SET, SLC34A2, SLC45A3, SND1, SS18, STIL, STRN, TAF15, TBL1XR1, TCF3, TFE3, TMPRSS2, TPM3, TPM4, or YWHAE. Further provided are libraries wherein the second gene comprises GLI1, TFE3, EWSR1, ALK, ABL1, GLIS2, RET, NRG1, ROS1, USP6, WDFY2, PLAG1, PDGFB, MAML2, RHEBL1, PRKACA, EGFR, SEPTIN14, EML4, MN1, NTRK3, PDGFRB, RUNX1, ATF1, CREB1, DDIT3, ERG, FEV, FLI1, NR4A3, POU5F1, WT1, TACC1, BAIAP2L1, TACC3, PAX3, CREB3L2, FUS, NCOA2, LPP, WIF1, PAX5, SUZ12, BRAF, AFDN, AFF1, CREBBP, ELL, EPS15, MLLT1, MLLT10, MLLT11, MLLT3, SEPTIN6, SEPTIN9, HMGA2, CRTC1, MET, ETV6, MYB, NFIB, STAT6, NTRK2, FOXO1, PAX8, PPARG, JAK2, CTNNB1, RARA, RSPO3, ETV6, RUNX1T1, NUP214, ELK4, SSX1, SSX2, SSX4B, TAL1, TP63, PBX1, ASPSCR1, NTRK1, or NUTM2B.

Provided herein are methods for preparing the synthetic library comprising fusion RNAs. Further provided are methods comprising: designing sequences for the library of polynucleotides; synthesizing DNA plasmids, wherein each plasmid comprises at least one polynucleotide sequence; digesting plasmids to release DNA fragments comprising the sequences; performing transcription on the DNA fragments to generate the library of polynucleotides. Further provided herein are methods wherein the plasmids are digested with a restriction enzyme. Further provided herein are methods wherein the restriction enzyme comprises one or more of AatII, AcuI, AflIII, AhdI, AjuI, AlfI, AlwNI, ApaLI, ArsI, AscI, AseI, AsiSI, AvaI, AvrII, BacGI, BamHI, BanII, BciVI, BdaI, Bme1580I, BmrI, Bpu10I, BsaHI, BsaXI, BseYI, BsiEI, BsiHKAI, BsiWI, BsmI, BsmBI, BsmFI, BsoBI, BspDI, BspHI, BsrDI, BsrFI, BssSI, BssSI, BtgZI, BtsI, BtsI, ClaI, CviQI, DraIII, DrdI, EaeI, EarI, Eco57MI, Esp3I, FaqI, FauI, HacII, HgaI, HindIII, Hpy166II, MlyI, MspAII, NdeI, NruI, NspI, PaeR7I, PciI, PflMI, PleI, PspFI, PspXI, PvuI, RsaI, Sau96I, SfcI, SmaI, SpeI, SspI, StyI, TaqII, TsoI, Tsp45I, TspGWI, TspMI, TstI, XbaI, XhoI, XmaI, and ZraI. Further provided herein are methods wherein transcription comprises in-vitro transcription.

Provided herein are systems for generating a polynucleotide library comprising: a computing system comprising at least one processor and instructions executable by the at least one processor to perform operations comprising: (a) receiving as input a nucleic acid reference sequence, at least one target region, and one or more variables; (b) generating a polynucleotide library by saturating the at least one target region with one or more polynucleotides; and (c) generating one or more outputs comprising sequences of the polynucleotide library. Further provided herein are systems wherein the input nucleic reference sequence comprises a genome. Further provided herein are systems wherein the at least one target region comprises at least one exon. Further provided herein are systems wherein the at least one target region comprises a variant. Further provided herein are systems wherein the variant comprises a copy number variation (CNV), single nucleotide variant (SNV), insertion/deletion (indel), or structural variant (SV). Further provided herein are systems wherein the one or more variables comprise polynucleotide length, offset, number of probes, overlap, overhang, target region merges, and tiling depth. Further provided herein are systems wherein the target region is smaller than a polynucleotide length, and polynucleotides are generated with 1 base offsets. Further provided herein are systems wherein the target region is larger than a polynucleotide length, and polynucleotides are generated such that the entire target region is evenly covered. Further provided herein are systems wherein the system further comprises one or more filters. Further provided herein are systems wherein the filter is configured to remove duplicate polynucleotide sequences. Further provided herein are systems wherein the filter is configured to remove SINE/LINE sequences. Further provided herein are systems wherein the one or more outputs comprises one or more log files. Further provided herein are systems wherein the one or more outputs comprises a file comprising the regions covered by the polynucleotides. Further provided herein are systems wherein the one or more outputs comprises a file, wherein the file comprises sequences from the library. Provided herein are systems for generating a polynucleotide library comprising: a computing system comprising at least one processor and instructions executable by the at least one processor to perform operations comprising: (a) receiving as input a plurality of sequences from a library described herein; (b) trimming the plurality of sequences around the one or more variants loci; and (c) generating one or more outputs comprising sequences of the polynucleotide library. Further provided herein are systems wherein the system further comprises a module for adding primers to each of the sequences in step (c). Further provided herein are systems wherein the system further comprises a module for organizing the sequences into clusters. Further provided herein are systems wherein the system further comprises a module for organizing the clusters for synthesis on a synthesis device. Further provided herein are systems wherein the polynucleotide library comprises approximately a leptokurtic distribution. Further provided herein are systems wherein the distance between variants loci is 5-10 bases. Further provided herein are systems wherein the distance between variants loci is 7 bases. Further provided herein are systems wherein the polynucleotide library comprises sequences representative of cfDNA. Further provided herein is a synthetic polynucleotide library comprising: a plurality of polynucleotides, wherein a portion of the polynucleotides comprise methylation, and the plurality of polynucleotides comprises at least one CpG site. In some embodiments, the plurality of polynucleotides comprise DNA. In some embodiments, the library comprises at least 24 polynucleotides. In some embodiments, the library comprises at least 36 polynucleotides. In some embodiments, the library comprises at least 48 polynucleotides. In some embodiments, the polynucleotides are 80-350 bases in length. In some embodiments, the at least one CpG site comprises 0 to 100% methylation. In some embodiments, the at least one CpG site comprises about 0%, 3%, 6%, 12%, 25%, 50%, 75%, or 100% methylation. In some embodiments, the at least one CpG site comprises between 1 to 20 CpG sites. In some embodiments, the at least one CpG site is associated with a disease or condition. In some embodiments, the at least one CpG site is associated with cancer. In some embodiments, the portion of the polynucleotides is about 10% to about 90% of the plurality of polynucleotides. In some embodiments, the plurality of polynucleotides comprise about 30% to about 70% GC content. In some embodiments, the plurality of polynucleotides comprise a pairwise hamming distance of at least 100 from each other. In some embodiments, the library further comprises adapters. In some embodiments, the adapters comprise methyl deoxycytidine adapters. Further provided herein is a method for quantifying methylation in a sample comprising: (a) preparing standards from a library provided herein; (b) analyzing one or more samples relative to the standards; and (c) quantifying the degree of methylation in the sample. In some embodiments, the degree of methylation in the sample comprises a per site methylation rate. In some embodiments, the standards are prepared by serial dilution. In some embodiments, preparing the standards comprises mixing the standards with a portion of the sample at one or more concentrations. In some embodiments, preparing the standards comprises adding adapters, barcodes, or both to the polynucleotides of the library. In some embodiments, preparing the standards comprises a library conversion. In some embodiments, the library conversion comprises an enzymatic conversion or a chemical conversion. In some embodiments, the enzymatic conversion results in increased yields, longer insert sizes, or both compared to a chemical conversion. In some embodiments, the enzymatic conversion results in uniform coverage across varying GC content compared to a chemical conversion. In some embodiments, further comprising target enrichment. In some embodiments, wherein target enrichment takes place before or after a library conversion. Further provided herein is a method for preparing the synthetic library provide herein. In some embodiments, the method comprises (a) designing sequences for the library of polynucleotides; (b) synthesizing the library of polynucleotides as one or more pools of polynucleotides; (c) amplifying the one or more pools; (d) methylating the one or more pools; and (c) combining the one or more pools based at least in part on a methylation ratio, thereby generating the plurality of polynucleotides, wherein a portion of the polynucleotides comprise methylation. designing sequences comprises adding an enzyme digestion site to each sequence. In some embodiments, further comprising exposing the plurality of polynucleotides to an enzyme for quality control. In some embodiments, the enzyme cleaves the plurality of polynucleotides at the enzyme digestion site. In some embodiments, methylating the one or more pools comprises methylation by a methyltransferase. In some embodiments, the portion comprises 0%, 3%, 6%, 12%, 25%, 50%, 75%, or 100% methylation. In some embodiments, each of the polynucleotides comprise one or more levels of CpG sites. Further provided herein is a kit comprising the synthetic library provided herein. In some embodiments, the kit further comprises instructions for quantifying methylation in a sample. In some embodiments, the kit further comprises packaging for the synthetic library provided herein. In some embodiments, the library comprises standards pre-prepared by serial dilution. In some embodiments, the kit further comprises reagents for next generation sequencing.

### BRIEF DESCRIPTION OF THE DRAWINGS

FIG. 1A depicts a design of synthetic ctDNA to target a variant site. Multiple overlapping or “tiled” polynucleotides are configured to contain the variant site (indicated with a star). The x-axis is labeled genome coordinate from 0-300 at 100 unit intervals; the y-axis is labeled oligos.

FIG. 1B depicts a distribution of indel sizes for a synthetic ctDNA library, including short, medium (5-10 bp), and large size variants (˜30 bp). Positive numbers are insertions, and negative numbers are deletions. The y-axis is labeled number of variants from 0 to 40 at 20 unit intervals; the x-axis is labeled indel size (bp) from −30 to 10 at 10 unit intervals.

FIG. 1C depicts a plot of signal (representative of abundance) vs. size for background cell-free DNA (cfDNA). The background cfDNA was obtained from healthy donor plasma. The y-axis is labeled fluorescence units (FU) from 0 to 400 at 50 unit intervals; the x-axis is labeled base pairs (bp) at 35, 100, 150, 200, 300, 400, 500, 600, 1000, 2000, 10380. Peak 1 and peak 2 are labeled.

FIG. 2 depicts an image of a plate having 256 clusters, each cluster having 121 loci with polynucleotides extending therefrom.

FIG. 3A depicts a plot of polynucleotide representation (polynucleotide frequency versus abundance, as measured absorbance) across a plate from synthesis of 29,040 unique polynucleotides from 240 clusters, each cluster having 121 polynucleotides.

FIG. 3B depicts a plot of measurement of polynucleotide frequency versus abundance absorbance (as measured absorbance) across each individual cluster, with control clusters identified by a box.

FIG. 4 illustrates a computer system.

FIG. 5 is a block diagram illustrating an architecture of a computer system.

FIG. 6 is a diagram demonstrating a network configured to incorporate a plurality of computer systems, a plurality of cell phones and personal data assistants, and Network Attached Storage (NAS).

FIG. 7 is a block diagram of a multiprocessor computer system using a shared virtual address memory space.

FIG. 8 depicts a heatmap of RNA concentration (as measured by UV signal) in ng/μL for positions on two plates (left: 08_16_IVT_84, and right: 09_12_IVT_76) wherein wells comprise synthetic RNA fusion controls. Rows are labeled A-H top to bottom; columns are labeled 1-12 left to right for each plate. Lighter yellow areas indicate higher values; darker blue indicates lower values.

FIG. 9 shows a non-limiting example of a schematic illustrating a workflow for methylation analysis according to some embodiments.

FIG. 10 shows a non-limiting example of a schematic illustrating challenges with overlapping counts according to some embodiments. As shown, the string ACA appears in the string three times (overlapping occurrences count). In some instances, the overlap of a prefix and a suffix need to be considered.

FIG. 11 shows a non-limiting example of a schematic illustrating a seed motif in an algorithm for determining a sequence according to some embodiments. Exemplary steps include: (1) adding all of the needed motifs into a list and permute the order, (2) finding the total padding space between motifs, (3) randomly partitioning the total space into spacing between each motif, and (4) placing each motif into the sequence.

FIG. 12 shows a non-limiting example of a schematic illustrating a step of filling gaps in an algorithm for determining a sequence according to some embodiments. Exemplary steps include: (1) beginning at first base, filling in bases with random base (e.g., put C at position 1), and (2) looking both backwards and forwards, where for example, the base at position 2 must not be C to avoid homopolymer with existing CpG.

FIG. 13 shows a non-limiting example of schematic for creating additional motifs in an algorithm for determining a sequence according to some embodiments. For example, if G is placed at position 11, this would create an additional CpG site. C would create a homopolymer, and only options at position 11 are A or T.

FIG. 14 shows a non-limiting example of a methylation control design according to some embodiments.

FIG. 15 shows a non-limiting example of CpG methyltransferase according to some embodiments. M.SssI enzyme can be isolated from a strain of E. coli. which contains the MQ1 Methyltransferase gene. CpG methyltransferase can methylate all cytosine residues within the double-stranded dinucleotide recognition sequence 5′ . . . CG . . . 3′. This process can utilize S-adenosylmethionine (SAM) to add these methylation groups to cytosine nucleotides when in the appropriate recognition sequence.

FIGS. 16A and 16B show a non-limiting example of CpG methyltransferase testing with (FIG. 16A) and without (FIG. 16B) according to some embodiments. Here, 1 ug of a single dsDNA sequence was used with CpG sites. If CpGs are (hemi)methylated, BsmBI may not cut. Nearly full methylation of CpG sites can be achieved when using the NEB CpG Methyltransferase. Bioanalyzer data post-BsmBI digestion showed the final QC trends when material was fully methylated (FIG. 16A) and non-fully methylated (FIG. 16B). Fully methylated material showed a single peak at approximately 170 base pairs. Non-fully methylated material showed several peaks, one peak demonstrating uncut material and two peaks demonstrating digested material.

FIG. 17 shows a non-limiting example of volume vs SPRI ratio in 384-well plate to determine if amplification using a lower volume to increase the SPRI ratio according to some embodiments. The experimental conditions included the following: utilized Design V2 for this experiment; performed PCR using standard oligo pool amplification process at a final volume of 18.75 ul and a final volume of 9.875 ul (cutting all reagents in half except for the oligo pool); and performed SPRI clean up at either 1× on the volume at 18.75 ul and 2× on the volume at 9.875 ul. The results show the gain achieved from using a larger SPRI ratio may be lost since the PCR reaction may not produce as much product using a lower volume. Further development may utilize about 18 ul of total PCR volume and a 1×SPRI ratio.

FIGS. 18A and 18B show a non-limiting example of a first set of methylation control results (1/2) according to some embodiments. The results include a figure showing percent methylation for various controls (FIG. 18A) and a table illustrating the mean standard deviation and standard mean error for various methylation levels (FIG. 18B).

FIGS. 19A and 19B show a non-limiting example of a second set of methylation control results (3/4) according to some embodiments. The results include a figure showing percent methylation for various controls (FIG. 19A) and a table illustrating the mean standard deviation and standard mean error for various methylation levels (FIG. 19B).

FIGS. 20A and 20B show a non-limiting example of methylation results according to some embodiments. Because of the BsmBI site added to each sequence, methylation level were tested in a different way to double check our results. For Methylation levels 100% and 0% for sets 1/2 and 3/4, 1 ug were added in to their own separate BsmBI reaction. Results showed similar trends, 100% methylation levels are not 100% methylated, and more so in the 3/4 set. In some cases, changes can be made the input of DNA or enzyme. In some cases, BsmB1 QC Step can be added before pooling using incubation of 1 hr.

FIGS. 21A and 21B show a non-limiting example of generating methylation controls according to some embodiments. Experimental Conditions included: start at Primer Removal step, add more SAM in a smaller volume, 320 uM compared to 160 uM, 20 ul vs 50 ul, use BsmBI to QC for methylation conversion.

FIGS. 22A, 22B, and 22C show a non-limiting example of generating methylation controls with peaks from FIGS. 21A and 21B highlighted.

FIGS. 23A and 23B show a non-limiting example of generating methylation controls according to some embodiments. Experimental Conditions included: start at previous methylation attempt, add 3× more enzyme in larger volume, 160 uM SAM, 50 ul, 12 units vs 4 units, use BsmBI to QC for methylation conversion.

FIGS. 24A and 24B show a non-limiting example of non-limiting example of generating methylation controls with peaks from FIGS. 23A and 23B highlighted.

FIGS. 25Ai, 25Aii, and 25Aiii show a non-limiting example of methylation control results according to some embodiments. The results include BA Traces of Final Product prior to pooling as well as qubit concentration of final product prior to pooling.

FIGS. 25Bi, 25Bii, and 25Biii show further non-limiting example of methylation control results according to some embodiments. The results include BA Traces of Final Product prior to pooling as well as qubit concentration of final product prior to pooling.

FIGS. 26A and 26B show a non-limiting example of methylation control results according to some embodiments. Shown are results for two different amplification round attempts.

FIG. 27 shows an example of eight specific levels of methylation with three distinct number of CpG sites per sequence, 2, 8, and 18, according to some embodiments. Within each methylation level containing a unique sequence, the material was made up of either low (2, purple or left), medium (8, orange or middle), or high (18, green or right) CpG sites. Each pool of controls contained different ratios of methylation levels in order to symbolize 0%, 3%, 6%, 12%, 25%, 50%, 75%, or 100%. This was achieved by mixing unique sequences that were 0% methylated material (lighter color) and 100% methylated material (darker color).

FIG. 28 shows a non-limiting example of a methylation control workflow, according to some embodiments. The methylation control process can start with the design strategy and DNA synthesis. Quantification can then occur, followed by a pooling operation. Pooling can comprise pooling based on high, medium, or low CpG sites, and/or replicates. The pools can then be enzymatically methylated. Mixtures of different methylation levels can then be made using the methylated and unmethylated pools.

FIG. 29 shows a non-limiting example of a methylation control detection system overview using methylation controls, according to some embodiments. Methylation controls can be spiked-in to sample gDNA and allowed to go through a library preparation conversion process. Libraries can then go through hybrid capture using user-defined panels and a specific panel complementary to the methylation controls. Methylation controls can be pulled down and sequenced alongside gDNA molecules and can be quantified using standard methylation sequencing methods.

FIG. 30 shows an example of coverage by target GC content for hypomethylated (FIG. 30A) and hypermethylated (FIG. 30B) DNA libraries prepared with bisulfite and enzymatic conversion, according to some embodiments. Improved coverage uniformity was observed across all GC bins when using enzymatic conversion to prepare libraries, regardless of the target methylation state.

FIG. 31 shows an example of measures vs expected percent methylation of each methylation level using a methylation detection system provided herein, according to some embodiments. Quantification of each methylation level was measured by taking the controls through library preparation and target enrichment. The controls were then analyzed using an analysis workflow to determine the amount of methylation for each sequence.

FIGS. 32A, 32B, and 32C, show an example of quantification of individual methylated CpG sites, according to some embodiments. Three amounts of CpG sites per methylation level, 2 (FIG. 32A), 8, (FIG. 32B), and 18 (FIG. 32C), were quantified to determine how many CpG sites were found in each sequence. The data showed that the majority of reads were cither fully methylated (100%) or completely unmethylated (0%), meaning that a 50% methylated control reflect half of the sites being fully methylated in half of the fragments, and half of the sites being completely unmethylated. There were a small number of fragments either missing one site or with one additional site, which likely reflected mild insufficiencies in the process and/or sequencing or conversion errors.

FIG. 33 shows a non-limiting example of the combination of an evaluation of aligners and methylation callers, according to some embodiments. Three aligners and two methylation callers were tested.

FIG. 34 show a non-limiting example of a summary of the bioinformatic processing steps utilizing the BWA-meth/MethylDackel analysis workflow, according to some embodiments. Reads were down-sampled, adapter trimmed, and aligned to the converted genome with BWA meth. After alignment, CpG methylation state was called with methydackel, and other sequencing metric (e.g., enrichment, GC bias, etc.) were collected with Picard.

FIG. 35 shows oligos of CNV covering all exons of target ERBB2, according to some embodiments. Whole gene coverage for all coding sequences of the CNV allows for compatibility with multiple assay formats, including both amplicon based and target enrichment chemistries. All 29 exons of the MANE gene model were covered with some intergenic regions as a buffer.

FIG. 36 shows CNV oligo depth covering all exons of target ERBB2, according to some embodiments. An extended IGV view is shown of the exons 6, 7, 8 and 9 illustrating the depth of oligo coverage for each base within the exon. Each base in the coding region of ERBB2 is covered by an average of 20.875 oligos.

FIG. 37 shows size distribution of a pan-cancer reference standard with and without ERBB2 CNV spike-in, according to some embodiments. Size of cfDNA libraries using a pan-cancer reference standard with (FIG. 37A, top) and without (FIG. 37B, bottom) the ERBB2 CNV Spike-in are shown. Libraries were constructed using UMI adapters (77 bp in length each). Total average length of cfDNA, 5% VAF pan-cancer reference, and the novel ERBB2 CNV Spike-in with adapters was 321 bp.

FIG. 38 shows a relative abundance of ERBB2 detected by ddPCR, according to some embodiments. Bar graph illustrating the increase in the relative abundance of ERBB2 relative to a non-template control is shown. Samples spiked with the ERBB2 control consistently showed a relative abundance of 8-10 fold increases relative to our native 0% VAF and 5% VAF pan-cancer standard.

FIG. 39 shows increased depth of coverage of ERBB2 with CNV Spike-in, according to some embodiments. IGV trace illustrating the increased depth of coverage for ERBB2 when CNV is spiked into the pan-cancer 5% VAF standard reference.

FIG. 40 shows a visual summary of increased depth of coverage of ERBB2 with CNV Spike-in, according to some embodiments. A dodged histogram is shown with the frequency (log axis) of depth of coverage between a sample negative for the ERBB2 spike and a sample positive for the ERBB2 CNV Spike-in.

FIG. 41 shows a proportion of ERBB2 CNV Control relative to background at genomic loci where the spiked in single nucleotide allele is different from the homozygous background allele, according to some embodiments. Spiked ERBB2 increased the total count of ERBB2 reads within NGS assay as well as decreased the proportion of WT reads. Shown are the read counts that contain either the background SNP from a cfDNA donor or the HG38 WT reference in the CNV reference standard for three loci within ERBB2. These loci include: chr17:39709752 (C>T; WT to Background Donor SNP), chr17:39723509 (G>A), and chr17:39727784 (C>G).

FIG. 42A depicts a schematic describing the process of configuring the RNA fusion content of a control.

FIG. 42B depicts a PI (partner 1) fusion exon on the left, including 750 nucleotides of sequence 3′- of the breakpoint, and a P2 (partner 2, right).

FIGS. 43Ai-43Cii depict a heatmap of fusion representation (presence/absence and normalized coverage) within each sample in a neat pool QC experiment. Results are shown for the following configurations: all-160 (left), fusion-80 (middle), and fusion-12 (right), in each of FIGS. 43Ai-43Cii. All expected fusions spiked-in (100%) in each sample are detected, but each configuration is different and may have non-overlapping fusions in the design. FIGS. 43Ai-Aii depict a first set of fusions, FIGS. 43Bi-Bii depicts a second set of fusions, and FIGS. 43Ci-Cii depict a third set of fusions. The legend depicts ranges in from 0.5 (blue) to 2.0 (green) at 0.5 unit intervals.

FIGS. 44Ai-44Ciii depict coverage plots of the reference tracks of one replicate of the fusion-80 configuration. Coordinates start and end with the DNA template input of the RNA transcription reaction. Green bars mark the intended transcription start site; orange bars indicate the intended transcription termination site. FIGS. 44Ai-Aiii depict a first set of fusions, FIGS. 44Bi-Biii depict a second set of fusions, FIGS. 44Ci-Ciii depict a third set of fusions.

FIGS. 45A-45F depict RNA size distributions of control pools. Histograms FIGS. 45A-C depict the distribution of designed sizes of RNAs within each configuration. The x-axes shows design length (nt) from 0 to 4000 in increments of 1000, while the y-axes show construct counts from 0 to 150 in increments of 50 (FIG. 45A), 0 to 10 in increments of 2.5 (FIG. 45B), and 0 to 60 in increments of 20 (FIG. 45C). FIGS. 45D-45F depict bioanalyzer electropherograms showing the measured length distributions of the indicated pool. In the electropherograms, a dashed green line marks the 1500 nucleotide size, the length of most RNA constructs. The x-axes shows length (nt) from 0 to 4000 in increments of 1000, while the y-axes show fluorescence from 0 to 1000 in increments of 25 (FIGS. 45D-E), and 0 to 70 in increments of 20 (FIG. 45F).

FIG. 46A depicts a categorical point plot showing the STAR-Fusion-observed FFPM (fusion fragments per million [total fragments]) versus dilution level, measured in Fusion pool mass percent (spiked into UHR RNA). Each point represents one unique fusion.

FIG. 46B depicts a bar plot depicting the recall rate observed from STAR-Fusion calls on the RNA-seq data.

FIGS. 47Ai-47Bii depict heat maps of identified fusions. FIGS. 47Ai-Aii depict a binary heat map (positive or negative) of STAR-Fusion-identified fusions in the fusion-80 configuration and in the negative control UHR RNA background material. Dark blue is not detected, and light teal is positively detected. FIGS. 47Bi-Bii depict a heat map (linear color scale) showing string-search-identified and -quantified. (Grey is not detected.)

### DETAILED DESCRIPTION

Described herein are compositions and methods for identification of genomic variants. Further provided herein are polynucleotide libraries configured as references or controls to measure detection sensitivity. Further described herein are controls or standards comprising RNA fusions and CNV standards. Further provided herein are methods, systems, and compositions for libraries for methylation analysis enrichment.

### Definitions

Throughout this disclosure, numerical features are presented in a range format. It should be understood that the description in range format is merely for convenience and brevity and should not be construed as an inflexible limitation on the scope of any embodiments. Accordingly, the description of a range should be considered to have specifically disclosed all the possible subranges as well as individual numerical values within that range to the tenth of the unit of the lower limit unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual values within that range, for example, 1.1, 2, 2.3, 5, and 5.9. This applies regardless of the breadth of the range. The upper and lower limits of these intervening ranges may independently be included in the smaller ranges, and are also encompassed within the invention, subject to any specifically excluded limit in the stated range. Where the stated range includes one or both of the limits, ranges excluding either or both of those included limits are also included in the invention, unless the context clearly dictates otherwise.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” in reference to a number or range of numbers is understood to mean the stated number and numbers +/−10% thereof, or 10% below the lower listed limit and 10% above the higher listed limit for the values listed for a range.

As used herein, the terms “preselected sequence”, “predefined sequence” or “predetermined sequence” are used interchangeably. The terms mean that the sequence of the polymer is known and chosen before synthesis or assembly of the polymer. In particular, various aspects of the invention are described herein primarily with regard to the preparation of nucleic acids molecules, the sequence of the oligonucleotide or polynucleotide being known and chosen before the synthesis or assembly of the nucleic acid molecules.

The term nucleic acid encompasses double- or triple-stranded nucleic acids, as well as single-stranded molecules. In double- or triple-stranded nucleic acids, the nucleic acid strands need not be coextensive (e.g., a double-stranded nucleic acid need not be double-stranded along the entire length of both strands). Nucleic acid sequences, when provided, are listed in the 5′ to 3′ direction, unless stated otherwise. Methods described herein provide for the generation of isolated nucleic acids. Methods described herein additionally provide for the generation of isolated and purified nucleic acids. The length of polynucleotides, when provided, are described as the number of bases and abbreviated, such as nt (nucleotides), bp (bases), kb (kilobases), Mb (megabases) or Gb (gigabases).

Provided herein are methods and compositions for production of synthetic (e.g. de novo synthesized or chemically synthesized) polynucleotides. The term oligonucleic acid, oligonucleotide, oligo, and polynucleotide are defined to be synonymous throughout. Libraries of synthesized polynucleotides described herein may comprise a plurality of polynucleotides collectively encoding for one or more genes or gene fragments. In some instances, the polynucleotide library comprises coding or non-coding sequences. In some instances, the polynucleotide library encodes for a plurality of cDNA sequences. Reference gene sequences from which the cDNA sequences are based may contain introns, whereas cDNA sequences exclude introns. Polynucleotides described herein may encode for genes or gene fragments from an organism. Exemplary organisms include, without limitation, prokaryotes (e.g., bacteria) and eukaryotes (e.g., mice, rabbits, humans, and non-human primates). In some instances, the polynucleotide library comprises one or more polynucleotides, each of the one or more polynucleotides encoding sequences for multiple exons. Each polynucleotide within a library described herein may encode a different sequence, e.g., non-identical sequence. In some instances, each polynucleotide within a library described herein comprises at least one portion that is complementary to sequence of another polynucleotide within the library. Polynucleotide sequences described herein may be, unless stated otherwise, comprise DNA or RNA. A polynucleotide library described herein may comprise at least 10, 20, 50, 100, 200, 500, 1,000, 2,000, 5,000, 10,000, 20,000, 30,000, 50,000, 100,000, 200,000, 500,000, 1,000,000, or more than 1,000,000 polynucleotides. A polynucleotide library described herein may have no more than 10, 20, 50, 100, 200, 500, 1,000, 2,000, 5,000, 10,000, 20,000, 30,000, 50,000, 100,000, 200,000, 500,000, or no more than 1,000,000 polynucleotides. A polynucleotide library described herein may comprise 10 to 500, 20 to 1000, 50 to 2000, 100 to 5000, 500 to 10,000, 1,000 to 5,000, 10,000 to 50,000, 100,000 to 500,000, or 50,000 to 1,000,000 polynucleotides. A polynucleotide library described herein may comprise about 370,000; 400,000; 500,000 or more different polynucleotides.

### Libraries of Variants

Provided herein are polynucleotide libraries configured to measure the sensitivity of variant measurements (e.g., fusions, indels, epigenetic variant, or other variant). In some instances, these libraries are used as references or controls. Known methods of generating such libraries may comprise isolating nucleic acids from biological sources (e.g., blood, plasma, cells, etc. for example, from patients) with an established disease or condition. However, known methods in some instances provide libraries which contain contamination from their biological source, have increased cost to prepare/purify, are available in limited quantities, are not generally customizable for specific applications (e.g., stoichiometry of each member of the library), or have significant variation between sources. In some instances, libraries are produced from biological samples to mimic cell-free DNA (cfDNA) by restriction digestion, sonication, or other method of generating short nucleic acid fragments. These methods may not mimic the natural fragmentation profile of cfDNA. Additionally, low abundance variants may not be detected from biologically-derived libraries. Provided herein are methods comprising design and de-novo synthesis of polynucleotide libraries (or sample sets) which are useful for measuring variant frequencies. Such libraries in some instances provide enhanced accuracy for diagnosing diseases or conditions, and are substantially free of biological contamination. Synthetic polynucleotide libraries in some instances provide additional control over library content, reliability/reproducibility, lack of reliance on fragmentation methods, or provide other advantages over traditional cell-derived libraries. In some instances, the synthetic polynucleotide libraries comprise a plurality of polynucleotides with sequences corresponding to one or more genetic abnormalities (e.g., fusion) in a genome. In some instances, the synthetic polynucleotide libraries comprise a plurality of polynucleotides with sequences corresponding to one or more post-transcriptional modifications, such as methylation. The one or more genetic abnormalities may be indicative of a disease or condition, such as, by way of non-limiting example, Lung Adenocarcinoma, Thyroid Papillary Carcinoma, Leukemia (Acute and Chronic), Prostate Adenocarcinoma, or Ewing's Sarcoma. These libraries (sample libraries or variant libraries) are in some instances mixed with control nucleic acids (e.g., cfDNA) to generate reference standards at specific VAFs (variant allele frequencies). In some instances, a polynucleotide library comprises a sample polynucleotide set comprising polynucleotides derived from genomic sequences. In some instances, a polynucleotide library comprises a background set comprising background polynucleotides, wherein the background set comprises cell-free DNA (cfDNA). In some instances, at least some of the polynucleotides of the sample polynucleotide set comprise at least one variant, wherein the at least one variant comprises one or more changes compared to a background polynucleotide. In some instances, at least some of the polynucleotides of the sample set are tiled across each of the at least one variant. In some instances, background cfDNA is obtained, derived, or expanded from a cell line or patient sample. In some instances, stoichiometry for each of the plurality of polynucleotides in a synthetic library are controlled.

Provided herein are libraries of polynucleotides comprising pre-determined variant sequences (e.g., variants). In some instances, libraries comprise at least 1, 5, 10, 15, 20, 25, 50, 75, 100, 150, 200, 250, 300, 350, 400, 450, 500, 750, 1000, or at least 2000 variants. In some instances, libraries comprise about 1, 5, 10, 15, 20, 25, 50, 75, 100, 150, 200, 250, 300, 350, 400, 450, 500, 750, 1000, or about 2000 variants. In some instances, libraries comprise no more than 1, 5, 10, 15, 20, 25, 50, 75, 100, 150, 200, 250, 300, 350, 400, 450, 500, 750, 1000, or no more than 2000 variants. In some instances, libraries comprise 1-500, 5-500, 10-500, 10-2000, 10-150, 15-500, 20-1000, 50-500, 50-750, 50-1000, 100-1000, 100-500, 100-750, 250-800, 400-1000, or 400-2000 variants.

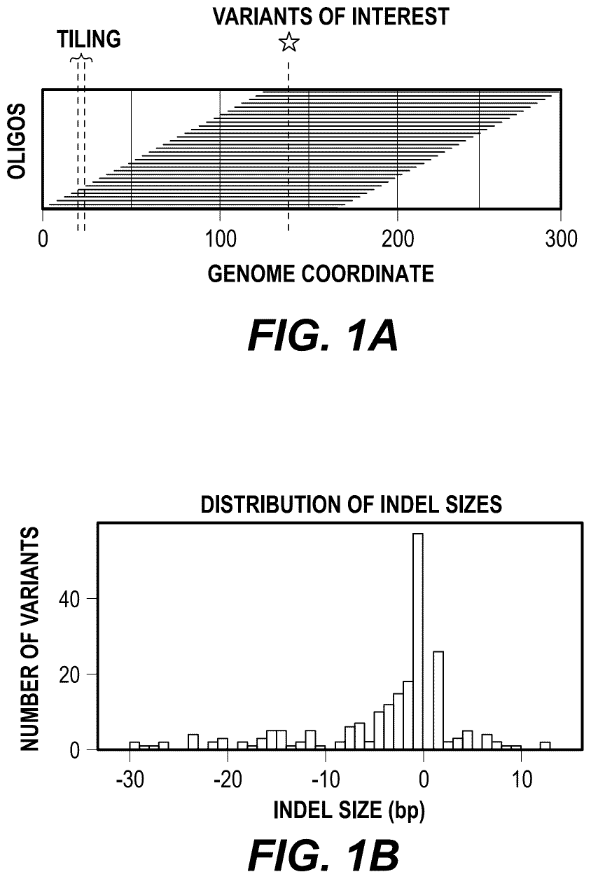

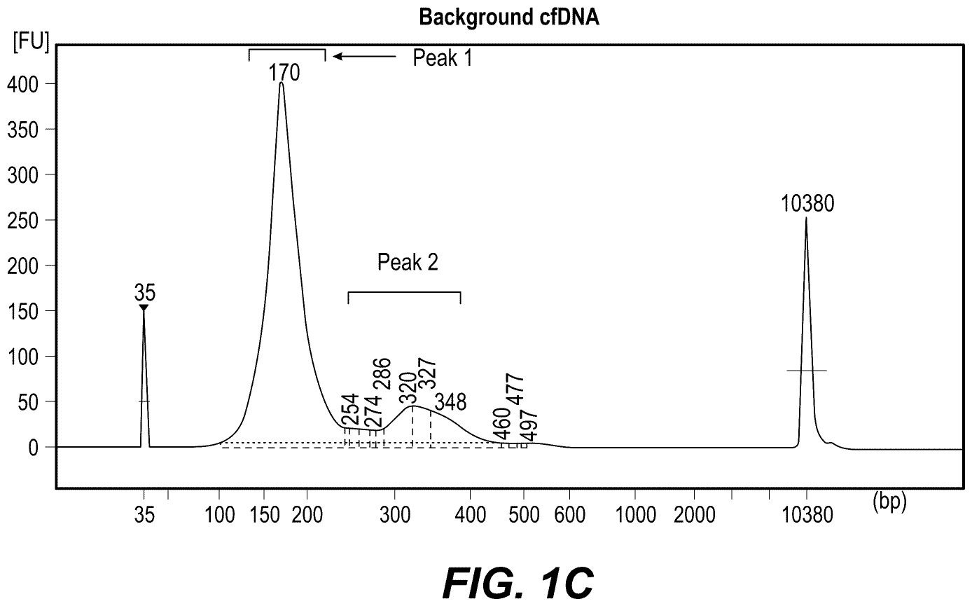

Polynucleotides provided herein may be tiled across a nucleic acid region. In some instances, polynucleotides comprise sequences representative of variants (e.g., CNVs). In some instances tiling describes the design of polynucleotides (or complements or reverse complements thereof) which cover or span a target area (such as a variant). An example of a tiling arrangement is shown in FIG. 1A. In some instances, tiling results in increases in sensitivity for detection either for probes targeting the variant, or in the design of corresponding standards, controls, or references. This is in some instances beneficial for regions of low abundance or comprising difficult sequences to sequence (repeating, high/low GC, or other challenge). In some instances, tiled polynucleotides for a target region are each different. Such tiling designs in some instances comprise about 2, 3, 4, 5, 6, 7, 8, 9, 10, 11, 12, 15, 20, 25, 27, 30, 32, 35, 40, 45, or about 50 polynucleotides tiled across a region (e.g., variant). Tiling designs in some instances comprise at least 2, 3, 4, 5, 6, 7, 8, 9, 10, 11, 12, 15, 20, 25, 30, 35, 40, 45, or at least 50 polynucleotides tiled across a region. Tiling designs in some instances comprise 10-100, 5-50, 2-50, 25-50, 30-40, or 30-60 polynucleotides tiled across a region. In some instances, tiled polynucleotides comprise at least one overlap region with another polynucleotide. In some instances, both 5′ and 3′ termini of a tiled polynucleotide overlap with an adjacent tiled polynucleotide. In some instances, one or more tiled polynucleotides are tiled with an offset value, such that a first polynucleotide starts at a different position than the next tiled polynucleotide. In some instances, the offset is about 1, 2, 3, 4, 5, 6, 7, 8, 9, 10, 12, 15, 17, 20, 25, or 30 bases. In some instances, the offset is 1-30, 1-20, 1-10, 1-8, or 2-5 bases. In some instances, the length of at least some of the polynucleotides is 20-500, 50-500, 75-500, 100-200, 100-500, 200-500, 100-250, 100-200, 100-1000, 250-500, or 250-1000. In some instances, the length of at least some of the polynucleotides is about 50, 75, 100, 125, 150, 155, 160, 165, 170, 175, 180, 190, 200, or 225 bases. In some instances, the length of at least 80% of the polynucleotides is 20-500, 50-500, 75-500, 100-200, 100-500, 200-500, 100-250, 100-200, 100-1000, 250-500, or 250-1000. In some instances, the length of at least 80% of the polynucleotides is about 50, 75, 100, 125, 150, 155, 160, 165, 170, 175, 180, 190, 200, or 225 bases. In some instances, the length of at least 90% of the polynucleotides is 20-500, 50-500, 75-500, 100-200, 100-500, 200-500, 100-250, 100-200, 100-1000, 250-500, or 250-1000. In some instances, the length of at least 90% of the polynucleotides is about 50, 75, 100, 125, 150, 155, 160, 165, 170, 175, 180, 190, 200, or 225 bases. In some instances, at least some of the polynucleotides are double stranded. In some instances, at least 50%, 60%, 70%, 75%, 80%, 90%, 95%, or at least 98% of the polynucleotides are double stranded. In some instances polynucleotides are tiled (coverage) on a target region at 1×, 1.5×, 2×, 2.5×, 3×, 4× 5×, 10×, 15×, 20×, 30×, 50×, or 75×. In some instances, a polynucleotide library comprises overlapping polynucleotides. In some instances, polynucleotides overlap at least 5, 10, 15, 20, 25, 30, 35, 40, 50, 60, 70, 80, 100, 150, 200, or at least 300 bases. In some instances, polynucleotides overlap 5-200, 5-100, 10-200, 10-150, 25-150, 50-150, 75-200, 100-200, 150-200, or 75-150 bases.

Polynucleotides may be tiled and organized into clusters. In some instances, each cluster comprises 3-10, 1-10, 2-10, 2-20, 2-8, 4-16, 4-10 or 3-8 polynucleotides per cluster. In some instances, each polynucleotide in a cluster is tiled 1, 2, 3, 4, 5, 6, or 7 bases (e.g., offset) along the gene. In some instances the start position for each cluster is 5-10, 2-20, 1-20, 1-10, 3-16, 4-12, 5-8, 6-8 or 8-16 bases between clusters. A tiled polynucleotide library may be described as having a mean max coverage. In some instances, the mean max coverage comprises the equation polynucleotide length*(length covered/(length covered+length skipped)). In some instances a polynucleotide library is designed to avoid or substantially reduce repetitive regions. In some instances a polynucleotide library substantially free of repetitive regions. Non-limiting examples of repetitive regions include LINE or SINE.

Variants may be present at a predetermined frequency relative to other variants in a library (e.g., sample library). In some instances, at least 80% of the at least one variants are present at frequencies that differ by no more than 20%, 15%, 12%, 10%, 8% or no more than 5% relative to the expected frequency for uniformly pooled variants. In some instances, at least 90% of the at least one variants are present at frequencies that differ by no more than 20%, 15%, 12%, 10%, 8% or no more than 5% relative to the expected frequency for uniformly pooled variants. In some instances, at least 95% of the at least one variants are present at frequencies that differ by no more than 20%, 15%, 12%, 10%, 8% or no more than 5% relative to the expected frequency for uniformly pooled variants. In some instances, at least 99% of the at least one variants are present at frequencies that differ by no more than 20%, 15%, 12%, 10%, 8% or no more than 5% relative to the expected frequency for uniformly pooled variants.

Compositions described herein may comprise a background set (or library) of polynucleotides. The background set in some instances mimics the background cfDNA that would be present in a patient sample. In some instances, background polynucleotides are mixed with sample polynucleotides (e.g., polynucleotides comprising variants, variant polynucleotide libraries) to generate reference standards or controls. Standards or controls in some instances comprise variants having a VAF of 0%, 0.1% 0.25%, 0.5%, 1%, 2%, 5%, 10%, 15%, or 20% relative to a wild-type genomic sequence. In some instances, the background polynucleotide set comprises wild-type regions corresponding to locations of the at least one variant. In some instances, wild-type sequences are derived from a reference database or sample. In some instances, the background polynucleotide set comprises wild-type regions corresponding to locations of the at least 1, 2, 5, 10, 15, 20, 25, 50, 75, 100, 125, 150, 200, 250, 300, 350, 400, 450, 500, or at least 500 variants. In some instances, the wild-type regions are represented within 30%, 25%, 20%, 15%, 12%, 10%, 9%, 8%, 7%, or within 5% of the variant frequency of the variant set. In some instances, the background set comprises a low level amount of variations. In some instances, least one background polynucleotide comprises a variant present at a frequency of 0.001%, 0.01%, 0.1% 0.25%, 0.5%, 1%, or 2% relative to a wild-type genomic sequence. In some instances, least 1% of the background polynucleotides comprise a variant present at a frequency of 0.001%, 0.01%, 0.1% 0.25%, 0.5%, 1%, or 2% relative to a wild-type genomic sequence. In some instances, a background set is synthesized from pre-determined sequences. In some instances, the pre-determined sequences reflect desired variant frequencies. In some instances, synthetic background sets are used to calibrate instruments or methods by providing control over variant frequencies. In some instances, synthetic background sets are configured to mimic variant frequencies corresponding to specific samples or disease states.

In some instances, a background set comprises background polynucleotides. In some instances, a background set comprises background polynucleotides which substantially consist of wild-type sequences. In some instances, background sets are derived or isolated from healthy individuals. In some instances, the individual is a male. In some instances, the individual is a female. In some instances, the individual is no more than 40, 35, 30, 25, 20, or 15 years old. In some instances, background sets are obtained from a biological sample. In some instances, the biological sample comprises blood, plasma, or other source of nucleic acids. In some instances, the background set comprises cfDNA. In some instances, background sets comprises at least 2, 5, 10, 100, 200, 500, 1000, 10,000, 100,000, 500,000 polynucleotides, 1 million, 5 million, 10 million, 50 million, 100 million, 200 million, or more than 500 million polynucleotides. In some instances, the highest abundance of polynucleotides in the background set are 100-500, 50-500, 75-250, 50-750, 50-300, 100-300, 100-200, 125-300, 150-175, 150-185, or 125-200 bases in length. In some instances, at least 50%, 60%, 70%, 75%, 80%, 85%, 90%, 95%, or at least 97% of the polynucleotides in the background set are mononucleosomal or dinucleosomal. In some instances, the ratio of mononucleosomal to dinucleosomal is 50:50 to 90:10, 60:40 to 90:10, 60:40 to 95:5, 70:30 to 95:5, 70:30 to 90:10, or 80:20 to 95:5.

Polynucleotide libraries described herein may be mixed to form standards. In some instances, a (reference) standard comprises both a sample (variant) polynucleotide set and control polynucleotide. In some instances, standards comprising both a sample (variant) polynucleotide set and control polynucleotide set further comprise a liquid buffer. In some instances, the buffer comprises TE or TBE buffer. In some instances, standards comprise no more than 50%, 40%, 30%, 25%, 20%, 15%, or no more than 10% sample (variant) polynucleotides relative to background polynucleotides. Standards or controls in some instances comprise variants having a VAF of 0%, 0.1% 0.25%, 0.5%, 1%, or 2% relative to a wild-type genomic sequence. In some instances, a standard is subjected to one or more quality control operations including one or more of fluorescence/UV DNA quantification, electrophoretic size analysis, sequencing, ddPCR analysis, or other analysis technique. In some instances, a sample polynucleotide set is subjected to one or more quality control operations including one or more of fluorescence/UV DNA quantification, electrophoretic size analysis, sequencing, ddPCR analysis, or other analysis technique prior to mixing with a background polynucleotide set. In some instances, adapters comprising UMIs are ligated to sample polynucleotides. In some instances, polynucleotides are mixed with donor background libraries.

Synthetic libraries (e.g., sample libraries/sets) comprising variants may have fewer contaminants (less contamination) than libraries derived from biological samples. A lower level of contaminants in some instances results in improved performance as a reference standard. In some instances, contamination includes but is not limited to cellular components, lipids, RNA, proteins, or other biomolecules derived from the biological source. In some instances, the biological source comprises plasma, cells, blood, or other source of nucleic acids. In some instances, synthetic libraries are prepared or stored in a buffer. In some instances, a synthetic library is at least 95%, 96%, 97%, 98%, 99%, 99.5%, or at least 99.7% free from biological contaminants.

### Cancer Diagnostics

The libraries provided herein may be used to detect or diagnose a disease. For example, the libraries provided herein may detect one or more epigenetic marks that are associated with the disease. In some embodiments, an epigenetic mark comprises histone modification. In some embodiments, an epigenetic mark comprises DNA methylation. In some embodiments, an epigenetic mark comprises noncoding RNA. The epigenetic mark or combination of epigenetic marks may be used to control or regulate gene expression.

In some embodiments, the disease is cancer. Non-limiting examples of cancers include Adenoid Cystic Carcinoma, Adrenal Gland Cancer, Amyloidosis, Anal Cancer, Ataxia-Telangiectasia, Atypical Mole Syndrome, Basal Cell Carcinoma, Bile Duct Cancer, Birt Hogg Dube Syndrome, Bladder Cancer, Bone Cancer, Brain Tumor, Breast Cancer, Breast Cancer in Men, Carcinoid Tumor, Cervical Cancer, Colorectal Cancer, Ductal Carcinoma, Endometrial Cancer, Esophageal Cancer, Gastric Cancer, Gastrointestinal Stromal Tumor (GIST), HER2-Positive Breast Cancer, Islet Cell Tumor, Juvenile Polyposis Syndrome, Kidney Cancer, Laryngeal Cancer, Leukemia-Acute Lymphoblastic Leukemia, Leukemia-Acute Lymphocytic (ALL), Leukemia-Acute Myeloid AML, Leukemia—Adult, Leukemia—Childhood, Leukemia—Chronic Lymphocytic (CLL), Leukemia—Chronic Myeloid (CML), Liver Cancer, Lobular Carcinoma, Lung Cancer, Lung Cancer—Small Cell (SCLC), Lung Cancer—Non-small Cell (NSCLC), Lymphoma—Hodgkin's, Lymphoma-Non-Hodgkin's, Malignant Glioma, Melanoma, Meningioma, Multiple Myeloma, Myelodysplastic Syndrome (MDS), Nasopharyngeal Cancer, Neuroendocrine Tumor, Oral Cancer, Osteosarcoma, Ovarian Cancer, Pancreatic Cancer, Pancreatic Neuroendocrine Tumors, Parathyroid Cancer, Penile Cancer, Peritoneal Cancer, Peutz-Jeghers Syndrome, Pituitary Gland Tumor, Polycythemia Vera, Prostate Cancer, Renal Cell Carcinoma, Retinoblastoma, Salivary Gland Cancer, Sarcoma, Sarcoma—Kaposi, Skin Cancer, Small Intestine Cancer, Stomach Cancer, Testicular Cancer, Thymoma, Thyroid Cancer, Uterine (Endometrial) Cancer, Vaginal Cancer, and Wilms' Tumor.

Genetic material to detect a disease can be obtained from a biopsy or a fluid sample from an individual. Non-limiting examples of a biopsy comprises a surgical (excisional) biopsy, shave biopsy/punch biopsy, endoscopic biopsy, laparoscopic biopsy, bone marrow aspiration and biopsy, and liquid biopsy. In some embodiment, the biopsy is a liquid biopsy. In some embodiments, the fluid sample comprises blood, serum, plasma, sweat, hair, tears, urine, which can be obtained using techniques known by one of skill in the art.

### Methylation Analysis

The libraries provided herein may be used for methylation analysis. DNA methylation at CpG nucleotide sites in eukaryotes can be a key epigenetic mark that can help control gene expression. Specific changes in CpG methylation can occur in many human cancers, making them a promising biomarker for early cancer detection, especially in the context of liquid biopsy testing. For example, DNA methylation modifications on specific nucleotides can affect gene expression levels through epigenetic processes, demonstrating changes in levels being linked to specific cancer types. Cytosine methylation is most commonly found at CG sequences in the genome, referred to as a CpG site, and is widely used to regulate gene expression in a cell-type specific manner. Defining the level of expression in a normal cell versus a cancer cell using a control sequence at a specific level can be life altering for patients. However, assays for methylation detection can often be only semi-quantitative for the methylated fraction, making it difficult to firmly establish the limit of detection for these assays and to define methylation levels in a given sequence.

Provided herein are designs and developments for a CpG methylation specific control that can impact the future cancer diagnosis by helping to calibrate assays that determine site-specific methylation rates. In some instances, the use of the control results in higher confidence for a diagnosis. In some instances, the use of the control confirms the diagnostic instrument is performing within specifications. In some instances, the systems and methods provided herein demonstrate an improved method for calibrating detection assays across a range of methylation levels (e.g., 0 to 100%). In some instances, the detection assays comprise variable amounts of CpG sites (e.g., 1 to 20 sites). In some instances, the systems and methods provided herein are used to analyze patterns in data related to methylation levels. In some instances, the patterns reflect chemical changes to one or more methylated or unmethylated bases. In some instances, the libraries comprising polynucleotides are constructed using DNA synthesis methods, such as those described herein

The libraries (e.g., methylation controls) comprising polynucleotides may comprise one or more pools. In some instances, the libraries comprise one or more sequences. In some instances, each sequence is a unique sequence. Each sequence may be about 50 to 300 bases in length. In some instances, each pool of the one or more pools comprises a unique sequence. In some instances, each pool comprises about 10 to 150 sequences. In some instances, each pool comprises about 10 to 20, 10 to 30, 10 to 40, 10 to 50, 10 to 60, 10 to 70, 10 to 80, 10 to 90, 10 to 100, 10 to 120, 10 to 150, 20 to 30, 20 to 40, 20 to 50, 20 to 60, 20 to 70, 20 to 80, 20 to 90, 20 to 100, 20 to 120, 20 to 150, 30 to 40, 30 to 50, 30 to 60, 30 to 70, 30 to 80, 30 to 90, 30 to 100, 30 to 120, 30 to 150, 40 to 50, 40 to 60, 40 to 70, 40 to 80, 40 to 90, 40 to 100, 40 to 120, 40 to 150, 50 to 60, 50 to 70, 50 to 80, 50 to 90, 50 to 100, 50 to 120, 50 to 150, 60 to 70, 60 to 80, 60 to 90, 60 to 100, 60 to 120, 60 to 150, 70 to 80, 70 to 90, 70 to 100, 70 to 120, 70 to 150, 80 to 90, 80 to 100, 80 to 120, 80 to 150, 90 to 100, 90 to 120, 90 to 150, 100 to 120, 100 to 150, or 120 to 150 sequences. In some instances, each pool comprises about 10, 15, 20, 25, 30, 35, 40, 45, 50, 55, 60, 65, 70, 75, 80, 85, 90, 95, 100, 120, or 150 sequences. In some instances, each pool comprises at least about 10, 15, 20, 25, 30, 35, 40, 45, 50, 55, 60, 65, 70, 75, 80, 85, 90, 95, 100, 120, or 150 sequences. In some instances, each pool comprises at most about 10, 15, 20, 25, 30, 35, 40, 45, 50, 55, 60, 65, 70, 75, 80, 85, 90, 95, 100, 120, or 150 sequences.

In some instances, a pool of sequences can be constructed with varying methylation levels. In some instances, a pool comprises about 2 to 20 different levels of methylation. In some instances, a pool comprises about 2 to 3, 2 to 4, 2 to 5, 2 to 6, 2 to 7, 2 to 8, 2 to 9, 2 to 10, 2 to 12, 2 to 15, 2 to 20, 3 to 4, 3 to 5, 3 to 6, 3 to 7, 3 to 8, 3 to 9, 3 to 10, 3 to 12, 3 to 15, 3 to 20, 4 to 5, 4 to 6, 4 to 7, 4 to 8, 4 to 9, 4 to 10, 4 to 12, 4 to 15, 4 to 20, 5 to 6, 5 to 7, 5 to 8, 5 to 9, 5 to 10, 5 to 12, 5 to 15, 5 to 20, 6 to 7, 6 to 8, 6 to 9, 6 to 10, 6 to 12, 6 to 15, 6 to 20, 7 to 8, 7 to 9, 7 to 10, 7 to 12, 7 to 15, 7 to 20, 8 to 9, 8 to 10, 8 to 12, 8 to 15, 8 to 20, 9 to 10, 9 to 12, 9 to 15, 9 to 20, 10 to 12, 10 to 15, 10 to 20, 12 to 15, 12 to 20, or 15 to 20 different levels of methylation. In some instances, a pool comprises about 2, 3, 4, 5, 6, 7, 8, 9, 10, 12, 15, or 20 different levels of methylation. In some instances, the level of methylation ranges from about 0% to about 100%. In some instances, the level of methylation ranges from about 0% to 10%, 0% to 20%, 0% to 30%, 0% to 40%, 0% to 50%, 0% to 60%, 0% to 70%, 0% to 80%, 0% to 90%, 0% to 100%, 10% to 20%, 10% to 30%, 10% to 40%, 10% to 50%, 10% to 60% 10% to 70%, 10% to 80%, 10% to 90%, 10% to 100%, 20% to 30%, 20% to 40%, 20% to 50%, 20% to 60%, 20% to 70%, 20% to 80%, 20% to 90%, 20% to 100%, 30% to 40%, 30% to 50%, 30% to 60%, 30% to 70%, 30% to 80%, 30% to 90%, 30% to 100%, 40% to 50%, 40% to 60%, 40% to 70%, 40% to 80%, 40% to 90%, 40% to 100%, 50% to 60%, 50% to 70%, 50% to 80%, 50% to 90%, 50% to 100%, 60% to 70%, 60% to 80%, 60% to 90%, 60% to 100%, 70% to 80%, 70% to 90%, 70% to 100%, 80% to 90%, 80% to 100%, or 90% to 100%. In some instances, the level of methylation is about 0%, 1.5%, 3%, 6%, 10%, 12%, 20%, 25%, 30%, 40%, 50%, 60%, 70%, 75%, 80%, 90%, or 100%. In some instances, the level of methylation is at least about 0%, 1.5%, 3%, 6%, 10%, 12%, 20%, 25%, 30%, 40%, 50%, 60%, 70%, 75%, 80%, or 90%. In some instances, the level of methylation is at most about 1.5%, 3%, 6%, 10%, 12%, 20%, 25%, 30%, 40%, 50%, 60%, 70%, 75%, 80%, 90%, or 100%. In some instances, a pool comprises sequences with the same methylation level.

A polynucleotide provided herein can comprise a number of CpG sites. In some instances, polynucleotide sequences are designed to have a GC content similar to the human genome. In some instances, polynucleotide sequences are designed to avoid stretches of homopolymers. In some instances, a sequence comprises a low, medium or high number of CpG sites. In some instances, a sequence comprises a low, medium, or high number of CpG sites for direct comparisons of sequences with various CpG sites. In some instances, each unique sequence in a pool can comprise different numbers of CpG sites. In some instances, a number of CpG sites is about 1 to 20 sites. In some instances, a number of CpG sites is about 1 to 3, 1 to 4, 1 to 5, 1 to 6, 1 to 7, 1 to 8, 1 to 9, 1 to 10, 1 to 12, 1 to 15, 1 to 20, 2 to 4, 2 to 5, 2 to 6, 2 to 7, 2 to 8, 2 to 9, 2 to 10, 2 to 12, 2 to 15, 2 to 20, 3 to 5, 3 to 6, 3 to 7, 3 to 8, 3 to 9, 3 to 10, 3 to 12, 3 to 15, 3 to 20, 4 to 6, 4 to 7, 4 to 8, 4 to 9, 4 to 10, 4 to 12, 4 to 15, 4 to 20, 5 to 7, 5 to 8, 5 to 9, 5 to 10, 5 to 12, 5 to 15, 5 to 20, 6 to 8, 6 to 9, 6 to 10, 6 to 12, 6 to 15, 6 to 20, 7 to 9, 7 to 10, 7 to 12, 7 to 15, 7 to 20, 8 to 10, 8 to 12, 8 to 15, 8 to 20, 9 to 12, 9 to 15, 9 to 20, 10 to 12, 10 to 15, 10 to 20, 12 to 15, 12 to 20, or 15 to 20 sites. In some instances, a number of CpG sites is 1, 2, 3, 4, 5, 6, 7, 8, 9, 10, 12, 15, or 20 sites. In some instances, a number of CpG sites is at least about 1, 2, 3, 4, 5, 6, 7, 8, 9, 10, 12, or 15 sites. In some instances, a number of CpG sites is at most about 2, 3, 4, 5, 6, 7, 8, 9, 10, 12, 15, or 20 sites. In some embodiments, a low number of CpG sites is less than about 5 sites. In some embodiments, a medium number of CpG sites is about 5 to 10 CpG sites. In some embodiments, a high number of CpG sites is greater than about 10 sites.

One or more CpG sites of a polynucleotide can be methylated. In some instances, polynucleotides are defined by an amount or level of methylation. In some instances, polynucleotides are defined by an amount or level of methylation at each CpG site. In some instances, the level of methylation at a CpG site is about 0% to about 100%. In some instances, the level of methylation at a CpG site is about 0% to 1.5%, 0% to 3%, 0% to 6%, 0% to 12%, 0% to 25%, 0% to 50%, 0% to 75%, 0% to 100%, 1.5% to 3%, 1.5% to 6%, 1.5% to 12%, 1.5% to 25%, 1.5% to 50%, 1.5% to 75%, 1.5% to 100%, 3% to 6%, 3% to 12%, 3% to 25%, 3% to 50%, 3% to 75%, 3% to 100%, 6% to 12%, 6% to 25%, 6% to 50%, 6% to 75%, 6% to 100%, 12% to 25%, 12% to 50%, 12% to 75%, 12% to 100%, 25% to 50%, 25% to 75%, 25% to 100%, 50% to 75%, 50% to 100%, or 75% to 100%. In some instances, the level of methylation at a CpG site is about 0%, 1.5%, 3%, 6%, 12%, 25%, 50%, 75%, or 100%. In some instances, the level of methylation at a CpG site is at least about 0%, 1.5%, 3%, 6%, 12%, 25%, 50%, or 75%. In some instances, the level of methylation at a CpG site is at most about 1.5%, 3%, 6%, 12%, 25%, 50%, 75%, or 100%.

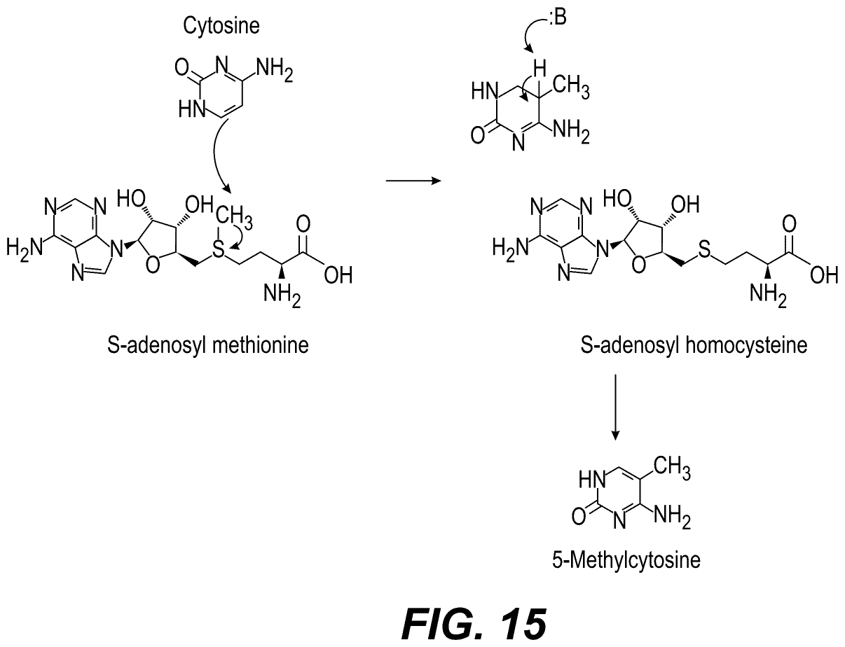

Methylation of a control or panel may be performed using an enzyme. In some instances, the methylation is performed one, two, three, four, or five times. In some instances, the methylation is performed at least one, two, three, four, or five times. In some instances, the methylation is performed at most one, two, three, four, or five times. In some examples, performing methylation twice results in sufficient levels of methylation. In some instances, the enzyme comprises a methyltransferase. In some instances, methylation is performed using a CpG methyltransferase. In some instances, the methyltransferase is M.SssI enzyme. In some instances, the M.SssI enzyme is isolated from a strain of E. coli which contains the MQ1 Methyltransferase gene. In some instances, the M.SssI enzyme methylates all cytosine residues within the double-stranded dinucleotide recognition sequence 5′ . . . CG . . . 3′ (FIG. 15). This process can utilize S-adenosylmethionine (SAM) to add methylation groups to cytosine nucleotides when they are present in the appropriate recognition sequence.

In some instances, polynucleotides are synthesized to mimic circulating tumor (ctDNA). In some instances, the polynucleotides are synthesized for use with workflow to analyze biopsy samples, such as liquid biopsy samples.

The controls provided herein can mimic DNA fragment lengths commonly found in cell-free DNA (cfDNA), such as, for example, about 120 base pairs to about 220 base pairs. In some examples, the length is about 170 base pairs. In some instances, the controls are compatible with experimental workflows that target biopsy applications, such as liquid biopsy applications. In some instances, the controls are compatible with workflows to analyze fluid samples. In some instances, the pools of a control are taken through a workflow to analyze one or more epigenetic markers, such as a target methylation sequencing workflow, using panels designed to target these controls. Target methylation sequencing workflows may comprise those exemplary illustrated in US2022/0135965, which is incorporated herein by reference in its entirety. In some instances, the panels are designed to target these controls as spike-in panels during hybrid capture. In some instances, the sequences in a panel comprise varying amounts of CpG content. In some instances, different levels of methylation are obtained by mixing. For example, different levels of methylation may be obtained by mixing one or more pools each with sequences varying in methylation levels.

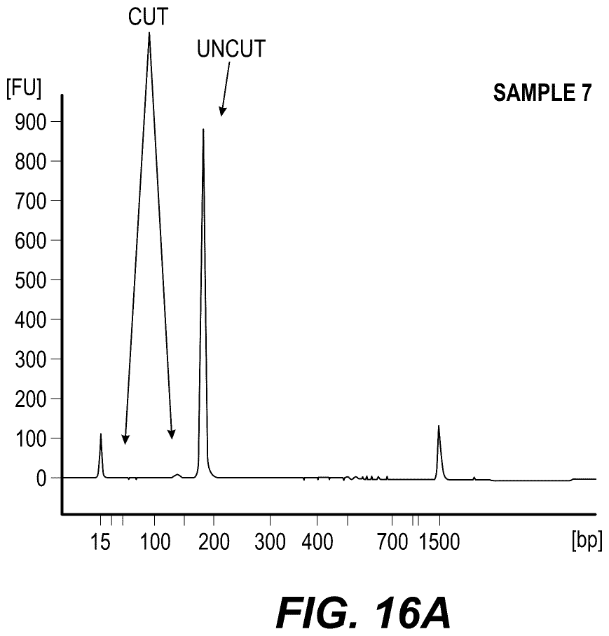

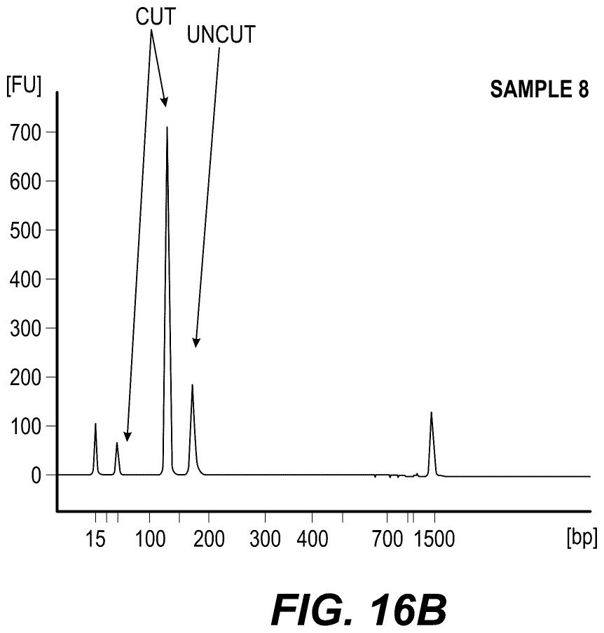

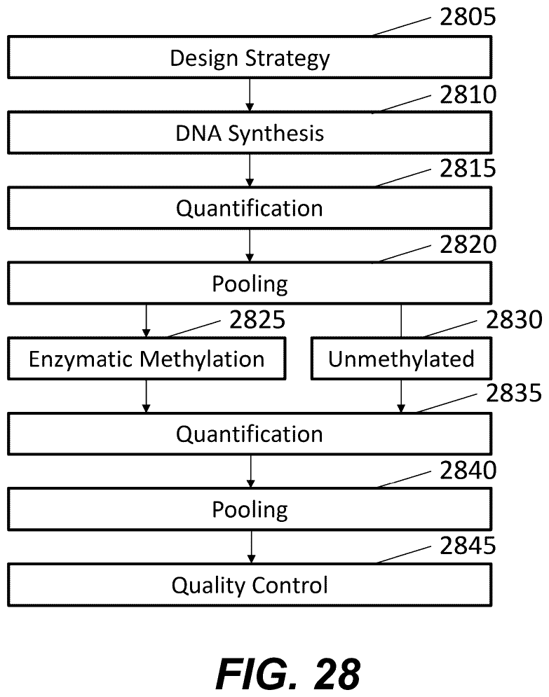

An exemplary methylation control workflow is generally provided in FIG. 28. A methylation control workflow can comprise one or more of: design (2805), synthesis (2810), quantification (2815/2835), pooling (2820/2840), methylation (2825), or quality control (2845). In some instances, each of these operations can be performed more than once during the methylation control workflow. In some instances, the workflow employs one or more quality control measures that can help to ensure performance of methylation pools. In some examples, a quality control measure can comprise, in the design process 2805, adding an enzyme digestion site (e.g., BsmBI digestion site) to each unique sequence. Additionally, a small volume of the polynucleotide sequences designated as 0% methylated and 100% methylated can be taken prior to a second pooling 2840 and BsmBI digestion can be done to QC methylation, since BsmBI may not cut when one or more CpG sites in its recognition site is methylated (e.g., FIG. 16). In some instances, pooling comprises pooling polynucleotides based on CpG sites (e.g., high, medium, or low) and/or replicates (e.g., 2820). In some instances, once polynucleotides are pooled, some may be subsequently methylated 2825 while some are left unmethylated 2830. In some instances, pooling can comprise pooling based on methylated and unmethylated sequenced (e.g., 2840). In some instances, quality control 2845 comprises Next-Generation Sequencing and/or digestion by an enzyme (e.g., BsmBI digest).

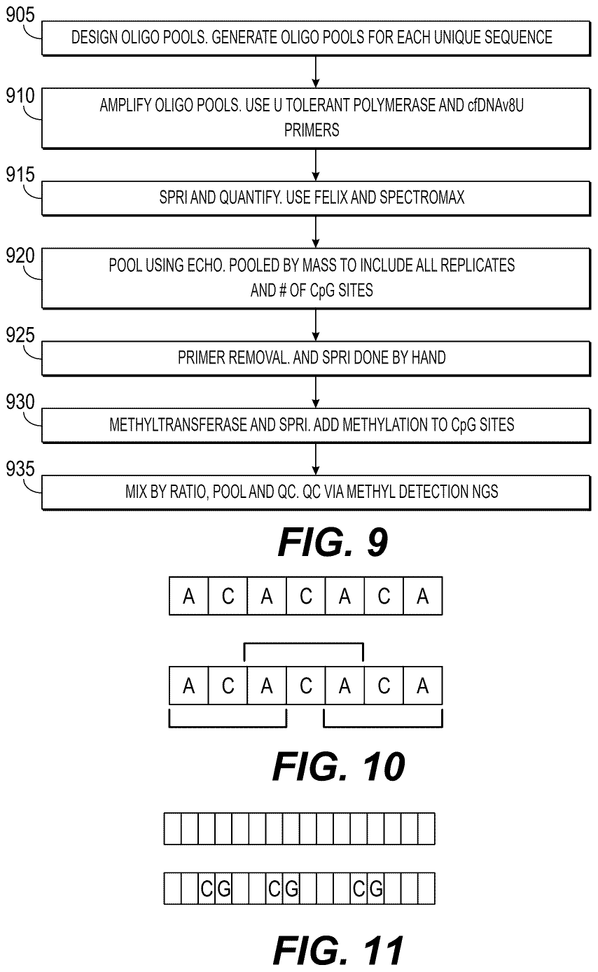

A further exemplary workflow for generation of methylation controls is provided in FIG. 9. The workflows may comprise designing oligo pools 905. In some instances, the oligo pools are each designed to represent a specific methylated nucleic acid sequence. In some instances, oligo pools are generated for each unique sequence (e.g., unique number of CpG sites). The workflow may further comprise amplifying oligo pools 910. In some instances, amplification is performed using a polymerase. In some instances, the polymerase is a uracil tolerant polymerase. In some instances, amplification is performed using custom primers. The workflow may further comprise solid phase reversible immobilization (SPRI) and quantification of the oligo pools 915. The workflow may further comprise pooling, for example, based on mass 920. In some instances, the pools are combined based on mass to include replicates and number of CpG sites. The workflow may further comprise primer removal and purification (e.g., by SPRI) 925. In some embodiments, primer removal is performed manually. In some embodiments, primer removal is performed automatically. The workflow may further comprise adding methylation to one or more CpG sites of oligos in the oligo pools via methyltransferase 930. In some instances, the methylated products are purified (e.g., by SPRI). The workflow may further comprise mixing the pools based on methylation ratio 935. In some instances, the pools are subjected to pooling and/or QC. In some embodiments, QC is performed using methylation detection platforms comprising Next Generating Sequencing.

A method for designing a methylation control sequence may generally comprise placing at least one CpG site into a sequence and filling each empty spots in a sequence with base. In some instances, designing a methylation control sequence comprises placing one or more CpG sites into a sequence, wherein each of the CpG sites is separated by a spacing. In some instances, designing a methylation control sequence comprises filling each of the spacings between the one or more CpG sites. In some instances, the spacing is filled with one or more bases to avoid homopolymers. In some instances, placing at least one CpG site into a sequence comprises adding one or more CpG sites to a list and permuting the list. In some instances, placing at least one CpG site into a sequence comprises determining padding spaces between the one or more CpG sites. In some instances, placing at least one CpG site into a sequence comprises randomly partition spacing between the one or more CpG sites. Each of the CpG site into a sequence may then be placed into the sequence. The remaining base positions may then be filled randomly to avoid homopolymers.

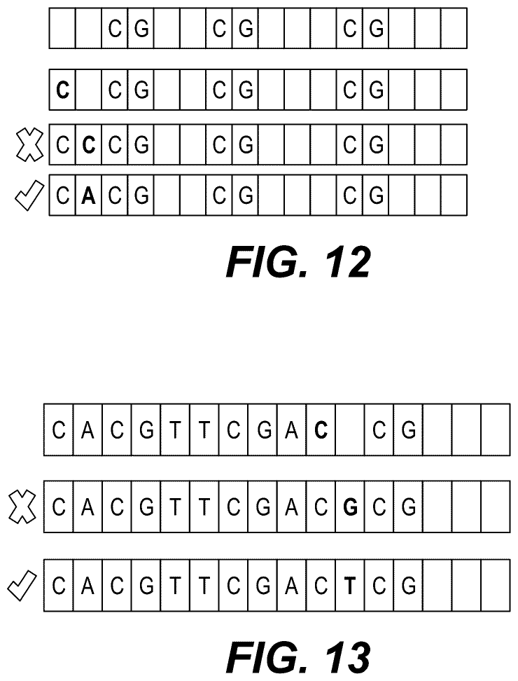

A process for designing such oligoes is exemplary illustrated in FIGS. 10-13 using an exemplary string. The number of overlapping sequences can be determined based on the number of times the string ACA appears in the string exemplary shown in FIG. 10, which is three times, taking into consideration the overlaps between teach prefix and suffix. First, the motifs are seeded as shown in FIG. 11. All the motifs needed are added to a list and the order is permuted. The total padding space between the motifs is determined and the total space is randomly partitioned into spacing between each motif. The motifs are then placed into the sequence. The gaps are then filled as shown in FIG. 12. Beginning at a first base, the bases are filled with random bases (i.e., put C at position I as shown in the second sequence of FIG. 12). As shown in FIG. 12, the next base in position 2 cannot be C to avoid a homopolymer with existing CpG sites. Bases are added to fill the sequence according to the general guidelines, which is exemplary shown in FIG. 13. For example, if G is placed at position 11, this would result in an additional CpG site, whereas C creates a homopolymer. Therefore, only A or T can be added to position 11. The process generally illustrated herein may be used to design unique sequences with variable number of CpG sites

### Methylation Analysis and Sequencing Workflows

The synthetic libraries for methylation control as described herein may be used for quantifying methylation in a sample (e.g., genomic DNA material). The method may generally comprise preparing standards from a library provided herein. The library may comprise one or more CpG sites, a percentage methylation (also referred to as methylation ratio or methylation rate), a percentage GC content, or any combination thereof. In some instances, the standards are prepared by serial dilution. In some instances, preparing standards comprises mixing standards with a portion of a sample. In some instances, preparing standards comprises addition of adapters and/or barcodes to the standards. In some instances, preparing standards comprises hybridization, or hybrid capture, using a panel complementary to a methylation control and/or a user-defined panel. The method may further comprise analyzing one or more samples relative to one or more standards that are prepared. The method may further comprise quantifying the degree of methylation in the sample using techniques known in the art.

Methylation sequencing generally involves enzymatic or chemical methods leading to the conversion of unmethylated cytosines to uracil through a series of events culminating in deamination, while leaving methylated cytosines intact. During amplification, uracils are paired with adenines on the complementary strand, leading to the inclusion of thymine in the original position of the unmethylated cytosine. There are identical sequences with each having unmethylated-cytosines in different positions. The end product is asymmetric, yielding two different double stranded DNA molecules after conversion; the same process for methylated DNA leads to yet additional sets of sequences.

In some instances, preparing standards comprises target enrichment. Target enrichment can proceed by pre- or post-capture conversion. Post-capture conversion targets the original sample DNA, while pre-capture targets the four strands of converted sequences. While post-capture conversion presents fewer challenges for probe design, it often requires large quantities of starting DNA material as PCR amplification does not preserve methylation patterns and cannot be performed before capture. Therefore, pre-capture conversion is often the method of choice for low-input, sensitive applications such as cell free DNA

Methods described herein may comprise treatment of a library with enzymes or bisulfite to facilitate conversion of cytosines to uracil. In some instances, adapters (e.g., universal adapters) described herein comprise methylated nucleobases, such as methylated cytosine. In some instances, preparing standards comprises enzymatic conversion (e.g., using NEBNext® Enzymatic Methyl-seq Kit). In some examples, enzymatic conversion results in high-quality DNA libraries with improved yields and longer insert sizes compared to chemical bisulfite conversion. In some examples, this can be important to maximize sequencing and mapping efficiency. In some examples, bisulfite treatment can be harsh to GC-rich DNA targets since conversion can take place at unmethylated cytosines. In some examples, this can result in reduced coverage at high-GC target regions that are of great interest in methylation sequencing applications. In some examples, enzymatic conversion results in more uniform coverage across targets of varying GC content without sacrificing methylation detection sensitivity. In some examples, enzyme conversion occurs before and/or after target enrichment.

Methylation sequencing experiments can be inherently challenging, since, in some instances, experimental variation in conversion can confound the results and produce false positives. In some instances, using an inline methylation control, these confounding effects can be detected and, in some examples, corrected. The methylation controls and/or detection system described herein can be used for calibrating methylation levels and identifying patterns using methylation-based hybridization assay technology.

Methylation calibration and methylation level quantification can generally comprise mixing controls to a gDNA input, and applying enzymatic conversion for library preparation. Target enrichment can be performed using the library, where hybridization reactions can take place. In some instances, a methylation control complementary panel can be used as a spike-in during the hybridization process. Sequencing can be performed using parallel sequencing.

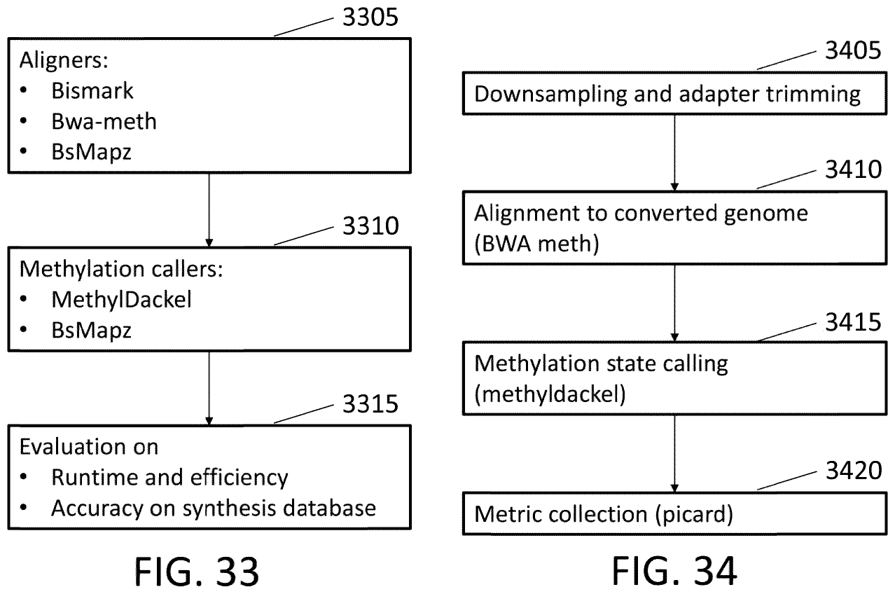

Data can then be aligned and analyzed, in some instances, using the system and methods provided herein. FIG. 33 provides an exemplary process for evaluating a combination of aligners and methylation callers. Alignment can be performed 3305 using an aligner, such as, by way of non-limiting example, Bismark, Bwa-meth, or BsMapz, or any other suitable aligner known in the art. Methylation can be analyzed using a methylation caller 3310, such as, by way of non-limiting example, MethylDackel or BsMapz, or any other suitable methylation caller known in the art. In some instances, an aligner and/or methylation caller is used to evaluate runtime and efficiency accuracy on synthetic datasets, or both 3315. In some examples, the aligner is Bwa-meth and the methylation caller is MethylDackel. An exemplary pipeline for analysis is generally provided in FIG. 34. An analysis workflow can comprise read processing to down-sample and remove adapters 3405. Further, alignment 3410 and methylation calling 3415 can be performed. The sequencing and enrichment metrics can further be collected 3420, for example, using a suitable software known in the art, such as Picard, to evaluate the success of target enrichment.

### Methylation Kit

The synthetic libraries for methylation control as described herein may be provided as a kit. The kit may contain in separate containers the various primers, adapters, and enzymes, and other reagents required to carry out the methods described herein. In some instances, the kit comprises instructions (e.g., written, CD-ROM, DVD, flash drive, SD card, digital download etc.) for quantifying methylation in a sample using the synthetic libraries (e.g., methylation controls) described herein. The kit may further comprise other necessary reagents in order to carry out the workflows (e.g., methylation control analysis) described herein. In some instances, the library comprises standards that are preprepared by serial dilution. In some instances, the library comprises reagents for next generation sequencing. The kit may further comprise packaging for the synthetic libraries described herein. The kit may also contain other packaged reagents and materials (e.g., wash buffers, nucleotides, silica spin columns, capture probes for ribosomal RNA depletion, and other reagents and/or devices for performing e.g., clonal amplification, digital PCR, NGS, ribosomal RNA depletion, nucleic acid purification, or any combination thereof).

### Genomic Variants

Genetic variants (“variants” in nucleic acids) among populations of individuals may provide information regarding risk for diseases, identification of individuals, response to drug treatments, or susceptibility to environmental factors such as toxins. Compositions described herein in some instances involve synthesis of polynucleotide libraries which contain these variants. In some instances variants comprise a single nucleotide polymorphism (SNP), a single nucleotide variation (SNV), an indel, a copy number variation, a translocation, fusion, inversion, or structural variant. In some instances, a SNP differs between individuals in the same population. In some instance, an SNP differs between individuals in a different population. In some instances, an SNV comprises a variation in a single nucleotide without any limitations of frequency. Polynucleotide libraries (e.g., probe libraries) described herein are in some instances used to identify such variants after sequencing. In some instances, polynucleotide libraries are configured to enrich for nucleic acids (e.g., fragments of a genome) which comprise variants. Such nucleic acids in some instances are captured using the polynucleotide libraries and sequenced for calling variants. In some instances, variant calls may be assessed comparing to known variants using metrics such as recall and/or precision for one or all of the variants. In some instances, an SNP or SNV is heterozygous. In some instances, an SNP or SNV is homozygous. In some instances, an SNP or SNV is homozygous in matching a reference sequence. In some instances a variant is homozygous for a state other than that observed in the human reference genome. In some instances, variants are identified after sequencing by comparison to a reference database. In some instances the reference database comprises GiAB, dbSNP, DoGSD, dbGaP, clinvar, ncbi, refseq, refSNP, COSMIC, or other database which comprises known variants. In some instances, variants comprise an insertion, deletion, fusion, duplication, frameshift, repeat expansion, or substitution. In some instances, variants comprise a copy number variant (CNV), microsatellite instability, loss of heterozygosity (LOH), DNA methylation, premature stop codon, trinucleotide repeat, translocation, somatic rearrangement, allelomorph, single nucleotide variant (SNV), indel, splice variant, regulator variant, copy number variant, or fusion. In some instances indels are 1-50, 1-25, 1-20, 1-15, 2-20, 5-25, 5-15, or 5-10 bases in length. In some instances indels are not more than 1, 2, 3, 5, 7, 8, 10, 12, 15, 17, 20, 25, or no more than 50 bases in length. In some instances, a variant described herein is located in a gene. In some instances, a library described herein comprises variants found in at least 2, 5, 10, 15, 20, 25, 30, 50, 60, 75, 100, 125, 150, 200, 250, 300, 400, or at least 500 genes. In some instances, a library described herein comprises variants found in about 2, 5, 10, 15, 20, 25, 30, 50, 60, 75, 100, 125, 150, 200, 250, 300, 400, or about 500 genes. In some instances, a library described herein comprises variants found in 5-500, 5-100, 5-50, 10-200, 10-100, 25-500, 25-250, 25-150, 50-150, 50-250, 50-500, or 75-500 genes.

Provided herein are synthetic libraries of polynucleotides comprising CNV (copy number variation) standards. CNVs (i.e., genetic abnormalities) may be associated with a number of different disease states. In some instances, CNV standards are designed to represent various disease states. In some instances polynucleotides correspond to exonic regions of the at least one gene. In some instances, a CNV standard is configured to target ERBB2/HER2. In some instances, CNVs are associated with a disease or condition. In some instances CNVs are associated with cancer. In some instance cancer comprises one or more of breast, ovarian, stomach, bladder, salivary, and lung cancers. In some instances, a CNV is associated with a gene. The variation in copy may comprise an increase or decrease. In some instances, copy number is increased by at least 2, 4, 6, 8, 10, 12, 15, or at least 20 fold. In some instances, copy number is decreased by at least 2, 4, 6, 8, 10, 12, 15, or at least 20 fold.

In some instances CNV libraries comprise polynucleotides of a defined length and/or GC content. In some instances at least 95%, at least 90%, at least 85%, at least 80%, or at least 70% of the polynucleotides have an average length of 100-200 bases. In some instances the polynucleotides have an average length of 150-180, 100-200, 50-300, 125-175, 150-170, 200-300, or 175-225 bases. In some instances at least 90% polynucleotides have an average length of 150-180, 100-200, 50-300, 125-175, 150-170, 200-300, or 175-225 bases. In some instances at least 95% polynucleotides have an average length of 150-180, 100-200, 50-300, 125-175, 150-170, 200-300, or 175-225 bases. In some instances at least 85% polynucleotides have an average length of 150-180, 100-200, 50-300, 125-175, 150-170, 200-300, or 175-225 bases. In some instances, the library has a minimum GC content of 20-40%, 15-60%, 15-50%, 20-50%, 20-45%, 25-45%, 30-40%, or 30-50%. In some instances, the library has a maximum GC content of 60-80%, 50-90%, 60-90%, 55-75%, 60-70%, 60-75%, or 65-85%. In some instances, the library has an average GC content of 40-60%, 30-75%, 50-70%, 50-80%, 50-60%, or 60-70%. In some instances, the library has a standard deviation GC content of 0.01-0.1%, 0.01-0.08%, 0.01-0.07%, 0.03-0.06%, or 0.02-0.06%. In some instances, the library has a standard deviation GC content of no more than 0.01%, 0.02%, 0.03%, 0.04%, 0.05%, 0.06%, 0.07%, 0.1%, or 0.15%. In some instances CNV standards are combined with additional standards such as those representing SNVs, INDELS, SVs or other variants. In some instances, a CNV standards library comprises polynucleotide with a distance between variants loci of 1-20, 1-15, 1-12, 1-5, 3-20, 3-15 3-10, 5-8, 5-10, 5-15, 5-25, 8-15, or 10-25 bases. In some instances the distance between variants loci is 3, 4, 5, 6, 7, 8, 9, 10, 11, or 12 bases.

Provided herein are synthetic libraries of RNA fusion standards. The synthetic libraries may comprise a plurality of polynucleotides comprising sequences corresponding to one or more genetic abnormalities. In some instances a polynucleotide comprises a first gene fused to a second gene. In some instances, RNA fusion standards are designed to represent various disease states. The one or more genetic abnormalities may correspond to the disease state. In some instances, the disease state comprises Lung Adenocarcinoma, Thyroid Papillary Carcinoma, Leukemia (Acute and Chronic), Prostate Adenocarcinoma, Ewing's Sarcoma. In some instances, RNA fusion standards comprise at least 20, 30, 40, 50, 60, 70, 80, 100, 120, 150, 175, or at least 200 fusions. In some instances, RNA fusion standards comprise 20-200, 20-170, 20-150, 20-100, 20-75, 50-250, 50-200, 50-150, 50-100, 75-200, 100-250, 100-500, 150-300, or 150-500 fusions. In some instances polynucleotides representing RNA fusions are 500-3000, 500-2500, 500-2000, 500-1500, 1000-3000, 1000-2000, 1200-2000, 1500-5000, 1500-3000, or 2000-4000 bases in length. In some instances, RNA fusions are found in a database. In some instances, the data comprises COSMIC. In some instances, at least 2, 4, 5, 7, 10, 15, 20, 40, 50, 75, 100, 125, 150, 175, or at least 200 fusions in a library are found in the COSMIC database. In some instances, at least 2-200, 2-150, 2-100, 2-75, 2-50, 2-25, 5-200, 5-150, 5-125, 10-200, 10-150, 10-125, 10-100, 25-250, 25-200, 25-150, 25-100, 50-200, 125-200 or 75-250 fusions in a library are found in the COSMIC database. In some instances, an RNA fusion comprises a first gene and a second gene. In some instances, an RNA fusion comprises a first gene fused to a second gene. In some instances, a first gene comprises ACTB, ASPSCR1, ATF1, ATIC, BCR, CBFA2T3, CCDC6, CD74, CDH11, CDKN2D, CHCHD7, CLTC, COL1A1, CRTC1, CRTC3, CTNNB1, DHH, DNAJB1, EGFR, EML4, ETV6, EWSR1, EZR, FGFR1, FGFR3, FOXO1, FUS, GOPC, HEY1, HMGA2, JAK2, JAZF1, KIAA1549, KIF5B, KMT2A, LIFR, LPP, MAML2, MET, MN1, MYB, NAB2, NACC2, NCOA4, NPM1, NUP214, PAX3, PAX7, PAX8, PCM1, PLAG1, PML, PRCC, PRKAR1A, PTPRK, RANBP2, RUNX1, SDC4, SET, SLC34A2, SLC45A3, SND1, SS18, STIL, STRN, TAF15, TBL1XR1, TCF3, TFE3, TMPRSS2, TPM3, TPM4, or YWHAE. In some instances a second gene comprises GLI1, TFE3, EWSR1, ALK, ABL1, GLIS2, RET, NRG1, ROS1, USP6, WDFY2, PLAG1, PDGFB, MAML2, RHEBL1, PRKACA, EGFR, SEPTIN14, EML4, MN1, NTRK3, PDGFRB, RUNX1, ATF1, CREB1, DDIT3, ERG, FEV, FLI1, NR4A3, POU5F1, WT1, TACC1, BAIAP2L1, TACC3, PAX3, CREB3L2, FUS, NCOA2, LPP, WIF1, PAX5, SUZ12, BRAF, AFDN, AFF1, CREBBP, ELL, EPS15, MLLT1, MLLT10, MLLT11, MLLT3, SEPTIN6, SEPTIN9, HMGA2, CRTC1, MET, ETV6, MYB, NFIB, STAT6, NTRK2, FOXO1, PAX8, PPARG, JAK2, CTNNB1, RARA, RSPO3, ETV6, RUNX1T1, NUP214, ELK4, SSX1, SSX2, SSX4B, TAL1, TP63, PBX1, ASPSCR1, NTRK1, or NUTM2B. In some instances, an RNA fusion comprises a fusion shown in Table 1. In some instances, libraries are synthesized as DNA libraries and then transcribed into RNA libraries.

TABLE 1

| | P1 | P1 | P2 | P2 | |
|---|---|---|---|---|---|
| Fusion_ID | Gene | Exon | Gene | Exon | FullFusion_Length |
| BCR: 19\|ABL1: 1 | BCR | 19 | ABL1 | 1 | 1500 |
| EWSR1: 17\|FLI1: 4 | EWSR1 | 17 | FLI1 | 4 | 1500 |
| PML: 7\|RARA: 3 | PML | 7 | RARA | 3 | 1500 |
| TMPRSS2: 5\|ERG: 2 | TMPRSS2 | 5 | ERG | 2 | 1329 |
| CCDC6: 8\|RET: 1 | CCDC6 | 8 | RET | 1 | 1500 |
| SS18: 11\|SSX1: 1 | SS18 | 11 | SSX1 | 1 | 1500 |
| KIAA1549: 19\|BRAF: 1 | KIAA1549 | 19 | BRAF | 1 | 1500 |
| RUNX1: 8\|RUNX1T1: 2 | RUNX1 | 8 | RUNX1T1 | 2 | 1500 |
| EML4: 20\|ALK: 1 | EML4 | 20 | ALK | 1 | 1500 |
| NCOA4: 12\|RET: 1 | NCOA4 | 12 | RET | 1 | 1500 |
| PAX3: 10\|FOXO1: 1 | PAX3 | 10 | FOXO1 | 1 | 1500 |
| SS18: 11\|SSX2: 1 | SS18 | 11 | SSX2 | 1 | 1500 |
| NPM1: 5\|ALK: 1 | NPM1 | 5 | ALK | 1 | 1309 |
| TCF3: 17\|PBX1: 3 | TCF3 | 17 | PBX1 | 3 | 1500 |
| ETV6: 8\|RUNX1: 1 | ETV6 | 8 | RUNX1 | 1 | 1500 |
| FUS: 15\|DDIT3: 1 | FUS | 15 | DDIT3 | 1 | 1500 |
| CRTC1: 14\|MAML2: 1 | CRTC1 | 14 | MAML2 | 1 | 1500 |
| NAB2: 7\|STAT6: 1 | NAB2 | 7 | STAT6 | 1 | 1500 |
| EWSR1: 17\|ATF1: 1 | EWSR1 | 17 | ATF1 | 1 | 1500 |
| COL1A1: 49\|PDGFB: 2 | COL1A1 | 49 | PDGFB | 2 | 1500 |
| ETV6: 8\|NTRK3: 1 | ETV6 | 8 | NTRK3 | 1 | 1500 |
| DNAJB1: 2\|PRKACA: 2 | DNAJB1 | 2 | PRKACA | 2 | 1500 |
| PAX7: 7\|FOXO1: 1 | PAX7 | 7 | FOXO1 | 1 | 1500 |
| EWSR1: 17\|WT1: 8 | EWSR1 | 17 | WT1 | 8 | 1500 |
| ASPSCR1: 16\|TFE3: 1 | ASPSCR1 | 16 | TFE3 | 1 | 1500 |
| HMGA2: 5\|LPP: 1 | HMGA2 | 5 | LPP | 1 | 1500 |
| FUS: 15\|ERG: 2 | FUS | 15 | ERG | 2 | 1500 |
| JAZF1: 3\|SUZ12: 2 | JAZF1 | 3 | SUZ12 | 2 | 1353 |
| KIF5B: 24\|RET: 1 | KIF5B | 24 | RET | 1 | 1500 |
| KMT2A: 36\|MLLT3: 1 | KMT2A | 36 | MLLT3 | 1 | 1500 |
| EWSR1: 17\|NR4A3: 1 | EWSR1 | 17 | NR4A3 | 1 | 1500 |
| EWSR1: 17\|ERG: 2 | EWSR1 | 17 | ERG | 2 | 1500 |
| EML4: 20\|EML4: 1 | EML4 | 20 | EML4 | 1 | 1500 |
| FUS: 15\|CREB3L2: 1 | FUS | 15 | CREB3L2 | 1 | 1500 |
| STIL: 3\|TAL1: 1 | STIL | 3 | TAL1 | 1 | 1057 |
| NUP214: 36\|ABL1: 1 | NUP214 | 36 | ABL1 | 1 | 1500 |
| CD74: 8\|ROS1: 32 | CD74 | 8 | ROS1 | 32 | 1500 |
| ETV6: 8\|ABL1: 1 | ETV6 | 8 | ABL1 | 1 | 1500 |
| CBFA2T3: 12\|GLIS2: 3 | CBFA2T3 | 12 | GLIS2 | 3 | 1500 |
| PAX8: 10\|PPARG: 2 | PAX8 | 10 | PPARG | 2 | 1500 |
| SET: 8\|NUP214: 1 | SET | 8 | NUP214 | 1 | 1500 |
| TPM3: 8\|NTRK1: 1 | TPM3 | 8 | NTRK1 | 1 | 1500 |
| KMT2A: 36\|AFF1: 1 | KMT2A | 36 | AFF1 | 1 | 1500 |
| PRKAR1A: 7\|RET: 1 | PRKAR1A | 7 | RET | 1 | 1500 |
| KMT2A: 36\|AFDN: 2 | KMT2A | 36 | AFDN | 2 | 1500 |
| KMT2A: 36\|MLLT1: 1 | KMT2A | 36 | MLLT1 | 1 | 1500 |
| ETV6: 8\|PDGFRB: 10 | ETV6 | 8 | PDGFRB | 10 | 1500 |
| FUS: 15\|FUS: 1 | FUS | 15 | FUS | 1 | 1500 |
| TPM3: 8\|ALK: 1 | TPM3 | 8 | ALK | 1 | 1500 |
| CTNNB1: 15\|PLAG1: 1 | CTNNB1 | 15 | PLAG1 | 1 | 1500 |
| EWSR1: 17\|DDIT3: 1 | EWSR1 | 17 | DDIT3 | 1 | 1500 |
| RANBP2: 18\|ALK: 1 | RANBP2 | 18 | ALK | 1 | 1500 |
| KMT2A: 36\|MLLT10: 8 | KMT2A | 36 | MLLT10 | 8 | 1500 |
| CLTC: 31\|ALK: 1 | CLTC | 31 | ALK | 1 | 1500 |
| EWSR1: 17\|CREB1: 7 | EWSR1 | 17 | CREB1 | 7 | 1500 |
| RUNX1: 8\|ETV6: 1 | RUNX1 | 8 | ETV6 | 1 | 1500 |
| MYB: 16\|NFIB: 8 | MYB | 16 | NFIB | 8 | 1500 |
| TAF15: 16\|NR4A3: 1 | TAF15 | 16 | NR4A3 | 1 | 1500 |
| FGFR1: 17\|PLAG1: 1 | FGFR1 | 17 | PLAG1 | 1 | 1500 |
| STRN: 3\|ALK: 1 | STRN | 3 | ALK | 1 | 1235 |
| CDKN2D: 2\|WDFY2: 3 | CDKN2D | 2 | WDFY2 | 3 | 1500 |
| CRTC3: 1\|MAML2: 1 | CRTC3 | 1 | MAML2 | 1 | 1031 |
| YWHAE: 5\|NUTM2B: 2 | YWHAE | 5 | NUTM2B | 2 | 1500 |
| ATIC: 7\|ALK: 1 | ATIC | 7 | ALK | 1 | 1500 |
| LPP: 11\|HMGA2: 1 | LPP | 11 | HMGA2 | 1 | 1500 |
| KMT2A: 36\|ELL: 2 | KMT2A | 36 | ELL | 2 | 1500 |
| TFE3: 10\|ASPSCR1: 1 | TFE3 | 10 | ASPSCR1 | 1 | 1500 |
| CD74: 8\|NRG1: 6 | CD74 | 8 | NRG1 | 6 | 1500 |
| SLC34A2: 13\|ROS1: 32 | SLC34A2 | 13 | ROS1 | 32 | 1500 |
| FGFR3: 18\|TACC3: 4 | FGFR3 | 18 | TACC3 | 4 | 1500 |
| MYB: 16\|MYB: 1 | MYB | 16 | MYB | 1 | 1500 |
| MN1: 2\|ETV6: 1 | MN1 | 2 | ETV6 | 1 | 1500 |
| EWSR1: 17\|POU5F1: 1 | EWSR1 | 17 | POU5F1 | 1 | 1500 |
| KMT2A: 36\|44813: 2 | KMT2A | 36 | SEPTIN9 | 2 | 1500 |
| TBL1XR1: 14\|TP63: 4 | TBL1XR1 | 14 | TP63 | 4 | 1500 |
| KIF5B: 24\|ALK: 1 | KIF5B | 24 | ALK | 1 | 1500 |
| SLC45A3: 4\|ELK4: 2 | SLC45A3 | 4 | ELK4 | 2 | 1500 |
| PAX8: 10\|PAX8: 1 | PAX8 | 10 | PAX8 | 1 | 1500 |
| PCM1: 39\|JAK2: 1 | PCM1 | 39 | JAK2 | 1 | 1500 |
| HEY1: 4\|NCOA2: 12 | HEY1 | 4 | NCOA2 | 12 | 1185 |
| DHH: 2\|RHEBL1: 2 | DHH | 2 | RHEBL1 | 2 | 1500 |
| ETV6: 8\|MN1: 1 | ETV6 | 8 | MN1 | 1 | 1500 |
| KMT2A: 36\|CREBBP: 1 | KMT2A | 36 | CREBBP | 1 | 1500 |
| PRCC: 7\|TFE3: 1 | PRCC | 7 | TFE3 | 1 | 1500 |
| EWSR1: 17\|EWSR1: 1 | EWSR1 | 17 | EWSR1 | 1 | 1500 |
| GOPC: 8\|ROS1: 32 | GOPC | 8 | ROS1 | 32 | 1500 |
| HMGA2: 5\|WIF1: 3 | HMGA2 | 5 | WIF1 | 3 | 1500 |
| KMT2A: 36\|44810: 2 | KMT2A | 36 | SEPTIN6 | 2 | 1500 |
| EZR: 12\|ROS1: 32 | EZR | 12 | ROS1 | 32 | 1500 |
| KMT2A: 36\|EPS15: 1 | KMT2A | 36 | EPS15 | 1 | 1500 |
| JAK2: 25\| PAX5: 1 | JAK2 | 25 | PAX5 | 1 | 1500 |
| SDC4: 4\|ROS1: 32 | SDC4 | 4 | ROS1 | 32 | 1235 |
| SND1: 14\|BRAF: 1 | SND1 | 14 | BRAF | 1 | 1500 |
| CHCHD7: 1\|PLAG1: 1 | CHCHD7 | 1 | PLAG1 | 1 | 799 |
| PLAG1: 5\|CTNNB1: 1 | PLAG1 | 5 | CTNNB1 | 1 | 1500 |
| TPM4: 7\|ALK: 1 | TPM4 | 7 | ALK | 1 | 1485 |
| ATF1: 7\|EWSR1: 1 | ATF1 | 7 | EWSR1 | 1 | 1500 |
| FOXO1: 3\|PAX3: 1 | FOXO1 | 3 | PAX3 | 1 | 1500 |
| SS18: 11\|SSX4B: 3 | SS18 | 11 | SSX4B | 3 | 1500 |
| KMT2A: 36\|MLLT11: 2 | KMT2A | 36 | MLLT11 | 2 | 1500 |
| EWSR1: 17\|FEV: 2 | EWSR1 | 17 | FEV | 2 | 1500 |
| CDH11: 2\|USP6: 1 | CDH11 | 2 | USP6 | 1 | 1059 |
| PTPRK: 7\|RSPO3: 2 | PTPRK | 7 | RSPO3 | 2 | 1500 |
| LIFR: 1\|PLAG1: 1 | LIFR | 1 | PLAG1 | 1 | 1063 |
| MAML2: 5\|CRTC1: 1 | MAML2 | 5 | CRTC1 | 1 | 1500 |
| ACTB: 6\|GLI1: 1 | ACTB | 6 | GLI1 | 1 | 1500 |
| CCDC6: 1\|RET: 12 | CCDC6 | 1 | RET | 12 | 1185 |
| EML4: 13\|ALK: 20 | EML4 | 13 | ALK | 20 | 1500 |
| SLC34A2: 4\|ROS1: 32 | SLC34A2 | 4 | ROS1 | 32 | 1172 |
| CD74: 6\|ROS1: 34 | CD74 | 6 | ROS1 | 34 | 1500 |
| EGFR: 1\|EGFR: 8 | EGFR | 1 | EGFR | 8 | 1099 |
| FGFR3: 17\|TACC3: 10 | FGFR3 | 17 | TACC3 | 10 | 1500 |
| KIF5B: 15\|RET: 12 | KIF5B | 15 | RET | 12 | 1500 |
| MET: 13\|MET: 15 | MET | 13 | MET | 15 | 1500 |
| NCOA4: 8\|RET: 12 | NCOA4 | 8 | RET | 12 | 1500 |
| TMPRSS2: 1\|ERG: 4 | TMPRSS2 | 1 | ERG | 4 | 828 |
| FGFR1: 17\|TACC1: 7 | FGFR1 | 17 | TACC1 | 7 | 1500 |
| NACC2: 4\|NTRK2: 13 | NACC2 | 4 | NTRK2 | 13 | 1500 |
| MET_exon14_skipping | MET | 13 | MET | 15 | |
| EGFR_variant_III | EGFR | 1 | EGFR | 8 | |
| BCR: 14\|ABL1: 2 | BCR | 14 | ABL1 | 2 | 1500 |
| BCR: 14\|ABL1: 2 | BCR | 14 | ABL1 | 2 | 1500 |
| TCF3: 16\|PBX1: 3 | TCF3 | 16 | PBX1 | 3 | 1500 |
| FGFR3: 17\|BAIAP2L1: 2 | FGFR3 | 17 | BAIAP2L1 | 2 | 1500 |
| PML: 6\|RARA: 3 | PML | 6 | RARA | 3 | 1500 |
| RUNX1: 5\|RUNX1T1: 2 | RUNX1 | 5 | RUNX1T1 | 2 | 1452 |
| TPM3: 7\|NTRK1: 10 | TPM3 | 7 | NTRK1 | 10 | 1500 |
| ETV6: 5\|ABL1: 2 | ETV6 | 5 | ABL1 | 2 | 1500 |
| EGFR: 24\|SEPTIN14: 10 | EGFR | 24 | SEPTIN14 | 10 | 1500 |

In some instances, RNA fusions are associated with one or more diseases or conditions. In some instances, the disease or condition comprises one or more of Lung Adenocarcinoma, Thyroid Papillary Carcinoma, Leukemia (Acute and Chronic), Prostate Adenocarcinoma, and Ewing's Sarcoma. In some instances, sequences for a synthetic library of polynucleotides are designed. In some instances polynucleotide comprises sequences within 3000, 2500, 2000, 1500, 1250, 1000, 750, 600, 500, 400, or within 300 bases of the fusion junction. In some instances polynucleotide comprises sequences within 200-3000, 200-2500, 200-2000, 200-1500, 200-1000, 500-2000, 500-1500, 500-1250, 500-800, 800-3000 or 1000-3000 bases of the fusion junction. In some instances polynucleotide comprises sequences within 3000, 2500, 2000, 1500, 1250, 1000, 750, 600, 500, 400, or within 300 bases of the fusion junction relative to the 3′ terminus. In some instances polynucleotide comprises sequences within 200-3000, 200-2500, 200-2000, 200-1500, 200-1000, 500-2000, 500-1500, 500-1250, 500-800, 800-3000 or 1000-3000 bases of the fusion junction relative to the 3′ terminus. In some instances polynucleotide comprises sequences within 3000, 2500, 2000, 1500, 1250, 1000, 750, 600, 500, 400, or within 300 bases of the fusion junction relative to the 5′ terminus. In some instances polynucleotide comprises sequences within 200-3000, 200-2500, 200-2000, 200-1500, 200-1000, 500-2000, 500-1500, 500-1250, 500-800, 800-3000 or 1000-3000 bases of the fusion junction relative to the 5′ terminus. RNA fusion libraries may be synthesized using any method known in the art. In some instances, DNA fragments corresponding to preselected RNA fusions are synthesized in a plasmid. In some instances, DNA fragments corresponding to one preselected RNA fusion is synthesized in a plasmid. In some instances, DNA fragments are removed from the plasmid using amplification with primers, transposases, recombinases, or restriction enzymes. In some instances, the restriction enzyme comprises one or more of AatII, AcuI, AflIII, AhdI, AjuI, AlfI, AlwNI, ApaLI, ArsI, AscI, AseI, AsiSI, AvaI, AvrII, BacGI, BamHI, BanII, BciVI, BdaI, Bme1580I, BmrI, Bpu10I, BsaHI, BsaXI, BseYI, BsiEI, BsiHKAI, BsiWI, BsmI, BsmBI, BsmFI, BsoBI, BspDI, BspHI, BsrDI, BsrFI, BssSI, BssSI, BtgZI, BtsI, BtsI, ClaI, CviQI, DraIII, DrdI, EaeI, EarI, Eco57MI, Esp3I, FaqI, FauI, HaeII, HgaI, HindIII, Hpy166II, MlyI, MspAII, NdeI, NruI, NspI, PaeR7I, PciI, PflMI, PleI, PspFI, PspXI, PvuI, RsaI, Sau96I, SfcI, SmaI, SpeI, SspI, StyI, TaqII, TsoI, Tsp45I, TspGWI, TspMI, TstI, XbaI, XhoI, XmaI, and ZraI. In some instances, the restriction enzyme comprises AscI. Digesting the plasmids can release DNA fragments comprising the sequences. After digestion, in some instances transcription is used to generate a library of polynucleotides from the DNA fragments. In some instances, transcription comprises in-vitro transcription. In some instances, transcription is used to generate the RNA fusion library from the DNA fragments. In some instances, RNA fusion polynucleotides are purified prior to use as a standard.

Identification of variants in some instances is accomplished using imputed data. In some instances, identification of variants near a known or detected variant inform the identity of a variant not measured, or which lacks sequencing data to accurately call. In some instances, the unmeasured (or unknown) genomic variant is within 100 bases, 500 bases, 1,000 bases, 10,000 bases, 100,000 bases, or 1,000,000 bases of a measured (or identified) genomic variant or variants, or more, depending on linkage disequilibrium (the non-random association of alleles for different variants within a population) between the measured and unmeasured variants. In some instances linkage disequilibrium may be inferred by making use of information about recombination rates observed in a genome or population otherwise known genetic distance. In some instances recombination rates, genetic distance maps, and variants themselves in some instances vary between different populations.

Variants may be present in a population of individuals, a single individual, tissue, or other group at different frequencies, such as in a genome. In some instances, genomic variants are co-occurring in less than 0.001, 0.01, 0.1, 0.5, 1, 1.5, 2, 5, 10, 20, 25, 50, or 75% of individuals in a group. In some instances, genomic variants are co-occurring in more than 0.001, 0.01, 0.1, 0.5, 1, 1.5, 2, 5, 10, 20, 25, 50, or 75% of individuals in a group. In some instances, genomic variants are co-occurring in about 0.001, 0.01, 0.1, 0.5, 1, 1.5, 2, 5, 10, 20, 25, 50, or 75% of individuals in a group. In some instances, genomic variants are co-occurring in 0.1-10%, 0.001-10%, 0.01-10%, 0.01-1%, 0.001-1%, 0.1-25%, 0.1-10%, or 0.1-5% of individuals in a group. In some instances, the occurrence of a variant is called a variant allele frequency (VAF).

Described herein are variants for detecting a disease or condition. In some instances, the disease or condition is a proliferative disease. In some instances, the disease or condition is cancer. In some instances, a variant is present in an oncogene or tumor suppressor gene. In some instances, a variant is present in one or more of genes ABL1, ABL2, AKT1, ALK, APC, AR, ARAF, ARID1A, ATM, ATR, BAP1, BRAF, BRCA1, BRCA2, CCND1, CDC6, CDH1, CDK12, CDK4, CDX2, CTNNB1, DDR2, EGFR, EML4, ERBB2, ERBB3, ERG, ESR1, EZH2, FBXW7, FGFR1, FGFR2, FGFR3, FLT3, FOXA1, FOXL2, GATA3, GNA11, GNAQ, GNAS, HNF1A, HRAS, IDH1, IDH2, JAK2, KDM5C, KDM6A, KIF5B, KIT, KRAS, MAP2K1, MAPK1, MET, MIR4728, ERBB2, MLH1, MPL, MYCN, MYD88, NCOA4, NF1, NF2, NFE2L2, NOTCH1, NPM1, NRAS, PBRM1, PDGFRA, PIK3CA, PTEN, PTPN11, RET, RHEB, RHOA, RIT1, ROS1, SETD2, SMAD4, SMO, SPOP, TERT, TMPRSS2, TP53, TPR, TSC1, and VHL. In some instances, a variant is present in one, two, three, five, seven, ten, 15, 20, 25 or more of genes ABL1, ABL2, AKT1, ALK, APC, AR, ARAF, ARID1A, ATM, ATR, BAP1, BRAF, BRCA1, BRCA2, CCND1, CDC6, CDH1, CDK12, CDK4, CDX2, CTNNB1, DDR2, EGFR, EML4, ERBB2, ERBB3, ERG, ESR1, EZH2, FBXW7, FGFR1, FGFR2, FGFR3, FLT3, FOXA1, FOXL2, GATA3, GNA11, GNAQ, GNAS, HNF1A, HRAS, IDH1, IDH2, JAK2, KDM5C, KDM6A, KIF5B, KIT, KRAS, MAP2K1, MAPK1, MET, MIR4728, ERBB2, MLH1, MPL, MYCN, MYD88, NCOA4, NF1, NF2, NFE2L2, NOTCH1, NPM1, NRAS, PBRM1, PDGFRA, PIK3CA, PTEN, PTPN11, RET, RHEB, RHOA, RIT1, ROS1, SETD2, SMAD4, SMO, SPOP, TERT, TMPRSS2, TP53, TPR, TSC1, and VHL. In some instances, multiple variants are present in a single gene. In some instances, a variant is present in one, two, three, five, seven, ten, 15, 20, 25 or more of genes. In some instances, a variant is present in one, two, three, five, seven, ten, 15, 20, 25 or more of genes which are associated with a disease or condition.

In some instances, the disease or condition is breast cancer. In some instances, a variant is present in one or more of genes TP53, PIK3CA, ERBB2, MYC, FGFR1/ZNF703, GATA3, CCND1, and CHD1 (e.g., CDH1*).

In some instances, the disease or condition is lung cancer. In some instances, a variant is present in one or more of genes KRAS (e.g., K117N), EGFR, ROS, ALK, and BRAF.

In some instances, the disease or condition is colorectal cancer. In some instances, a variant is present in one or more of genes TP53 APC, KRAS, BRAF, PIK3CA, SMAD4, FBXW7 (e.g., R465C), and NF1.

In some instances, the disease or condition is bladder cancer. In some instances, a variant is present in one or more of TP53, FGFR3 (e.g., S249C), ARID1A and KDM6A.

In some instances, the disease or condition is prostate cancer. In some instances, a variant is present in one or more of genes ETS (e.g., ETS-TMPRSS2), SPOP (e.g., F133V), TP53, FOXA1 (e.g., R219), and PTEN.

In some instances, the disease or condition is kidney cancer. In some instances, a variant is present in one or more of genes PBRM1, SETD2, BAP1, KDM5C, MTOR, VHL, MET, NF2, KDM6A, SMARCB1, FH, and CDKN2A.

In some instances, the disease or condition is melanoma. In some instances, a variant is present in one or more of genes NRAS, BRAF, PTEN, CDKN2A, MAP2K1, MAP2K2, GNAQ, GNA11, BAP (e.g., W196X).

Variants (e.g., genomic variants) may be detected from a sample (e.g., genomic sample) with varying degrees of recall and precision. In some instances, the upper limit on detection is determined by performance of a reference standard described herein. In some instances, reference standards have pre-selected variant frequencies for comparison to patient samples. In some instances, recall represents the number of variants detected out of all that variants expected to be detectable. In some instances, precision represents the number of variants that are called correctly out of everything detected as a variant. In some instances, the variant is detected with a recall of at least 30%, 50%, 75%, 80%, 85%, 90%, 95%, 97%, 98%, or at least 99%. In some instances, the variant is detected with a recall of about 30%, 50%, 75%, 80%, 85%, 90%, 95%, 97%, 98%, or about 99%. In some instances, the variant is detected with a recall of about 10%-99%, 25-99%, 30-90%, 45-80%, 50-99%, 75-99%, or 90-99%. In some instances, the variant is detected with a precision of at least 30%, 50%, 75%, 80%, 85%, 90%, 95%, 97%, 98%, or at least 99%. In some instances, the variant is detected with a precision of about 30%, 50%, 75%, 80%, 85%, 90%, 95%, 97%, 98%, or about 99%. In some instances, the variant is detected with a precision of about 10%-99%, 25-99%, 30-90%, 45-80%, 50-99%, 75-99%, or 90-99%.

Polynucleotide libraries may be designed to comprise sequences which are identical to or complementary (to target, hybridize) to one or more variants. In some instances, at least some of the polynucleotides are each configured to hybridize to genomic regions which comprise at least two variants. In some instances, at least some of the polynucleotides are each configured to hybridize to genomic regions which comprise at least one, two, three, four, five, six, or more than six variants. In some instances, at least some of the polynucleotides are each configured to hybridize to genomic regions which comprise one to four variants. In some instances, at least some of the polynucleotides are each configured to hybridize to genomic regions which comprise one to two or three variants. In some instances, at least 50% of the polynucleotides are each configured to hybridize to genomic regions which comprise at least two variants. In some instances, at least 50% of the polynucleotides are each configured to hybridize to genomic regions which comprise at least one, two, three, four, five, six, or more than six variants. In some instances, at least 50% of the polynucleotides are each configured to hybridize to genomic regions which comprise one to four variants. In some instances, at least 50% of the polynucleotides are each configured to hybridize to genomic regions which comprise one to two or three variants. In some instances, at least 25% of the polynucleotides are each configured to hybridize to genomic regions which comprise at least two variants. In some instances, at least 25% of the polynucleotides are each configured to hybridize to genomic regions which comprise at least one, two, three, four, five, six, or more than six variants. In some instances, at least 25% of the polynucleotides are each configured to hybridize to genomic regions which comprise one to four variants. In some instances, at least 25% of the polynucleotides are each configured to hybridize to genomic regions which comprise one to two or three variants. In some instances, at least 5% of the polynucleotides are each configured to hybridize to genomic regions which comprise at least two variants. In some instances, at least 5% of the polynucleotides are each configured to hybridize to genomic regions which comprise at least one, two, three, four, five, six, or more than six variants. In some instances, at least 5% of the polynucleotides are each configured to hybridize to genomic regions which comprise one to four variants. In some instances, at least 5% of the polynucleotides are each configured to hybridize to genomic regions which comprise one to two or three variants.

Polynucleotide libraries may be configured to bind to many variants. In some instances, a polynucleotide library is collectively configured to bind to genomic regions comprising about 50, 100, 200, 500, 800, 1000, 2000, 5000, 8000, 10,000, 20,000, 50,000, 80,000, 100,000, 250,000, 500,000, 750,000, 1 million, 1.5 million, 2 million, 2.5 million, 3 million, 3.5 million, 4 million, 4.5 million, or about 5 million variants. In some instances, a polynucleotide library is collectively configured to bind to genomic regions comprising at least 50, 100, 200, 500, 800, 1000, 2000, 5000, 8000, 10,000, 20,000, 50,000, 80,000, 100,000, 250,000, 500,000, 750,000, 1 million, 1.5 million, 2 million, 2.5 million, 3 million, 3.5 million, 4 million, 4.5 million, or at least 5 million variants. In some instances, a polynucleotide library is collectively configured to bind to genomic regions comprising 100-1000, 50-100, 50-500, 50-5000, 50-10,000, 100,000-5 million, 250,000-3 million, 500,000-2 million, 750,000-4 million, 1 million-5 million, 1 million-3 million, 1 million-4 million, or 4 million to 6 million variants.

Polynucleotide libraries for identifying variants may be optimized. In some instances, the library is uniform (each unique polynucleotide is equally represented). In some instances, the library is not uniform. In some instances, polynucleotides are represented in an amount within at least about 1.5 times the mean representation for the polynucleotide library. In some instances, polynucleotides are represented in an amount within at least about 2 times the mean representation for the polynucleotide library. In some instances, polynucleotides are represented in an amount within at least about 1.2 times the mean representation for the polynucleotide library. In some instances, polynucleotides are represented in an amount within at least about 1.7 times the mean representation for the polynucleotide library. In some instances, at least 80% polynucleotides are represented in an amount within at least about 1.5 times the mean representation for the polynucleotide library. In some instances, at least 80% polynucleotides are represented in an amount within at least about 2 times the mean representation for the polynucleotide library. In some instances, at least 80% polynucleotides are represented in an amount within at least about 1.7 times the mean representation for the polynucleotide library. In some instances, at least 80% polynucleotides are represented in an amount within at least about 2 times the mean representation for the polynucleotide library. In some instances, at least 90% polynucleotides are represented in an amount within at least about 1.5 times the mean representation for the polynucleotide library. In some instances, at least 90% polynucleotides are represented in an amount within at least about 2 times the mean representation for the polynucleotide library. In some instances, at least 80% polynucleotides are represented in an amount within at least about 1.7 times the mean representation for the polynucleotide library. In some instances, at least 90% polynucleotides are represented in an amount within at least about 2 times the mean representation for the polynucleotide library. In some instances, at least 95% polynucleotides are represented in an amount within at least about 1.5 times the mean representation for the polynucleotide library. In some instances, at least 95% polynucleotides are represented in an amount within at least about 2 times the mean representation for the polynucleotide library. In some instances, at least 95% polynucleotides are represented in an amount within at least about 1.7 times the mean representation for the polynucleotide library. In some instances, at least 95% polynucleotides are represented in an amount within at least about 2 times the mean representation for the polynucleotide library. Polynucleotide libraries in some instances comprise at least some polynucleotides which each comprise an overlap region with another polynucleotide in the library. In some instances at least 10%, 20%, 30%, 40%, 50%, 60%, 70%, 80%, or at least 90% of the polynucleotides each comprise an overlap region with another polynucleotide in the library. In some instances about 10%, 20%, 30%, 40%, 50%, 60%, 70%, 80%, or about 90% of the polynucleotides each comprise an overlap region with another polynucleotide in the library. In some instances 10%-90%, 10-80%, 10-75%, 25%-50%, 25-90%, 50-90%, 15-35%, or 80-99% of the polynucleotides each comprise an overlap region with another polynucleotide in the library. In some instances, the amount of at least some of the polynucleotides in the library is 5, 10, 20, 25, 50, 75, 100, 150, 200, 250, 300, 400, 500, or 600 times higher than the mean representation for the polynucleotide library. In some instances, the amount of at least 1% of the polynucleotides in the library is 5, 10, 20, 25, 50, 75, 100, 150, 200, 250, 300, 400, 500, or 600 times higher than the mean representation for the polynucleotide library. In some instances, the amount of at least 2% of the polynucleotides in the library is 5, 10, 20, 25, 50, 75, 100, 150, 200, 250, 300, 400, 500, or 600 times higher than the mean representation for the polynucleotide library. In some instances, the amount of at least 5% of the polynucleotides in the library is 5, 10, 20, 25, 50, 75, 100, 150, 200, 250, 300, 400, 500, or 600 times higher than the mean representation for the polynucleotide library. In some instances, the amount of no more than 5% of the polynucleotides in the library is 5, 10, 20, 25, 50, 75, 100, 150, 200, 250, 300, 400, 500, or 600 times higher than the mean representation for the polynucleotide library. In some instances, the amount of no more than 10% of the polynucleotides in the library is 5, 10, 20, 25, 50, 75, 100, 150, 200, 250, 300, 400, 500, or 600 times higher than the mean representation for the polynucleotide library. In some instances, the amount of at least 1%-10% of the polynucleotides in the library is 5, 10, 20, 25, 50, 75, 100, 150, 200, 250, 300, 400, 500, or 600 times higher than the mean representation for the polynucleotide library. In some instances, the amount of at least 1%-20% of the polynucleotides in the library is 5, 10, 20, 25, 50, 75, 100, 150, 200, 250, 300, 400, 500, or 600 times higher than the mean representation for the polynucleotide library. In some instances, the relative amount of a polynucleotide library is adjusted based on high or low GC content.

Polynucleotide libraries for identifying variants may collectively target a desired number of bases (bait territory). In some instances, a polynucleotide library comprise a bait territory of at least 5, 10, 15, 20, 25, 30, 40, 50, 60, 70, 80, 90 or at least 100 million bases. In some instances, a polynucleotide library comprise a bait territory of about 5, 10, 15, 20, 25, 30, 40, 50, 60, 70, 80, 90 or about 100 million bases. In some instances, a polynucleotide library comprise a bait territory of no more than 5, 10, 15, 20, 25, 30, 40, 50, 60, 70, 80, 90 or no more than 100 million bases.

Provided herein are systems and methods for generating polynucleotide libraries, such as those targeting variants. In some instances, systems comprise generation of in-silico polynucleotide libraries comprising sequences. In some instances, systems generate nucleic acid standards (e.g., SNV, CV, Indel, CNV, or other standard) described herein. In some instances systems for generating a polynucleotide library comprise: a computing system comprising at least one processor and instructions executable by the at least one processor to perform operations comprising one or more of: (a) receiving as input; (b) generating a polynucleotide library by saturating at least one target region with one or more polynucleotides; and (c) generating one or more outputs comprising sequences of the polynucleotide library. In some instances the input comprises a nucleic acid reference sequence, one or more of at least one target region, a nucleic acid reference sequence, and one or more variables. In some instances an input nucleic reference sequence comprises a genome. In some instances an input nucleic reference sequence comprises mRNA. In some instances, the at least one target region comprises at least one exon. In some instances, the at least one target region comprises a variant. In some instances the variant comprises a copy number variant (CNV), a single nucleotide variant (SNV), insertion/deletion (indel), or structural variant (SV).

Variables which control the sequences generated by systems may be tuned for specific applications or target regions. In some instances one or more variables independently comprise polynucleotide length, offset, number of probes, overlap, overhang, target region merges, and tiling depth. In some instances, the relationship between the size of the polynucleotide and the target is used to generate the library. In some instances the target region is smaller than a polynucleotide length. In some instances when the target region is smaller than a polynucleotide length, polynucleotides are generated with 1, 2, 3, 4, 5, or 6 base offsets. In some instances the target region is larger than a polynucleotide length. In some instances when the target region is larger than the polynucleotide length, polynucleotides are generated such that the entire target region is evenly covered.

Filters may be used with the systems provided herein. In some instances filters remove specific sequences from the library. In some instances a filter is configured to remove duplicate polynucleotide sequences from the library. In some instances a filter is configured to remove repetitive regions or regions with secondary structure. In some instances a filter is configured to remove SINE/LINE sequences from the polynucleotides. Further provided herein are systems wherein the one or more outputs comprises one or more log files.

Systems provided herein may comprise one or more outputs. In some instances, an output comprises a computer file or visual display of the library. In some instances an output comprises a file comprising the regions covered by the polynucleotides (i.e., covering the target region). In some instances an output comprises a file, wherein the file comprises all or a portion of the sequences from the library.

Output from a system may be used as input for a subsequent system. In some instances a system comprises a computing system comprising at least one processor and instructions executable by the at least one processor to perform operations comprising one or more of: (a) receiving as input a plurality of sequences from a library described herein; (b) trimming the plurality of sequences around the one or more variants loci; and (c) generating one or more outputs comprising sequences of the polynucleotide library. In some instances, a system provides an output to a synthesis module for printing of the library. In some instances, systems comprises a module for adding additional sequences to all or a portion of the polynucleotides in the library. In some instances, systems comprises a module for adding primers to all or a portion of the sequences in the library. In some instances, systems comprises a module for adding primers to each of the sequences in the library after step (b). In some instances, systems comprises a module for adding primers to each of the sequences in the library after step (c). In some instances, systems comprise a module for organizing the sequences into clusters. In some instances, systems comprise a module for organizing the clusters for synthesis on a synthesis device. In some instances, systems provided herein generate a polynucleotide library comprising an approximately a leptokurtic distribution. In some instances a system generates polynucleotides such at a distance between variants loci in the polynucleotides is 1-20, 1-15, 1-12, 1-5, 3-20, 3-15 3-10, 5-8, 5-10, 5-15, 5-25, 8-15, or 10-25 bases. In some instances the distance between variants loci is 3, 4, 5, 6, 7, 8, 9, 10, 11, or 12 bases

### Unique Molecular Identifiers

Described herein are adapters comprising unique molecular identifiers (UMIs). In some instances, adapters comprise universal adapters. In some instances adapters comprise a Y-annealing region (anneals to form yoke), one or more Y-step non-annealing regions, a first index region, a second index region, a first UMI (index) region, a second UMI (index) region, and one or more regions exterior to the index. In some instances, adapters are ligated to sample polynucleotides to form an adapter-ligated polynucleotide. After denaturation of, top and bottom [symbol] igation products are formed. In some instances, each strand is labeled with a different

[symbol] fter amplification with forward and backward primers, top strand and bottom strand PCR products are generated. In some instances, adapter ligated polynucleotides generated with universal adapters are further amplified with barcoded primers. In some instances adapters described herein comprise “in-line” UMIs, wherein at least one of a 5′ or 3′ UMI is not complementary to the other corresponding strand of the adapter. In some instances adapters described herein comprise “duplex” UMIs, wherein at least one of a 5′ or 3′ UMI is complementary to the other corresponding strand of the adapter.

Adapter-ligated libraries comprising unique molecular identifiers may be used to distinguish between “true” mutations from a polynucleotide sample library and artifacts generated during sequencing library preparation (e.g., PCR errors, sequencing errors, or other erroneous base call). In some instances, a workflow is used to analyze a library of adapter-ligated sample polynucleotides. Adapter-ligated sample polynucleotides each comprise two distinct UMIs represented by letters (A-F; six combinations of barcodes are shown for simplicity), and are attached to a sample polynucleotide. After sequencing, forward and reverse read pairs from sequencing are sorted into read pair groups. Next, read pairs are grouped by barcode and barcode position. Single-stranded consensus sequences are then generated from each group of barcode-grouped read pairs. Errors from D-C, and F-E are identified, although the error in A-B remains. Finally, duplex consensus sequences are generated by comparing each set of single stranded consensus sequences. The error in A-B can be identified, and true mutation E-F can be confirmed. In some instances, errors include substitutions, deletions, or insertions. In some instances, an error is present in the sample polynucleotide portion of an adapter-ligated polynucleotide. In some instances, an error is present in a barcode configured to identify a sample origin (e.g., index) or to uniquely identify a sample polynucleotide. In some instances, an error is present in a UMI. In some instances, an error is present in a sample index. Compositions and methods described herein in some instances are used to identify such errors.

Described herein are sets of UMIs, wherein the set has defined properties. In some instances, a UMI set comprises a plurality of different polynucleotides having unique sequences. In some instances, a UMI set is 8, 12, 16, 20, 24, 30, 32, 36, 39, 48, or 64 unique sequences. In some instances, the sequences of a UMI set differ by a Hamming distance of no more than 1, 2, 3, 4, or 5. In some instances, the sequences of a UMI set differ by a Hamming distance of at least 1, 2, 3, 4, or 5. In some instances, the sequences of a UMI set differ by a Hamming distance of at least 2. In some instances, the sequences of a UMI set differ by a Hamming distance of at least 1.

UMIs may be any length, depending on the desired application. In some instances, a UMI is no more than 15, 12, 10, 8, 7, 6, 5, 4, or not more than 3 bases in length. In some instances, a UMI is about 15, 12, 10, 8, 7, 6, 5, 4, or about 3 bases in length. In some instances, a UMI is about 3-12, 3-10, 3-8. 4-12, 4-10, 4-8, 6-12, or 8-12 bases in length. UMIs in a set may comprise more than one length. In some instances, 10, 20, 25, 30, 40, 50, 60, or 70 percent of UMIs in the set are a first length, and 90, 80, 75, 70, 60, 50, 40, or 30 percent are a second length. In some instances, the first length is 3-5 bases, and the second length is 3-5 bases. In some instances, UMIs comprise lengths of 5 or 6 bases.

After addition of UMI-containing adapters to sample polynucleotides, at least some of the sample polynucleotides may be uniquely labeled. In some instances, at least 30%, 50%, 75%, 80%, 90%, 95%, or at least 98% of the sample polynucleotides are ligated to adapters comprising UMIs. In some instances, at least 1%, 2%, 5%, 10%, 15%, 20%, 30%, 50%, 75%, 80%, 90%, 95%, or at least 98% of the sample polynucleotides are labeled with a unique UMI sequence. In some instances, no more than 1%, 2%, 5%, 10%, 15%, 20%, 30%, 50%, 75%, 80%, 90%, 95%, or no more than 98% of the sample polynucleotides are labeled with a unique UMI sequence. In some instances, at least 1%, 2%, 5%, 10%, 15%, 20%, 30%, 50%, 75%, 80%, 90%, 95%, or at least 98% of the sample polynucleotides are uniquely identifiable after labeling with a UMI.

UMIs described herein in some instances comprise sequences of one or more of AAGGA, ACAAC, ATACG, CACTG, CATGA, CGATA, CGTGT, GCCAT, GCTGT, GTCAC, GTCGT, TACGA, TCCTA, TCGTG, TGTCG, TTGGC, AACAC, AATGC, ACTAG, AGCAT, AGTAC, ATCTC, CAGAC, CAGTA, CGAAT, CGGTT, CTTGG, GCATA, GCTAA, GTGAG, GTGTC, and TGTGC. UMIs described herein in some instances comprise sequences of two or more of AAGGA, ACAAC, ATACG, CACTG, CATGA, CGATA, CGTGT, GCCAT, GCTGT, GTCAC, GTCGT, TACGA, TCCTA, TCGTG, TGTCG, TTGGC, AACAC, AATGC, ACTAG, AGCAT, AGTAC, ATCTC, CAGAC, CAGTA, CGAAT, CGGTT, CTTGG, GCATA, GCTAA, GTGAG, GTGTC, and TGTGC. UMIs described herein in some instances comprise sequences of five or more of AAGGA, ACAAC, ATACG, CACTG, CATGA, CGATA, CGTGT, GCCAT, GCTGT, GTCAC, GTCGT, TACGA, TCCTA, TCGTG, TGTCG, TTGGC, AACAC, AATGC, ACTAG, AGCAT, AGTAC, ATCTC, CAGAC, CAGTA, CGAAT, CGGTT, CTTGG, GCATA, GCTAA, GTGAG, GTGTC, and TGTGC. UMIs described herein in some instances comprise sequences of ten or more of AAGGA, ACAAC, ATACG, CACTG, CATGA, CGATA, CGTGT, GCCAT, GCTGT, GTCAC, GTCGT, TACGA, TCCTA, TCGTG, TGTCG, TTGGC, AACAC, AATGC, ACTAG, AGCAT, AGTAC, ATCTC, CAGAC, CAGTA, CGAAT, CGGTT, CTTGG, GCATA, GCTAA, GTGAG, GTGTC, and TGTGC.

UMIs may be represented at pre-selected percentages among a library of UMIs. In some instances at least 90% of the UMIs are present at fraction of 1-5%. In some instances at least 90% of the UMIs are present at fraction of 0.5%, 1%, 1.5%, 2%, 2.5%, 3%, 3.5%, 4%, 4.5%, 5%, 5.5%, 6%, 7%, or 8%. In some instances at least 90% of the UMIs are present at fraction of 0.5-8%, 1-7%, 1.5-7%, 2-7%, 2.5-6%, 3-8%, 3-6%, 1-5%, 0.5-5.5%, 1-4%, 1-6%, or 1-8%.

Any amount of sample polynucleotides (e.g., input DNA or other nucleic acid) may be ligated to adapters described herein. In some instances, the amount of sample polynucleotides is about 1, 5, 8, 10, 15, 20, 25, 30, 50, 75, or about 100 ng. In some instances, the amount of sample polynucleotides is no more than 1, 5, 8, 10, 15, 20, 25, 30, 50, 75, or no more than 100 ng. In some instances, the amount of sample polynucleotides is at least 1, 5, 8, 10, 15, 20, 25, 30, 50, 75, or at least 100 ng. In some instances, the amount of sample polynucleotides 1-10 ng, 1-100 ng, 3-10 ng, 5-100 ng, 5-75 ng, 5-50 ng, 10-100 ng, 10-50 ng, 25-100 ng, or 25-75 ng.

Provided herein are methods of generating adapters comprising UMIs. In a first method of adapter synthesis comprising synthesis of a top strand of an adapter comprising at least one UMI and a complementary bottom strand. After annealing the top and bottom adapter strands, an adapter comprising the structure of an adapter is formed. In a second method of adapter synthesis, a top strand is synthesized without a UMI, and a bottom strand comprising a complementary region and a UMI. After, annealing, PCR is used to generate a complementary UMI on the top strand, and a terminal transferase adds a T to the 3′ end of top strand to generate an adapter. In a third method of synthesis, a top strand which does not comprise a UMI, and a bottom strand comprising a UMI, a restrictions site, and a 5′ overhang are synthesized. After annealing, the top strand is extended with PCR, and a restriction endonuclease is used to cleave a portion of the 3′ top strand and 5′ bottom strand to generate an adapter. In a fourth method of adapter synthesis, two complementary strands each comprising a UMI, a restriction site, and an overhang portion (3′ top strand, 5′ bottom strand) are synthesized, annealed, and cleaved with a restriction enzyme to generate an adapter. More than one UMIs may be present per adapter. In some instances, an adapter comprises 1, 2, 3, 4, 5, or more UMIs. In some instances, adapters comprise a first UMI and a second UMI. In some instances, a first UMI and a second UMI are complementary. In some instances, adapters comprise a first UMI and a second UMI. In some instances, a first UMI and a second UMI are not complementary. In some instances adapters are combined into libraries of adapters. In some instances adapters in a library comprise UMIs. In some instances adapters in a library comprise unique combinations of a first UMI and a second UMI.

### Universal Adapters

Provided herein are universal adapters. In some instances, universal adapters comprise one or more unique molecular identifiers. In some instances, the universal adapters disclosed herein may comprise a universal polynucleotide adapter comprising a first strand and a second strand. In some instances, a first strand comprises a first primer binding region, a first non-complementary region, and a first yoke region. In some instances, a second strand comprises a second primer binding region, a second non-complementary region, and a second yoke region. In some instances, a primer binding region allows for PCR amplification of a polynucleotide adapter. In some instances, a primer binding region allows for PCR amplification of a polynucleotide adapter and concurrent addition of one or more barcodes to the polynucleotide adapter. In some instances, the first yoke region is complementary to the second yoke region. In some instances, the first non-complementary region is not complementary to the second non-complementary region. In some instances, the universal adapter is a Y-shaped or forked adapter. In some instances, one or more yoke regions comprise nucleobase analogues that raise the Tm between a first yoke region and a second yoke region. Primer binding regions as described herein may be in the form of a terminal adapter region of a polynucleotide. In some instances, a universal adapter comprises one index sequence. In some instances, a universal adapter comprises one unique molecular identifier. In some instances, universal adapters are configured for use with barcoded primers, wherein after ligation, barcoded primers are added via PCR.

A universal (polynucleotide) adapter may be shortened relative to a typical barcoded adapter (e.g., full-length “Y adapter”). For example, a universal adapter strand is 20-45 bases in length. In some instances, a universal adapter strand is 25-40 bases in length. In some instances, a universal adapter strand is 30-35 bases in length. In some instances, a universal adapter strand is no more than 50 bases in length, no more than 45 bases in length, no more than 40 bases in length, no more than 35 bases in length, no more than 30 bases in length, or no more than 25 bases in length. In some instances, a universal adapter strand is about 25, 27, 30, 32, 34, 36, 38, 40, 42, 44, 46, 48, 50, 52, 54, 56, 58, or about 60 bases in length. In some instances, a universal adapter strand is about 60 base pairs in length. In some instances, a universal adapter strand is about 58 base pairs in length. In some instances, a universal adapter strand is about 52 base pairs in length. In some instances, a universal adapter strand is about 33 base pairs in length.

A universal adapter may be modified to facilitate ligation with a sample polynucleotide. For example, the 5′ terminus is phosphorylated. In some instances, a universal adapter comprises one or more non-native nucleobase linkages such as a phosphorothioate linkage. For example, a universal adapter comprises a phosphorothioate between the 3′ terminal base, and the base adjacent to the 3′ terminal base. A sample polynucleotide in some instances comprises nucleic acid from a variety of sources, such as DNA or RNA of human, bacterial, plant, animal, fungal, or viral origin. An adapter-ligated sample polynucleotide in some instances comprises a sample polynucleotide (e.g., sample nucleic acid) with adapters universal adapters ligated to both the 5′ and 3′ end of the sample polynucleotide to form an adapter-ligated polynucleotide. A duplex sample polynucleotide comprises both a first strand (forward) and a second strand (reverse).

Universal adapters may contain any number of different nucleobases (DNA, RNA, etc.), nucleobase analogues, or non-nucleobase linkers or spacers. For example, an adapter comprises one or more nucleobase analogues or other groups that enhance hybridization (Tₘ) between two strands of the adapter. In some instances, nucleobase analogues are present in the yoke region of an adapter. Nucleobase analogues and other groups include but are not limited to locked nucleic acids (LNAs), bicyclic nucleic acids (BNAs), C5-modified pyrimidine bases, 2′-O-methyl substituted RNA, peptide nucleic acids (PNAs), glycol nucleic acid (GNAs), threose nucleic acid (TNAs), xenonucleic acids (XNAs) morpholino backbone-modified bases, minor grove binders (MGBs), spermine, G-clamps, or a anthraquinone (Uaq) caps.

Universal adapters may comprise any number of nucleobase analogues (such as LNAs or BNAs), depending on the desired hybridization Tₘ. For example, an adapter comprises 1 to 20 nucleobase analogues. In some instances, an adapter comprises 1 to 8 nucleobase analogues. In some instances, an adapter comprises at least 1, 2, 3, 4, 5, 6, 7, 8, 9, 10, 11, 12, or at least 12 nucleobase analogues. In some instances, an adapter comprises about 1, 2, 3, 4, 5, 6, 7, 8, 9, 10, 11, 12, 13, 14, 15, or about 16 nucleobase analogues. In some instances, the number of nucleobase analogous is expressed as a percent of the total bases in the adapter. For example, an adapter comprises at least 1%, 2%, 5%, 10%, 12%, 18%, 24%, 30%, or more than 30% nucleobase analogues. In some instances, adapters (e.g., universal adapters) described herein comprise methylated nucleobases, such as methylated cytosine.

### Barcodes

Polynucleotide primers may comprise defined sequences, such as barcodes (or indices). Adapters in some instances comprise one or more barcodes. In some instances, an adapter comprises at least one indexing barcode and at least one unique molecular identifier barcode. Barcodes can be attached to universal adapters, for example, using PCR and barcoded primers to generate barcoded adapter-ligated sample polynucleotides. Primer binding sites, such as universal primer binding sites, facilitate simultaneous amplification of all members of a barcode primer library, or a subpopulation of members. In some instances, a primer binding site comprises a region that binds to a flow cell or other solid support during next generation sequencing. In some instances, a barcoded primer comprises a P5 (5′-AATGATACGGCGACCACCGA-3′) (SEQ ID NO.: 5) or P7 (5′-CAAGCAGAAGACGGCATACGAGAT-3′) (SEQ ID NO.: 6) sequence. In some instances, primer binding sites are configured to bind to universal adapter sequences, and facilitate amplification and generation of barcoded adapters. In some instances, barcoded primers are no more than 60 bases in length. In some instances, barcoded primers are no more than 55 bases in length. In some instances, barcoded primers are 50-60 bases in length. In some instances, barcoded primers are about 60 bases in length. In some instances, barcodes described herein comprise methylated nucleobases, such as methylated cytosine.

The number of unique barcodes available for a barcode set (collection of unique barcodes or barcode combinations configured to be used together to unique define samples) may depend on the barcode length. In some instances, a Hamming distance is defined by the number of base differences between any two barcodes. In some instances, a Levenshtein distance is defined by the number changes needed to change one barcode into another (insertions, substitutions, or deletions). In some instances, barcode sets described herein comprise a Levenshtein distance of at least 2, 3, 4, 5, 6, 7, or at least 8. In some instances, barcode sets described herein comprise a Hamming distance of at least 2, 3, 4, 5, 6, 7, or at least 8.

Barcodes may be incorrectly associated with a different sample than they were assigned. In some instances, incorrect barcodes are occur from PCR errors (e.g., substitution) during library amplification. In some instances, entire barcodes “hop” or are transferred from one sample polynucleotide to another. Such transfers in some instances result from cross-contamination of free adapters or primers during a library generation workflow. In some instances a group of barcodes (barcode set) is chosen to minimize “barcode hopping”. In some instances, barcode hopping (for a single barcode) for a barcode set described herein is no more than 7%, 5%, 4%, 3%, 2%, 1%, 0.5%, or no more than 0.1%. In some instances, barcode hopping (for a single barcode) for a barcode set described herein is 0.1-6%, 0.1-5%, 0.2-5%, 0.5-5%, 1-7%, 1-5%, or 0.5-7%. In some instances, barcode hopping (for two barcodes) for a barcode set described herein is no more than 0.7%, 0.5%, 0.4%, 0.3%, 0.2%, 0.1%, 0.05%, or no more than 0.1%. In some instances, barcode hopping (for two barcodes) for a barcode set described herein is 0.01-0.6%, 0.01-0.5%, 0.02-0.5%, 0.05-0.5%, 0.1-0.7%, 0.1-0.5%, or 0.05-0.7%.

Barcoded primers comprise one or more barcodes. In some instances, the barcodes are added to universal adapters through PCR reaction. Barcodes are nucleic acid sequences that allow some feature of a polynucleotide with which the barcode is associated to be identified. In some instances, a barcode comprises an index sequence. In some instances, index sequences allow for identification of a sample, or unique source of nucleic acids to be sequenced. A barcode or combination of barcodes in some instances identifies a specific patient. A barcode or combination of barcodes in some instances identifies a specific sample from a patient among other samples from the same patient. After sequencing, the barcode (or barcode region) provides an indicator for identifying a characteristic associated with the coding region or sample source. Barcodes can be designed at suitable lengths to allow sufficient degree of identification, e.g., at least about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, or more bases in length. Multiple barcodes, such as about 2, 3, 4, 5, 6, 7, 8, 9, 10, or more barcodes, may be used on the same molecule, optionally separated by non-barcode sequences. In some instances, a barcode is positioned on the 5′ and the 3′ sides of a sample polynucleotide. In some instances, each barcode in a plurality of barcodes differ from every other barcode in the plurality at least three base positions, such as at least about 3, 4, 5, 6, 7, 8, 9, 10, or more positions. Use of barcodes allows for the pooling and simultaneous processing of multiple libraries for downstream applications, such as sequencing (multiplex). In some instances, at least 4, 8, 16, 32, 48, 64, 128, or more 512 barcoded libraries are used. In some instances, at least 400, 500, 800, 1000, 2000, 5000, 10,000, 12,000, 15,000, 18,000, 20,000, or at 25,000 barcodes are used. Barcoded primers or adapters may comprise unique molecular identifiers (UMI). Such UMIs in some instances uniquely tag all nucleic acids in a sample. In some instances, at least 60%, 70%, 80%, 90%, 95%, or more than 95% of the nucleic acids in a sample are tagged with a UMI. In some instances, at least 85%, 90%, 95%, 97%, or at least 99% of the nucleic acids in a sample are tagged with a unique barcode, or UMI. Barcoded primers in some instances comprise an index sequence and one or more UMI. UMIs allow for internal measurement of initial sample concentrations or stoichiometry prior to downstream sample processing (e.g., PCR or enrichment steps) which can introduce bias. In some instances, UMIs comprise one or more barcode sequences. In some instances, each strand (forward vs. reverse) of an adapter-ligated sample polynucleotide possesses one or more unique barcodes. Such barcodes are optionally used to uniquely tag each strand of a sample polynucleotide. In some instances, a barcoded primer comprises an index barcode and a UMI barcode. In some instances, after amplification with at least two barcoded primers, the resulting amplicons comprise two index sequences and two UMIs. In some instances, after amplification with at least two barcoded primers, the resulting amplicons comprise two index barcodes and one UMI barcode. In some instances, each strand of a universal adapter-sample polynucleotide duplex is tagged with a unique barcode, such as a UMI or index barcode.

Barcoded primers in a library comprise a region that is complementary to a primer binding region on a universal adapter. For example, universal adapter binding region is complementary to primer region of the universal adapter, and universal adapter binding region is complementary to primer region of the universal adapter. Such arrangements facilitate extension of universal adapters during PCR, and attach barcoded primers. In some instances, the Tm between the primer and the primer binding region is 40-65 degrees C. In some instances, the Tm between the primer and the primer binding region is 42-63 degrees C. In some instances, the Tm between the primer and the primer binding region is 50-60 degrees C. In some instances, the Tm between the primer and the primer binding region is 53-62 degrees C. In some instances, the Tm between the primer and the primer binding region is 54-58 degrees C. In some instances, the Tm between the primer and the primer binding region is 40-57 degrees C. In some instances, the Tm between the primer and the primer binding region is 40-50 degrees C. In some instances, the Tm between the primer and the primer binding region is about 40, 45, 47, 50, 52, 53, 55, 57, 59, 61, or 62 degrees C.

### Hybridization Blockers

Blockers may contain any number of different nucleobases (DNA, RNA, etc.), nucleobase analogues (non-canonical), or non-nucleobase linkers or spacers. In some instances, blockers comprise universal blockers. Such blockers may in some instances are described as a “set”, wherein the set comprises two or more blockers configured to prevent unwanted interactions with the same adapter sequence. In some instances, universal blockers prevent adapter-adapter interactions independent of one or more barcodes present on at least one of the adapters. For example, a blocker comprises one or more nucleobase analogues or other groups that enhance hybridization (Tₘ) between the blocker and the adapter. In some instances, a blocker comprises one or more nucleobases which decrease hybridization (Tₘ) between the blocker and the adapter (e.g., “universal” bases). In some instances, a blocker described herein comprises both one or more nucleobases which increase hybridization (Tₘ) between the blocker and the adapter and one or more nucleobases which decrease hybridization (Tₘ) between the blocker and the adapter.

Described herein are hybridization blockers comprising one or more regions which enhance binding to targeted sequences (e.g., adapter), and one or more regions which decrease binding to target sequences (e.g., adapter). In some instances, each region is tuned for a given desired level of off-bait activity during target enrichment applications. In some instances, each region can be altered with either a single type of chemical modification/moiety or multiple types to increase or decrease overall affinity of a molecule for a targeted sequence. In some instances, the melting temperature of all individual members of a blocker set are held above a specified temperature (e.g., with the addition of moieties such as LNAs and/or BNAs). In some instances, a given set of blockers will improve off bait performance independent of index length, independent of index sequence, and independent of how many adapter indices are present in hybridization.

Blockers may comprise moieties which increase and/or decrease affinity for a target sequencing, such as an adapter. In some instances, such specific regions can be thermodynamically tuned to specific melting temperatures to either avoid or increase the affinity for a particular targeted sequence. This combination of modifications is in some instances designed to help increase the affinity of the blocker molecule for specific and unique adapter sequence and decrease the affinity of the blocker molecule for repeated adapter sequence (e.g., Y-stem annealing portion of adapter). In some instances, blockers comprise moieties which decrease binding of a blocker to the Y-stem region of an adapter. In some instances, blockers comprise moieties which decrease binding of a blocker to the Y-stem region of an adapter, and moieties which increase binding of a blocker to non-Y-stem regions of an adapter.

Blockers (e.g., universal blockers) and adapters may form a number of different populations during hybridization. In a population ‘A’ in some instances comprises blockers correctly bound to non-index regions of the adapters. In a population ‘B’, a region of the blockers is bound to the “yoke” region of the adapter, but a remaining portion of the blocker does not bind to an adjacent region of the adapter. In a population ‘C’, two blockers unproductively dimerize. In a population ‘D’, blockers are unbound to any other nucleic acids. In some instances, when the number of DNA modifications that decrease affinity in the Y-stem annealing region of the blocker are increased, the populations ‘A’ & ‘D’ dominate and either have the desired or minimal effect. In some instances, as the number of DNA modifications that decrease affinity in the Y-stem annealing region of the blocker are decreased, the populations ‘B’ & ‘C’ dominate and have undesired effects where daisy-chaining or annealing to other adapters can occur (‘B’) or sequester blockers where they are unable to function properly (‘C’).

The index on both single or dual index adapter designs may be either partially or fully covered by universal blockers that have been extended with specifically designed DNA modifications to cover adapter index bases. In some instances, such modifications comprise moieties which decrease annealing to the index, such as universal bases. In some instances, the index of a dual index adapter is partially covered (or is overlapped) by one or more blockers. In some instances, the index of a dual index adapter is fully covered by one or more blockers. In some instances, the index of a single index adapter is partially covered by one or more blockers. In some instances, the index of a single index adapter is fully covered by one or more blockers. In some instances, a blocker overlaps an index sequence by at least 1, 2, 3, 4, 5, 6, 7, 8, 9, 10, 11, 12, 13, 14, 15, 20 or more than 20 bases. In some instances, a blocker overlaps an index sequence by no more than 1, 2, 3, 4, 5, 6, 7, 8, 9, 10, 11, 12, 13, 14, 15, 20, or no more than 25 bases. In some instances, a blocker overlaps an index sequence by about 1, 2, 3, 4, 5, 6, 7, 8, 9, 10, 11, 12, 13, 14, 15, 20 or about 30 bases. In some instances, a blocker overlaps an index sequence by 1-5, 1-3, 2-5, 2-8, 2-10, 3-6, 3-10, 4-10, 4-15, 1-4 or 5-7 bases. In some instances, a region of a blocker which overlaps an index sequences comprises at least one 2-deoxyinosine or 5-nitroindole nucleobase.

One or two blockers may overlap with an index sequence present on an adapter. In some instances, one or two blockers combined overlap with at least 1, 2, 3, 4, 5, 6, 7, 8, 9, 10, 11, 12, 13, 14, 15, 20 or more than 20 bases of the index sequence. In some instances, one or two blockers combined overlap with no more than 1, 2, 3, 4, 5, 6, 7, 8, 9, 10, 11, 12, 13, 14, 15, 20 or no more than 20 bases of the index sequence. In some instances, one or two blockers combined overlap with about 1, 2, 3, 4, 5, 6, 7, 8, 9, 10, 11, 12, 13, 14, 15, 20 or about 20 bases of the index sequence. In some instances, one or two blockers combined overlap by 1-5, 1-3, 2-5, 2-8, 2-10, 3-6, 3-10, 4-10, 4-15, 1-4 or 5-7 bases of the index sequence. In some instances, a region of a blocker which overlaps an index sequences comprises at least one 2-deoxyinosine or 5-nitroindole nucleobase.

In a first arrangement, the length of the adapter index overhang may be varied. When designed from a single side, the adapter index overhang can be altered to cover from 0 to n of the adapter index bases from either side of the index. This allows for the ability to design such adapter blockers for both single and dual index adapter systems.

In a second arrangement, the adapter index bases are covered from both sides. When adapter index bases are covered from both sides, the length of the covering region of each blocker can be chosen such that a single pair of blockers is capable of interacting with a range of adapter index lengths while still covering a significant portion of the total number of index bases. As an example, take two blockers that have been designed with 3 bp overhangs that cover the adapter index. In the context of 6 bp, 8 bp, or 10 bp adapter index lengths, these blockers will leave 0 bp, 2 bp, or 4 bp exposed during hybridization, respectively.

In a third arrangement, modified nucleobases are selected to cover index adapter bases. Examples of these modifications that are currently commercially available include degenerate bases (e.g., mixed bases of A, T, C, G), 2′-deoxyInosine, & 5-nitroindole.

In a forth arrangement, blockers with adapter index overhangs bind to either the sense (i.e., ‘top’) or anti-sense (i.e., ‘bottom’) strand of a next generation sequencing library.

In a fifth arrangement, blockers are further extended to cover other polynucleotide sequences (e.g., a poly-A tail added in a previous biochemical step in order to facilitate ligation or other method to introduce a defined adapter sequence, unique molecular identifier for bioinformatic assignment following sequencing, etc.) in addition to the standard adapter index bases of defined length and composition. These types of sequences can be placed in multiple locations of an adapter and in this case the most widely utilized case (e.g., unique molecular index next to the genomic insert) is presented. Other positions for the unique molecular identifier (e.g., next to adapter index bases) could also be addressed with similar approaches.

In a sixth arrangement, all of the previous arrangements are utilized in various combinations to meet a targeted performance metric for off-bait performance during target enrichment under specified conditions.

Blockers may comprise moieties, such as nucleobase analogues. Nucleobase analogues and other groups include but are not limited to locked nucleic acids (LNAs), bicyclic nucleic acids (BNAs), C5-modified pyrimidine bases, 2′-O-methyl substituted RNA, peptide nucleic acids (PNAs), glycol nucleic acid (GNAs), threose nucleic acid (TNAs), inosine, 2′-deoxyInosine, 3-nitropyrrole, 5-nitroindole, xenonucleic acids (XNAs) morpholino backbone-modified bases, minor grove binders (MGBs), spermine, G-clamps, or a anthraquinone (Uaq) caps. In some instances, nucleobase analogues comprise universal bases, wherein the nucleobase has a lower Tₘ for binding to a cognate nucleobase. In some instances, universal bases comprise 5-nitroindole or 2′-deoxyInosine. In instances, blockers comprise spacer elements that connect two polynucleotide chains. In some instances, blockers comprise one or more nucleobase analogues. In some instances, such nucleobase analogues are added to control the Tₘ of a blocker. Blockers may comprise any number of nucleobase analogues (such as LNAs or BNAs), depending on the desired hybridization Tₘ. For example, a blocker comprises 20 to 40 nucleobase analogues. In some instances, a blocker comprises 8 to 16 nucleobase analogues. In some instances, a blocker comprises at least 1, 2, 3, 4, 5, 6, 7, 8, 9, 10, 11, 12, or at least 12 nucleobase analogues. In some instances, a blocker comprises about 1, 2, 3, 4, 5, 6, 7, 8, 9, 10, 11, 12, 13, 14, 15, or about 16 nucleobase analogues. In some instances, the number of nucleobase analogous is expressed as a percent of the total bases in the blocker. For example, a blocker comprises at least 1%, 2%, 5%, 10%, 12%, 18%, 24%, 30%, or more than 30% nucleobase analogues. In some instances, the blocker comprising a nucleobase analogue raises the Tn in a range of about 2° C. to about 8° C. for each nucleobase analogue. In some instances, the Tn is raised by at least or about 1° C., 2° C., 3° C., 4° C., 5° C., 6° C., 7° C., 8° C., 9° C., 10° C., 12° C., 14° C., or 16° C. for each nucleobase analogue. Such blockers in some instances are configured to bind to the top or “sense” strand of an adapter. Blockers in some instances are configured to bind to the bottom or “anti-sense” strand of an adapter. In some instances a set of blockers includes sequences which are configured to bind to both top and bottom strands of an adapter. Additional blockers in some instances are configured to the complement, reverse, forward, or reverse complement of an adapter sequence. In some instances, a set of blockers targeting a top (binding to the top) or bottom strand (or both) is designed and tested, followed by optimization, such as replacing a top blocker with a bottom blocker, or a bottom blocker with a top blocker. In some instances, a blocker is configured to overlap fully or partially with bases of an index or barcode on an adapter. A set of blockers in some instances comprise at least one blocker overlapping with an adapter index sequence. A set of blockers in some instances comprise at least one blocker overlapping with an adapter index sequence, and at least one blocker which does not overlap with an adapter sequence. A set of blockers in some instances comprise at least one blocker which does not overlap with a yoke region sequence. A set of blockers in some instances comprise at least one blocker which does not overlap with a yoke region sequence and at least one blocker which overlaps with a yoke region sequence. A sets of blockers in some instances comprises 2, 3, 4, 5, 6, 7, 8, 9, 10, or more than 10 blockers.

Blockers may be any length, depending on the size of the adapter or hybridization Tₘ. For example, blockers are 20 to 50 bases in length. In some instances, blockers are 25 to 45 bases, 30 to 40 bases, 20 to 40 bases, or 30 to 50 bases in length. In some instances, blockers are 25 to 35 bases in length. In some instances blockers are at least 25, 26, 27, 28, 29, 30, 31, 32, 33, 34, or at least 35 bases in length. In some instances, blockers are no more than 25, 26, 27, 28, 29, 30, 31, 32, 33, 34, or no more than 35 bases in length. In some instances, blockers are about 25, 26, 27, 28, 29, 30, 31, 32, 33, 34, or about 35 bases in length. In some instances, blockers are about 50 bases in length. A set of blockers targeting an adapter-tagged genomic library fragment in some instances comprises blockers of more than one length. Two blockers are in some instances tethered together with a linker. Various linkers are well known in the art, and in some instances comprise alkyl groups, polyether groups, amine groups, amide groups, or other chemical group. In some instances, linkers comprise individual linker units, which are connected together (or attached to blocker polynucleotides) through a backbone such as phosphate, thiophosphate, amide, or other backbone. In an exemplary arrangement, a linker spans the index region between a first blocker that each targets the 5′ end of the adapter sequence and a second blocker that targets the 3′ end of the adapter sequence. In some instances, capping groups are added to the 5′ or 3′ end of the blocker to prevent downstream amplification. Capping groups variously comprise polyethers, polyalcohols, alkanes, or other non-hybridizable group that prevents amplification. Such groups are in some instances connected through phosphate, thiophosphate, amide, or other backbone. In some instances, one or more blockers are used. In some instances, at least 4 non-identical blockers are used. In some instances, a first blocker spans a first 3′ end of an adaptor sequence, a second blocker spans a first 5′ end of an adaptor sequence, a third blocker spans a second 3′ end of an adaptor sequence, and a fourth blockers spans a second 5′ end of an adaptor sequence. In some instances a first blocker is at least 20, 21, 22, 23, 24, 25, 26, 27, 28, 29, 30, 31, 32, 33, 34, or at least 35 bases in length. In some instances a second blocker is at least 20, 21, 22, 23, 24, 25, 26, 27, 28, 29, 30, 31, 32, 33, 34, or at least 35 bases in length. In some instances a third blocker is at least 20, 21, 22, 23, 24, 25, 26, 27, 28, 29, 30, 31, 32, 33, 34, or at least 35 bases in length. In some instances a fourth blocker is at least 20, 21, 22, 23, 24, 25, 26, 27, 28, 29, 30, 31, 32, 33, 34, or at least 35 bases in length. In some instances, a first blocker, second blocker, third blocker, or fourth blocker comprises a nucleobase analogue. In some instances, the nucleobase analogue is LNA.

The design of blockers may be influenced by the desired hybridization Tₘ to the adapter sequence. In some instances, non-canonical nucleic acids (for example locked nucleic acids, bridged nucleic acids, or other non-canonical nucleic acid or analog) are inserted into blockers to increase or decrease the blocker's Tₘ. In some instances, the Tₘ of a blocker is calculated using a tool specific to calculating Tₘ for polynucleotides comprising a non-canonical amino acid. In some instances, a Tₘ is calculated using the Exiqon™ online prediction tool. In some instances, blocker Tₘ described herein are calculated in-silico. In some instances, the blocker Tₘ is calculated in-silico, and is correlated to experimental in-vitro conditions. Without being bound by theory, an experimentally determined Tₘ may be further influenced by experimental parameters such as salt concentration, temperature, presence of additives, or other factor. In some instances, Tₘ described herein are in-silico determined Tₘ that are used to design or optimize blocker performance. In some instances, Tₘ values are predicted, estimated, or determined from melting curve analysis experiments. In some instances, blockers have a Tₘ of 70 degrees C. to 99 degrees C. In some instances, blockers have a Tₘ of 75 degrees C. to 90 degrees C. In some instances, blockers have a Tₘ of at least 85 degrees C. In some instances, blockers have a Tₘ of at least 70, 72, 75, 77, 80, 82, 85, 88, 90, or at least 92 degrees C. In some instances, blockers have a Tₘ of about 70, 72, 75, 77, 80, 82, 85, 88, 90, 92, or about 95 degrees C. In some instances, blockers have a Tₘ of 78 degrees C. to 90 degrees C. In some instances, blockers have a Tₘ of 79 degrees C. to 90 degrees C. In some instances, blockers have a Tₘ of 80 degrees C. to 90 degrees C. In some instances, blockers have a Tₘ of 81 degrees C. to 90 degrees C. In some instances, blockers have a Tₘ of 82 degrees C. to 90 degrees C. In some instances, blockers have a Tₘ of 83 degrees C. to 90 degrees C. In some instances, blockers have a Tₘ of 84 degrees C. to 90 degrees C. In some instances, a set of blockers have an average Tₘ of 78 degrees C. to 90 degrees C. In some instances, a set of blockers have an average Tₘ of 80 degrees C. to 90 degrees C. In some instances, a set of blockers have an average Tₘ of at least 80 degrees C. In some instances, a set of blockers have an average Tₘ of at least 81 degrees C. In some instances, a set of blockers have an average Tₘ of at least 82 degrees C. In some instances, a set of blockers have an average Tₘ of at least 83 degrees C. In some instances, a set of blockers have an average Tₘ of at least 84 degrees C. In some instances, a set of blockers have an average Tₘ of at least 86 degrees C. Blocker Tₘ are in some instances modified as a result of other components described herein, such as use of a fast hybridization buffer and/or hybridization enhancer.

The molar ratio of blockers to adapter targets may influence the off-bait (and subsequently off-target) rates during hybridization. The more efficient a blocker is at binding to the target adapter, the less blocker is required. Blockers described herein in some instances achieve sequencing outcomes of no more than 20% off-target reads with a molar ratio of less than 20:1 (blocker:target). In some instances, no more than 20% off-target reads are achieved with a molar ratio of less than 10:1 (blocker:target). In some instances, no more than 20% off-target reads are achieved with a molar ratio of less than 5:1 (blocker:target). In some instances, no more than 20% off-target reads are achieved with a molar ratio of less than 2:1 (blocker:target). In some instances, no more than 20% off-target reads are achieved with a molar ratio of less than 1.5:1 (blocker:target). In some instances, no more than 20% off-target reads are achieved with a molar ratio of less than 1.2:1 (blocker:target). In some instances, no more than 20% off-target reads are achieved with a molar ratio of less than 1.05:1 (blocker:target).

The universal blockers may be used with panel libraries of varying size. In some embodiments, the panel libraries comprises at least or about 0.01, 0.02, 0.03, 0.04, 0.05, 0.06, 0.07, 0.08, 0.09, 1.0, 2.0, 4.0, 8.0, 10.0, 12.0, 14.0, 16.0, 18.0, 20.0, 22.0, 24.0, 26.0, 28.0, 30.0, 40.0, 50.0, 60.0, or more than 60.0 megabases (Mb).

Blockers as described herein may improve on-target performance. In some embodiments, on-target performance is improved by at least or about 5%, 10%, 15%, 20%, 25%, 30%, 35%, 40%, 45%, 50%, 55%, 60%, 65%, 70%, 75%, 80%, 85%, 90%, 95%, or more than 95%. In some embodiments, the on-target performance is improved by at least or about 5%, 10%, 15%, 20%, 25%, 30%, 35%, 40%, 45%, 50%, 55%, 60%, 65%, 70%, 75%, 80%, 85%, 90%, 95%, or more than 95% for various index designs. In some embodiments, the on-target performance is improved by at least or about 5%, 10%, 15%, 20%, 25%, 30%, 35%, 40%, 45%, 50%, 55%, 60%, 65%, 70%, 75%, 80%, 85%, 90%, 95%, or more than 95% is improved for various panel sizes.

### De Novo Synthesis of Small Polynucleotide Populations for Amplification Reactions

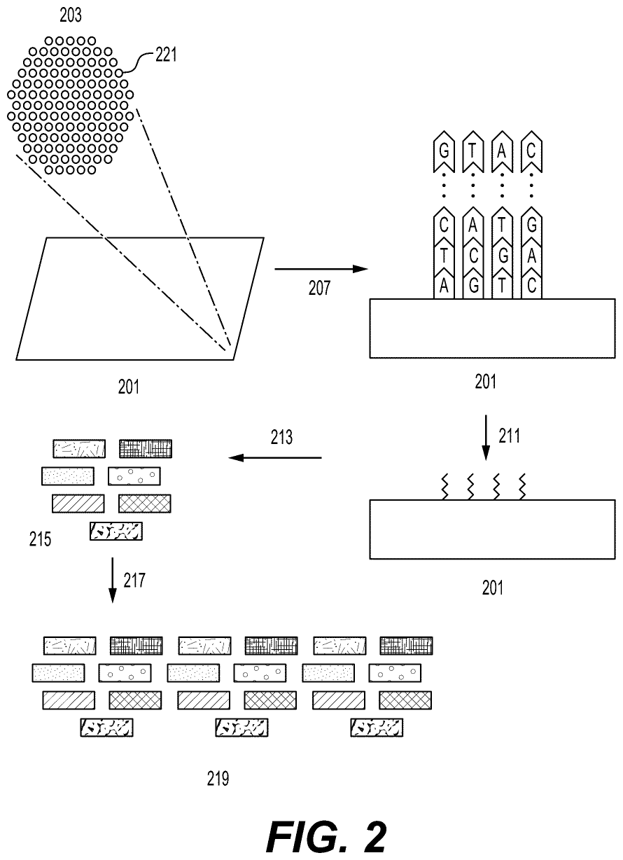

Described herein are methods of synthesis of polynucleotides from a surface, e.g., a plate (FIG. 2). In some instances, polynucleotide libraries comprise sample polynucleotide libraries. In some instances, the polynucleotides are synthesized on a cluster of loci for polynucleotide extension, released and then subsequently subjected to an amplification reaction, e.g., PCR. An exemplary workflow of synthesis of polynucleotides from a cluster is depicted in FIG. 2. A silicon plate 201 includes multiple clusters 203. Within each cluster are multiple loci 221. Polynucleotides are synthesized 207 de novo on a plate 201 from the cluster 203. Polynucleotides are cleaved 211 and removed 213 from the plate to form a population of released polynucleotides 215. The population of released polynucleotides 215 is then amplified 217 to form a library of amplified polynucleotides 219.

Provided herein are methods where amplification of polynucleotides synthesized on a cluster provide for enhanced control over polynucleotide representation compared to amplification of polynucleotides across an entire surface of a structure without such a clustered arrangement. In some instances, amplification of polynucleotides synthesized from a surface having a clustered arrangement of loci for polynucleotides extension provides for overcoming the negative effects on representation due to repeated synthesis of large polynucleotide populations. Exemplary negative effects on representation due to repeated synthesis of large polynucleotide populations include, without limitation, amplification bias resulting from high/low GC content, repeating sequences, trailing adenines, secondary structure, affinity for target sequence binding, or modified nucleotides in the polynucleotide sequence.

Cluster amplification as opposed to amplification of polynucleotides across an entire plate without a clustered arrangement can result in a tighter distribution around the mean. For example, if 100,000 reads are randomly sampled, an average of 8 reads per sequence would yield a library with a distribution of about 1.5× from the mean. In some cases, single cluster amplification results in at most about 1.5×, 1.6×, 1.7×, 1.8×, 1.9×, or 2.0× from the mean. In some cases, single cluster amplification results in at least about 1.0×, 1.2×, 1.3×, 1.5×1.6×, 1.7×, 1.8×, 1.9×, or 2.0× from the mean.

Cluster amplification methods described herein when compared to amplification across a plate can result in a polynucleotide library that requires less sequencing for equivalent sequence representation. In some instances at least 10%, at least 20%, at least 30%, at least 40%, at least 50%, at least 60%, at least 70%, at least 80%, at least 90%, or at least 95% less sequencing is required. In some instances up to 10%, up to 20%, up to 30%, up to 40%, up to 50%, up to 60%, up to 70%, up to 80%, up to 90%, or up to 95% less sequencing is required. Sometimes 30% less sequencing is required following cluster amplification compared to amplification across a plate. Sequencing of polynucleotides in some instances is verified by high-throughput sequencing such as by next generation sequencing. Sequencing of the sequencing library can be performed with any appropriate sequencing technology, including but not limited to single-molecule real-time (SMRT) sequencing, polony sequencing, sequencing by ligation, reversible terminator sequencing, proton detection sequencing, ion semiconductor sequencing, nanopore sequencing, electronic sequencing, pyrosequencing, Maxam-Gilbert sequencing, chain termination (e.g., Sanger) sequencing, +S sequencing, or sequencing by synthesis. The number of times a single nucleotide or polynucleotide is identified or “read” is defined as the sequencing depth or read depth. In some cases, the read depth is referred to as a fold coverage, for example, 55 fold (or 55×) coverage, optionally describing a percentage of bases.

In some instances, amplification from a clustered arrangement compared to amplification across a plate results in less dropouts, or sequences which are not detected after sequencing of amplification product. Dropouts can be of AT and/or GC. In some instances, a number of dropouts are at most about 1%, 2%, 3%, 4%, or 5% of a polynucleotide population. In some cases, the number of dropouts is zero.

A cluster as described herein comprises a collection of discrete, non-overlapping loci for polynucleotide synthesis. A cluster can comprise about 50-1000, 75-900, 100-800, 125-700, 150-600, 200-500, or 300-400 loci. In some instances, each cluster includes 121 loci. In some instances, each cluster includes about 50-500, 50-200, 100-150 loci. In some instances, each cluster includes at least about 50, 100, 150, 200, 500, 1000 or more loci. In some instances, a single plate includes 100, 500, 10000, 20000, 30000, 50000, 100000, 500000, 700000, 1000000 or more loci. A locus can be a spot, well, microwell, channel, or post. In some instances, each cluster has at least 1×, 2×, 3×, 4×, 5×, 6×, 7×, 8×, 9×, 10×, or more redundancy of separate features supporting extension of polynucleotides having identical sequence.

Generation of Polynucleotide Libraries with Controlled Stoichiometry of Sequence Content

In some instances, the polynucleotide library (such as a sample polynucleotide set for variant detection) is synthesized with a specified distribution of desired polynucleotide sequences. In some instances, adjusting polynucleotide libraries for enrichment of specific desired sequences results in improved downstream application outcomes.

One or more specific sequences can be selected based on their evaluation in a downstream application. In some instances, the evaluation is binding affinity to target sequences for amplification, enrichment, or detection, stability, melting temperature, biological activity, ability to assemble into larger fragments, or other property of polynucleotides. In some instances, the evaluation is empirical or predicted from prior experiments and/or computer algorithms. An exemplary application includes increasing sequences in a probe library which correspond to areas of a genomic target having less than average read depth.

Selected sequences in a polynucleotide library can be at least 10%, 20%, 30%, 40%, 50%, 60%, 70%, 80%, 90%, 95%, or more than 95% of the sequences. In some instances, selected sequences in a polynucleotide library are at most 10%, 20%, 30%, 40%, 50%, 60%, 70%, 80%, 90%, 95%, or at most 100% of the sequences. In some cases, selected sequences are in a range of about 5-95%, 10-90%, 30-80%, 40-75%, or 50-70% of the sequences.

Polynucleotide libraries can be adjusted for the frequency of each selected sequence. In some instances, polynucleotide libraries favor a higher number of selected sequences. For example, a library is designed where increased polynucleotide frequency of selected sequences is in a range of about 40% to about 90%. In some instances, polynucleotide libraries contain a low number of selected sequences. For example, a library is designed where increased polynucleotide frequency of the selected sequences is in a range of about 10% to about 60%. A library can be designed to favor a higher and lower frequency of selected sequences. In some instances, a library favors uniform sequence representation. For example, polynucleotide frequency is uniform with regard to selected sequence frequency, in a range of about 10% to about 90%. In some instances, a library comprises polynucleotides with a selected sequence frequency of about 10% to about 95% of the sequences.

Generation of polynucleotide libraries with a specified selected sequence frequency in some cases occurs by combining at least 2 polynucleotide libraries with different selected sequence frequency content. In some instances, at least 2, 3, 4, 5, 6, 7, 10, or more than 10 polynucleotide libraries are combined to generate a population of polynucleotides with a specified selected sequence frequency. In some cases, no more than 2, 3, 4, 5, 6, 7, or 10 polynucleotide libraries are combined to generate a population of non-identical polynucleotides with a specified selected sequence frequency.

In some instances, selected sequence frequency is adjusted by synthesizing fewer or more polynucleotides per cluster. For example, at least 25, 50, 100, 200, 300, 400, 500, 600, 700, 800, 900, 1000, or more than 1000 non-identical polynucleotides are synthesized on a single cluster. In some cases, no more than about 50, 100, 200, 300, 400, 500, 600, 700, 800, 900, 1000 non-identical polynucleotides are synthesized on a single cluster. In some instances, 50 to 500 non-identical polynucleotides are synthesized on a single cluster. In some instances, 100 to 200 non-identical polynucleotides are synthesized on a single cluster. In some instances, about 100, about 120, about 125, about 130, about 150, about 175, or about 200 non-identical polynucleotides are synthesized on a single cluster.

In some cases, selected sequence frequency is adjusted by synthesizing non-identical polynucleotides of varying length. For example, the length of each of the non-identical polynucleotides synthesized may be at least or about at least 10, 15, 20, 25, 30, 35, 40, 45, 50, 100, 150, 200, 300, 400, 500, 2000 nucleotides, or more. The length of the non-identical polynucleotides synthesized may be at most or about at most 2000, 500, 400, 300, 200, 150, 100, 50, 45, 35, 30, 25, 20, 19, 18, 17, 16, 15, 14, 13, 12, 11, 10 nucleotides, or less. The length of each of the non-identical polynucleotides synthesized may fall from 10-2000, 10-500, 9-400, 11-300, 12-200, 13-150, 14-100, 15-50, 16-45, 17-40, 18-35, and 19-25.

### Use of Polynucleotide Libraries as Standards

Provided herein are methods of using polynucleotide libraries to improve the sensitivity and accuracy of nucleic acid variant detection. In some instances, the method comprises preparing a nucleic acid sample useful for determining the detection limit of genomic variants. In some instances, the method comprises one or more of the steps of providing a polynucleotide library described herein (e.g., reference standard); obtaining at least one sample from a patient suspected of having a disease or condition; detecting the presence or absence of the one or more variants in the library; and detecting the presence or absence of the one or more variants in the at least one sample. In some instances, detecting comprises sequencing. In some instances, detecting comprises Next Generation Sequencing. In some instances, sequencing comprises sequencing by synthesis, nanopore sequencing, SMRT sequencing, or other sequencing method described herein. In some instances, detecting comprises ddPCR or specific hybridization to an array.

Samples (e.g., test samples, samples for assay) may be obtained from any source. In some instances, the source is a human. In some instances, the source is a human (or patient) suspected of having a disease or condition. In some instances, the test sample comprises a liquid biopsy. In some instances, the test sample comprises circulating tumor DNA (ctDNA). In some instances, the test sample comprises circulating tumor DNA (ctDNA). In some instances, the test sample is obtained from blood. In some instances, the test sample is substantially cell-free. In some instances, more than one test sample is analyzed sequentially or in parallel. In some instances, at least 1, 2, 3, 4, 5, 10, 20, 50, 100, 200, 500, 1000, or more than 2000 test samples are analyzed. In some instances, the method further comprises detection of minimal residual disease (MRD). In some instances, the patient is suspected of having a disease or condition. In some instances, the disease or condition is a proliferative disease. In some instances, the disease or condition is cancer. In some instances, the patient was previously treated, is currently treated, or has received a clinical diagnosis for cancer. In some instances, the method further comprises ligating sequencing adapters to at least some polynucleotides in the sample, the library, or both. In some instances, the method further comprises amplifying at least some polynucleotides in the sample, the library, or both. In some instances, if one or more variants are not detected in the library, then results obtained from the at least one sample is discarded or re-analyzed.

### Kits

Provided herein are kits comprising libraries of polynucleotides. In some instances, a kit comprises one or more of a reference standards (controls), wherein the reference standard comprises a sample polynucleotide set and a background set; instructions for use of the kit contents; and packaging to hold and describe the kit contents. In some instances, a kit comprises at least two standards selected from sample polynucleotides having a VAF of 0%, 0.1% 0.25%, 0.5%, 1%, or 2% relative to a wild-type genomic sequence. In some instances, a kit comprises five standards each having a VAF of 0%, 0.1% 0.25%, 0.5%, 1%, or 2% relative to a wild-type genomic sequence. In some instances, kits comprise instructions of use of reference standards with one or more sequencing instruments or other instrument which is configured to measure genomic variants. In some instances, the reference standard is packaged in a buffer. In some instances, the reference standard is packaged in a tube. In some instances, the reference standard is not packaged in a plasma-like format. In some instances, the reference standard comprises 500 ng to 5 micrograms of total DNA.

### Next Generation Sequencing Applications

Downstream applications of polynucleotide libraries (such as sample polynucleotide sets or reference standards) may include next generation sequencing. For example, enrichment of target sequences with a controlled stoichiometry polynucleotide probe library results in more efficient sequencing. The performance of a polynucleotide library for capturing or hybridizing to targets may be defined by a number of different metrics describing efficiency, accuracy, and precision. For example, Picard metrics comprise variables such as HS library size (the number of unique molecules in the library that correspond to target regions, calculated from read pairs), mean target coverage (the percentage of bases reaching a specific coverage level), depth of coverage (number of reads including a given nucleotide) fold enrichment (sequence reads mapping uniquely to the target/reads mapping to the total sample, multiplied by the total sample length/target length), percent off-bait bases (percent of bases not corresponding to bases of the probes/baits), percent off-target (percent of bases not corresponding to bases of interest), usable bases on target, AT or GC dropout rate, fold 80 base penalty (fold over-coverage needed to raise 80 percent of non-zero targets to the mean coverage level), percent zero coverage targets, PF reads (the number of reads passing a quality filter), percent selected bases (the sum of on-bait bases and near-bait bases divided by the total aligned bases), percent duplication, or other variable consistent with the specification.

Read depth (sequencing depth, or sampling) represents the total number of times a sequenced nucleic acid fragment (a “read”) is obtained for a sequence. Theoretical read depth is defined as the expected number of times the same nucleotide is read, assuming reads are perfectly distributed throughout an idealized genome. Read depth is expressed as function of % coverage (or coverage breadth). For example, 10 million reads of a 1 million base genome, perfectly distributed, theoretically results in 10× read depth of 100% of the sequences. In practice, a greater number of reads (higher theoretical read depth, or oversampling) may be needed to obtain the desired read depth for a percentage of the target sequences. Enrichment of target sequences with a controlled stoichiometry probe library increases the efficiency of downstream sequencing, as fewer total reads will be required to obtain an outcome with an acceptable number of reads over a desired % of target sequences. For example, in some instances 55× theoretical read depth of target sequences results in at least 30× coverage of at least 90% of the sequences. In some instances no more than 55× theoretical read depth of target sequences results in at least 30× read depth of at least 80% of the sequences. In some instances no more than 55× theoretical read depth of target sequences results in at least 30× read depth of at least 95% of the sequences. In some instances no more than 55× theoretical read depth of target sequences results in at least 10× read depth of at least 98% of the sequences. In some instances, 55× theoretical read depth of target sequences results in at least 20× read depth of at least 98% of the sequences. In some instances no more than 55× theoretical read depth of target sequences results in at least 5× read depth of at least 98% of the sequences. Increasing the concentration of probes during hybridization with targets can lead to an increase in read depth. In some instances, the concentration of probes is increased by at least 1.5×, 2.0×, 2.5×, 3×, 3.5×, 4×, 5×, or more than 5×. In some instances, increasing the probe concentration results in at least a 1000% increase, or a 20%, 30%, 40%, 50%, 60%, 70%, 80%, 90%, 100%, 200%, 300%, 500%, 750%, 1000%, or more than a 1000% increase in read depth. In some instances, increasing the probe concentration by 3× results in a 1000% increase in read depth. In some instances, sequencing is performed to achieve a theoretical read depth of at least 30×, 50×, 100×, 150×, 200×, 250×, 300×, 500×, or at least 1000×. In some instances, sequencing is performed to achieve a theoretical read depth of about 30×, 50×, 100×, 150×, 200×, 250×, 300×, 500×, or about 1000×. In some instances, sequencing is performed to achieve a theoretical read depth of no more than 30×, 50×, 100×, 150×, 200×, 250×, 300×, 500×, or no more than 1000×. In some instances, sequencing is performed to achieve an actual read depth of at least 30×, 50×, 100×, 150×, 200×, 250×, 300×, 500×, or at least 1000×. In some instances, sequencing is performed to achieve an actual read depth of no more than 30×, 50×, 100×, 150×, 200×, 250×, 300×, 500×, or no more than 1000×. In some instances, sequencing is performed to achieve an actual read depth of about 30×, 50×, 100×, 150×, 200×, 250×, 300×, 500×, or about 1000×.

On-target rate represents the percentage of sequencing reads that correspond with the desired target sequences. In some instances, a controlled stoichiometry polynucleotide probe library results in an on-target rate of at least 30%, or at least 35%, 40%, 45%, 50%, 55%, 60%, 65%, 70%, 75%, 80%, 85%, or at least 90%. Increasing the concentration of polynucleotide probes during contact with target nucleic acids leads to an increase in the on-target rate. In some instances, the concentration of probes is increased by at least 1.5×, 2.0×, 2.5×, 3×, 3.5×, 4×, 5×, or more than 5×. In some instances, increasing the probe concentration results in at least a 20% increase, or a 10%, 20%, 30%, 40%, 50%, 60%, 70%, 80%, 90%, 100%, 200%, 300%, or at least a 500% increase in on-target binding. In some instances, increasing the probe concentration by 3× results in a 20% increase in on-target rate.

Coverage uniformity is in some cases calculated as the read depth as a function of the target sequence identity. Higher coverage uniformity results in a lower number of sequencing reads needed to obtain the desired read depth. For example, a property of the target sequence may affect the read depth, for example, high or low GC or AT content, repeating sequences, trailing adenines, secondary structure, affinity for target sequence binding (for amplification, enrichment, or detection), stability, melting temperature, biological activity, ability to assemble into larger fragments, sequences containing modified nucleotides or nucleotide analogues, or any other property of polynucleotides. Enrichment of target sequences with controlled stoichiometry polynucleotide probe libraries results in higher coverage uniformity after sequencing. In some instances, 95% of the sequences have a read depth that is within 1× of the mean library read depth, or about 0.05, 0.1, 0.2, 0.5, 0.7, 1, 1.2, 1.5, 1.7 or about within 2× the mean library read depth. In some instances, 80%, 85%, 90%, 95%, 97%, or 99% of the sequences have a read depth that is within 1× of the mean.

Enrichment of Target Nucleic Acids with a Polynucleotide Probe Library

A probe library described herein may be used to enrich target polynucleotides present in a population of sample polynucleotides, for a variety of downstream applications. In one some instances, a sample is obtained from one or more sources, and the population of sample polynucleotides is isolated. Samples are obtained (by way of non-limiting example) from biological sources such as saliva, blood, tissue, skin, or completely synthetic sources. The plurality of polynucleotides obtained from the sample are fragmented, end-repaired, and adenylated to form a double stranded sample nucleic acid fragment. In some instances, end repair is accomplished by treatment with one or more enzymes, such as T4 DNA polymerase, klenow enzyme, and T4 polynucleotide kinase in an appropriate buffer. A nucleotide overhang to facilitate ligation to adapters is added, in some instances with 3′ to 5′ exo minus klenow fragment and dATP.

Adapters (such as universal adapters) may be ligated to both ends of the sample polynucleotide fragments with a ligase, such as T4 ligase, to produce a library of adapter-tagged polynucleotide strands, and the adapter-tagged polynucleotide library is amplified with primers, such as universal primers. In some instances, the adapters are Y-shaped adapters comprising one or more primer binding sites, one or more grafting regions, and one or more index (or barcode) regions. In some instances, the one or more index region is present on each strand of the adapter. In some instances, grafting regions are complementary to a flowcell surface, and facilitate next generation sequencing of sample libraries. In some instances, Y-shaped adapters comprise partially complementary sequences. In some instances, Y-shaped adapters comprise a single thymidine overhang which hybridizes to the overhanging adenine of the double stranded adapter-tagged polynucleotide strands. Y-shaped adapters may comprise modified nucleic acids, that are resistant to cleavage. For example, a phosphorothioate backbone is used to attach an overhanging thymidine to the 3′ end of the adapters. If universal primers are used, amplification of the library is performed to add barcoded primers to the adapters. A library of double stranded adapter-tagged polynucleotide strands is contacted with polynucleotide probes, to form hybrid pairs. Such pairs are separated from unhybridized fragments, and isolated from probes to produce an enriched library. The enriched library may then be sequenced.

The library of double stranded sample nucleic acid fragments is then denatured in the presence of adapter blockers. Adapter blockers minimize off-target hybridization of probes to the adapter sequences (instead of target sequences) present on the adapter-tagged polynucleotide strands, and/or prevent intermolecular hybridization of adapters (e.g., “daisy chaining”). Denaturation is carried out in some instances at 96° C., or at about 85, 87, 90, 92, 95, 97, 98 or about 99° C. A polynucleotide targeting library (probe library) is denatured in a hybridization solution, in some instances at 96° C., at about 85, 87, 90, 92, 95, 97, 98 or 99° C. The denatured adapter-tagged polynucleotide library and the hybridization solution are incubated for a suitable amount of time and at a suitable temperature to allow the probes to hybridize with their complementary target sequences. In some instances, a suitable hybridization temperature is about 45 to 80° C., or at least 45, 50, 55, 60, 65, 70, 75, 80, 85, or 90° C. In some instances, the hybridization temperature is 70° C. In some instances, a suitable hybridization time is 16 hours, or at least 4, 6, 8, 10, 12, 14, 16, 18, 20, 22, or more than 22 hours, or about 12 to 20 hours. Binding buffer is then added to the hybridized adapter-tagged-polynucleotide probes, and a solid support comprising a capture moiety is used to selectively bind the hybridized adapter-tagged polynucleotide-probes. The solid support is washed with buffer to remove unbound polynucleotides before an elution buffer is added to release the enriched, tagged polynucleotide fragments from the solid support. In some instances, the solid support is washed 2 times, or 1, 2, 3, 4, 5, or 6 times. The enriched library of adapter-tagged polynucleotide fragments is amplified and the enriched library is sequenced.

A plurality of nucleic acids (e.g. genomic sequence) may obtained from a sample, and fragmented, optionally end-repaired, and adenylated. Adapters are ligated to both ends of the polynucleotide fragments to produce a library of adapter-tagged polynucleotide strands, and the adapter-tagged polynucleotide library is amplified. The adapter-tagged polynucleotide library is then denatured at high temperature, preferably 96° C., in the presence of adapter blockers. A polynucleotide targeting library (probe library) is denatured in a hybridization solution at high temperature, preferably about 90 to 99° C., and combined with the denatured, tagged polynucleotide library in hybridization solution for about 10 to 24 hours at about 45 to 80° C. Binding buffer is then added to the hybridized tagged polynucleotide probes, and a solid support comprising a capture moiety are used to selectively bind the hybridized adapter-tagged polynucleotide-probes. The solid support is washed one or more times with buffer, preferably about 2 and 5 times to remove unbound polynucleotides before an elution buffer is added to release the enriched, adapter-tagged polynucleotide fragments from the solid support. The enriched library of adapter-tagged polynucleotide fragments is amplified and then the library is sequenced. Alternative variables such as incubation times, temperatures, reaction volumes/concentrations, number of washes, or other variables consistent with the specification are also employed in the method.

In any of the instances, the detection or quantification analysis of the oligonucleotides can be accomplished by sequencing. The subunits or entire synthesized oligonucleotides can be detected via full sequencing of all oligonucleotides by any suitable methods known in the art, e.g., Illumina sequencing by synthesis, PacBio nanopore sequencing, or BGI/MGI nanoball sequencing, including the sequencing methods described herein.

Sequencing can be accomplished through classic Sanger sequencing methods which are well known in the art. Sequencing can also be accomplished using high-throughput systems some of which allow detection of a sequenced nucleotide immediately after or upon its incorporation into a growing strand, e.g., detection of sequence in red time or substantially real time. In some cases, high throughput sequencing generates at least 1,000, at least 5,000, at least 10,000, at least 20,000, at least 30,000, at least 40,000, at least 50,000, at least 100,000 or at least 500,000 sequence reads per hour; with each read being at least 50, at least 60, at least 70, at least 80, at least 90, at least 100, at least 120 or at least 150 bases per read.

In some instances, high-throughput sequencing involves the use of technology available by Illumina's Genome Analyzer IIX, MiSeq personal sequencer, or HiSeq systems, such as those using HiSeq 2500, HiSeq 1500, HiSeq 2000, HiSeq 1000, iSeq 100, Mini Seq, MiSeq, NextSeq 550, NextSeq 2000, NextSeq 550, or NovaSeq 6000. These machines use reversible terminator-based sequencing by synthesis chemistry. These machines can generate 6000 Gb or more reads in 13-44 hours. Smaller systems may be utilized for runs within 3, 2, 1 days or less time. Short synthesis cycles may be used to minimize the time it takes to obtain sequencing results.

In some instances, high-throughput sequencing involves the use of technology available by ABI Solid System. This genetic analysis platform that enables massively parallel sequencing of clonally-amplified DNA fragments linked to beads. The sequencing methodology is based on sequential ligation with dye-labeled oligonucleotides.

The next generation sequencing can comprise ion semiconductor sequencing (e.g., using technology from Life Technologies (Ion Torrent)). Ion semiconductor sequencing can take advantage of the fact that when a nucleotide is incorporated into a strand of DNA, an ion can be released. To perform ion semiconductor sequencing, a high density array of micromachined wells can be formed. Each well can hold a single DNA template. Beneath the well can be an ion sensitive layer, and beneath the ion sensitive layer can be an ion sensor. When a nucleotide is added to a DNA, H+ can be released, which can be measured as a change in pH. The H+ ion can be converted to voltage and recorded by the semiconductor sensor. An array chip can be sequentially flooded with one nucleotide after another. No scanning, light, or cameras can be required. In some cases, an IONPROTON™ Sequencer is used to sequence nucleic acid. In some cases, an IONPGM™ Sequencer is used. The Ion Torrent Personal Genome Machine (PGM) can do 10 million reads in two hours.

In some instances, high-throughput sequencing involves the use of technology available by Helicos BioSciences Corporation (Cambridge, Mass.) such as the Single Molecule Sequencing by Synthesis (SMSS) method. SMSS is unique because it allows for sequencing the entire human genome in up to 24 hours. Finally, SMSS is powerful because, like the MW technology, it does not require a pre amplification step prior to hybridization. In fact, SMSS does not require any amplification.

In some instances, high-throughput sequencing involves the use of technology available by 454 Lifesciences, Inc. (Branford, Conn.) such as the Pico Titer Plate device which includes a fiber optic plate that transmits chemiluminescent signal generated by the sequencing reaction to be recorded by a CCD camera in the instrument. This use of fiber optics allows for the detection of a minimum of 20 million base pairs in 4.5 hours.

Methods for using bead amplification followed by fiber optics detection are described in Marguiles, M., et al. “Genome sequencing in microfabricated high-density picolitre reactors”, Nature, doi: 10.1038/nature03959.

In some instances, high-throughput sequencing is performed using Clonal Single Molecule Array (Solexa, Inc.) or sequencing-by-synthesis (SBS) utilizing reversible terminator chemistry. Constans, A., The Scientist 2003, 17(13):36. High-throughput sequencing of oligonucleotides can be achieved using any suitable sequencing method known in the art, such as those commercialized by Pacific Biosciences, Complete Genomics, Genia Technologies, Halcyon Molecular, Oxford Nanopore Technologies and the like. Overall such systems involve sequencing a target oligonucleotide molecule having a plurality of bases by the temporal addition of bases via a polymerization reaction that is measured on a molecule of oligonucleotide, i e., the activity of a nucleic acid polymerizing enzyme on the template oligonucleotide molecule to be sequenced is followed in real time. Sequence can then be deduced by identifying which base is being incorporated into the growing complementary strand of the target oligonucleotide by the catalytic activity of the nucleic acid polymerizing enzyme at each step in the sequence of base additions. A polymerase on the target oligonucleotide molecule complex is provided in a position suitable to move along the target oligonucleotide molecule and extend the oligonucleotide primer at an active site. A plurality of labeled types of nucleotide analogs are provided proximate to the active site, with each distinguishably type of nucleotide analog being complementary to a different nucleotide in the target oligonucleotide sequence. The growing oligonucleotide strand is extended by using the polymerase to add a nucleotide analog to the oligonucleotide strand at the active site, where the nucleotide analog being added is complementary to the nucleotide of the target oligonucleotide at the active site. The nucleotide analog added to the oligonucleotide primer as a result of the polymerizing step is identified. The steps of providing labeled nucleotide analogs, polymerizing the growing oligonucleotide strand, and identifying the added nucleotide analog are repeated so that the oligonucleotide strand is further extended and the sequence of the target oligonucleotide is determined.

The next generation sequencing technique can comprises real-time (SMRT™) technology by Pacific Biosciences. In SMRT, each of four DNA bases can be attached to one of four different fluorescent dyes. These dyes can be phospho linked. A single DNA polymerase can be immobilized with a single molecule of template single stranded DNA at the bottom of a zero-mode waveguide (ZMW). A ZMW can be a confinement structure which enables observation of incorporation of a single nucleotide by DNA polymerase against the background of fluorescent nucleotides that can rapidly diffuse in an out of the ZMW (in microseconds). It can take several milliseconds to incorporate a nucleotide into a growing strand. During this time, the fluorescent label can be excited and produce a fluorescent signal, and the fluorescent tag can be cleaved off. The ZMW can be illuminated from below. Attenuated light from an excitation beam can penetrate the lower 20-30 nm of each ZMW. A microscope with a detection limit of 20 zepto liters (10″ liters) can be created. The tiny detection volume can provide 1000-fold improvement in the reduction of background noise. Detection of the corresponding fluorescence of the dye can indicate which base was incorporated. The process can be repeated.

In some cases, the next generation sequencing is nanopore sequencing {See e.g., Soni G V and Meller A. (2007) Clin Chem 53: 1996-2001). A nanopore can be a small hole, of the order of about one nanometer in diameter. Immersion of a nanopore in a conducting fluid and application of a potential across it can result in a slight electrical current due to conduction of ions through the nanopore. The amount of current which flows can be sensitive to the size of the nanopore. As a DNA molecule passes through a nanopore, each nucleotide on the DNA molecule can obstruct the nanopore to a different degree. Thus, the change in the current passing through the nanopore as the DNA molecule passes through the nanopore can represent a reading of the DNA sequence. The nanopore sequencing technology can be from Oxford Nanopore Technologies; e.g., a GridION system. A single nanopore can be inserted in a polymer membrane across the top of a microwell. Each microwell can have an electrode for individual sensing. The microwells can be fabricated into an array chip, with 100,000 or more microwells (e.g., more than 200,000, 300,000, 400,000, 500,000, 600,000, 700,000, 800,000, 900,000, or 1,000,000) per chip. An instrument (or node) can be used to analyze the chip. Data can be analyzed in real-time. One or more instruments can be operated at a time. The nanopore can be a protein nanopore, e.g., the protein alpha-hemolysin, a heptameric protein pore. The nanopore can be a solid-state nanopore made, e.g., a nanometer sized hole formed in a synthetic membrane (e.g., SiNₓ, or SiO₂). The nanopore can be a hybrid pore (e.g., an integration of a protein pore into a solid-state membrane). The nanopore can be a nanopore with an integrated sensors (e.g., tunneling electrode detectors, capacitive detectors, or graphene based nano-gap or edge state detectors (see e.g., Garaj et al. (2010) Nature vol. 67, doi: 10.1038/nature09379)). A nanopore can be functionalized for analyzing a specific type of molecule (e.g., DNA, RNA, or protein). Nanopore sequencing can comprise “strand sequencing” in which intact DNA polymers can be passed through a protein nanopore with sequencing in real time as the DNA translocates the pore. An enzyme can separate strands of a double stranded DNA and feed a strand through a nanopore. The DNA can have a hairpin at one end, and the system can read both strands. In some cases, nanopore sequencing is “exonuclease sequencing” in which individual nucleotides can be cleaved from a DNA strand by a processive exonuclease, and the nucleotides can be passed through a protein nanopore. The nucleotides can transiently bind to a molecule in the pore (e.g., cyclodextran). A characteristic disruption in current can be used to identify bases.

Nanopore sequencing technology from GENIA can be used. An engineered protein pore can be embedded in a lipid bilayer membrane. “Active Control” technology can be used to enable efficient nanopore-membrane assembly and control of DNA movement through the channel. In some cases, the nanopore sequencing technology is from NABsys. Genomic DNA can be fragmented into strands of average length of about 100 kb. The 100 kb fragments can be made single stranded and subsequently hybridized with a 6-mer probe. The genomic fragments with probes can be driven through a nanopore, which can create a current-versus-time tracing. The current tracing can provide the positions of the probes on each genomic fragment. The genomic fragments can be lined up to create a probe map for the genome. The process can be done in parallel for a library of probes. A genome-length probe map for each probe can be generated. Errors can be fixed with a process termed “moving window Sequencing By Hybridization (mwSBH).” In some cases, the nanopore sequencing technology is from IBM/Roche. An electron beam can be used to make a nanopore sized opening in a microchip. An electrical field can be used to pull or thread DNA through the nanopore. A DNA transistor device in the nanopore can comprise alternating nanometer sized layers of metal and dielectric. Discrete charges in the DNA backbone can get trapped by electrical fields inside the DNA nanopore. Turning off and on gate voltages can allow the DNA sequence to be read.

The next generation sequencing can comprise DNA nanoball sequencing (as performed, e.g., by Complete Genomics; see e.g., Drmanac et al. (2010) Science 327:78-81). DNA can be isolated, fragmented, and size selected. For example, DNA can be fragmented (e.g., by sonication) to a mean length of about 500 bp. Adaptors (Adl) can be attached to the ends of the fragments. The adaptors can be used to hybridize to anchors for sequencing reactions. DNA with adaptors bound to each end can be PCR amplified. The adaptor sequences can be modified so that complementary single strand ends bind to each other forming circular DNA. The DNA can be methylated to protect it from cleavage by a type IIS restriction enzyme used in a subsequent step. An adaptor (e.g., the right adaptor) can have a restriction recognition site, and the restriction recognition site can remain non-methylated. The non-methylated restriction recognition site in the adaptor can be recognized by a restriction enzyme (e.g., AcuI), and the DNA can be cleaved by AcuI 13 bp to the right of the right adaptor to form linear double stranded DNA. A second round of right and left adaptors (Ad2) can be ligated onto either end of the linear DNA, and all DNA with both adapters bound can be PCR amplified (e.g., by PCR). Ad2 sequences can be modified to allow them to bind each other and form circular DNA. The DNA can be methylated, but a restriction enzyme recognition site can remain non-methylated on the left Adl adapter. A restriction enzyme (e.g., AcuI) can be applied, and the DNA can be cleaved 13 bp to the left of the Adl to form a linear DNA fragment. A third round of right and left adaptor (Ad3) can be ligated to the right and left flank of the linear DNA, and the resulting fragment can be PCR amplified. The adaptors can be modified so that they can bind to each other and form circular DNA. A type III restriction enzyme (e.g., EcoP15) can be added; EcoP15 can cleave the DNA 26 bp to the left of Ad3 and 26 bp to the right of Ad2. This cleavage can remove a large segment of DNA and linearize the DNA once again. A fourth round of right and left adaptors (Ad4) can be ligated to the DNA, the DNA can be amplified (e.g., by PCR), and modified so that they bind each other and form the completed circular DNA template.

Rolling circle replication (e.g., using Phi 29 DNA polymerase) can be used to amplify small fragments of DNA. The four adaptor sequences can contain palindromic sequences that can hybridize and a single strand can fold onto itself to form a DNA nanoball (DNB™) which can be approximately 200-300 nanometers in diameter on average. A DNA nanoball can be attached (e.g., by adsorption) to a microarray (sequencing flowcell). The flow cell can be a silicon wafer coated with silicon dioxide, titanium and hexamethyldisilazane (HMDS) and a photoresist material. Sequencing can be performed by unchained sequencing by ligating fluorescent probes to the DNA. The color of the fluorescence of an interrogated position can be visualized by a high resolution camera. The identity of nucleotide sequences between adaptor sequences can be determined.

A population of polynucleotides may be enriched prior to adapter ligation. In one example, a plurality of polynucleotides is obtained from a sample, fragmented, optionally end-repaired, and denatured at high temperature, preferably 90-99° C. A polynucleotide targeting library (probe library) is denatured in a hybridization solution at high temperature, preferably about 90 to 99° C., and combined with the denatured, tagged polynucleotide library in hybridization solution for about 10 to 24 hours at about 45 to 80° C. Binding buffer is then added to the hybridized tagged polynucleotide probes, and a solid support comprising a capture moiety are used to selectively bind the hybridized adapter-tagged polynucleotide-probes. The solid support is washed one or more times with buffer, preferably about 2 and 5 times to remove unbound polynucleotides before an elution buffer is added to release the enriched, adapter-tagged polynucleotide fragments from the solid support. The enriched polynucleotide fragments are then polyadenylated, adapters are ligated to both ends of the polynucleotide fragments to produce a library of adapter-tagged polynucleotide strands, and the adapter-tagged polynucleotide library is amplified. The adapter-tagged polynucleotide library is then sequenced.

A polynucleotide targeting library may also be used to filter undesired sequences from a plurality of polynucleotides, by hybridizing to undesired fragments. For example, a plurality of polynucleotides is obtained from a sample, and fragmented, optionally end-repaired, and adenylated. Adapters are ligated to both ends of the polynucleotide fragments to produce a library of adapter-tagged polynucleotide strands, and the adapter-tagged polynucleotide library is amplified. Alternatively, adenylation and adapter ligation steps are instead performed after enrichment of the sample polynucleotides. The adapter-tagged polynucleotide library is then denatured at high temperature, preferably 90-99° C., in the presence of adapter blockers. A polynucleotide filtering library (probe library) designed to remove undesired, non-target sequences is denatured in a hybridization solution at high temperature, preferably about 90 to 99° C., and combined with the denatured, tagged polynucleotide library in hybridization solution for about 10 to 24 hours at about 45 to 80° C. Binding buffer is then added to the hybridized tagged polynucleotide probes, and a solid support comprising a capture moiety are used to selectively bind the hybridized adapter-tagged polynucleotide-probes. The solid support is washed one or more times with buffer, preferably about 1 and 5 times to elute unbound adapter-tagged polynucleotide fragments. The enriched library of unbound adapter-tagged polynucleotide fragments is amplified and then the amplified library is sequenced.

### Highly Parallel De Novo Nucleic Acid Synthesis

Described herein is a platform approach utilizing miniaturization, parallelization, and vertical integration of the end-to-end process from polynucleotide synthesis to gene assembly within Nano wells on silicon to create a revolutionary synthesis platform. Devices described herein provide, with the same footprint as a 96-well plate, a silicon synthesis platform is capable of increasing throughput by a factor of 100 to 1,000 compared to traditional synthesis methods, with production of up to approximately 1,000,000 polynucleotides in a single highly-parallelized run. In some instances, a single silicon plate described herein provides for synthesis of about 6,100 non-identical polynucleotides. In some instances, each of the non-identical polynucleotides is located within a cluster. A cluster may comprise 50 to 500 non-identical polynucleotides.

Methods described herein provide for synthesis of a library of polynucleotides each encoding for a predetermined variant of at least one predetermined reference nucleic acid sequence. In some cases, the predetermined reference sequence is nucleic acid sequence encoding for a protein, and the variant library comprises sequences encoding for variation of at least a single codon such that a plurality of different variants of a single residue in the subsequent protein encoded by the synthesized nucleic acid are generated by standard translation processes. The synthesized specific alterations in the nucleic acid sequence can be introduced by incorporating nucleotide changes into overlapping or blunt ended polynucleotide primers. Alternatively, a population of polynucleotides may collectively encode for a long nucleic acid (e.g., a gene) and variants thereof. In this arrangement, the population of polynucleotides can be hybridized and subject to standard molecular biology techniques to form the long nucleic acid (e.g., a gene) and variants thereof. When the long nucleic acid (e.g., a gene) and variants thereof are expressed in cells, a variant protein library is generated. Similarly, provided here are methods for synthesis of variant libraries encoding for RNA sequences (e.g., miRNA, shRNA, and mRNA) or DNA sequences (e.g., enhancer, promoter, UTR, and terminator regions). Also provided here are downstream applications for variants selected out of the libraries synthesized using methods described here. Downstream applications include identification of variant nucleic acid or protein sequences with enhanced biologically relevant functions, e.g., biochemical affinity, enzymatic activity, changes in cellular activity, and for the treatment or prevention of a disease state.

### Substrates

Provided herein are substrates comprising a plurality of clusters, wherein each cluster comprises a plurality of loci that support the attachment and synthesis of polynucleotides. The term “locus” as used herein refers to a discrete region on a structure which provides support for polynucleotides encoding for a single predetermined sequence to extend from the surface. In some instances, a locus is on a two dimensional surface, e.g., a substantially planar surface. In some instances, a locus refers to a discrete raised or lowered site on a surface e.g., a well, micro well, channel, or post. In some instances, a surface of a locus comprises a material that is actively functionalized to attach to at least one nucleotide for polynucleotide synthesis, or preferably, a population of identical nucleotides for synthesis of a population of polynucleotides. In some instances, polynucleotide refers to a population of polynucleotides encoding for the same nucleic acid sequence. In some instances, a surface of a device is inclusive of one or a plurality of surfaces of a substrate.

Provided herein are structures that may comprise a surface that supports the synthesis of a plurality of polynucleotides having different predetermined sequences at addressable locations on a common support. In some instances, a device provides support for the synthesis of more than 2,000; 5,000; 10,000; 20,000; 30,000; 50,000; 75,000; 100,000; 200,000; 300,000; 400,000; 500,000; 600,000; 700,000; 800,000; 900,000; 1,000,000; 1,200,000; 1,400,000; 1,600,000; 1,800,000; 2,000,000; 2,500,000; 3,000,000; 3,500,000; 4,000,000; 4,500,000; 5,000,000; 10,000,000 or more non-identical polynucleotides. In some instances, the device provides support for the synthesis of more than 2,000; 5,000; 10,000; 20,000; 30,000; 50,000; 75,000; 100,000; 200,000; 300,000; 400,000; 500,000; 600,000; 700,000; 800,000; 900,000; 1,000,000; 1,200,000; 1,400,000; 1,600,000; 1,800,000; 2,000,000; 2,500,000; 3,000,000; 3,500,000; 4,000,000; 4,500,000; 5,000,000; 10,000,000 or more polynucleotides encoding for distinct sequences. In some instances, at least a portion of the polynucleotides have an identical sequence or are configured to be synthesized with an identical sequence.

Provided herein are methods and devices for manufacture and growth of polynucleotides about 5, 10, 20, 30, 40, 50, 60, 70, 80, 90, 100, 125, 150, 175, 200, 225, 250, 275, 300, 325, 350, 375, 400, 425, 450, 475, 500, 600, 700, 800, 900, 1000, 1100, 1200, 1300, 1400, 1500, 1600, 1700, 1800, 1900, or 2000 bases in length. In some instances, the length of the polynucleotide formed is about 5, 10, 20, 30, 40, 50, 60, 70, 80, 90, 100, 125, 150, 175, 200, or 225 bases in length. A polynucleotide may be at least 5, 10, 20, 30, 40, 50, 60, 70, 80, 90, or 100 bases in length. A polynucleotide may be from 10 to 225 bases in length, from 12 to 100 bases in length, from 20 to 150 bases in length, from 20 to 130 bases in length, or from 30 to 100 bases in length.

In some instances, polynucleotides are synthesized on distinct loci of a substrate, wherein each locus supports the synthesis of a population of polynucleotides. In some instances, each locus supports the synthesis of a population of polynucleotides having a different sequence than a population of polynucleotides grown on another locus. In some instances, the loci of a device are located within a plurality of clusters. In some instances, a device comprises at least 10, 500, 1000, 2000, 3000, 4000, 5000, 6000, 7000, 8000, 9000, 10000, 11000, 12000, 13000, 14000, 15000, 20000, 30000, 40000, 50000 or more clusters. In some instances, a device comprises more than 2,000; 5,000; 10,000; 100,000; 200,000; 300,000; 400,000; 500,000; 600,000; 700,000; 800,000; 900,000; 1,000,000; 1,100,000; 1,200,000; 1,300,000; 1,400,000; 1,500,000; 1,600,000; 1,700,000; 1,800,000; 1,900,000; 2,000,000; 300,000; 400,000; 500,000; 600,000; 700,000; 800,000; 900,000; 1,000,000; 1,200,000; 1,400,000; 1,600,000; 1,800,000; 2,000,000; 2,500,000; 3,000,000; 3,500,000; 4,000,000; 4,500,000; 5,000,000; or 10,000,000 or more distinct loci. In some instances, a device comprises about 10,000 distinct loci. The amount of loci within a single cluster is varied in different instances. In some instances, each cluster includes 1, 2, 3, 4, 5, 6, 7, 8, 9, 10, 20, 30, 40, 50, 60, 70, 80, 90, 100, 120, 130, 150, 200, 300, 400, 500, 1000 or more loci. In some instances, each cluster includes about 50-500 loci. In some instances, each cluster includes about 100-200 loci. In some instances, each cluster includes about 100-150 loci. In some instances, each cluster includes about 109, 121, 130 or 137 loci. In some instances, each cluster includes about 19, 20, 61, 64 or more loci.

The number of distinct polynucleotides synthesized on a device may be dependent on the number of distinct loci available in the substrate. In some instances, the density of loci within a cluster of a device is at least or about 1 locus per mm², 10 loci per mm², 25 loci per mm², 50 loci per mm², 65 loci per mm², 75 loci per mm², 100 loci per mm², 130 loci per mm², 150 loci per mm², 175 loci per mm², 200 loci per mm², 300 loci per mm², 400 loci per mm², 500 loci per mm², 1,000 loci per mm² or more. In some instances, a device comprises from about 10 loci per mm² to about 500 mm², from about 25 loci per mm² to about 400 mm², from about 50 loci per mm² to about 500 mm², from about 100 loci per mm² to about 500 mm², from about 150 loci per mm² to about 500 mm², from about 10 loci per mm² to about 250 mm², from about 50 loci per mm² to about 250 mm², from about 10 loci per mm² to about 200 mm², or from about 50 loci per mm² to about 200 mm². In some instances, the distance from the centers of two adjacent loci within a cluster is from about 10 um to about 500 um, from about 10 um to about 200 um, or from about 10 um to about 100 um. In some instances, the distance from two centers of adjacent loci is greater than about 10 um, 20 um, 30 um, 40 um, 50 um, 60 um, 70 um, 80 um, 90 um or 100 um. In some instances, the distance from the centers of two adjacent loci is less than about 200 um, 150 um, 100 um, 80 um, 70 um, 60 um, 50 um, 40 um, 30 um, 20 um or 10 um. In some instances, each locus has a width of about 0.5 um, 1 um, 2 um, 3 um, 4 um, 5 um, 6 um, 7 um, 8 um, 9 um, 10 um, 20 um, 30 um, 40 um, 50 um, 60 um, 70 um, 80 um, 90 um or 100 um. In some instances, each locus is has a width of about 0.5 um to 100 um, about 0.5 um to 50 um, about 10 um to 75 um, or about 0.5 um to 50 um.

In some instances, the density of clusters within a device is at least or about 1 cluster per 100 mm², 1 cluster per 10 mm², 1 cluster per 5 mm², 1 cluster per 4 mm², 1 cluster per 3 mm², 1 cluster per 2 mm², 1 cluster per 1 mm², 2 clusters per 1 mm², 3 clusters per 1 mm², 4 clusters per 1 mm², 5 clusters per 1 mm², 10 clusters per 1 mm², 50 clusters per 1 mm² or more. In some instances, a device comprises from about 1 cluster per 10 mm² to about 10 clusters per 1 mm². In some instances, the distance from the centers of two adjacent clusters is less than about 50 um, 100 um, 200 um, 500 um, 1000 um, or 2000 um or 5000 um. In some instances, the distance from the centers of two adjacent clusters is from about 50 um and about 100 um, from about 50 um and about 200 um, from about 50 um and about 300 um, from about 50 um and about 500 um, and from about 100 um to about 2000 um. In some instances, the distance from the centers of two adjacent clusters is from about 0.05 mm to about 50 mm, from about 0.05 mm to about 10 mm, from about 0.05 mm and about 5 mm, from about 0.05 mm and about 4 mm, from about 0.05 mm and about 3 mm, from about 0.05 mm and about 2 mm, from about 0.1 mm and 10 mm, from about 0.2 mm and 10 mm, from about 0.3 mm and about 10 mm, from about 0.4 mm and about 10 mm, from about 0.5 mm and 10 mm, from about 0.5 mm and about 5 mm, or from about 0.5 mm and about 2 mm. In some instances, each cluster has a diameter or width along one dimension of about 0.5 to 2 mm, about 0.5 to 1 mm, or about 1 to 2 mm. In some instances, each cluster has a diameter or width along one dimension of about 0.5, 0.6, 0.7, 0.8, 0.9, 1, 1.1, 1.2, 1.3, 1.4, 1.5, 1.6, 1.7, 1.8, 1.9 or 2 mm. In some instances, each cluster has an interior diameter or width along one dimension of about 0.5, 0.6, 0.7, 0.8, 0.9, 1, 1.1, 1.15, 1.2, 1.3, 1.4, 1.5, 1.6, 1.7, 1.8, 1.9 or 2 mm.

A device may be about the size of a standard 96 well plate, for example from about 100 and 200 mm by from about 50 and 150 mm. In some instances, a device has a diameter less than or equal to about 1000 mm, 500 mm, 450 mm, 400 mm, 300 mm, 250 nm, 200 mm, 150 mm, 100 mm or 50 mm. In some instances, the diameter of a device is from about 25 mm and 1000 mm, from about 25 mm and about 800 mm, from about 25 mm and about 600 mm, from about 25 mm and about 500 mm, from about 25 mm and about 400 mm, from about 25 mm and about 300 mm, or from about 25 mm and about 200. Non-limiting examples of device size include about 300 mm, 200 mm, 150 mm, 130 mm, 100 mm, 76 mm, 51 mm and 25 mm. In some instances, a device has a planar surface area of at least about 100 mm²; 200 mm²; 500 mm²; 1,000 mm²; 2,000 mm²; 5,000 mm²; 10,000 mm²; 12,000 mm²; 15,000 mm²; 20,000 mm²; 30,000 mm²; 40,000 mm²; 50,000 mm² or more. In some instances, the thickness of a device is from about 50 mm and about 2000 mm, from about 50 mm and about 1000 mm, from about 100 mm and about 1000 mm, from about 200 mm and about 1000 mm, or from about 250 mm and about 1000 mm. Non-limiting examples of device thickness include 275 mm, 375 mm, 525 mm, 625 mm, 675 mm, 725 mm, 775 mm and 925 mm. In some instances, the thickness of a device varies with diameter and depends on the composition of the substrate. For example, a device comprising materials other than silicon has a different thickness than a silicon device of the same diameter. Device thickness may be determined by the mechanical strength of the material used and the device must be thick enough to support its own weight without cracking during handling. In some instances, a structure comprises a plurality of devices described herein.

### Surface Materials

Provided herein is a device comprising a surface, wherein the surface is modified to support polynucleotide synthesis at predetermined locations and with a resulting low error rate, a low dropout rate, a high yield, and a high oligo representation. In some instances, surfaces of a device for polynucleotide synthesis provided herein are fabricated from a variety of materials capable of modification to support a de novo polynucleotide synthesis reaction. In some cases, the devices are sufficiently conductive, e.g., are able to form uniform electric fields across all or a portion of the device. A device described herein may comprise a flexible material. Exemplary flexible materials include, without limitation, modified nylon, unmodified nylon, nitrocellulose, and polypropylene. A device described herein may comprise a rigid material. Exemplary rigid materials include, without limitation, glass, fuse silica, silicon, silicon dioxide, silicon nitride, plastics (for example, polytetrafluoroethylene, polypropylene, polystyrene, polycarbonate, and blends thereof, and metals (for example, gold, platinum). Device disclosed herein may be fabricated from a material comprising silicon, polystyrene, agarose, dextran, cellulosic polymers, polyacrylamides, polydimethylsiloxane (PDMS), glass, or any combination thereof. In some cases, a device disclosed herein is manufactured with a combination of materials listed herein or any other suitable material known in the art.

A listing of tensile strengths for exemplary materials described herein is provides as follows: nylon (70 MPa), nitrocellulose (1.5 MPa), polypropylene (40 MPa), silicon (268 MPa), polystyrene (40 MPa), agarose (1-10 MPa), polyacrylamide (1-10 MPa), polydimethylsiloxane (PDMS) (3.9-10.8 MPa). Solid supports described herein can have a tensile strength from 1 to 300, 1 to 40, 1 to 10, 1 to 5, or 3 to 11 MPa. Solid supports described herein can have a tensile strength of about 1, 1.5, 2, 3, 4, 5, 6, 7, 8, 9, 10, 11, 20, 25, 40, 50, 60, 70, 80, 90, 100, 150, 200, 250, 270, or more MPa. In some instances, a device described herein comprises a solid support for polynucleotide synthesis that is in the form of a flexible material capable of being stored in a continuous loop or reel, such as a tape or flexible sheet.

Young's modulus measures the resistance of a material to clastic (recoverable) deformation under load. A listing of Young's modulus for stiffness of exemplary materials described herein is provides as follows: nylon (3 GPa), nitrocellulose (1.5 GPa), polypropylene (2 GPa), silicon (150 GPa), polystyrene (3 GPa), agarose (1-10 GPa), polyacrylamide (1-10 GPa), polydimethylsiloxane (PDMS) (1-10 GPa). Solid supports described herein can have a Young's moduli from 1 to 500, 1 to 40, 1 to 10, 1 to 5, or 3 to 11 GPa. Solid supports described herein can have a Young's moduli of about 1, 1.5, 2, 3, 4, 5, 6, 7, 8, 9, 10, 11, 20, 25, 40, 50, 60, 70, 80, 90, 100, 150, 200, 250, 400, 500 GPa, or more. As the relationship between flexibility and stiffness are inverse to each other, a flexible material has a low Young's modulus and changes its shape considerably under load.

In some cases, a device disclosed herein comprises a silicon dioxide base and a surface layer of silicon oxide. Alternatively, the device may have a base of silicon oxide. Surface of the device provided here may be textured, resulting in an increase overall surface area for polynucleotide synthesis. Device disclosed herein may comprise at least 5%, 10%, 25%, 50%, 80%, 90%, 95%, or 99% silicon. A device disclosed herein may be fabricated from a silicon on insulator (SOI) wafer.

### Surface Architecture

Provided herein are devices comprising raised and/or lowered features. One benefit of having such features is an increase in surface area to support polynucleotide synthesis. In some instances, a device having raised and/or lowered features is referred to as a three-dimensional substrate. In some instances, a three-dimensional device comprises one or more channels. In some instances, one or more loci comprise a channel. In some instances, the channels are accessible to reagent deposition via a deposition device such as a polynucleotide synthesizer. In some instances, reagents and/or fluids collect in a larger well in fluid communication one or more channels. For example, a device comprises a plurality of channels corresponding to a plurality of loci with a cluster, and the plurality of channels are in fluid communication with one well of the cluster. In some methods, a library of polynucleotides is synthesized in a plurality of loci of a cluster.

In some instances, the structure is configured to allow for controlled flow and mass transfer paths for polynucleotide synthesis on a surface. In some instances, the configuration of a device allows for the controlled and even distribution of mass transfer paths, chemical exposure times, and/or wash efficacy during polynucleotide synthesis. In some instances, the configuration of a device allows for increased sweep efficiency, for example by providing sufficient volume for a growing a polynucleotide such that the excluded volume by the growing polynucleotide does not take up more than 50, 45, 40, 35, 30, 25, 20, 15, 14, 13, 12, 11, 10, 9, 8, 7, 6, 5, 4, 3, 2, 1%, or less of the initially available volume that is available or suitable for growing the polynucleotide. In some instances, a three-dimensional structure allows for managed flow of fluid to allow for the rapid exchange of chemical exposure.

Provided herein are methods to synthesize an amount of DNA of 1 fM, 5 fM, 10 fM, 25 fM, 50 fM, 75 fM, 100 fM, 200 fM, 300 fM, 400 fM, 500 fM, 600 fM, 700 fM, 800 fM, 900 fM, 1 pM, 5 pM, 10 pM, 25 pM, 50 pM, 75 pM, 100 pM, 200 pM, 300 pM, 400 PM, 500 pM, 600 pM, 700 pM, 800 pM, 900 pM, or more. In some instances, a polynucleotide library may span the length of about 1%, 2%, 3%, 4%, 5%, 10%, 15%, 20%, 30%, 40%, 50%, 60%, 70%, 80%, 90%, 95%, or 100% of a gene. A gene may be varied up to about 1%, 2%, 3%, 4%, 5%, 10%, 15%, 20%, 30%, 40%, 50%, 60%, 70%, 80%, 85%, 90%, 95%, or 100%.

Non-identical polynucleotides may collectively encode a sequence for at least 1%, 2%, 3%, 4%, 5%, 10%, 15%, 20%, 30%, 40%, 50%, 60%, 70%, 80%, 85%, 90%, 95%, or 100% of a gene. In some instances, a polynucleotide may encode a sequence of 50%, 60%, 70%, 80%, 85%, 90%, 95%, or more of a gene. In some instances, a polynucleotide may encode a sequence of 80%, 85%, 90%, 95%, or more of a gene.

In some instances, segregation is achieved by physical structure. In some instances, segregation is achieved by differential functionalization of the surface generating active and passive regions for polynucleotide synthesis. Differential functionalization is also be achieved by alternating the hydrophobicity across the device surface, thereby creating water contact angle effects that cause beading or wetting of the deposited reagents. Employing larger structures can decrease splashing and cross-contamination of distinct polynucleotide synthesis locations with reagents of the neighboring spots. In some instances, a device, such as a polynucleotide synthesizer, is used to deposit reagents to distinct polynucleotide synthesis locations. Substrates having three-dimensional features are configured in a manner that allows for the synthesis of a large number of polynucleotides (e.g., more than about 10,000) with a low error rate (e.g., less than about 1:500, 1:1000, 1:1500, 1:2,000; 1:3,000; 1:5,000; or 1:10,000). In some instances, a device comprises features with a density of about or greater than about 1, 5, 10, 20, 30, 40, 50, 60, 70, 80, 100, 110, 120, 130, 140, 150, 160, 170, 180, 190, 200, 300, 400 or 500 features per mm².

A well of a device may have the same or different width, height, and/or volume as another well of the substrate. A channel of a device may have the same or different width, height, and/or volume as another channel of the substrate. In some instances, the width of a cluster is from about 0.05 mm to about 50 mm, from about 0.05 mm to about 10 mm, from about 0.05 mm and about 5 mm, from about 0.05 mm and about 4 mm, from about 0.05 mm and about 3 mm, from about 0.05 mm and about 2 mm, from about 0.05 mm and about 1 mm, from about 0.05 mm and about 0.5 mm, from about 0.05 mm and about 0.1 mm, from about 0.1 mm and 10 mm, from about 0.2 mm and 10 mm, from about 0.3 mm and about 10 mm, from about 0.4 mm and about 10 mm, from about 0.5 mm and 10 mm, from about 0.5 mm and about 5 mm, or from about 0.5 mm and about 2 mm. In some instances, the width of a well comprising a cluster is from about 0.05 mm to about 50 mm, from about 0.05 mm to about 10 mm, from about 0.05 mm and about 5 mm, from about 0.05 mm and about 4 mm, from about 0.05 mm and about 3 mm, from about 0.05 mm and about 2 mm, from about 0.05 mm and about 1 mm, from about 0.05 mm and about 0.5 mm, from about 0.05 mm and about 0.1 mm, from about 0.1 mm and 10 mm, from about 0.2 mm and 10 mm, from about 0.3 mm and about 10 mm, from about 0.4 mm and about 10 mm, from about 0.5 mm and 10 mm, from about 0.5 mm and about 5 mm, or from about 0.5 mm and about 2 mm. In some instances, the width of a cluster is less than or about 5 mm, 4 mm, 3 mm, 2 mm, 1 mm, 0.5 mm, 0.1 mm, 0.09 mm, 0.08 mm, 0.07 mm, 0.06 mm or 0.05 mm. In some instances, the width of a cluster is from about 1.0 and 1.3 mm. In some instances, the width of a cluster is about 1.150 mm. In some instances, the width of a well is less than or about 5 mm, 4 mm, 3 mm, 2 mm, 1 mm, 0.5 mm, 0.1 mm, 0.09 mm, 0.08 mm, 0.07 mm, 0.06 mm or 0.05 mm. In some instances, the width of a well is from about 1.0 and 1.3 mm. In some instances, the width of a well is about 1.150 mm. In some instances, the width of a cluster is about 0.08 mm. In some instances, the width of a well is about 0.08 mm. The width of a cluster may refer to clusters within a two-dimensional or three-dimensional substrate.

In some instances, the height of a well is from about 20 um to about 1000 um, from about 50 um to about 1000 um, from about 100 um to about 1000 um, from about 200 um to about 1000 um, from about 300 um to about 1000 um, from about 400 um to about 1000 um, or from about 500 um to about 1000 um. In some instances, the height of a well is less than about 1000 um, less than about 900 um, less than about 800 um, less than about 700 um, or less than about 600 um.

In some instances, a device comprises a plurality of channels corresponding to a plurality of loci within a cluster, wherein the height or depth of a channel is from about 5 um to about 500 um, from about 5 um to about 400 um, from about 5 um to about 300 um, from about 5 um to about 200 um, from about 5 um to about 100 um, from about 5 um to about 50 um, or from about 10 um to about 50 um. In some instances, the height of a channel is less than 100 um, less than 80 um, less than 60 um, less than 40 um or less than 20 um.

In some instances, the diameter of a channel, locus (e.g., in a substantially planar substrate) or both channel and locus (e.g., in a three-dimensional device wherein a locus corresponds to a channel) is from about 1 um to about 1000 um, from about 1 um to about 500 μm, from about 1 um to about 200 um, from about 1 um to about 100 um, from about 5 um to about 100 um, or from about 10 um to about 100 um, for example, about 90 um, 80 um, 70 um, 60 um, 50 um, 40 um, 30 um, 20 um or 10 um. In some instances, the diameter of a channel, locus, or both channel and locus is less than about 100 um, 90 um, 80 um, 70 um, 60 um, 50 um, 40 um, 30 um, 20 um or 10 um. In some instances, the distance from the center of two adjacent channels, loci, or channels and loci is from about 1 um to about 500 um, from about 1 um to about 200 um, from about 1 um to about 100 um, from about 5 um to about 200 um, from about 5 um to about 100 um, from about 5 um to about 50 um, or from about 5 um to about 30 um, for example, about 20 um.

### Surface Modifications

In various instances, surface modifications are employed for the chemical and/or physical alteration of a surface by an additive or subtractive process to change one or more chemical and/or physical properties of a device surface or a selected site or region of a device surface. For example, surface modifications include, without limitation, (1) changing the wetting properties of a surface, (2) functionalizing a surface, e.g., providing, modifying or substituting surface functional groups, (3) defunctionalizing a surface, e.g., removing surface functional groups, (4) otherwise altering the chemical composition of a surface, e.g., through etching, (5) increasing or decreasing surface roughness, (6) providing a coating on a surface, e.g., a coating that exhibits wetting properties that are different from the wetting properties of the surface, and/or (7) depositing particulates on a surface.

In some instances, the addition of a chemical layer on top of a surface (referred to as adhesion promoter) facilitates structured patterning of loci on a surface of a substrate. Exemplary surfaces for application of adhesion promotion include, without limitation, glass, silicon, silicon dioxide and silicon nitride. In some instances, the adhesion promoter is a chemical with a high surface energy. In some instances, a second chemical layer is deposited on a surface of a substrate. In some instances, the second chemical layer has a low surface energy. In some instances, surface energy of a chemical layer coated on a surface supports localization of droplets on the surface. Depending on the patterning arrangement selected, the proximity of loci and/or area of fluid contact at the loci are alterable.

In some instances, a device surface, or resolved loci, onto which nucleic acids or other moieties are deposited, e.g., for polynucleotide synthesis, are smooth or substantially planar (e.g., two-dimensional) or have irregularities, such as raised or lowered features (e.g., three-dimensional features). In some instances, a device surface is modified with one or more different layers of compounds. Such modification layers of interest include, without limitation, inorganic and organic layers such as metals, metal oxides, polymers, small organic molecules and the like. Non-limiting polymeric layers include peptides, proteins, nucleic acids or mimetics thereof (e.g., peptide nucleic acids and the like), polysaccharides, phospholipids, polyurethanes, polyesters, polycarbonates, polyureas, polyamides, polyethyleneamines, polyarylene sulfides, polysiloxanes, polyimides, polyacetates, and any other suitable compounds described herein or otherwise known in the art. In some instances, polymers are heteropolymeric. In some instances, polymers are homopolymeric. In some instances, polymers comprise functional moieties or are conjugated.

In some instances, resolved loci of a device are functionalized with one or more moieties that increase and/or decrease surface energy. In some instances, a moiety is chemically inert. In some instances, a moiety is configured to support a desired chemical reaction, for example, one or more processes in a polynucleotide synthesis reaction. The surface energy, or hydrophobicity, of a surface is a factor for determining the affinity of a nucleotide to attach onto the surface. In some instances, a method for device functionalization may comprise: (a) providing a device having a surface that comprises silicon dioxide; and (b) silanizing the surface using, a suitable silanizing agent described herein or otherwise known in the art, for example, an organofunctional alkoxysilane molecule.

In some instances, the organofunctional alkoxysilane molecule comprises dimethylchloro-octodecyl-silane, methyldichloro-octodecyl-silane, trichloro-octodecyl-silane, trimethyl-octodecyl-silane, triethyl-octodecyl-silane, or any combination thereof. In some instances, a device surface comprises functionalized with polyethylene/polypropylene (functionalized by gamma irradiation or chromic acid oxidation, and reduction to hydroxyalkyl surface), highly crosslinked polystyrene-divinylbenzene (derivatized by chloromethylation, and aminated to benzylamine functional surface), nylon (the terminal aminohexyl groups are directly reactive), or etched with reduced polytetrafluoroethylene. Other methods and functionalizing agents are described in U.S. Pat. No. 5,474,796, which is herein incorporated by reference in its entirety.

In some instances, a device surface is functionalized by contact with a derivatizing composition that contains a mixture of silanes, under reaction conditions effective to couple the silanes to the device surface, typically via reactive hydrophilic moieties present on the device surface. Silanization generally covers a surface through self-assembly with organofunctional alkoxysilane molecules.

A variety of siloxane functionalizing reagents can further be used as currently known in the art, e.g., for lowering or increasing surface energy. The organofunctional alkoxysilanes can be classified according to their organic functions.

Provided herein are devices that may contain patterning of agents capable of coupling to a nucleoside. In some instances, a device may be coated with an active agent. In some instances, a device may be coated with a passive agent. Exemplary active agents for inclusion in coating materials described herein includes, without limitation, N-(3-triethoxysilylpropyl)-4-hydroxybutyramide (HAPS), 11-acetoxyundecyltriethoxysilane, n-decyltricthoxysilane, (3-aminopropyl) trimethoxysilane, (3-aminopropyl)triethoxysilane, 3-glycidoxypropyltrimethoxysilane (GOPS), 3-iodo-propyltrimethoxysilane, butyl-aldehydr-trimethoxysilane, dimeric secondary aminoalkyl siloxanes, (3-aminopropyl)-diethoxy-methylsilane, (3-aminopropyl)-dimethyl-ethoxysilane, and (3-aminopropyl)-trimethoxysilane, (3-glycidoxypropyl)-dimethyl-ethoxysilane, glycidoxy-trimethoxysilane, (3-mercaptopropyl)-trimethoxysilane, 3-4 epoxycyclohexyl-ethyltrimethoxysilane, and (3-mercaptopropyl)-methyl-dimethoxysilane, allyl trichlorochlorosilane, 7-oct-1-enyl trichlorochlorosilane, or bis(3-trimethoxysilylpropyl) amine.

Exemplary passive agents for inclusion in a coating material described herein includes, without limitation, perfluorooctyltrichlorosilane; tridecafluoro-1,1,2,2-tetrahydrooctyl)trichlorosilane; 1H, 1H, 2H, 2H-fluorooctyltriethoxysilane (FOS); trichloro(1H, 1H, 2H, 2H-perfluorooctyl) silane; tert-butyl-[5-fluoro-4-(4,4,5,5-tetramethyl-1,3,2-dioxaborolan-2-yl) indol-1-yl]-dimethyl-silane; CYTOP™; Fluorinert™; perfluorooctyltrichlorosilane (PFOTCS); perfluorooctyldimethylchlorosilane (PFODCS); perfluorodecyltriethoxysilane (PFDTES); pentafluorophenyl-dimethylpropylchloro-silane (PFPTES); perfluorooctyltriethoxysilane; perfluorooctyltrimethoxysilane; octylchlorosilane; dimethylchloro-octodecyl-silane; methyldichloro-octodecyl-silane; trichloro-octodecyl-silane; trimethyl-octodecyl-silane; triethyl-octodecyl-silane; or octadecyltrichlorosilane.

In some instances, a functionalization agent comprises a hydrocarbon silane such as octadecyltrichlorosilane. In some instances, the functionalizing agent comprises 11-acetoxyundecyltriethoxysilane, n-decyltriethoxysilane, (3-aminopropyl) trimethoxysilane, (3-aminopropyl)triethoxysilane, glycidyloxypropyl/trimethoxysilane and N-(3-triethoxysilylpropyl)-4-hydroxybutyramide.

### Polynucleotide Synthesis

Methods of the current disclosure for polynucleotide synthesis may include processes involving phosphoramidite chemistry. In some instances, polynucleotide synthesis comprises coupling a base with phosphoramidite. Polynucleotide synthesis may comprise coupling a base by deposition of phosphoramidite under coupling conditions, wherein the same base is optionally deposited with phosphoramidite more than once, e.g., double coupling. Polynucleotide synthesis may comprise capping of unreacted sites. In some instances, capping is optional. Polynucleotide synthesis may also comprise oxidation or an oxidation step or oxidation steps. Polynucleotide synthesis may comprise deblocking, detritylation, and sulfurization. In some instances, polynucleotide synthesis comprises either oxidation or sulfurization. In some instances, between one or each step during a polynucleotide synthesis reaction, the device is washed, for example, using tetrazole or acetonitrile. Time frames for any one step in a phosphoramidite synthesis method may be less than about 2 minutes, 1 minute, 50 seconds, 40 seconds, 30 seconds, 20 seconds and 10 seconds.

Polynucleotide synthesis using a phosphoramidite method may comprise a subsequent addition of a phosphoramidite building block (e.g., nucleoside phosphoramidite) to a growing polynucleotide chain for the formation of a phosphite triester linkage. Phosphoramidite polynucleotide synthesis proceeds in the 3′ to 5′ direction. Phosphoramidite polynucleotide synthesis allows for the controlled addition of one nucleotide to a growing nucleic acid chain per synthesis cycle. In some instances, each synthesis cycle comprises a coupling step.

Phosphoramidite coupling involves the formation of a phosphite triester linkage between an activated nucleoside phosphoramidite and a nucleoside bound to the substrate, for example, via a linker. In some instances, the nucleoside phosphoramidite is provided to the device activated. In some instances, the nucleoside phosphoramidite is provided to the device with an activator. In some instances, nucleoside phosphoramidites are provided to the device in a 1.5, 2, 3, 4, 5, 6, 7, 8, 9, 10, 11, 12, 13, 14, 15, 16, 17, 18, 19, 20, 25, 30, 35, 40, 50, 60, 70, 80, 90, 100-fold excess or more over the substrate-bound nucleosides. In some instances, the addition of nucleoside phosphoramidite is performed in an anhydrous environment, for example, in anhydrous acetonitrile. Following addition of a nucleoside phosphoramidite, the device is optionally washed. In some instances, the coupling step is repeated one or more additional times, optionally with a wash step between nucleoside phosphoramidite additions to the substrate. In some instances, a polynucleotide synthesis method used herein comprises 1, 2, 3 or more sequential coupling steps. Prior to coupling, in many cases, the nucleoside bound to the device is de-protected by removal of a protecting group, where the protecting group functions to prevent polymerization. A common protecting group is 4,4′-dimethoxytrityl (DMT).

Following coupling, phosphoramidite polynucleotide synthesis methods optionally comprise a capping step. In a capping step, the growing polynucleotide is treated with a capping agent. A capping step is useful to block unreacted substrate-bound 5′-OH groups after coupling from further chain elongation, preventing the formation of polynucleotides with internal base deletions. Further, phosphoramidites activated with 1H-tetrazole may react, to a small extent, with the O6 position of guanosine. Without being bound by theory, upon oxidation with I₂/water, this side product, possibly via O6-N7 migration, may undergo depurination. The apurinic sites may end up being cleaved in the course of the final deprotection of the polynucleotide thus reducing the yield of the full-length product. The O6 modifications may be removed by treatment with the capping reagent prior to oxidation with I₂/water. In some instances, inclusion of a capping step during polynucleotide synthesis decreases the error rate as compared to synthesis without capping. As an example, the capping step comprises treating the substrate-bound polynucleotide with a mixture of acetic anhydride and 1-methylimidazole. Following a capping step, the device is optionally washed.

In some instances, following addition of a nucleoside phosphoramidite, and optionally after capping and one or more wash steps, the device bound growing nucleic acid is oxidized. The oxidation step comprises the phosphite triester is oxidized into a tetracoordinated phosphate triester, a protected precursor of the naturally occurring phosphate diester internucleoside linkage. In some instances, oxidation of the growing polynucleotide is achieved by treatment with iodine and water, optionally in the presence of a weak base (e.g., pyridine, lutidine, collidine). Oxidation may be carried out under anhydrous conditions using, e.g. tert-Butyl hydroperoxide or (1S)-(+)-(10-camphorsulfonyl)-oxaziridine (CSO). In some methods, a capping step is performed following oxidation. A second capping step allows for device drying, as residual water from oxidation that may persist can inhibit subsequent coupling. Following oxidation, the device and growing polynucleotide is optionally washed. In some instances, the step of oxidation is substituted with a sulfurization step to obtain polynucleotide phosphorothioates, wherein any capping steps can be performed after the sulfurization. Many reagents are capable of the efficient sulfur transfer, including but not limited to 3-(Dimethylaminomethylidene)amino)-3H-1,2,4-dithiazole-3-thione, DDTT, 3H-1,2-benzodithiol-3-one 1,1-dioxide, also known as Beaucage reagent, and N,N,N′N′-Tetraethylthiuram disulfide (TETD).

In order for a subsequent cycle of nucleoside incorporation to occur through coupling, the protected 5′ end of the device bound growing polynucleotide is removed so that the primary hydroxyl group is reactive with a next nucleoside phosphoramidite. In some instances, the protecting group is DMT and deblocking occurs with trichloroacetic acid in dichloromethane. Conducting detritylation for an extended time or with stronger than recommended solutions of acids may lead to increased depurination of solid support-bound polynucleotide and thus reduces the yield of the desired full-length product. Methods and compositions of the disclosure described herein provide for controlled deblocking conditions limiting undesired depurination reactions. In some instances, the device bound polynucleotide is washed after deblocking. In some instances, efficient washing after deblocking contributes to synthesized polynucleotides having a low error rate.

Methods for the synthesis of polynucleotides typically involve an iterating sequence of the following steps: application of a protected monomer to an actively functionalized surface (e.g., locus) to link with either the activated surface, a linker or with a previously deprotected monomer; deprotection of the applied monomer so that it is reactive with a subsequently applied protected monomer; and application of another protected monomer for linking. One or more intermediate steps include oxidation or sulfurization. In some instances, one or more wash steps precede or follow one or all of the steps.

Methods for phosphoramidite-based polynucleotide synthesis comprise a series of chemical steps. In some instances, one or more steps of a synthesis method involve reagent cycling, where one or more steps of the method comprise application to the device of a reagent useful for the step. For example, reagents are cycled by a series of liquid deposition and vacuum drying steps. For substrates comprising three-dimensional features such as wells, microwells, channels and the like, reagents are optionally passed through one or more regions of the device via the wells and/or channels.

Methods and systems described herein relate to polynucleotide synthesis devices for the synthesis of polynucleotides. The synthesis may be in parallel. For example at least or about at least 2, 3, 4, 5, 6, 7, 8, 9, 10, 11, 12, 13, 14, 15, 16, 17, 18, 19, 20, 21, 22, 23, 24, 25, 30, 35, 40, 45, 50, 100, 150, 200, 250, 300, 350, 400, 450, 500, 550, 600, 650, 700, 750, 800, 850, 900, 1000, 10000, 50000, 75000, 100000 or more polynucleotides can be synthesized in parallel. The total number polynucleotides that may be synthesized in parallel may be from 2-100000, 3-50000, 4-10000, 5-1000, 6-900, 7-850, 8-800, 9-750, 10-700, 11-650, 12-600, 13-550, 14-500, 15-450, 16-400, 17-350, 18-300, 19-250, 20-200, 21-150, 22-100, 23-50, 24-45, 25-40, 30-35. Those of skill in the art appreciate that the total number of polynucleotides synthesized in parallel may fall within any range bound by any of these values, for example 25-100. The total number of polynucleotides synthesized in parallel may fall within any range defined by any of the values serving as endpoints of the range. Total molar mass of polynucleotides synthesized within the device or the molar mass of each of the polynucleotides may be at least or at least about 10, 20, 30, 40, 50, 100, 250, 500, 750, 1000, 2000, 3000, 4000, 5000, 6000, 7000, 8000, 9000, 10000, 25000, 50000, 75000, 100000 picomoles, or more. The length of each of the polynucleotides or average length of the polynucleotides within the device may be at least or about at least 10, 15, 20, 25, 30, 35, 40, 45, 50, 100, 150, 200, 300, 400, 500 nucleotides, or more. The length of each of the polynucleotides or average length of the polynucleotides within the device may be at most or about at most 500, 400, 300, 200, 150, 100, 50, 45, 35, 30, 25, 20, 19, 18, 17, 16, 15, 14, 13, 12, 11, 10 nucleotides, or less. The length of each of the polynucleotides or average length of the polynucleotides within the device may fall from 10-500, 9-400, 11-300, 12-200, 13-150, 14-100, 15-50, 16-45, 17-40, 18-35, 19-25. Those of skill in the art appreciate that the length of each of the polynucleotides or average length of the polynucleotides within the device may fall within any range bound by any of these values, for example 100-300. The length of each of the polynucleotides or average length of the polynucleotides within the device may fall within any range defined by any of the values serving as endpoints of the range.

Methods for polynucleotide synthesis on a surface provided herein allow for synthesis at a fast rate. As an example, at least 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 70, 80, 90, 100, 125, 150, 175, 200 nucleotides per hour, or more are synthesized. Nucleotides include adenine, guanine, thymine, cytosine, uridine building blocks, or analogs/modified versions thereof. In some instances, libraries of polynucleotides are synthesized in parallel on substrate. For example, a device comprising about or at least about 100; 1,000; 10,000; 30,000; 75,000; 100,000; 1,000,000; 2,000,000; 3,000,000; 4,000,000; or 5,000,000 resolved loci is able to support the synthesis of at least the same number of distinct polynucleotides, wherein polynucleotide encoding a distinct sequence is synthesized on a resolved locus. In some instances, a library of polynucleotides are synthesized on a device with low error rates described herein in less than about three months, two months, one month, three weeks, 15, 14, 13, 12, 11, 10, 9, 8, 7, 6, 5, 4, 3, 2 days, 24 hours or less. In some instances, larger nucleic acids assembled from a polynucleotide library synthesized with low error rate using the substrates and methods described herein are prepared in less than about three months, two months, one month, three weeks, 15, 14, 13, 12, 11, 10, 9, 8, 7, 6, 5, 4, 3, 2 days, 24 hours or less.

In some instances, methods described herein provide for generation of a library of polynucleotides comprising variant polynucleotides differing at a plurality of codon sites. In some instances, a polynucleotide may have 1 site, 2 sites, 3 sites, 4 sites, 5 sites, 6 sites, 7 sites, 8 sites, 9 sites, 10 sites, 11 sites, 12 sites, 13 sites, 14 sites, 15 sites, 16 sites, 17 sites 18 sites, 19 sites, 20 sites, 30 sites, 40 sites, 50 sites, or more of variant codon sites.

In some instances, the one or more sites of variant codon sites may be adjacent. In some instances, the one or more sites of variant codon sites may not be adjacent and separated by 1, 2, 3, 4, 5, 6, 7, 8, 9, 10, or more codons.

In some instances, a polynucleotide may comprise multiple sites of variant codon sites, wherein all the variant codon sites are adjacent to one another, forming a stretch of variant codon sites. In some instances, a polynucleotide may comprise multiple sites of variant codon sites, wherein none the variant codon sites are adjacent to one another. In some instances, a polynucleotide may comprise multiple sites of variant codon sites, wherein some the variant codon sites are adjacent to one another, forming a stretch of variant codon sites, and some of the variant codon sites are not adjacent to one another.

### Large Polynucleotide Libraries Having Low Error Rates

Average error rates for polynucleotides synthesized within a library using the systems and methods provided may be less than 1 in 1000, less than 1 in 1250, less than 1 in 1500, less than 1 in 2000, less than 1 in 3000 or less often. In some instances, average error rates for polynucleotides synthesized within a library using the systems and methods provided are less than 1/500, 1/600, 1/700, 1/800, 1/900, 1/1000, 1/1100, 1/1200, 1/1250, 1/1300, 1/1400, 1/1500, 1/1600, 1/1700, 1/1800, 1/1900, 1/2000, 1/3000, or less. In some instances, average error rates for polynucleotides synthesized within a library using the systems and methods provided are less than 1/1000.

In some instances, aggregate error rates for polynucleotides synthesized within a library using the systems and methods provided are less than 1/500, 1/600, 1/700, 1/800, 1/900, 1/1000, 1/1100, 1/1200, 1/1250, 1/1300, 1/1400, 1/1500, 1/1600, 1/1700, 1/1800, 1/1900, 1/2000, 1/3000, or less compared to the predetermined sequences. In some instances, aggregate error rates for polynucleotides synthesized within a library using the systems and methods provided are less than 1/500, 1/600, 1/700, 1/800, 1/900, or 1/1000. In some instances, aggregate error rates for polynucleotides synthesized within a library using the systems and methods provided are less than 1/1000.

In some instances, an error correction enzyme may be used for polynucleotides synthesized within a library using the systems and methods provided can use. In some instances, aggregate error rates for polynucleotides with error correction can be less than 1/500, 1/600, 1/700, 1/800, 1/900, 1/1000, 1/1100, 1/1200, 1/1300, 1/1400, 1/1500, 1/1600, 1/1700, 1/1800, 1/1900, 1/2000, 1/3000, or less compared to the predetermined sequences. In some instances, aggregate error rates with error correction for polynucleotides synthesized within a library using the systems and methods provided can be less than 1/500, 1/600, 1/700, 1/800, 1/900, or 1/1000. In some instances, aggregate error rates with error correction for polynucleotides synthesized within a library using the systems and methods provided can be less than 1/1000.

Error rate may limit the value of gene synthesis for the production of libraries of gene variants. With an error rate of 1/300, about 0.7% of the clones in a 1500 base pair gene will be correct. As most of the errors from polynucleotide synthesis result in frame-shift mutations, over 99% of the clones in such a library will not produce a full-length protein. Reducing the error rate by 75% would increase the fraction of clones that are correct by a factor of 40. The methods and compositions of the disclosure allow for fast de novo synthesis of large polynucleotide and gene libraries with error rates that are lower than commonly observed gene synthesis methods both due to the improved quality of synthesis and the applicability of error correction methods that are enabled in a massively parallel and time-efficient manner. Accordingly, libraries may be synthesized with base insertion, deletion, substitution, or total error rates that are under 1/300, 1/400, 1/500, 1/600, 1/700, 1/800, 1/900, 1/1000, 1/1250, 1/1500, 1/2000, 1/2500, 1/3000, 1/4000, 1/5000, 1/6000, 1/7000, 1/8000, 1/9000, 1/10000, 1/12000, 1/15000, 1/20000, 1/25000, 1/30000, 1/40000, 1/50000, 1/60000, 1/70000, 1/80000, 1/90000, 1/100000, 1/125000, 1/150000, 1/200000, 1/300000, 1/400000, 1/500000, 1/600000, 1/700000, 1/800000, 1/900000, 1/1000000, or less, across the library, or across more than 80%, 85%, 90%, 93%, 95%, 96%, 97%, 98%, 99%, 99.5%, 99.8%, 99.9%, 99.95%, 99.98%, 99.99%, or more of the library. The methods and compositions of the disclosure further relate to large synthetic polynucleotide and gene libraries with low error rates associated with at least 30%, 40%, 50%, 60%, 70%, 75%, 80%, 85%, 90%, 93%, 95%, 96%, 97%, 98%, 99%, 99.5%, 99.8%, 99.9%, 99.95%, 99.98%, 99.99%, or more of the polynucleotides or genes in at least a subset of the library to relate to error free sequences in comparison to a predetermined/preselected sequence. In some instances, at least 30%, 40%, 50%, 60%, 70%, 75%, 80%, 85%, 90%, 93%, 95%, 96%, 97%, 98%, 99%, 99.5%, 99.8%, 99.9%, 99.95%, 99.98%, 99.99%, or more of the polynucleotides or genes in an isolated volume within the library have the same sequence. In some instances, at least 30%, 40%, 50%, 60%, 70%, 75%, 80%, 85%, 90%, 93%, 95%, 96%, 97%, 98%, 99%, 99.5%, 99.8%, 99.9%, 99.95%, 99.98%, 99.99%, or more of any polynucleotides or genes related with more than 95%, 96%, 97%, 98%, 99%, 99.5%, 99.6%, 99.7%, 99.8%, 99.9% or more similarity or identity have the same sequence. In some instances, the error rate related to a specified locus on a polynucleotide or gene is optimized. Thus, a given locus or a plurality of selected loci of one or more polynucleotides or genes as part of a large library may each have an error rate that is less than 1/300, 1/400, 1/500, 1/600, 1/700, 1/800, 1/900, 1/1000, 1/1250, 1/1500, 1/2000, 1/2500, 1/3000, 1/4000, 1/5000, 1/6000, 1/7000, 1/8000, 1/9000, 1/10000, 1/12000, 1/15000, 1/20000, 1/25000, 1/30000, 1/40000, 1/50000, 1/60000, 1/70000, 1/80000, 1/90000, 1/100000, 1/125000, 1/150000, 1/200000, 1/300000, 1/400000, 1/500000, 1/600000, 1/700000, 1/800000, 1/900000, 1/1000000, or less. In various instances, such error optimized loci may comprise at least 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 200, 300, 400, 500, 600, 700, 800, 900, 1000, 1500, 2000, 2500, 3000, 4000, 5000, 6000, 7000, 8000, 9000, 10000, 30000, 50000, 75000, 100000, 500000, 1000000, 2000000, 3000000 or more loci. The error optimized loci may be distributed to at least 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 200, 300, 400, 500, 600, 700, 800, 900, 1000, 1500, 2000, 2500, 3000, 4000, 5000, 6000, 7000, 8000, 9000, 10000, 30000, 75000, 100000, 500000, 1000000, 2000000, 3000000 or more polynucleotides or genes.

The error rates can be achieved with or without error correction. The error rates can be achieved across the library, or across more than 80%, 85%, 90%, 93%, 95%, 96%, 97%, 98%, 99%, 99.5%, 99.8%, 99.9%, 99.95%, 99.98%, 99.99%, or more of the library.

### Computer Systems

Any of the systems described herein, may be operably linked to a computer and may be automated through a computer either locally or remotely. In various instances, the methods and systems of the disclosure may further comprise software programs on computer systems and use thereof. Accordingly, computerized control for the synchronization of the dispense/vacuum/refill functions such as orchestrating and synchronizing the material deposition device movement, dispense action and vacuum actuation are within the bounds of the disclosure. The computer systems may be programmed to interface between the user specified base sequence and the position of a material deposition device to deliver the correct reagents to specified regions of the substrate.

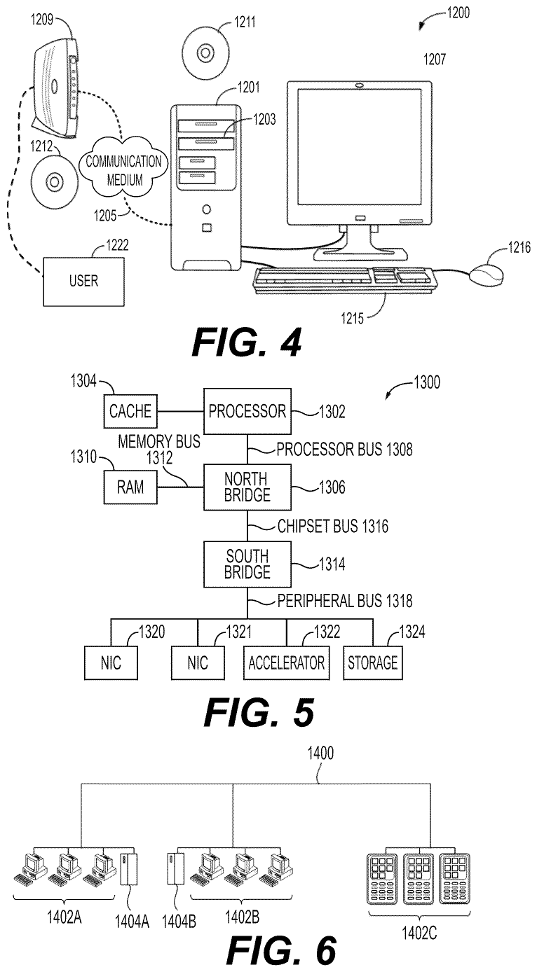

The computer system 1200 illustrated in FIG. 4 may be understood as a logical apparatus that can read instructions from media 1211 and/or a network port 1205, which can optionally be connected to server 1209 having fixed media 1212. The system, such as shown in FIG. 4 can include a CPU 1201, disk drives 1203, optional input devices such as keyboard 1215 and/or mouse 1216 and optional monitor 1207. Data communication can be achieved through the indicated communication medium to a server at a local or a remote location. The communication medium can include any means of transmitting and/or receiving data. For example, the communication medium can be a network connection, a wireless connection or an internet connection. Such a connection can provide for communication over the World Wide Web. It is envisioned that data relating to the present disclosure can be transmitted over such networks or connections for reception and/or review by a party 1222 as illustrated in FIG. 4.

FIG. 5 is a block diagram illustrating a first example architecture of a computer system 1300 that can be used in connection with example instances of the present disclosure. As depicted in FIG. 5, the example computer system can include a processor 1302 for processing instructions. Non-limiting examples of processors include: Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some instances, multiple processors or processors with multiple cores can also be used, whether in a single computer system, in a cluster, or distributed across systems over a network comprising a plurality of computers, cell phones, and/or personal data assistant devices.

As illustrated in FIG. 5, a high speed cache 1304 can be connected to, or incorporated in, the processor 1302 to provide a high speed memory for instructions or data that have been recently, or are frequently, used by processor 1302. The processor 1302 is connected to a north bridge 1306 by a processor bus 1308. The north bridge 1306 is connected to random access memory (RAM) 1310 by a memory bus 1312 and manages access to the RAM 1310 by the processor 1302. The north bridge 1306 is also connected to a south bridge 1314 by a chipset bus 1316. The south bridge 1314 is, in turn, connected to a peripheral bus 1318. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 1318. In some alternative architectures, the functionality of the north bridge can be incorporated into the processor instead of using a separate north bridge chip. In some instances, system 1300 can include an accelerator card 1322 attached to the peripheral bus 1318. The accelerator can include field programmable gate arrays (FPGAs) or other hardware for accelerating certain processing. For example, an accelerator can be used for adaptive data restructuring or to evaluate algebraic expressions used in extended set processing.

Software and data are stored in external storage 1324 and can be loaded into RAM 1310 and/or cache 1304 for use by the processor. The system 1300 includes an operating system for managing system resources; non-limiting examples of operating systems include: Linux, Windows™, MACOS™, BlackBerry OS™, iOS™, and other functionally-equivalent operating systems, as well as application software running on top of the operating system for managing data storage and optimization in accordance with example instances of the present disclosure. In this example, system 1300 also includes network interface cards (NICs) 1320 and 1321 connected to the peripheral bus for providing network interfaces to external storage, such as Network Attached Storage (NAS) and other computer systems that can be used for distributed parallel processing.

FIG. 6 is a diagram showing a network 1400 with a plurality of computer systems 1402a, and 1402b, a plurality of cell phones and personal data assistants 1402c, and Network Attached Storage (NAS) 1404a, and 1404b. In example instances, systems 1402a, 1402b, and 1402c can manage data storage and optimize data access for data stored in Network Attached Storage (NAS) 1404a and 1404b. A mathematical model can be used for the data and be evaluated using distributed parallel processing across computer systems 1402a, and 1402b, and cell phone and personal data assistant systems 1402c. Computer systems 1402a, and 1402b, and cell phone and personal data assistant systems 1402c can also provide parallel processing for adaptive data restructuring of the data stored in Network Attached Storage (NAS) 1404a and 1404b. FIG. 6 illustrates an example only, and a wide variety of other computer architectures and systems can be used in conjunction with the various instances of the present disclosure. For example, a blade server can be used to provide parallel processing. Processor blades can be connected through a back plane to provide parallel processing. Storage can also be connected to the back plane or as Network Attached Storage (NAS) through a separate network interface. In some example instances, processors can maintain separate memory spaces and transmit data through network interfaces, back plane or other connectors for parallel processing by other processors. In other instances, some or all of the processors can use a shared virtual address memory space.

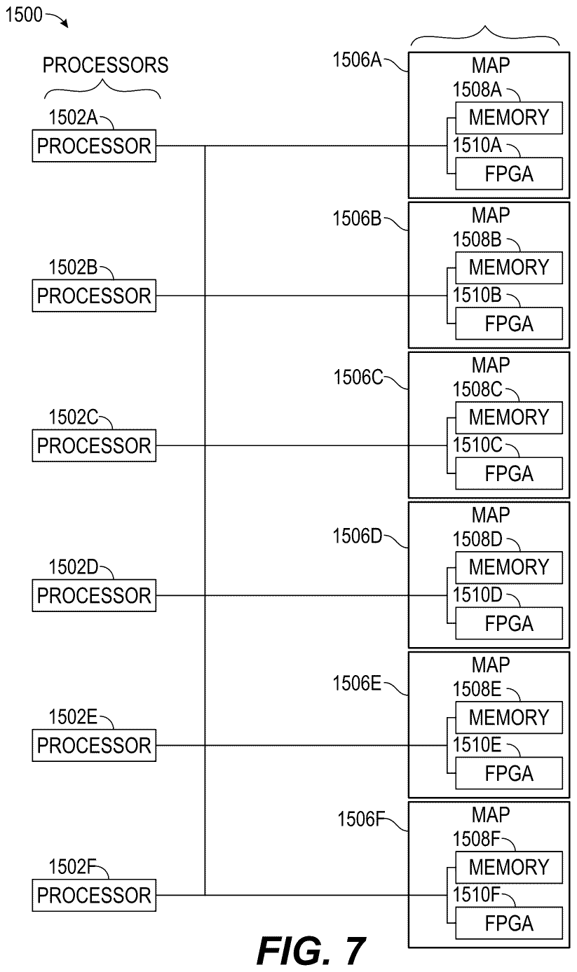

FIG. 7 is a block diagram of a multiprocessor computer system 1500 using a shared virtual address memory space in accordance with an example instance. The system includes a plurality of processors 1502a-f that can access a shared memory subsystem 1504. The system incorporates a plurality of programmable hardware memory algorithm processors (MAPs) 1506a-f in the memory subsystem 1504. Each MAP 1506a-f can comprise a memory 1508a-f and one or more field programmable gate arrays (FPGAs) 1510a-f. The MAP provides a configurable functional unit and particular algorithms or portions of algorithms can be provided to the FPGAs 1510a-f for processing in close coordination with a respective processor. For example, the MAPs can be used to evaluate algebraic expressions regarding the data model and to perform adaptive data restructuring in example instances. In this example, each MAP is globally accessible by all of the processors for these purposes. In one configuration, each MAP can use Direct Memory Access (DMA) to access an associated memory 1508a-f, allowing it to execute tasks independently of, and asynchronously from the respective microprocessor 1502a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example instances, including systems using any combination of general processors, co-processors, FPGAs and other programmable logic devices, system on chips (SOCs), application specific integrated circuits (ASICs), and other processing and logic elements. In some instances, all or part of the computer system can be implemented in software or hardware. Any variety of data storage media can be used in connection with example instances, including random access memory, hard drives, flash memory, tape drives, disk arrays, Network Attached Storage (NAS) and other local or distributed data storage devices and systems.

In example instances, the computer system can be implemented using software modules executing on any of the above or other computer architectures and systems. In other instances, the functions of the system can be implemented partially or completely in firmware, programmable logic devices such as field programmable gate arrays (FPGAs) as referenced in FIG. 7, system on chips (SOCs), application specific integrated circuits (ASICs), or other processing and logic elements. For example, the Set Processor and Optimizer can be implemented with hardware acceleration through the use of a hardware accelerator card, such as accelerator card 1322 illustrated in FIG. 5.

### EXAMPLES

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### Example 1: Functionalization of a Substrate Surface

A substrate was functionalized to support the attachment and synthesis of a library of polynucleotides. The substrate surface was first wet cleaned using a piranha solution comprising 90% H₂SO₄ and 10% H₂O₂ for 20 minutes. The substrate was rinsed in several beakers with DI water, held under a DI water gooseneck faucet for 5 minutes, and dried with N₂. The substrate was subsequently soaked in NH₄OH (1:100; 3 mL: 300 mL) for 5 minutes, rinsed with DI water using a handgun, soaked in three successive beakers with DI water for 1 minute each, and then rinsed again with DI water using the handgun. The substrate was then plasma cleaned by exposing the substrate surface to O₂. A SAMCO PC-300 instrument was used to plasma etch O₂ at 250 watts for 1 minute in downstream mode.

The cleaned substrate surface was actively functionalized with a solution comprising N-(3-triethoxysilylpropyl)-4-hydroxybutyramide using a YES-1224P vapor deposition oven system with the following parameters: 0.5 to 1 torr, 60 minutes, 70° C., 135° C. vaporizer. The substrate surface was resist coated using a Brewer Science 200× spin coater. SPR™ 3612 photoresist was spin coated on the substrate at 2500 rpm for 40 seconds. The substrate was pre-baked for 30 minutes at 90° C. on a Brewer hot plate. The substrate was subjected to photolithography using a Karl Suss MA6 mask aligner instrument. The substrate was exposed for 2.2 seconds and developed for 1 minute in MSF 26A. Remaining developer was rinsed with the handgun and the substrate soaked in water for 5 minutes. The substrate was baked for 30 minutes at 100° C. in the oven, followed by visual inspection for lithography defects using a Nikon L200. A descum process was used to remove residual resist using the SAMCO PC-300 instrument to O₂ plasma etch at 250 watts for 1 minute.

The substrate surface was passively functionalized with a 100 μL solution of perfluorooctyltrichlorosilane mixed with 10 μL light mineral oil. The substrate was placed in a chamber, pumped for 10 minutes, and then the valve was closed to the pump and left to stand for 10 minutes. The chamber was vented to air. The substrate was resist stripped by performing two soaks for 5 minutes in 500 mL NMP at 70° C. with ultrasonication at maximum power (9 on Crest system). The substrate was then soaked for 5 minutes in 500 mL isopropanol at room temperature with ultrasonication at maximum power. The substrate was dipped in 300 mL of 200 proof ethanol and blown dry with N₂. The functionalized surface was activated to serve as a support for polynucleotide synthesis.

### Example 2: Synthesis of a 50-mer Sequence on a Polynucleotide Synthesis Device

A two dimensional polynucleotide synthesis device was assembled into a flowcell, which was connected to a flowcell (Applied Biosystems (ABI394 DNA Synthesizer”). The polynucleotide synthesis device was uniformly functionalized with N-(3-TRIETHOXYSILYLPROPYL)-4-HYDROXYBUTYRAMIDE (Gelest) was used to synthesize an exemplary polynucleotide of 50 bp (“50-mer polynucleotide”) using polynucleotide synthesis methods described herein.

The sequence of the 50-mer was as described in SEQ ID NO.: 1. 5′AGACAATCAACCATTTGGGGTGGACAGCCTTGACCTCTAGACTTCGGCAT##TTTTT TTTTT3′ (SEQ ID NO.: 1), where # denotes Thymidine-succinyl hexamide CED phosphoramidite (CLP-2244 from ChemGenes), which is a cleavable linker enabling the release of polynucleotides from the surface during deprotection.

The synthesis was done using standard DNA synthesis chemistry (coupling, capping, oxidation, and deblocking) and an ABI synthesizer.

The phosphoramidite/activator combination was delivered similar to the delivery of bulk reagents through the flowcell. No drying steps were performed as the environment stays “wet” with reagent the entire time.

The flow restrictor was removed from the ABI 394 synthesizer to enable faster flow. Without flow restrictor, flow rates for amidites (0.1M in ACN), Activator, (0.25M Benzoylthiotetrazole (“BTT”; 30-3070-xx from GlenResearch) in ACN), and Ox (0.02M I₂ in 20% pyridine, 10% water, and 70% THF) were roughly ˜100 uL/second, for acetonitrile (“ACN”) and capping reagents (1:1 mix of CapA and CapB, wherein CapA is acetic anhydride in THF/Pyridine and CapB is 16% 1-methylimidizole in THF), roughly ˜200 uL/second, and for Deblock (3% dichloroacetic acid in toluene), roughly ˜300 uL/second (compared to ˜50 uL/second for all reagents with flow restrictor). The time to completely push out Oxidizer was observed, the timing for chemical flow times was adjusted accordingly and an extra ACN wash was introduced between different chemicals. After polynucleotide synthesis, the chip was deprotected in gaseous ammonia overnight at 75 psi. Five drops of water were applied to the surface to recover polynucleotides. The recovered polynucleotides were then analyzed on a BioAnalyzer small RNA chip (data not shown).

### Example 3: Synthesis of a 100-mer Sequence on a Polynucleotide Synthesis Device

The same process as described in Example 2 for the synthesis of the 50-mer sequence was used for the synthesis of a 100-mer polynucleotide (“100-mer polynucleotide”; 5′ CGGGATCCTTATCGTCATCGTCGTACAGATCCCGACCCATTTGCTGTCCACCAGTCA TGCTAGCCATACCATGATGATGATGATGATGAGAACCCCGCAT##TTTTTTTTTT3′, where # denotes Thymidine-succinyl hexamide CED phosphoramidite (CLP-2244 from ChemGenes); SEQ ID NO.: 2) on two different silicon chips, the first one uniformly functionalized with N-(3-TRIETHOXYSILYLPROPYL)-4-HYDROXYBUTYRAMIDE and the second one functionalized with 5/95 mix of 11-acetoxyundecyltriethoxysilane and n-decyltriethoxysilane, and the polynucleotides extracted from the surface were analyzed on a BioAnalyzer instrument (data not shown).

All ten samples from the two chips were further PCR amplified using a forward (5′ATGCGGGGTTCTCATCATC3′; SEQ ID NO.: 3) and a reverse (5′CGGGATCCTTATCGTCATCG3′; SEQ ID NO.: 4) primer in a 50 uL PCR mix (25 uL NEB Q5 master mix, 2.5 uL 10 uM Forward primer, 2.5 uL 10 uM Reverse primer, 1 uL polynucleotide extracted from the surface, and water up to 50 uL) using the following thermal cycling program:
98 C, 30 seconds
98 C, 10 seconds; 63 C, 10 seconds; 72 C, 10 seconds; repeat 12 cycles
72 C, 2 minutes

The PCR products were also run on a BioAnalyzer (data not shown), demonstrating sharp peaks at the 100-mer position. Next, the PCR amplified samples were cloned, and Sanger sequenced. Table 2 summarizes the results from the Sanger sequencing for samples taken from spots 1-5 from chip 1 and for samples taken from spots 6-10 from chip 2.

TABLE 2

| | | |
|---|---|---|
| Spot | Error rate | Cycle efficiency |

| | | | |
|---|---|---|---|
| 1 | 1/763 | bp | 99.87% |
| 2 | 1/824 | bp | 99.88% |
| 3 | 1/780 | bp | 99.87% |
| 4 | 1/429 | bp | 99.77% |
| 5 | 1/1525 | bp | 99.93% |
| 6 | 1/1615 | bp | 99.94% |
| 7 | 1/531 | bp | 99.81% |
| 8 | 1/1769 | bp | 99.94% |
| 9 | 1/854 | bp | 99.88% |
| 10 | 1/1451 | bp | 99.93% |

Thus, the high quality and uniformity of the synthesized polynucleotides were repeated on two chips with different surface chemistries. Overall, 89%, corresponding to 233 out of 262 of the 100-mers that were sequenced were perfect sequences with no errors.

Finally, Table 3 summarizes error characteristics for the sequences obtained from the polynucleotides samples from spots 1-10.

TABLE 3

| Sample | | | | | | | | | | |
|---|---|---|---|---|---|---|---|---|---|---|
| ID/Spot | OSA_0 | OSA_0 | OSA_0 | OSA_0 | OSA_0 | OSA_0 | OSA_0 | OSA_0 | OSA_0 | OSA_0 |
| no. | 046/1 | 047/2 | 048/3 | 049/4 | 050/5 | 051/6 | 052/7 | 053/8 | 054/9 | 055/10 |
| Total | 32 | 32 | 32 | 32 | 32 | 32 | 32 | 32 | 32 | 32 |
| Sequences | | | | | | | | | | |
| Sequencing | 25 of 28 | 27 of 27 | 26 of 30 | 21 of 23 | 25 of 26 | 29 of 30 | 27 of 31 | 29 of 31 | 28 of 29 | 25 of 28 |
| Quality | | | | | | | | | | |
| Oligo | 23 of 25 | 25 of 27 | 22 of 26 | 18 of 21 | 24 of 25 | 25 of 29 | 22 of 27 | 28 of 29 | 26 of 28 | 20 of 25 |
| Quality | | | | | | | | | | |
| ROI | 2500 | 2698 | 2561 | 2122 | 2499 | 2666 | 2625 | 2899 | 2798 | 2348 |
| Match | | | | | | | | | | |
| Count | | | | | | | | | | |
| ROI | 2 | 2 | 1 | 3 | 1 | 0 | 2 | 1 | 2 | 1 |
| Mutation | | | | | | | | | | |
| ROI Multi | 0 | 0 | 0 | 0 | 0 | 0 | 0 | 0 | 0 | 0 |
| Base | | | | | | | | | | |
| Deletion | | | | | | | | | | |
| ROI | 1 | 0 | 0 | 0 | 0 | 0 | 0 | 0 | 0 | 0 |
| Small | | | | | | | | | | |
| Insertion | | | | | | | | | | |
| ROI | 0 | 0 | 0 | 0 | 0 | 0 | 0 | 0 | 0 | 0 |
| Single | | | | | | | | | | |
| Base | | | | | | | | | | |
| Deletion | | | | | | | | | | |
| Large | 0 | 0 | 1 | 0 | 0 | 1 | 1 | 0 | 0 | 0 |
| Deletion | | | | | | | | | | |
| Count | | | | | | | | | | |
| Mutation: | 2 | 2 | 1 | 2 | 1 | 0 | 2 | 1 | 2 | 1 |
| G > A | | | | | | | | | | |
| Mutation: | 0 | 0 | 0 | 1 | 0 | 0 | 0 | 0 | 0 | 0 |
| T > C | | | | | | | | | | |
| ROI Error | 3 | 2 | 2 | 3 | 1 | 1 | 3 | 1 | 2 | 1 |
| Count | | | | | | | | | | |
| ROI Error | Err: ~ 1 | Err: ~ 1 | Err: ~ 1 | Err: ~ 1 | Err: ~ 1 | Err: ~ 1 | Err: ~ 1 | Err: ~ 1 | Err: ~ 1 | Err: ~ 1 |
| Rate | in 834 | in 1350 | in 1282 | in 708 | in 2500 | in 2667 | in 876 | in 2900 | in 1400 | in 2349 |
| ROI | MP | MP | MP | MP | MP | MP | MP | MP | MP | MP |
| Minus | Err: ~ 1 | Err: ~ 1 | Err: ~ 1 | Err: ~ 1 | Err: ~ 1 | Err: ~ 1 | Err: ~ 1 | Err: ~ 1 | Err: ~ 1 | Err: ~1 |
| Primer | in 763 | in 824 | in 780 | in 429 | in 1525 | in 1615 | in 531 | in 1769 | in 854 | in 1451 |
| Error Rate | | | | | | | | | | |

### Example 4: Parallel Assembly of 29,040 Unique Polynucleotides

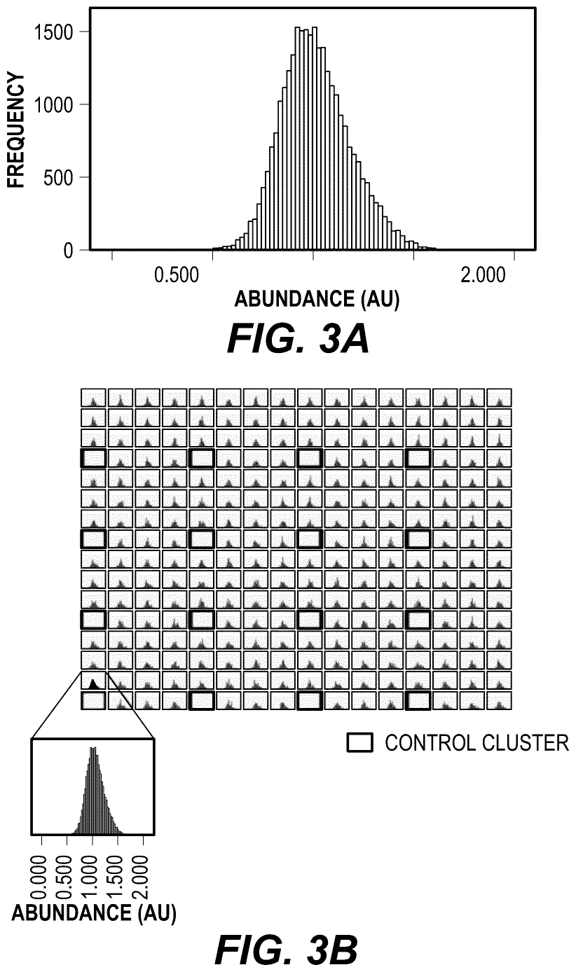

A structure comprising 256 clusters each comprising 121 loci on a flat silicon plate 201 was manufactured as shown in FIG. 2. An expanded view of a cluster is shown in 205 with 121 loci. Loci from 240 of the 256 clusters provided an attachment and support for the synthesis of polynucleotides having distinct sequences. Polynucleotide synthesis was performed by phosphoramidite chemistry using general methods from Example 3. Loci from 16 of the 256 clusters were control clusters. The global distribution of the 29,040 unique polynucleotides synthesized (240×121) is shown in FIG. 3A. Polynucleotide libraries were synthesized at high uniformity. 90% of sequences were present at signals within 4× of the mean, allowing for 100% representation. Distribution was measured for each cluster, as shown in FIG. 3B. On a global level, all polynucleotides in the run were present and 99% of the polynucleotides had abundance that was within 2× of the mean indicating synthesis uniformity. This same observation was consistent on a per-cluster level.

The error rate for each polynucleotide was determined using an Illumina MiSeq gene sequencer. The error rate distribution for the 29,040 unique polynucleotides averages around 1 in 500 bases, with some error rates as low as 1 in 800 bases. Distribution was measured for each cluster. The library of 29,040 unique polynucleotides was synthesized in less than 20 hours. Analysis of GC percentage versus polynucleotide representation across all of the 29,040 unique polynucleotides showed that synthesis was uniform despite GC content.

### Example 5. Design and Synthesis of a Synthetic cfDNA Variant Library

Using the general synthesis methods described in Example 3, a synthetic variant library was designed and synthesized. The total number of target variants represented was 458, and each polynucleotide in the library was 167 base pairs in length. Variants were present on 85 different human genes, and included SNVs (228), indels (215 total; 168 deletions, 47 insertions), fusions, and SVs (15). This included 147 clinically relevant variants (including all SVs). Polynucleotides targeting a single variant were tiled using the general design of FIG. 1A, with an offset of 4 bases and with 32 polynucleotides targeting each variant. The distribution of indel sizes for the library is shown in FIG. 1B. The variant library was then mixed with a background cfDNA library obtained from plasma of a healthy male donor (less than 30 years old, shown in FIG. 1C). Libraries having a variant allele frequency (VAF) of 0% (wild-type), 0.1%, 0.25%, 0.5%, 1%, 2%, and 5% were generated. Accurate representation and distribution of polynucleotides in the library was further confirmed by Next Generation Sequencing (all variant sites) and ddPCR (for a subset of variant sites).

### Example 6. Variant Libraries as a Reference Standard

At least one sample from a patient suspected of having a disease or condition is obtained, such as a sample obtained via liquid biopsy. The patient may have been previously untreated, previously diagnosed/treated, or concurrently treated for a disease or condition. A library generated using the general methods of Example 5 (reference standard, includes mixture variant polynucleotides and background cfDNA) is analyzed on an instrument (sequencing or ddPCR) with the at least one patient sample. If the variants are not detected with the required confidence in the reference standard, the instrument may be adjusted/recalibrated, subjected to maintenance, or the patient sample may be re-analyzed or results discarded. From the sensitivity of the reference standard, the patient sample is analyzed and determined to contain or not contain one or more variants found in the reference standard. Based on this result, the patient may be diagnosed or treated appropriately by a healthcare professional.

### Example 7. Design of ctDNA Standards Using Restriction Site Adapter Cleavage

Sequences for approximately 500 variants were acquired comprising mostly SBS (single base substitutions) from a reference genome. Approximately 10,000 fragments were designed having a length of about 160 bp, with an 8 bp sliding window. About 20 fragments were tiled across each variant. Optionally, a 5 base identifier was added to label the fragments as synthetic. This identifier in some instances was a significant edit distance from the reference gene, or else it may just be called as a variant. Given a variant fasta file, fragments are designed by:
1. Selecting 162 bases (for 2 base “synthetic signatures” to the 5′ and 3′ of the variant base, for a total of 325 bases.
2. The 5′ 164 bases will be fragment 1.
3. Looping over a sliding window+8, each will be new fragment, 20 fragments to synthesize per variant.
4. For each fragment, change 5 bases at the 5′ end to encode the complement. e.g., AGATC . . . TCTAG . . . .
5. For each fragment, change 5 bases at the 3′ end to encode the complement as above.

If the variant is at the end of a molecule, in some instances it is soft-clipped. In one embodiment, the sliding window is at 7, but starts closer to the variant. This would result in 20 unique molecules per variant.

The length is 324 bp (for 2 bp on each end for barcoding). The variant is placed at base position 161. In another embodiment, the sliding window is +7 (every 8th base), the variant is at base 161 in the original fasta at 171 in the expanded fasta, start at −150, fragment length is 164, 2 bp on each end is complemented, and flanks are added as described below. Exemplary 20 oligos to be synthesized were prepared, without the flanks added, to show the location of each of the variants across each molecule. The top is the original variant. In the bottom 20, each line is a unique molecule from the sliding window. The highlighted region contains the variant base. Within the GACCTGG, the bolded base is the variant. It is present within each molecule at least 8 bases within the end of the alignable. Flanks are added as below. Initial builds using this design resulted in 6760 oligos for the SNVs (333 variants with 20 oligos per variant). The oligos are screened for restriction sites:

TABLE 4

| | bspq1 | bsmb1 | bbs1 |
|---|---|---|---|
| number of oligos | 162 | 208 | 792 |
| with site | | | |
| % with site | 2.39538666 | 3.07555818 | 11.7107792 |

Bspq1 and bsmb1 (both 7 cutters) result in fewer oligos with cut sites; bbs1 is a 6 cutter, and cuts more frequently. BSPQ1 cleaves at the fewest endogenous locations, so this is used to remove adapters; the cut sequences are:

GCTCTTC(N1)-3′
CGAGAAG(N4)-5′

There is a 3 base 5′ overhang after cutting. These are filled in with Klenow after cleanup. The N1 base is in ( ). The initial oligo has the sequence: 5′-GAAGTGCCATTCCGC GCTCTTC(A) (SEQ ID NO.: 7)-2b complement-160b w/variant-2b complement-(T)GAAGAGCATCGTACAG CTGCTCG-3′ (SEQ ID NO.: 8).

In another embodiment, the oligo has the sequence: 5′-CCATTCCGC GCTCTTC(A) (SEQ ID NO.: 9)-2b complement-160b w/variant-2b complement-(T)GAAGAGCATC GTACAGCT-3′ (SEQ ID NO.: 10).

Exemplary primers include those described in Tables 5 and 6.

TABLE 5

| | |
|---|---|
| Uni9 | GAAGTGCCATTCCGCCTGACCT |
| | (SEQ ID NO.: 11) |
| B1-BSPQ-M-AFR-1B | #-CGAGCAGCTGTACGATGCTCTTCA |
| | (SEQ ID NO.: 12) |
| B2-BSPQ-M-AFR-1B | #-CGCTGACGATGTCAGTGCTCTTCA |
| | (SEQ ID NO.: 13) |

TABLE 6

| | Forward primer | | |
|---|---|---|---|
| | (Uni9 | Reverse primer | reverse |
| | based) | (B1 based) | rev_comp |
| original | #-GAAGTGC | #-CGAGCAGC | TGAAGAGC |
| | CATTCCGC | TGTACGAT | ATCGTACA |
| | GCTCTTCA | GCTCTTCA | GCTGCTCG |
| | (SEQ ID | (SEQ ID | (SEQ ID |
| | NO.: 14) | NO.: 15) | NO.: 16) |
| Q5 | 73° C. | 71° C. | |
| Tm | | | |
| | #- | #- | TGAAGAGC |
| | CCATTCCGC | AGCTGTACGA | ATCGTACA |
| | GCTCTTCA | TGCTCTTCA | GCT |
| | (SEQ ID | (SEQ ID | (SEQ ID |
| | NO.: 17) | NO.: 18) | NO.: 19) |
| Q5 | 65° C. | 63° C. | |
| Tm | | | |

In some instances, primers are further shortened or comprise lower GC content. In some instances primers are no more than 200 bp. Primers are biotinylated for removal after cleavage. T4 DNA polymerase is used to fill-in 5′ overhangs. SPRI beads are also used to remove ends. If the primers misprime on each other (due to similar 3′ ends) primers will still introduce BSPQ1 and a biotinylated tail. Oligos are binned by GC to avoid bias during amplification, and printed to a matrixed pool at 60 oligos per cluster.

Primers are synthesized having the sequences:

cfDNA_BSPQ1_F #-
(SEQ ID NO.: 17)
CCATTCCGCGCTCTTCA
cfDNA_BSPQ1_R #-
(SEQ ID NO.: 18)
AGCTGTACGATGCTCTTCA

Genes are binned by GC to prevent competition. For these genes, any molecules with BSPQ1 sites are removed to prevent potential issues downstream.

An adapter-off process for this design in some instances uses restriction. Using Bsa1 may result in variance in cleavage by methylation status, as cfDNA in some instances have adapters with Bsa1 cut sites. These are methylation sensitive because the primers used are biotinylated on the 5′ end and unmethylated. Bsa1 cut side have the sequences:

GGTCTC(N1)-3′
CCAGAG(N4)-5′

In some instances, endogenous sites are protected by adding 5-methyl-dCTP to the PCR step. After digestion, uncleaved products and cleaved adapters are removed by streptavidin binding, then filled in with Klenow. In some instances, Bsmb1 is used as a restriction enzyme, resulting in sequences:

5′-CGTCTC(N1)-3′
3′-GCAGAG(N4)-5′

Bottom strand methylation results in protection from digestion. To evaluate how this effects adapter removal, 5m-dCTP is spiked in at various ratios in a range from 10-100%. Both forward and reverse primers are biotinylated. Primers in some instances are designed to reduce homology and dimerization, as shown in Table 7.

TABLE 7

| | | | 3′ rev_ |
|---|---|---|---|
| | Forward | Reverse | comp |
| | primer | primer | adapter |
| Primer | #-CCATGT | #-AGTCAG | CGAGACGA |
| | GCTCACGT | GATGTCGT | CATCCTG |
| | CTCA | CTCG | ACT |
| | (SEQ ID | (SEQ ID | (SEQ ID |
| | NO.: 20) | NO.: 21) | NO.: 22) |
| Q5 | 65° C. | 63° C. | |
| Tm | | | |

A design utilizing the adapters of Table 7 is synthesized at 40 oligos per cluster binned by GC:. The 5′ overhang is filled in at the end with Klenow. Optionally, a PTO (phosphorothioate oligonucleotide) modification at the most 3′ of the primer is introduced which may protect the full length DNA from exonuclease digestion. In some cases, multiple PTO modifications are employed.

### Example 8. CfDNA Expansion with Uracil Adapter Cleavage

A cfDNA library was prepared using uracil as a terminal nucleotide of primers to enable facile cleavage of adapters sequences after amplification. In some instances, use of uracil results in fewer cleavage events in cfDNA libraries relative to a restriction enzyme digestion. Two cfDNA replicates were generated of 30 ng of cfDNA, amplified using UNI9 FWD/REV v2.1 (single uracil primers), a cfDNA expansion workflow performed comprising a) overhang digestion using Klenow and b) Overhang digestion using (non-HotStart) KAPA Hifi, and whole genome sequencing performed. A cfDNA sample was used to evaluate cleavage protocols.

cfDNA was obtained from commercial samples, or alternatively isolated from cell lines by nucleosome preparation. Briefly, Expi293 cells were harvested and diluted to 1×10⁶ cells per mL in 1×PBS, spun down, and the cells lysed. Isolated nuclei were treated with a nuclease and incubated, then treated with Proteinase K treatment. The product was then purified using spin columns.

Library preparation. 30 ng of input cfDNA was dissolved in 30 microliters EB buffer, and combined with 5 microliters water, 5 microliters 10× fragmentation buffer, and 10 microliters 5× fragmentation enzyme. The reaction was incubated for 30 minutes, the held at 4 degrees C., and mixed with 5 microliters of adapter solution. Ligation master mix was prepared from water (15 microliters), DNA ligation buffer (20 microliters), and DNA ligation mix (10 microliters), followed by incubation at 20 degrees C. for 15 minutes. Cleanup was then performed using 0.8×SPRI, and products eluted with 20 microliters EB buffer. The adapter library (20 microliters), forward and reverse primers (2.5 microliters each at 20 uM), and KAPA Hifi U+master mix (25 microliters) were used to amplify the library. The thermocycler program was initialization (98 C, 45 s, 1 cycle); denaturation (98 C, 15 s), annealing (70 C, 30 s), and extension (72 C, 30 s)—3 cycles; final extension (72 C, 1 min); and hold at 4 C. After amplification, the products were cleaned up with 1×SPRI, and eluted with 30 microliters EB buffer. Amplicon size was approximately 150-500 bases, with most fragments about 234 bases in length. After fragmentation of the cfDNA sample, ligation of adapters, and amplification with uracil-containing primers, the cfDNA library comprised the sequences:

```
5′(B) GAAGTGCCATTCCGCCTGACCTGCTCTTCCGUNNNNNNNNNNACGGAAGAGCTCCGATCCACCTCCGAGTCAC (SEQ ID NO.: 23)
            |||||||||||||||||||||||||||||||||||||||||||||||||||||||||||||||||||||||||
      3′ CTTCACGGTAAGGCGGACTGGACGAGAAGGCANNNNNNNNNNUGCCTTCTCGAGGCTAGGTGGAGGCTCAGTG (B) (SEQ ID NO.: 24)
```

The library was next digested with USER to cleave the adapters. 1 microgram of cfDNA was incubated with USER (1000 U/mL, 2.5 microliters), 10× cutsmart buffer (5 microliters), and water to 50 microliters at 37 C for 1 hour. 3′ overhangs were removed by Klenow (1 microliter), 10×NEB buffer 2 (5 microliters), dNTPs (10 mM, 1 microliter), and water (5 microliter) incubated at 25 C for 1 hour. Alternatively, 5×KAPA Hifi was used (5×KAPA Hifi Buffer, 10 microliters; KAPA Hifi Enzyme, 1 microliter; and dNTPs, 10 mM, 1 microliter) incubated at 72 C for 1 hour. Products were purified by streptavidin binding to beads, and SPRI cleanup. Alternatively, primers were removed by Prep Streptavidin beads with Cutsmart (50 ul beads, wash 2 times with 1× Cutsmart buffer; Elute 20 ul 1× Cutsmart buffer); Bind sample to beads (Add beads to 500 ng of library ˜30 ul; Incubate in thermocycler 20° C. 30 min); USER digestion (Add 2.5 ul USER enzyme, Advance thermocycler 37° C. 1 hr); Strand disassociation (Advance thermocycler 70° C. 30m); Collect flow-through (Put tubes on magnetic rack, collect flow through); End blunting (Add 6 ul of 10×NEB Buffer 2; Add 1 ul of Klenow; Add 3 ul of nuclease free water; Incubate 25° C. 30 min); SPRI cleanup (2×SPRI cleanup; Elute 30 ul EB buffer). Alternatively, the following protocol changes were made: Bind to beads 20° C. 1 hr (500 ng); Add 5 ul USER, digest 37° C. 2 hr; Incubate 80° C. for 30 minutes (immediate magnetization to minimize potential re-annealing); Use KAPA Hifi for end digestion (14 ul 5×KAPA Buffer, 1 ul KAPA Hifi (70 ul reaction total), Incubate 72° C. 1 hr); 2×SPRI cleanup (Elute 35 ul EB buffer).

After cleavage/exoIII digestion, the library had sequences:

```
5′ (B) GAAGTGCCATTCCGCCTGACCTGCTCTTCCGNNNNNNNNNNACGGAAGAGCTCCGATCCACCTCCGAGTCAC (SEQ ID NO.: 25)
              ||||||||||||||||||||||||||||||| ||||||||||||||||||||||||||||||||||||||||
        3′ CTTCACGGTAAGGCGGACTGGACGAGAAGGCANNNNNNNNNNGCCTTCTCGAGGCTAGGTGGAGGCTCAGTG (B) (SEQ ID NO.: 26)
```

After cleanup was performed with streptavidin beads and strand dissociation to generate sequences:

```
5′ NNNNNNNNNNACGGAAGAGCTCCGATCCACCTCCGAGTCAC (SEQ ID NO.: 27)
                                                                    ||||||||||
              3′ CTTCACGGTAAGGCGGACTGGACGAGAAGGCANNNNNNNNNN (SEQ ID NO.: 28)
```

Lastly, cfDNA repair and extension using polymerase are used to generate the cfDNA library:

5′ NNNNNNNNNN
||||||||||
3′ NNNNNNNNNN

### Example 9. CfDNA Expansion Using Phosphorothioates

Following the general methods of Example 8, cfDNA expansion libraries were generated using either no phosphorothioate at the 3′ uracil, 1 phosphorothioate bond at the 3′ uracil, or 3 phosphorothioate bonds at the 3′ uracil. Primer sequences were:

cfDNA_Exp_v2.1_FWD
(SEQ ID NO.: 29)
/5Biosg/GA AGT GCC ATT CCG CCT GAC
CTG CTC TTC CG/3deoxyU/
cfDNA_Exp_v2.1_REV
(SEQ ID NO.: 30)
/5Biosg/GT GAC TCG GAG GTG GAT CGG
AGC TCT TCC G/3deoxyU/
cfDNA_Exp_v2.1_1PTO_FWD
(SEQ ID NO.: 31)
/5Biosg/GA AGT GCC ATT CCG CCT GAC
CTG CTC TTC CG*/3deoxyU/
cfDNA_Exp_v2.1_1PTO_REV
(SEQ ID NO.: 32)
/5Biosg/GT GAC TCG GAG GTG GAT CGG
AGC TCT TCC G*/3deoxyU/
cfDNA_Exp_v2.1_3PTO_FWD
(SEQ ID NO.: 33)
/5Biosg/GA AGT GCC ATT CCG CCT GAC
CTG CTC TTC* C*G*/3deoxyU/
cfDNA_Exp_v2.1_3PTO_REV
(SEQ ID NO.: 34)
/5Biosg/GT GAC TCG GAG GTG GAT CGG
AGC TCT TC*C* G*/3deoxyU/

Use of phosphorothioate bonds led to increased yields. Without being bound by theory, use of the phosphorothioate preserved the terminal uracil via preventing exonucleolytic removal of the U by the polymerase. After fragmentation of the cfDNA sample, ligation of adapters, and amplification with uracil-containing primers, the cfDNA library comprised the sequences:

```
5′ (B) GAAGTGCCATTCCGCCTGACCTGCTCTTCCGUNNNNNNNNNNACGGAAGAGCTCCGATCCACCTCCGAGTCAC (SEQ ID NO.: 23)
              |||||||||||||||||||||||||||||||||||||||||||||||||||||||||||||||||||||||||
        3′ CTTCACGGTAAGGCGGACTGGACGAGAAGGCANNNNNNNNNNUGCCTTCTCGAGGCTAGGTGGAGGCTCAGTG (B) (SEQ ID NO.: 24)
```

Phosphorothioate bonds are shown between G and U bases (bolded, underlined).

### Example 10. CfDNA Analysis Using UMIs for Cancer Detection

Early detection can significantly improve the clinical outcome for a number of cancers, but many of the best current screening methods require invasive procedures. A promising alternative approach is to perform a liquid biopsy of cell-free DNA (cfDNA) from patient plasma. Because tumors generally shed relatively large amounts of DNA into the circulation, cancer can potentially be detected by identifying oncogenic variants in cfDNA. This process generally requires extremely deep sequencing, and is in some cases limited by the accuracy of next-generation sequencing (NGS).

One approach to overcoming this limitation is to use unique molecular identifiers (UMIs), which are short sequences that uniquely tag each input DNA molecule prior to preparing NGS libraries. The approach can further be improved by tagging each original strand of the DNA molecule, in a technique termed duplex sequencing, which allows for correction of early PCR errors and/or single-strand DNA damage events.

Following the general procedures of Example 6, a contrived sample was designed and synthesized to simulate a fraction of tumor DNA in a healthy background and ligated to polynucleotide “duplex” UMI-containing adapters. UMI sequences were optimized to maximize sequence distances for error correction. The library was then subjected to sequencing analysis.

The rate at which input DNA is converted into sequencing libraries was determined. Using contrived samples to simulate a fraction of tumor DNA in a healthy background, both high sensitivity and specificity towards oncogenic variants was demonstrated. The baseline error rate using unmodified human cell-free DNA was evaluated, and mutation frequency in synthetic biology applications were determined.

### Example 11. Variant Analysis of cfDNA Analysis Using UMIs

Following the general procedures of Example 10, 30 ng of ctDNA (Seracare) AF1%, 3 μl of 10 μM adapter solution, followed by amplification (Equinox MM, 9 cycles PCR). Standard capture was performed using a 37 kb variant-targeting panel, with a hybridization time of 16 hrs (1 plex). 50 ng of input material was used and subjected to 16 cycles PCR prior to sequencing. Duplex efficiency is shown below in Table 8.

TABLE 8

| Run | blend | 20000x | 30000x | 40000x | 50000x |
|---|---|---|---|---|---|
| 1 | Y | 6.3% | 5.0% | 4.0% | 3.4% |
| 1 | Y | 6.7% | 5.3% | 4.3% | 3.6% |
| 1 | Z1 | 8.6% | 6.6% | 5.3% | 4.4% |
| 1 | Z1 | 9.7% | 8.2% | 6.9% | 5.9% |
| 1 | Z1 | 9.9% | 8.3% | 6.9% | 5.9% |
| 1 | Z3 | 9.7% | 8.3% | 7.0% | 6.0% |
| 1 | Z3 | 9.7% | 8.0% | 6.7% | 5.7% |
| 1 | Z3 | 9.8% | 8.1% | 6.7% | 5.7% |
| 2 | Y | 5.8% | 4.9% | 4.1% | 3.5% |
| 2 | Y | 6.4% | 5.4% | 4.6% | 3.9% |
| 2 | Z1 | 8.6% | 7.7% | 6.7% | 5.9% |
| 2 | Z1 | 9.0% | 8.1% | 7.2% | 6.3% |
| 2 | Z1 | 9.0% | 7.9% | 6.9% | 6.0% |
| 2 | Z3 | 8.0% | 7.1% | 6.1% | 5.3% |
| 2 | Z3 | 9.8% | 8.7% | 7.6% | 6.7% |
| 2 | Z3 | 8.0% | 7.2% | 6.3% | 5.5% |

### Example 12. Variant Analysis of Pan Cancer Controls

Following the general procedures of Examples 6 and 10, a 458 member pan-cancer cfDNA standard was designed, ligated to UMI-containing adapters, and sequenced. Results with and without downsampling and/or filtering were obtained.

### Example 13. Design and Synthesis of Fusion RNAs

Fusion genes are structural variants made when the coding region of two previously independent genes become joined together and can be a major driving cause of cancer development. Since many gene fusions are clinically-actionable, sensitive and accurate diagnostic assays are desperately needed and are rapidly under development. Regardless of the assay methodology (e.g. high-throughput or not, e.g. multiplexed NGS or qPCR), there is a need for standard reference gene fusion material for assay development, analytical validation, and establishment/standardization of assay specificity and sensitivity.

The synthetic RNAs were designed centered around the known and documented fusion sites with 750 nt of RNA 5′- of and 3′- of the fusion junction, suitable for short read sequencing and qPCR experiments. Pooled synthetic fusion RNAs were quantified at known molar ratios, analyzed for QC using NGS for uniformity, and ddPCR used to establish a highly precise pool concentration. The Fusion Control library was designed to serve as a spike-in or stand-alone positive control and specifically pairs well with a clinically-relevant target enrichment (TE) panel.

A set of RNA fusions was designed based on available databases and corresponding DNAs were designed and synthesized using the methods described herein (Twist Bioscience). The fusions synthesized are shown in Table 9.

TABLE 9

| Fusion_ID | Fusion_ID | Fusion_ID |
|---|---|---|
| EWSR1: 17\|FLI1: 4 | TBL1XR1: 14\|TP63: 4 | ATIC: 7\|ALK: 1 |
| EWSR1: 17\|NR4A3: 1 | TPM3: 8\|ALK: 1 | CLTC: 31\|ALK: 1 |
| FUS: 15\|ERG: 2 | PRCC: 7\|TFE3: 1 | DHH: 2\|RHEBL1: 2 |
| ETV6: 8\|RUNX1: 1 | TFE3: 10\|ASPSCR1: 1 | ETV6: 8\|MN1: 1 |
| KMT2A: 36\|MLLT3: 1 | PTPRK: 7\|RSPO3: 2 | ETV6: 8\|PDGFRB: 10 |
| NPM1: 5\|ALK: 1 | CD74: 8\|NRG1: 6 | JAK2: 25\|PAX5: 1 |
| PML: 7\|RARA: 3 | CD74: 8\|ROS1: 32 | KMT2A: 36\|44810: 2 |
| RUNX1: 8\|RUNX1T1: 2 | EZR: 12\|ROS1: 32 | KMT2A: 36\|44813: 2 |
| DNAJB1: 2\|PRKACA: 2 | KIF5B: 24\|ALK: 1 | KMT2A: 36\|AFDN: 2 |
| EML4: 20\|ALK: 1 | SDC4: 4\|ROS1: 32 | KMT2A: 36\|AFF1: 1 |
| EML4: 20\|EML4: 1 | CDKN2D: 2\|WDFY2: 3 | KMT2A: 36\|ELL: 2 |
| TCF3: 17\|PBX1: 3 | SLC45A3: 4\|ELK4: 2 | KMT2A: 36\|EPS15: 1 |
| TMPRSS2: 5\|ERG: 2 | CHCHD7: 1\|PLAG1: 1 | KMT2A: 36\|MLLT11: 2 |
| CRTC1: 14\|MAML2: 1 | FGFR1: 17\|PLAG1: 1 | PCM1: 39\|JAK2: 1 |
| ASPSCR1: 16\|TFE3: 1 | HMGA2: 5\|WIF1: 3 | SET: 8\|NUP214: 1 |
| COL1A1: 49\|PDGFB: 2 | MAML2: 5\|CRTC1: 1 | STIL: 3\|TAL1: 1 |
| EWSR1: 17\|ATF1: 1 | MYB: 16\|NFIB: 8 | TMPRSS2: 1\|ERG: 4 |
| EWSR1: 17\|WT1: 8 | PLAG1: 5\|CTNNB1: 1 | TPM3: 7\|NTRK1: 10 |
| FUS: 15\|DDIT3: 1 | ATF1: 7\|EWSR1: 1 | FGFR3: 18\|TACC3: 4 |
| HMGA2: 5\|LPP: 1 | EWSR1: 17\|CREB1: 7 | BCR: 14\|ABL1: 2 |
| JAZF1: 3\|SUZ12: 2 | EWSR1: 17\|DDIT3: 1 | CCDC6: 1\|RET: 12 |
| SS18: 11\|SSX1: 1 | FUS: 15\|CREB3L2: 1 | CD74: 6\|ROS1: 34 |
| SS18: 11\|SSX2: 1 | LPP: 11\|HMGA2: 1 | EGFR: 24\|SEPTIN14: 10 |
| CDH11: 2\|USP6: 1 | RANBP2: 18\|ALK: 1 | EML4: 13\|ALK: 20 |
| EWSR1: 17\|EWSR1: 1 | SS18: 11\|SSX4B: 3 | ETV6: 5\|ABL1: 2 |
| EWSR1: 17\|POU5F1: 1 | TPM4: 7\|ALK: 1 | FGFR1: 17\|TACC1: 7 |
| HEY1: 4\|NCOA2: 12 | YWHAE: 5\|NUTM2B: 2 | FGFR3: 17\|BAIAP2L1: 2 |
| GOPC: 8\|ROS1: 32 | PAX8: 10\|PPARG: 2 | FGFR3: 17\|TACC3: 10 |
| RUNX1: 5\|RUNX1T1: 2 | MET: 13\|MET: 15 | KIF5B: 15\|RET: 12 |
| SLC34A2: 4\|ROS1: 32 | NCOA4: 8\|RET: 12 | TCF3: 16\|PBX1: 3 |
| PML: 6\|RARA: 3 | | |

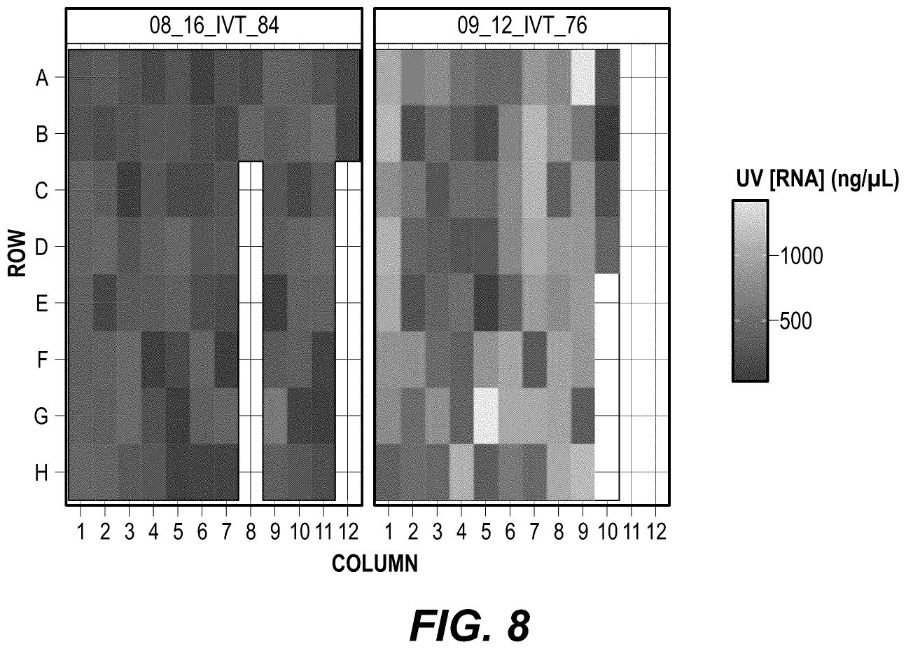

Plasmids comprising DNA segments corresponding to the RNA fusions were distributed into plates, digested with Ascl, purified using an in-place SPRI cleanup, and analyzed to confirm complete digestion of the plasmid. NEB HiScribe T7 High Yield RNA Synthesis Kit was used to transcribe the DNA into RNA. Transcription was carried according to the manufacturer's instructions, but carried out for 4 hours instead of 2 hours at 37 degrees C. Next, samples were treated with DNase to dissolve any remaining template and purified using RNA Clean XP Bead Clean Up (Beckman Coulter) or Monarch (NEB) 500 μg Columns. Per plate yields are shown in FIG. 8. The RNA fusion library is then used as a reference library for oncogene analysis.

### Example 14: SNV and RNA Libraries for Calibration

SNV and RNA fusion libraries are each constructed following the general procedures of Examples 12 and 13. The libraries are each mixed with known background donor libraries, and analyzed using ddPCR or other technique provided herein. Results from the standards are compared with data obtained from human clinical samples suspected of having an SNV mutation or RNA fusion abnormality associated with cancer. Use of the standards results in higher confidence for diagnosis and confirms the diagnostic instrument is performing within specifications.

### Example 15: Design of Methylation Standards

A methylation library was designed according to FIG. 9. Polynucleotide pools were designed to represent specific methylated nucleic acid sequences, pools were amplified with a uracil tolerant polymerase, the pools were purified with SPRI and quantified, pools were combined based on mass to include replicates and number of CpG sites, primers were removed by USER and products purified by SPRI, methylation sites were added using a methyltransferase, the products purified by SPRI, and pools mixed by ratio, pooled, and subjected to analysis for quality control.

A methylation control was designed according to the following conditions. The control included about 5 to 10% difference in size related to a 1 bp tile hopping across the span of about 175 base pairs, and included three different amounts of CpG sites: at a low amount (2 sites), medium amount (8 sites), and high amount (18 sites), with two replicates of each, which was done using 4 unique sequences. The control included eight methylation levels, which meant making 8 unique sequences to reflect each level (100%, 50%, 25%, 12.5%, 6.25%, 3.125%, 1.6125%, and 0% methylation). The GC content was similar to that observed in the human genome. All sequences had 1 BsmBI site (with the primers removed). No sequence had a homopolymer >=3 (with the primers removed). All sequences had pairwise hamming distances of at least 100 from each other and nothing BLASTs to either nr or the human genomic+transcript.

Considerations for designing oligos in a control included being able to design oligos with a fixed count of specific sequences (e.g., exactly 7 GCs, exactly 1 CGTCTC BsmBI site), that excludes other sequences (e.g., does not contain a homopolymer >2, meaning must exclude TTT, CCC, GGG and AAA), of a defined length (e.g., 167 bp), and with a buffer on the ends (e.g., CpG or BsmBI sites cannot appear in edge 20 bases).

The oligos were designed following the method generally illustrated in FIG. 10-13. In this workflow, the number of overlapping sequences were counted as exemplary shown in FIG. 10. As shown, in this illustrative schematic, the number of times the string ACA appear in the sequence in FIG. 10 is three times. In the oligo design process, the CpG motifs were first seeded as shown in FIG. 11. All the motifs needed were added to a list and the order was permuted. The total padding space between the motifs was determined and the total space (e.g., 16 base positions total) was randomly partitioned into spacing between each motif. The motifs were then placed into the sequence. The gaps were then filled as shown in FIG. 12. Beginning at a first base, the bases were filled with random bases. For example, if the base C is placed at position 1 as shown in FIG. 12, the next base in position 2 cannot be C to avoid a homopolymer with existing CpG sites. Bases were added to fill the sequence according to these general guidelines, which is exemplary shown in FIG. 13. In a further example, if G was placed at position 11, this would result in an additional CpG site, whereas C would create a homopolymer. Therefore, only A or T could be added to position 11.

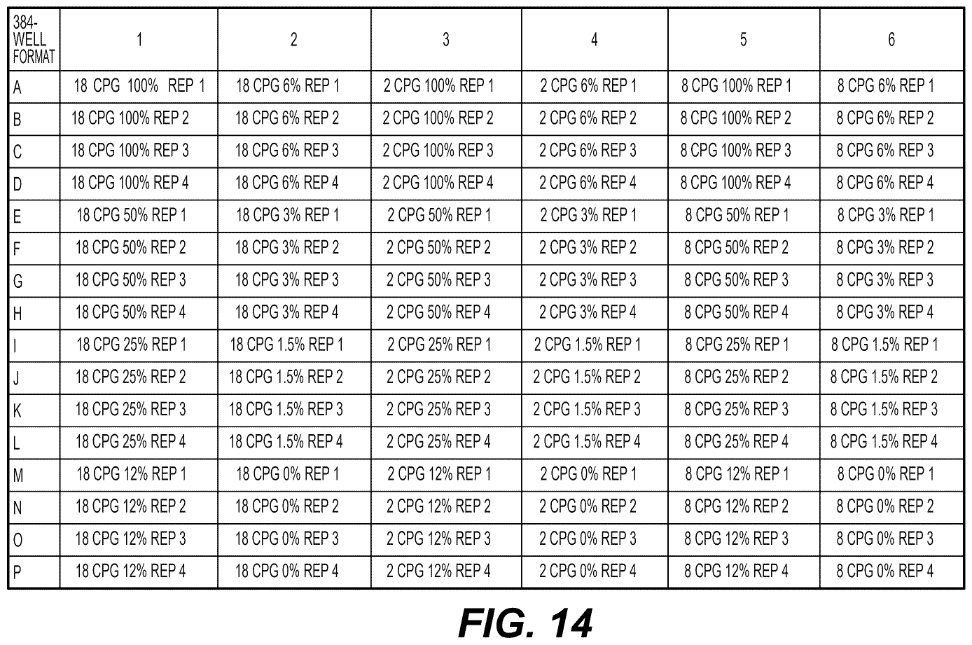

FIG. 14 shows a 386 well plate comprising polynucleotides with various numbers of CpG islands and levels of methylation. Methylation was performed using a CpG methyltransferase, M. SssI enzyme isolated from a strain of E. coli which contains the MQ1 Methyltransferase gene. The M.SssI enzyme methylated all cytosine residues within the double-stranded dinucleotide recognition sequence 5′ . . . . CG . . . 3′, as shown in FIG. 15. The process utilized S-adenosylmethionine (SAM) to add methylation groups to cytosine nucleotides when in the appropriate recognition sequence.

FIGS. 16A and 16B show sizes of polynucleotides after primer removal, where NEB CpG Methyltransferase enzyme efficiency was tested as a way to methylate CpG sequences in vitro. 1 ug of a single dsDNA sequence was used with CpG sites. If CpGs were (hemi)methylated, BsmBI would not cut. Nearly full methylation of CpG sites was achieved when using the NEB CpG Methyltransferase. This enzyme worked well and was used to prepare controls.

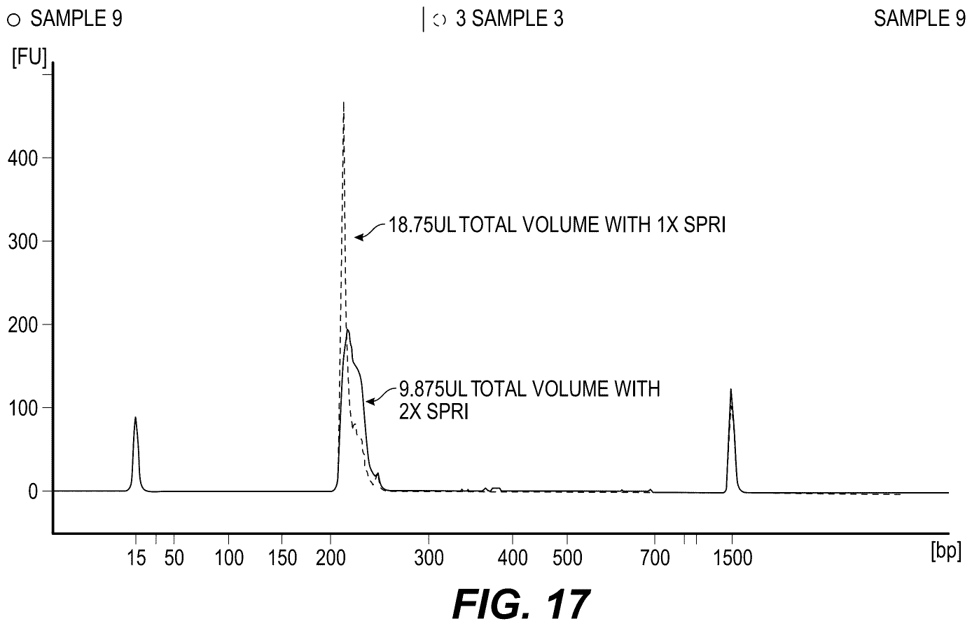

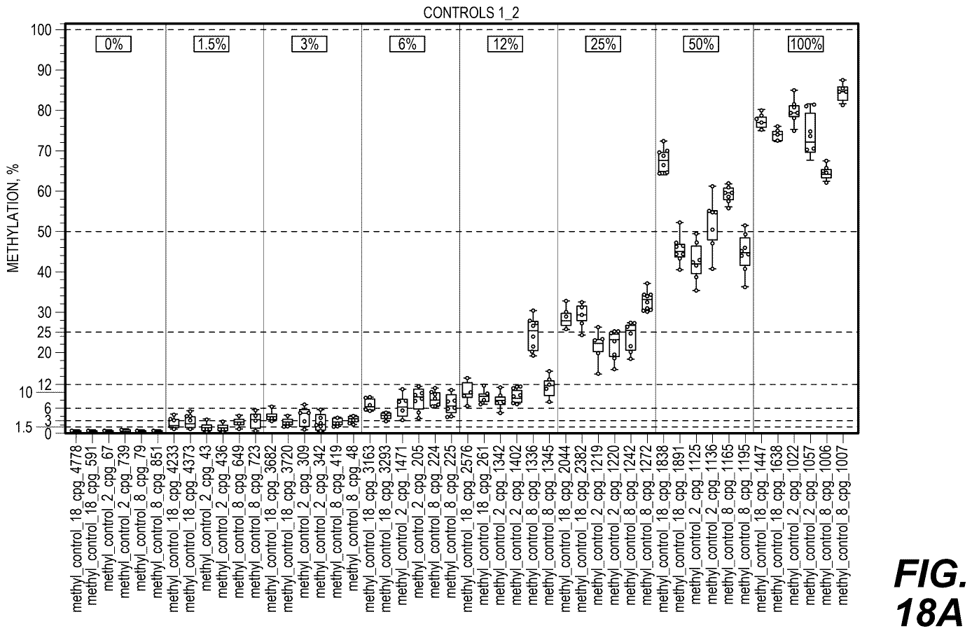

Next, volume versus SPRI Ratio in 384-well Plate was studied. The experiment goal was to achieve amplification with a lower volume so that the SPRI ratio could be increased in a 384-well plate. The experimental conditions included performing PCR using standard oligo pool amplification process at a final volume of 18.75 ul and a final volume of 9.875 ul (cutting all reagents in half except for the oligo pool). SPRI cleanup was performed at either 1× on the volume at 18.75 ul and 2× on the volume at 9.875 ul. FIG. 17 shows the results of the polynucleotide sizes using different amounts of SPRI bead cleanup. Any gain achieved using a larger SPRI ratio resulted in a loss because the PCR reaction did not produce as much product using a lower volume. Therefore, moving forward, about 18 ul of total PCR volume and a 1×SPRI ratio was used.

Methylation controls were generated based on these results and the above mentioned conditions at methylation ratios of 0%, 1.5%, 3%, 6%, 12%, 25%, 50%, and 100%. Four controls were prepared and analyzed.

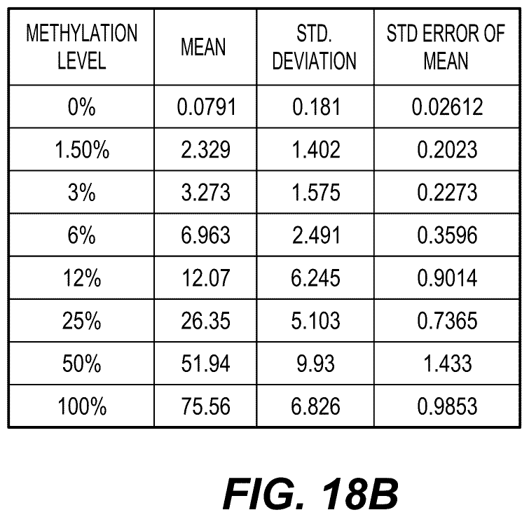

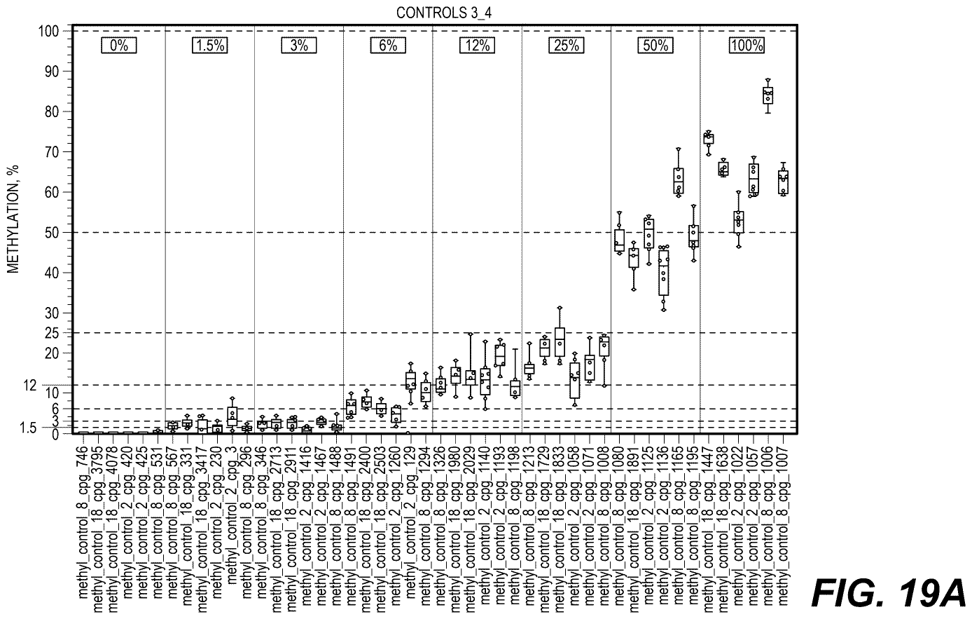

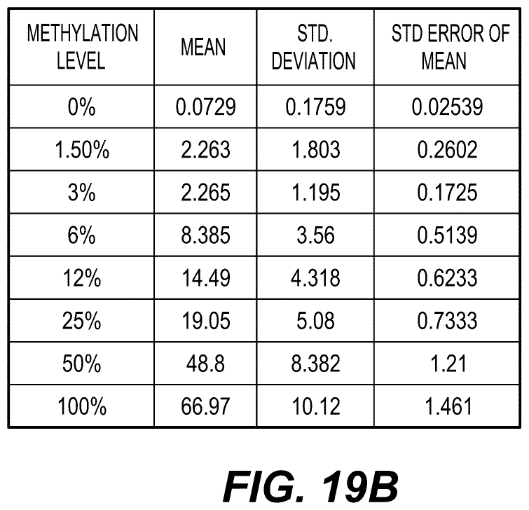

FIGS. 18A-19B show the methylation percent for members of the library. The 100% methylated controls were lower than expected at 76% for controls 1_2 and 67% for controls 3_4. Additionally, enzymatic conversion worked as expected (pUC19 Control). Concentration of the control DNA strains were good, and the suggested amount of 1 ul yielded good coverage for most of the controls. Methylation level seemed to be replicated well between replicate sequences, especially in the 0 to 12%. Better accuracy was observed as far as the methylation levels. In some instances, increased accuracy may be obtained by having more than 2 unique replicates for each methylation level and CpG frequency. In some instances, more ratios between the 50% and 100% ranges may be added.

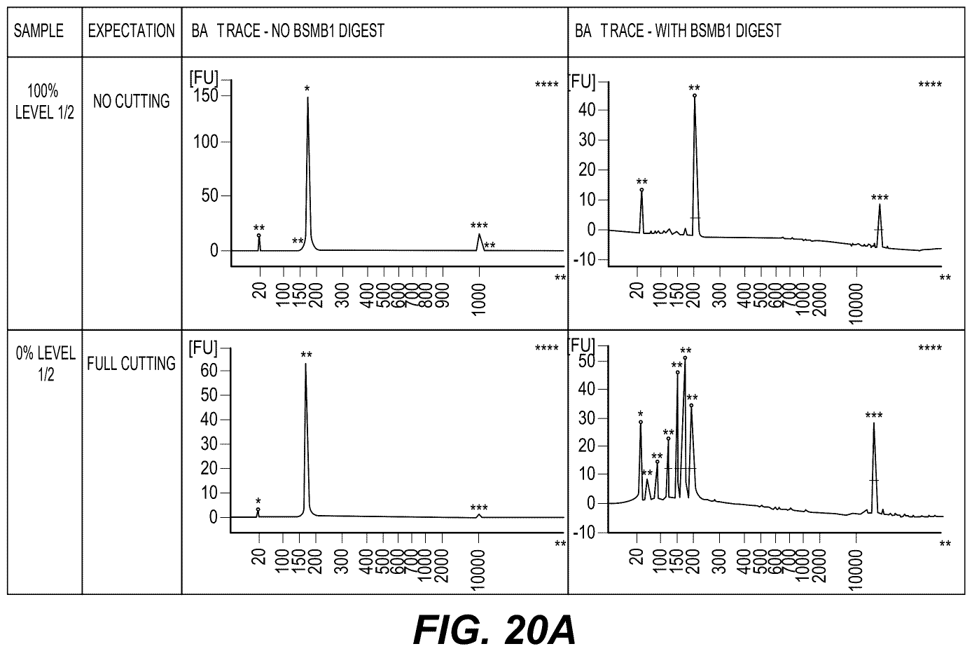

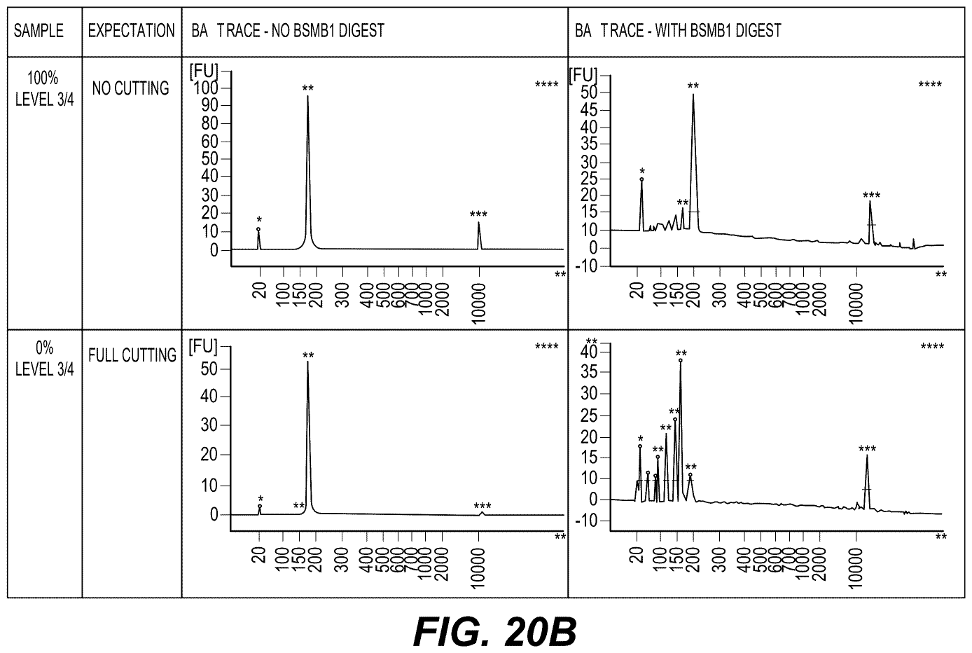

Because of the BsmBI site added to each sequence, methylation level were able to be tested in a different way to double check results. For methylation levels 100% and 0% for sets 1/2 and 3/4, 1 ug was added in to their own separate BsmBI reaction. The results, shown in FIGS. 20A and 20B, showed similar trends, where 100% methylation levels were 100% methylated. This was more so in the 3/4 set. This process may be redone using the appropriate conditions, including but not limited to, changing the input of DNA or enzyme and adding BsmB1 QC Step before pooling using incubation of 1 hour.

Changes were then made to the methylation control design to use BsmB1 for methylation conversion, with methylation ratios of 0%, 3%, 6%, 12%, 25%, 50%, 75%, and 100%. Generally, 160 uM of SAM was used but in some cases was increased to 320 uM. Additionally, 4 units of enzyme with 1 ug of DNA in 50 ul was used and the total volume used in this experiment was generally 50 ul.

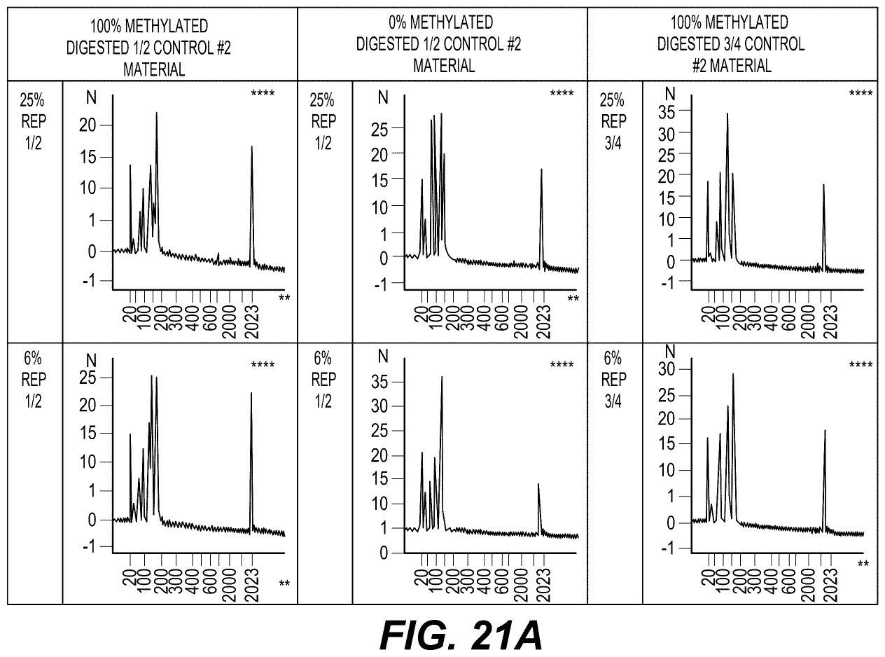

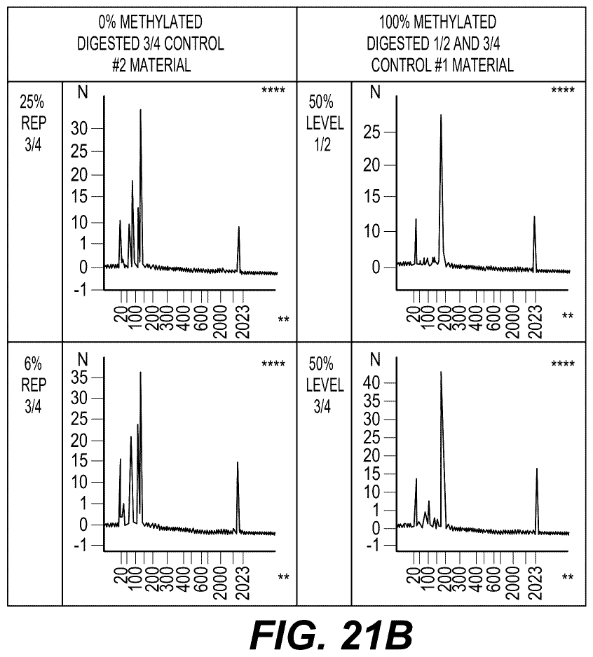

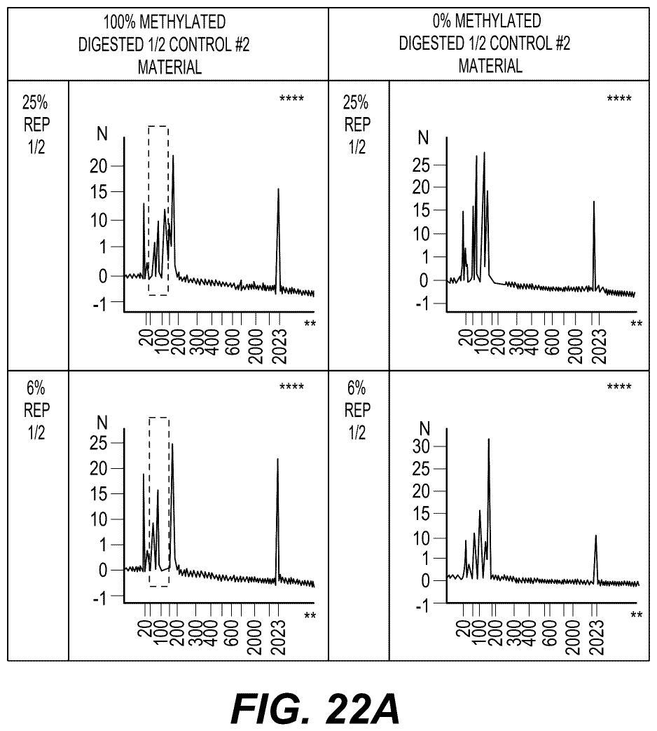

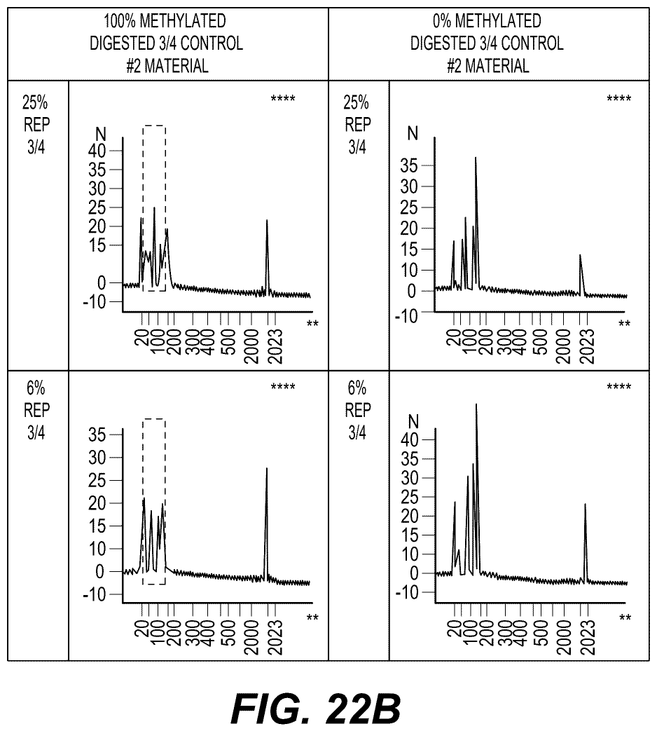

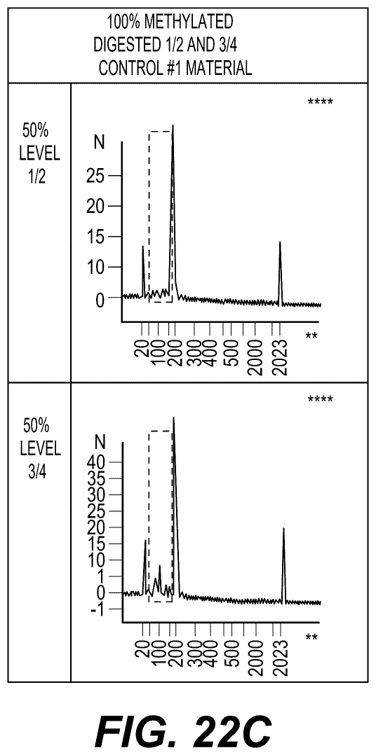

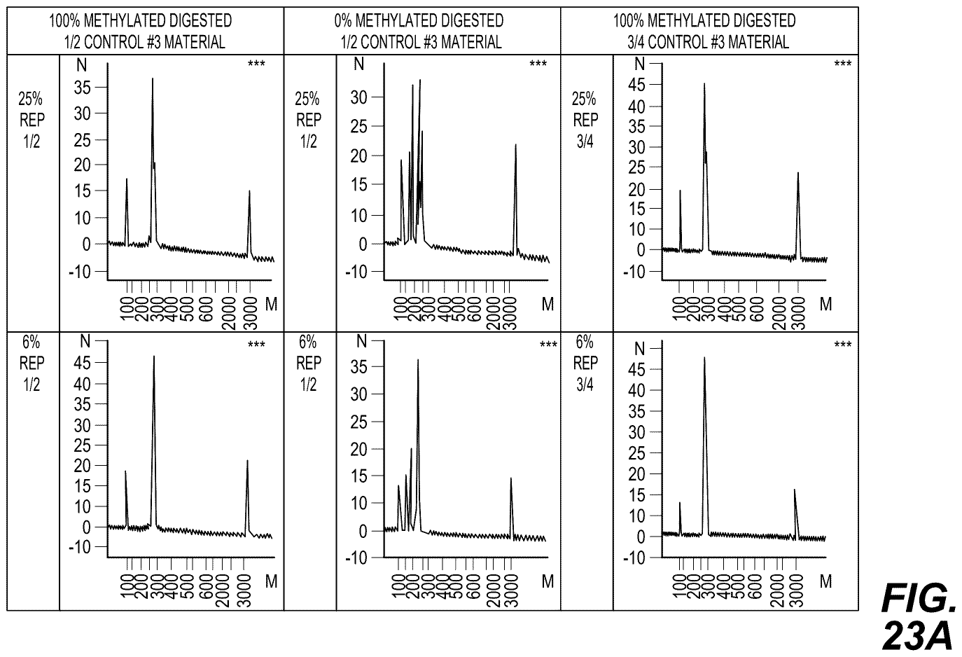

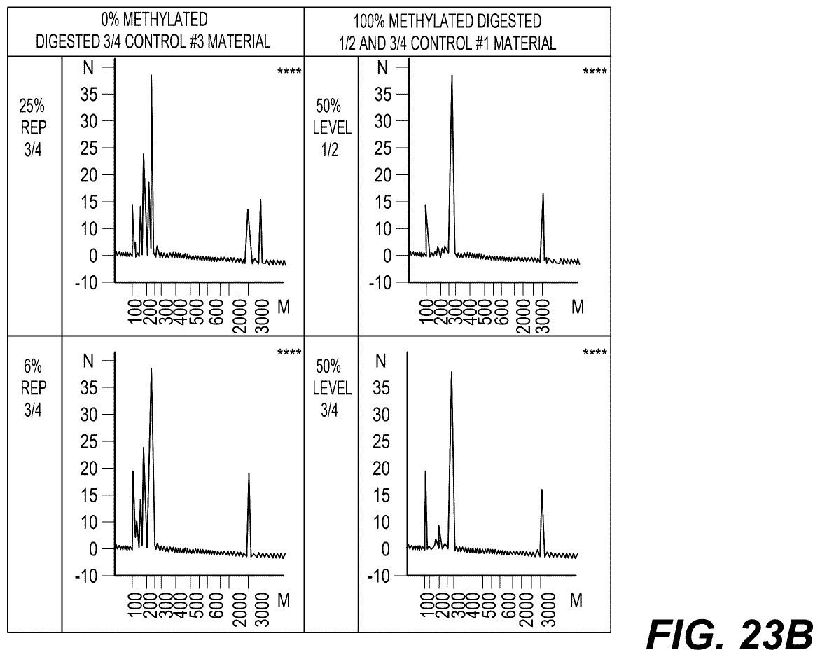

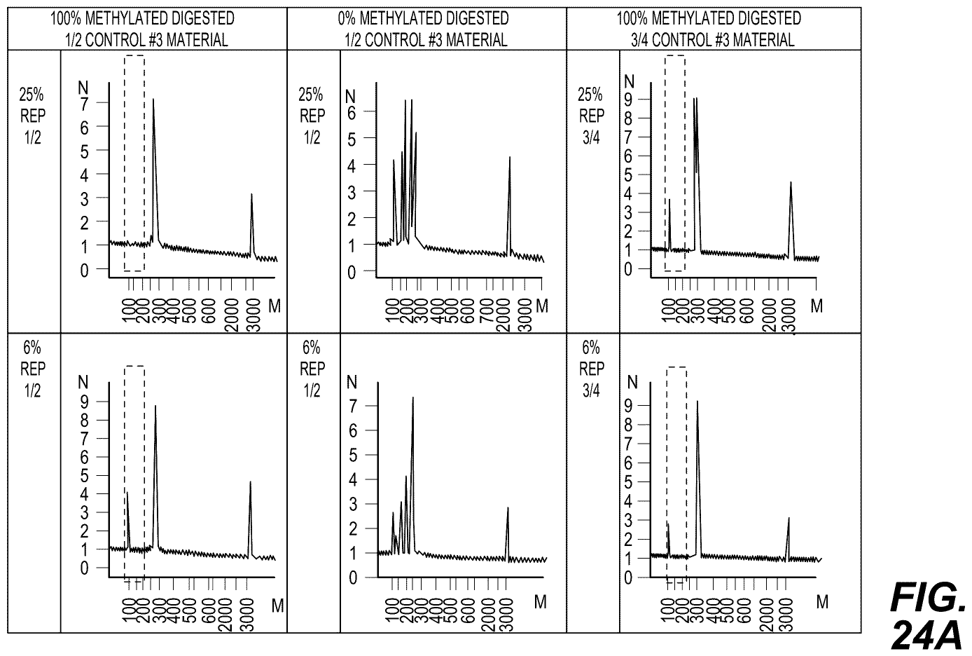

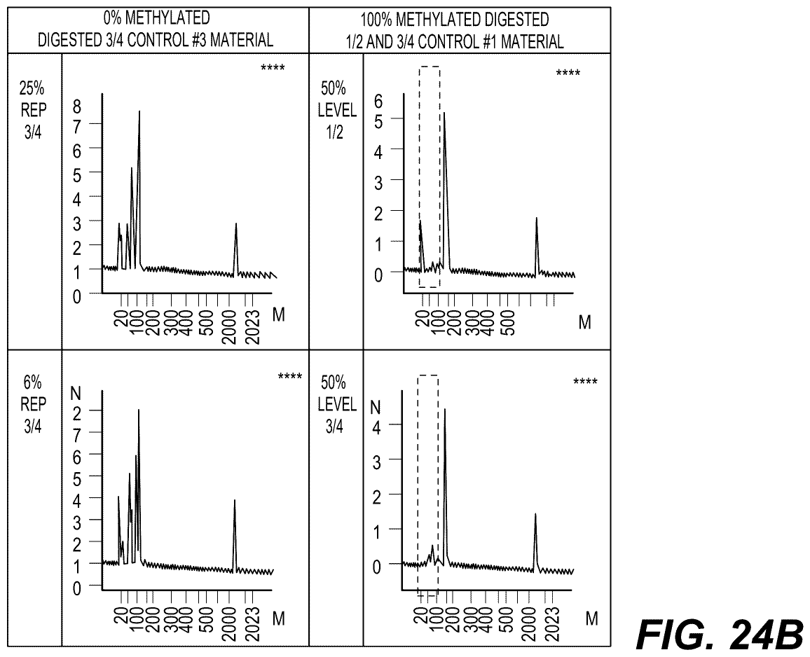

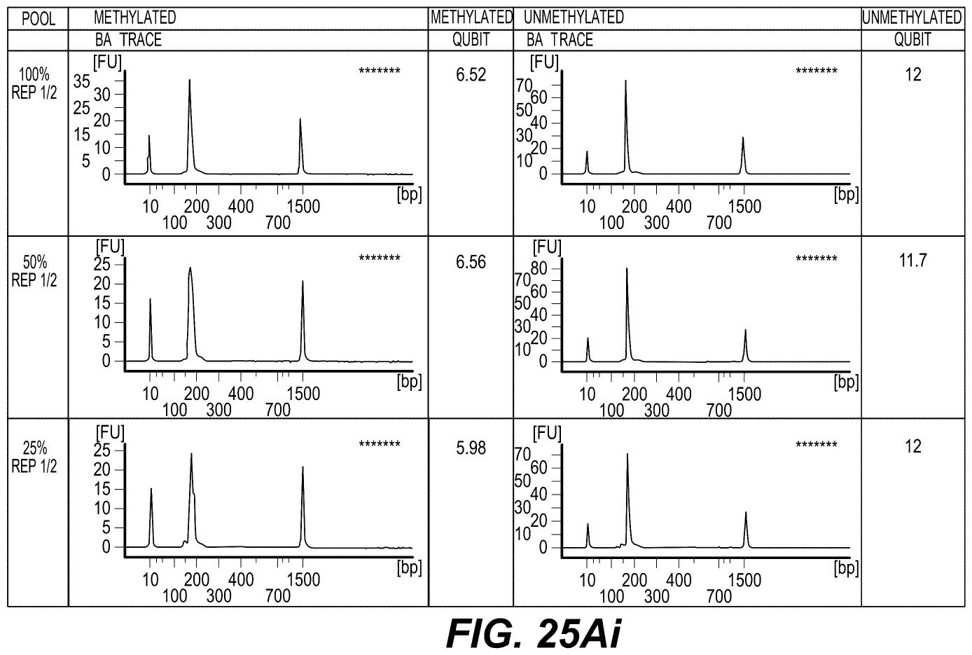

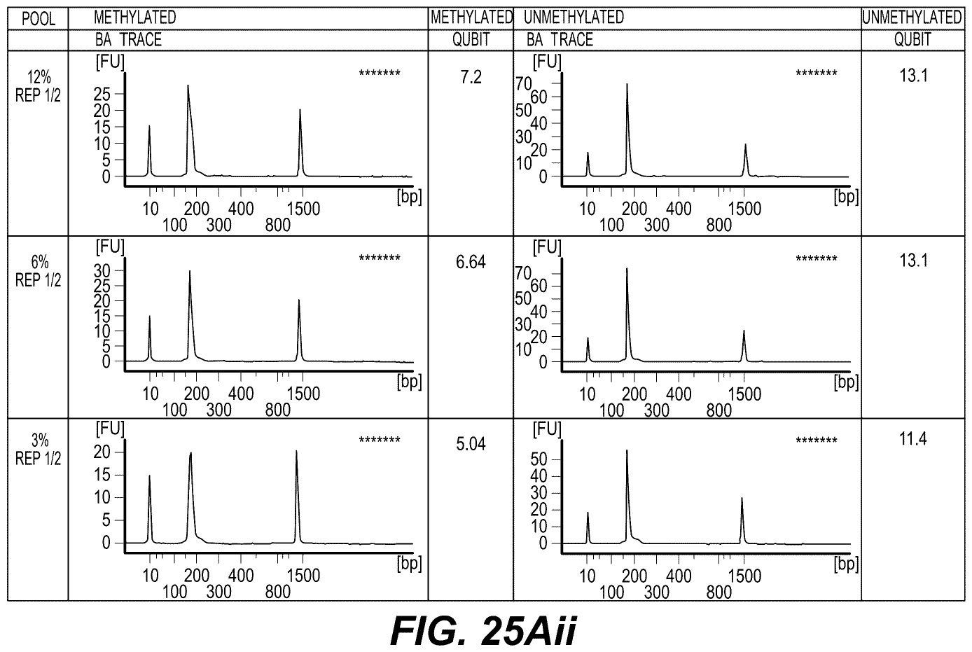

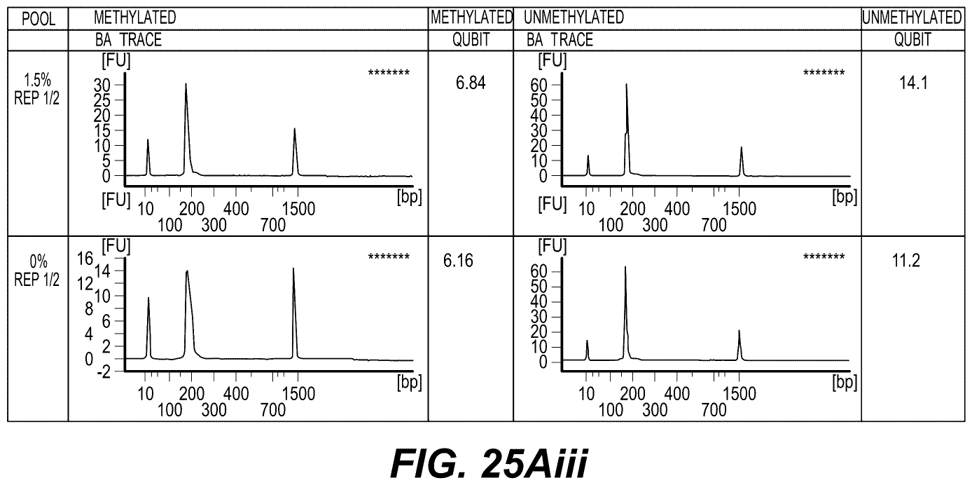

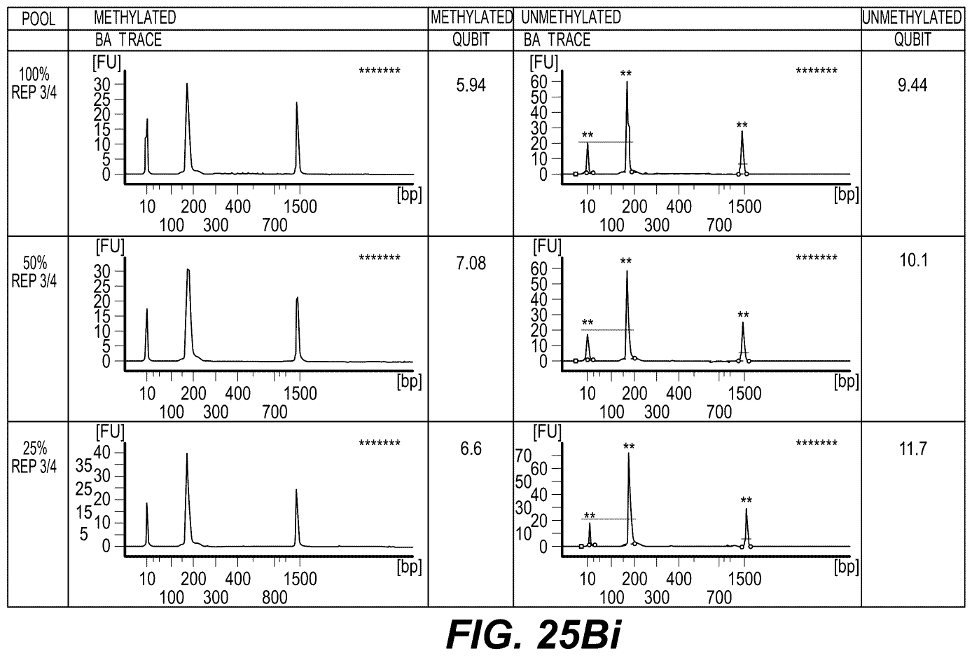

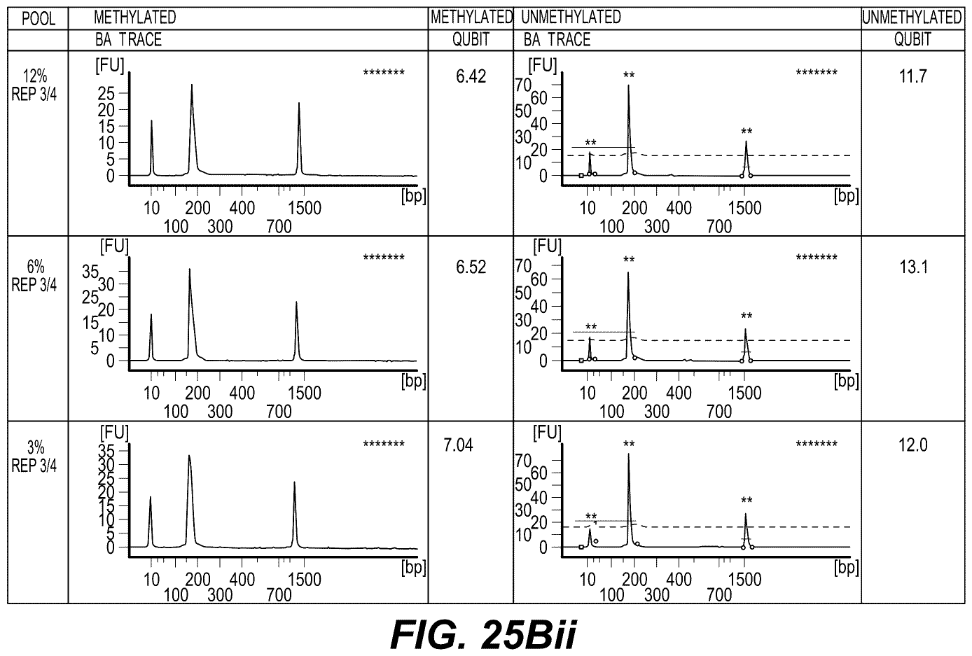

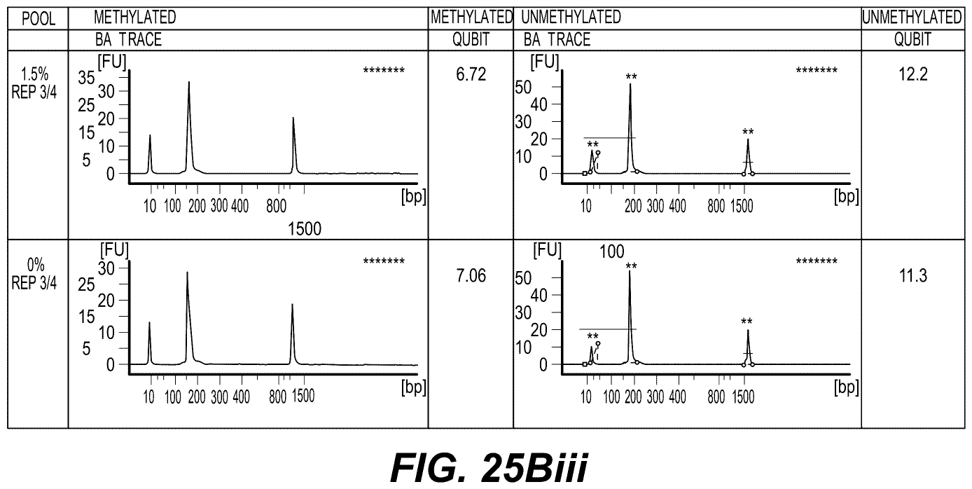

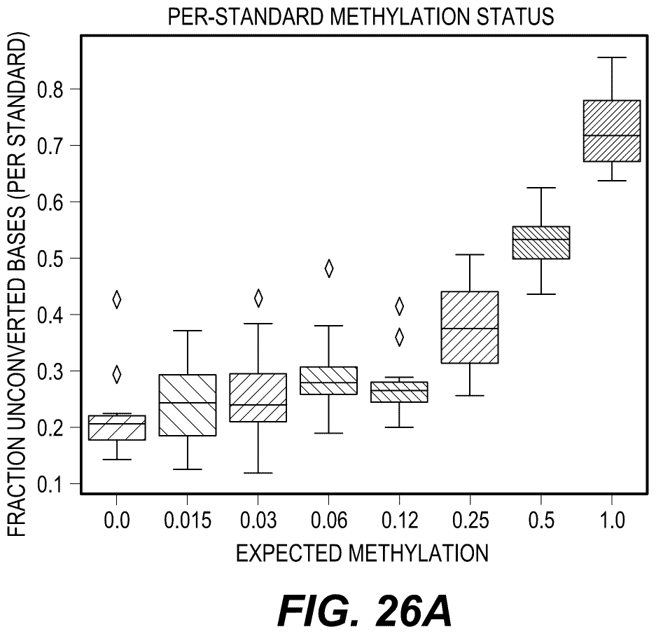

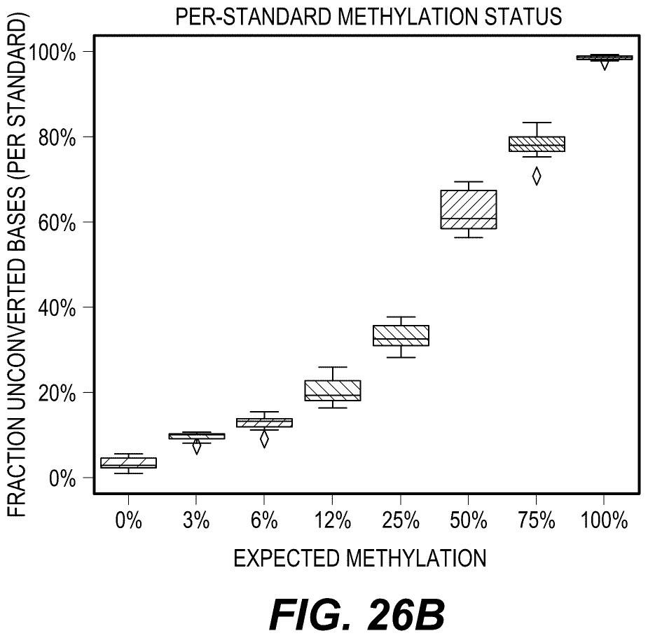

FIG. 21A-25Biii show polynucleotide sizes either with treatment or after digestion with BSMB1, which cuts unmethylated CpG sites. Experimental conditions for the results in FIGS. 21A and 21B and FIGS. 22A and 22B included starting at a primer removal step, adding more SAM in a smaller volume (320 uM compared to 160 uM), which was 20 ul vs 50 ul, and using BsmBI to QC for methylation conversion. Experimental conditions for the results in FIGS. 23A and 23B and FIGS. 24A and 24B included starting at previous methylation attempt, adding 3× more enzyme in larger volume with 160 uM of SAM, 50 ul, and 12 units vs 4 units of enzyme, and using BsmBI to QC for methylation conversion. FIGS. 25Ai-25Biii further shows methylation control results with BA traces of final product prior to pooling as well as Qubit concentration of final concentration of the final product prior to pooling. FIGS. 26A and 26B show the fraction of unconverted bases versus expected methylation levels for polynucleotides in the library from a previous amplification round attempt (FIG. 26A) versus current amplification round attempt (FIG. 26B). These results showed the fully methylated control matched expectations and the overall variability between the standards was much lower. Additionally, the total methylated fractions did skew a little high, where 50% methylated sequences were closer to 60% on average.

The conditions for the controls based on these studies were as follows. The final concentration was at 0.88 pg/ul with 48 unique sequences per control at 8 total levels of methylation: 0%, 3%, 6%, 12%, 25%, 50%, 75%, and 100%. All sequences had 1 BsmBI site and were expected to have the expected numbers of CpG sites (2, 8, or 18). No sequence had a homopolymer ≥3 and all sequences had GC contents between 39-67%. All sequences had pairwise hamming distances of at least 100 from each other and nothing BLASTs to either nr or the human genomic+transcript.

### Example 16: Methylation Control Design and Quality Control

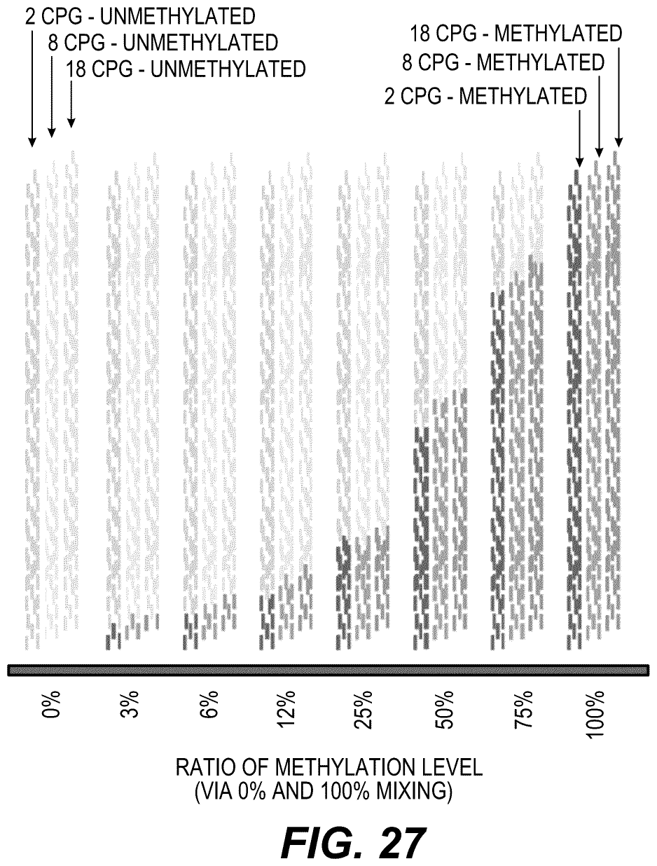

Following the general procedures of Example 15, methylation library standards were prepared. Methylation controls were carefully designed to enable accurate methylation calling in cfDNA samples. Sequences were chosen to be cfDNA-like in length (˜170 bp) and distinct from each other and any sequence in the non-redundant (nr) database. A total of 48 different sequences were present, representing: 8 methylation levels (0%, 3%, 6%, 12%, 25%, 50%, 75%, and 100%), 3 levels of CpG sites per molecule (2, 8, or 18 CpG sites per molecule), and 2 replicate sequences for each combination of methylation level and CpG site number. All sequences were also designed to have a GC content similar to the human genome and to avoid stretches of homopolymers. As shown in FIG. 27, specific methylation levels were achieved by mixing fully methylated and unmethylated populations of the same sequences.

Methylation control preparation comprised several distinct processes. An exemplary methylation control workflow is provided in FIG. 28. Pools of controls were first made based on methylation level, mixing the low, medium, or high CpG site sequences that corresponded to that methylation level. This ensured that ratios of the different CpG site numbers were consistent in the final pool. After this first pooling, sequences were methylated and mixed with untreated material, resulting in the different methylation levels shown in FIG. 27.

Two quality control (QC) measures were performed to guarantee performance of the methylation pools. During the design process, a BsmBI digestion site was added to each unique sequence. A small volume of the sequences designated as 0% methylated and 100% methylated were taken prior to the second pooling and a BsmBI digestion was performed. BsmBI did not cut when the CpG in its recognition site is methylated (e.g., FIG. 16). Therefore, this digestion was done to confirm the methylation step generated fully methylated material prior to pooling the different methylation levels. Once the pools were finished, next-generation sequencing (e.g., enzymatic methyl--seq) of the methylation controls was completed to ensure that pooling and methylation levels were correct.

### Example 17: Methylation Detection System

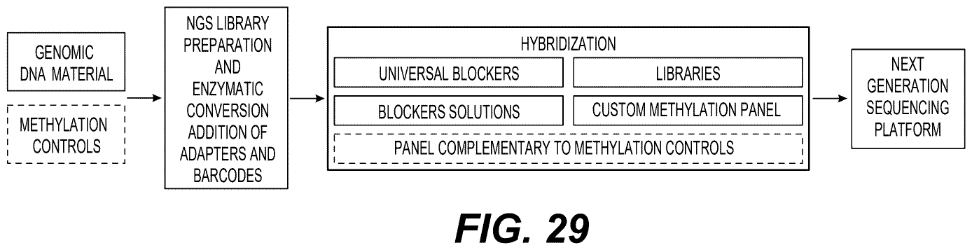

Methylation controls generated following the general procedures from Example 16 were used in conjunction with a methylation detection system. The methylation detection system included target enrichment. The methylation controls were added to sample gDNA prior to library preparation. Target enrichment was then performed using a panel that combined probes designed against user-defined targets and methylation control targets (e.g., FIG. 29).

Conventional library preparation protocols convert unmethylated cytosines to uracils using bisulfite, which causes unwanted DNA breaks that complicate downstream sample preparation and, ultimately, methylation detection. Here, a NEBNext Enzymatic Methyl-seq (EM-seq) kit was employed as part of the methylation detection system. This process accomplished the same conversion results as bisulfite treatment without the harshness of chemical conversion, yielding a superior end result.

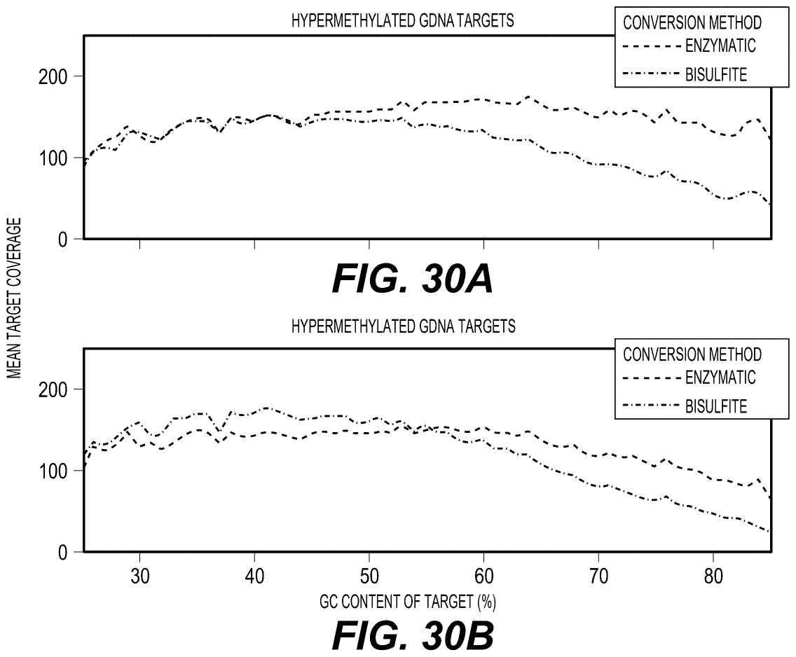

Compared to chemical bisulfite conversion, enzymatic conversion with the NEBNext EM-seq kit resulted in high-quality DNA libraries with improved yields and longer insert sizes, each of which helped to maximize sequencing and mapping efficiency. Further, bisulfite treatment was harsh to GC-rich DNA targets since conversion took place at unmethylated cytosines. This resulted in reduced coverage at high-GC target regions that were of interest in methylation sequencing applications. The gentle approach taken by enzymatic conversion resulted in more uniform coverage across targets of varying GC content without sacrificing methylation detection sensitivity (FIG. 30).

Target enrichment can generally occur before or after library conversion. While post-capture conversion can simplify probe design, this approach can require large amounts of DNA input since PCR amplification may not preserve DNA methylation or take place before conversion. Therefore, pre-capture conversion is generally the preferred approach, especially for low-input applications of methylation sequencing, such as cell-free DNA.

### Example 18: Methylation Calibration, Quantification, and Analysis

Methylation sequencing experiments can be inherently challenging, as experimental variation in conversion can confound the results and produce false positives. By using an inline methylation control, these confounding effects can be detected and even potentially corrected. The methylation controls obtained following the general procedures from Example 16, in combination with the methylation detection system as generally illustrated in Example 17, were used to calibrate methylation levels and identify patterns using methylation-based hybridization assay technology.

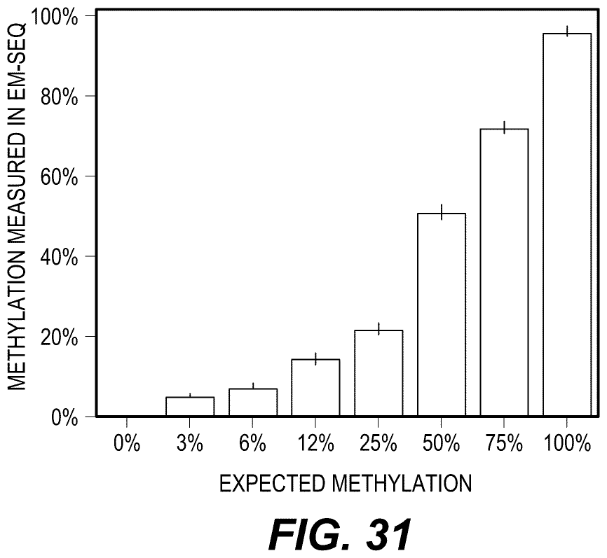

To test these controls, 1 μL of control was added to 200 ng of gDNA input (NA12878, Coriell) and the NEBNext EM-seq kit was used for library preparation. Target enrichment was performed using 200 ng of library, a 65° C. Fast Wash 1 Buffer temperature, and 2-hour hybridization reactions. A methylation control complementary panel was used as a spike-in during the hybridization process. Sequencing was performed with the Illumina NextSeq platform and 151 bp paired-end reads were obtained. Data was down-sampled to 150× aligned coverage relative to probe territory and analyzed with BWA-meth/MethylDackel and Picard HsMetrics. Measured and expected percent methylation levels were compared (FIG. 31) to determine if the expected and observed methylation levels matched.

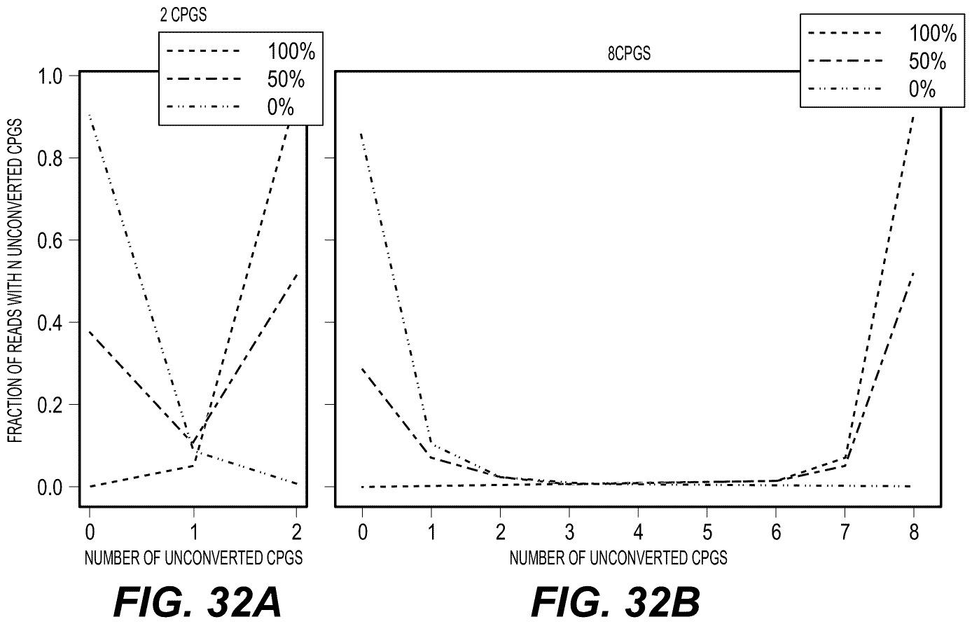

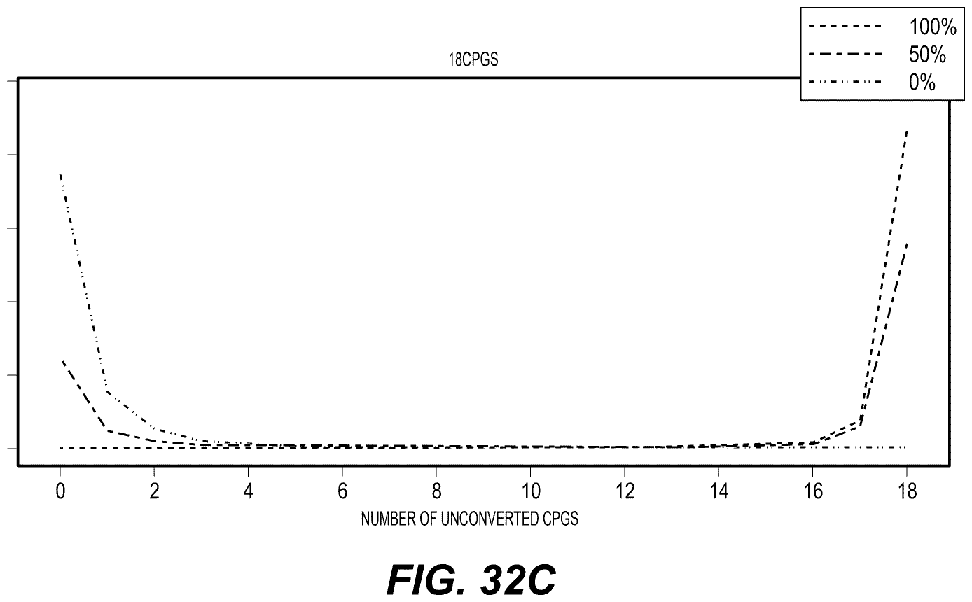

The standards were produced as either fully methylated or fully unmethylated molecules and then pooled to the desired fractions. Therefore, individual sequences were expected to show a bimodal distribution of sites by methylation state. This is what was observed (FIGS. 32A, 32B, and 32C), with the vast majority of sequences being either fully methylated or fully unmethylated.

Three methylation aligners (Bismark, Bwa-meth, and BsMapz) and two methylation callers (BsMapz and MethylDackel), as shown in in FIG. 33, were then evaluated as part of an analysis workflow. Components were evaluated or performance and efficiency on a contrived dataset with known methylation states. On the basis of these metrics, Bwa-meth and MethylDackel, was selected for alignment and calling, respectively.

The pipeline used for analysis is generally illustrated in FIG. 34. The workflow comprised read processing to down-sample and remove adapters, followed by alignment (using Bwa-meth) and methylation state calling (with MethylDackel). Sequencing and enrichment metrics were collected using Picard to evaluate the success of the target enrichment portion. Plotting was done with custom Python scripts.

The results demonstrated the importance of methylation patterns as a component of the cancer detection toolbox. The methylation spike-in controls and the methylation detection system provided herein can be used to aid the accurate quantification of methylation states, serving as useful process controls for methylation applications.

### Example 19: Use of Methylation Standards

Following the general procedures of Example 15, methylation library standards were prepared. The libraries are each mixed with known background donor libraries, and analyzed for methylation content. Results from the standards are compared with data obtained from human clinical samples suspected of having methylations associated with a disease or condition. Use of the standards results in higher confidence for diagnosis and confirms the diagnostic instrument is performing within specifications.

### Example 20: Design and Synthesis of CNV Standards

Diagnostic assays of liquid biopsies hold great promise for cancer detection and reducing the burden of the disease on patients. To aid the advancement of this technology, cfDNA mimic reference material with varying allele frequencies of synthetically-printed single nucleotide variations (SNVs), insertion-deletions (INDELs), and structural variants (SVs) are disclosed herein. However, many cancers are characterized by duplicate copy number variants (CNVs) of genes that support growth and survival of cancer tissue. To aid assay development for detection of copy number variants, a CNV for the exonic regions of the ERBB2 gene (also known as HER2) was designed, synthesized, built, and characterized. ERBB2 is often amplified and overexpressed in invasive carcinomas, including breast, ovarian, stomach, bladder, salivary, and lung cancers, making it a desirable variant to include in a reference material for assay development.

A cfDNA cancer panel targeting variants of ERBB2 was designed and synthesized. The ERBB2 CNV DNA was generally developed to closely mimic the size and content of native ctDNA while providing a wide selection of common and rare cancer targets for analytical validation. It mimics the length distribution of cfDNA, with a peak at 167 bp±5 bp for diversity. The synthetic CNV DNA tiles over the exonic intervals for uniform gene coverage. Variant fragments were printed (Twist Bioscience), quantified, and uniformly pooled followed by spiking into DNA derived from a single, highly NGS-characterized donor as background. The final admixture of ERBB2 was ddPCR-verified for copy number amplification.

### CNV Design

A concern when working with synthetic standard references can be the ability of that reference to mimic the behavior of cfDNA fragments from in vivo samples. To address this issue, the existing pan-cancer reference standard may be designed to maintain a narrow size distribution of DNA fragments around 167 bp, which can mimic native cfDNA from blood plasma (see for example, Udomruk S. et al., Size distribution of cell-free DNA in oncology. Crit Rev Oncol Hematol. 2021, incorporated herein by reference in its entirety). Similarly, the same conditions and tiling strategy were applied to the development of a novel CNV Spike-in as the oligos in the Pan-Cancer Reference Standard, but with much deeper coverage of ERBB2 and existing alleles in the HG38 genomic reference.

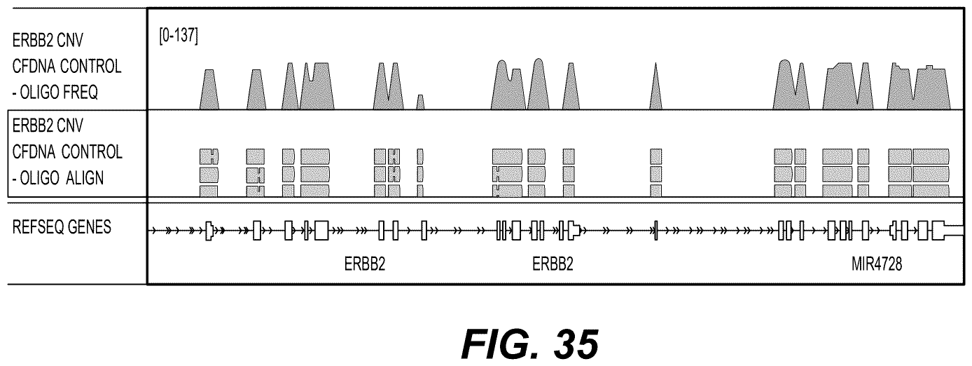

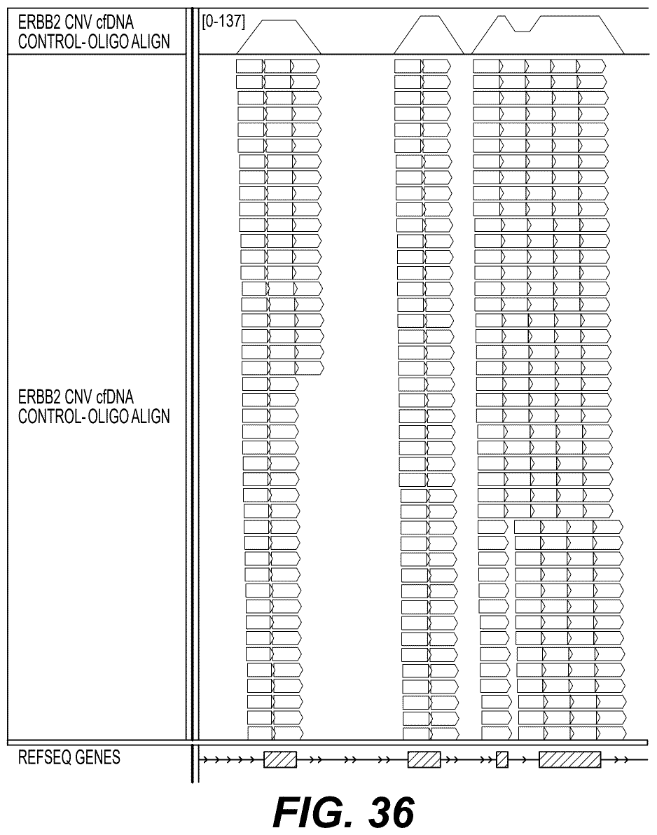

To evaluated the ability of DNA printing technology to generate a novel CNV standard, the sequence of ERBB2 was targeted due to its role in a large variety of cancers and as a target of directed therapies. A coding sequence of ERBB2 gene model listed in the MANE gene model from ENSEMBL was used to design a cfDNA CNV reference standard. The entire 3,965 bp of the coding sequence was tiled using 167 bp oligos with a total of 1,097 probes (FIG. 35). To ensure even and deep coverage of all bases within the exon, the design extended some coverage over inter-exonic bases adjacent to the coding region. After standard filtering and post processing, a total of 3,906 bp of the coding region was covered within the design with each base covered at a depth of over 120 unique oligos (FIG. 36).

Oligos were printed using a silicon chip writer resulting in a pool oligos with an average length of 167 bp+/−5 bp. These pools of short oligos were diluted and spiked into a pan-cancer 5% VAF reference standard at a concentration of 15× genomic equivalents of ERBB2 for testing and quality control.

### CNV Uniformity Design

When adding a high concentration of a single gene with few oligos into an existing panel, it can be important to ensure that these fragments behave similarly under standard molecular protocols. While fragment size and design were similar to a pan-cancer reference standard, there was a possibility of aberrant behavior due to the relatively high concentration of a single locus.

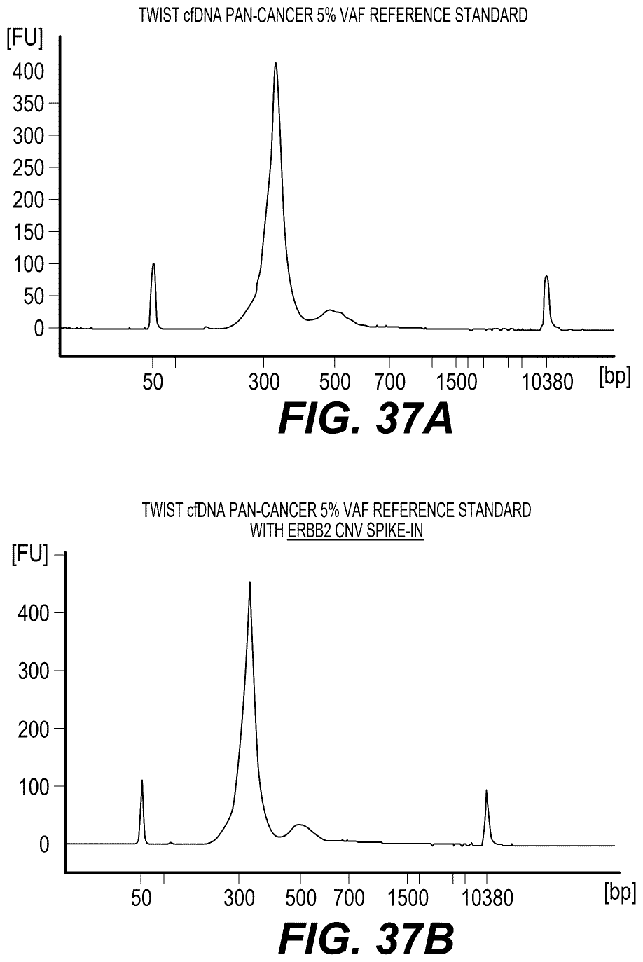

ERBB2 CNV Spike-in chemically and synthetic cfDNA fragments found in the existing pan-cancer reference standard were evaluated for reactivity. Illumina short-read DNA sequencing libraries were constructed with and without the ERBB2 CNV Spike-in. BioA traces of the sequencing libraries with a 5% VAF Reference Standard in conjunction with UMI Adapters showed no aberrant spikes or unrelated peaks (FIG. 37). Thus, the CNV reference standard mimicked natural cfDNA and functional to be added directly into established and developing cancer detection protocols.

### Increased CNV Raw Abundance

Successful detection of CNV variants can rely on accurate and sensitive detection of gene copies above background relative to the number of genome equivalents. A generally well-accepted method of CNV detection is the use of quantitative PCR, including digital droplet PCR (ddPCR), using a single copy reference gene to normalize copy number.

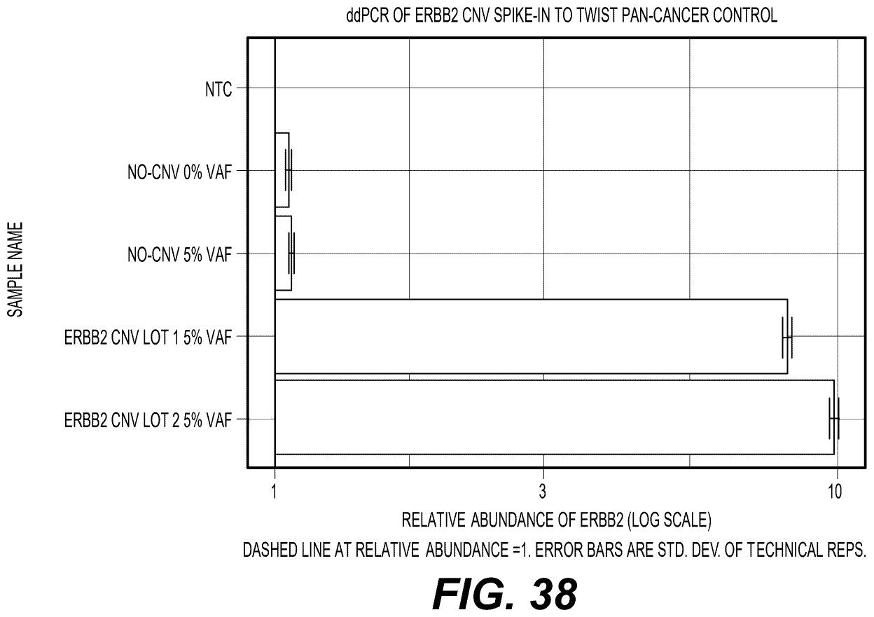

The ERBB2 CNV reference standard developed herein was evaluated against the existing pan-cancer reference standard with 0% and 5% VAF using BioRad's ddPCR Copy Number Assay for ERBB2. The assay used a small section of ERBB2 exon 21 and EIF2C1 as a reference for genomic copy number. Amplification of ERBB2 exon 21 showed approximately the same concentration of ERBB2 fragments with just over I genomic equivalent in both the 0% and 5% Pan-Cancer Reference Standard. Comparatively, two separate dilutions of the ERBB2 CNV Reference standard showed over an 8-fold enrichment of genomic equivalents relative to background (FIG. 38). This illustrated that the CNV design was successfully used to standardize accurate CNV detection.

### Coverage of ERBB2 CNV

While qPCR detection assays are generally considered the gold standard for detection of individual CNV loci, sequencing-based assays (NGS) can be developed to detect multiple cancer-diagnostic loci, including SNPs, INDELs, and CNVs. To evaluate the ERBB2 CNV reference standard in an NGS assay, three libraries of the NGS control and two libraries of the ERBB2 CNV Spike-in using an UMI adapter system were sequenced.

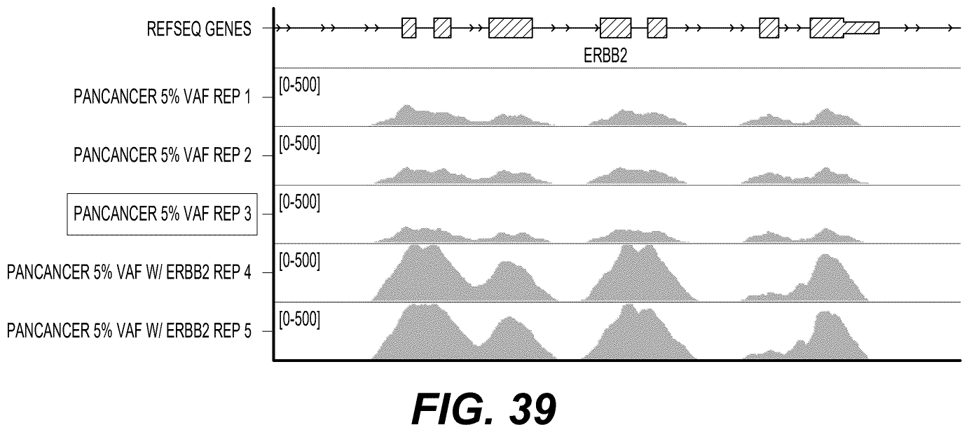

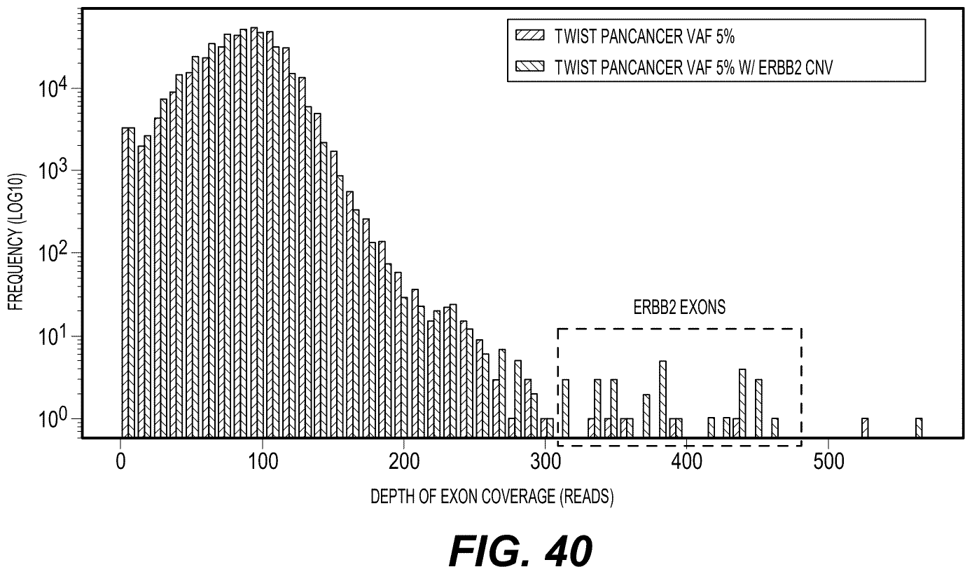

The ERBB2 CNV Standard Reference showed superior sequencing depth without sacrificing coverage. Both the native cfDNA Pan-cancer 5% VAF Reference Standard samples and samples with the CNV spike-in showed full coverage of all exons that were designed within the ERBB2 coding sequence. However, all exons in samples with the ERBB2 CNV Spike-in showed 3-5× increased depth of sequencing over the native cfDNA Pan-cancer 5% VAF Reference Standard (FIG. 39). Additionally, a frequency histogram regarding depth of coverage for all targeted exons within the exome panel showed a slight increase in the representation of the 24 Exons of ERBB2 exons, with deep coverage (>300 reads) observed relative to all other targeted exons (FIG. 40). These results indicated that the CNV Standard reference served as a predictable reference for development and detection of diagnostic CNVs.

### Proportion of ERBB2 CNV Relative to Background

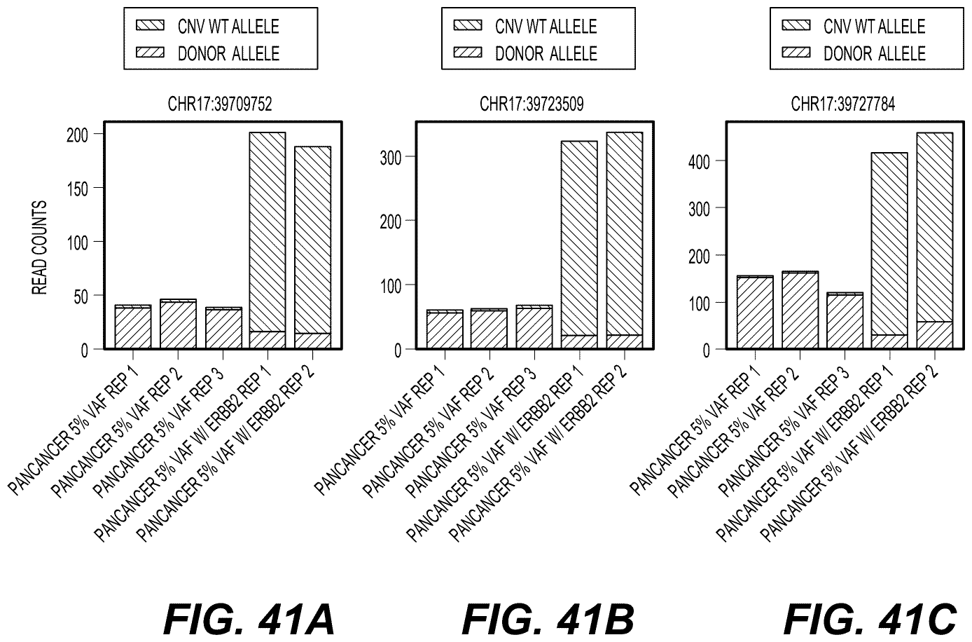

As shown and described by FIG. 38 and FIG. 39, both ddPCR and NGS TE assays detected the presence of the synthetic ERBB2 cfDNA spiked in to the 5% VAF Pan-Cancer Control. Despite this positive result, the relative abundance of the amplification event observed in the assay resulted is lower than the targeted 15-fold amplification level. These results highlighted the importance of assay selection and optimization for the detection of genomic variants as neither the assay were optimized for the quantitative detection of the ERBB2 copy number event. In the case of the ddPCR assay, an off-the shelf, validated probe-set targeting ERBB2 copy number alterations was selected for analysis. It was discovered post-analysis that the reverse primer of the ddPCR amplicon lied within a region of reduced coverage depth in an intergenic region between exon 21 and 22 of ERBB2. This sub-optimal probe design resulted in a deflated estimate of the relative abundance of the contrived copy number event. However, the proportion of background ERBB2 SNPs from the donor relative to the number of wild type (WT) alleles from the synthetic CNV spike-in was used to assess the quality of enrichment more accurately over the background within the NGS data. Using three SNPs from the donor background (chr17:39709752, chr17:39723509, and chr17:39727784), a dramatic increase in the number of NGS reads was observed covering that SNP (FIG. 41). Relative to the pan-cancer reference standard samples, samples containing the synthetic ERBB2 CNV Spike-in showed a 3.85× increase in enrichment of ERBB2. However, the number of raw reads containing the donor SNPs at these positions in the ERBB2 CNV spiked-in samples were much lower than that of the stock the pan-cancer reference controls. Without being bound by theory, this was likely due to the saturation of ERBB2 probes contained within the standard protocol for exome panel used for target enrichment. When looking within the ERBB2 CNV Spike-in samples, an average enrichment of 12.6× reads was observed covering the ERBB2 CNV allele over the background donor SNP. Thus, a more accurate estimate of CNV enrichment was achieved when normalizing to the number of background reads from the donor.

### Materials and Methods

A CNV reference standard of ERBB2 was designed using design approaches to tile the exonic regions of the ERBB2 gene with reference sequences. The design was printed on a silicon DNA writer (Twist Bioscience), processed through a pan-cancer cfDNA production process, and pooled to equimolarity of oligos. The pooled ERBB2 reference standard DNA was quantified and spiked into a Pan-Cancer Reference Standard VAF 5% (SKU: 104569). Two distinct pools of the ERBB2 copy number variant were produced with a goal of a 15× amplification over the background ERBB2 copies. One sample of the same 5% VAF material with no ERBB2 spike-in was included.

This material was analyzed using two distinct assays (ddPCR and NGS) to test for the abundance, coverage, and quality of the ERBB2 CNV reference standard. Three technical replicates of a native Pan-cancer Reference Standard and ERBB2 Spike-in were used to determine total copy number amplification and sequence enrichment using a BioRad ddPCR™ Copy Number Variation Assay and the EIF2C1 locus as an internal reference. Additionally, these controls and test material were also assayed via target enrichment using a standard capture system (SKU: 105560) with an exome panel (SKU: 104132). Sample concentrations were quantified and quality control was performed via Bioanalyzer HS, pooled, and sequenced on two NextSeq 550 High Output runs with 5% phiX spike-in. Sequence alignments were run using BWA mem, resulting in a mean coverage of 102×.

### Example 21: Pan-Cancer Synthetic RNA Fusion Control

Fusion genes are the result of genomic structural variants that arise when the coding region of two previously independent genes become joined together and can be a major driving cause of cancer development. Many gene fusion events have been classified as clinically-relevant and are targets for both diagnostic applications, such as TMPRSS2-ERG in prostate cancer, and therapeutic applications, such as CD74-ROS1 and EML4-ALK in non-small cell lung cancer. Given the potential clinical benefits of early detection, there is significant interest in developing highly sensitive and accurate diagnostic assays to detect cancer using RNA transcripts of these gene fusions as biomarkers. One potential challenge to the development of these diagnostic assays is the lack of a reliable and renewable gene fusion positive control for use in assay development and analytical validation.

Described herein is a fusion reference material, pan-cancer RNA fusion control, a highly-multiplexed positive control designed to be spiked into a selected RNA background or as a stand-alone positive control. The control provides a wide selection of 80+ common and curated cancer targets for analytical validation and assay development. The synthetic RNAs were designed centered around the known and documented fusion sites with 750 nt of RNA 5′- of and 3′- of the fusion junction and were suitable for both short read sequencing and qPCR experiments. Pooled synthetic fusion RNAs were quantified, pooled and normalized to similar molar ratios, analyzed for uniformity by NGS, and ddPCR′d to establish a highly precise pool concentration. Finally, in fusion detection NGS experiments, over a 90% recall rate of fusion events was observed.

The pan-cancer RNA fusion control was designed to serve as a spike-in or stand-alone positive control and specifically pairs well with a clinically-relevant target enrichment (TE) panel. This control sample positive for RNA fusions can be applied in both qPCR and NGS workflows to validate panel/probe sets, establish limits of detection, and monitor ongoing assay performance. The pan-cancer RNA fusion control was designed for use in detection of a wide array of cancer-associated fusion transcripts.

Fusion Genes. Fusion genes are the result of genomic structural variants that arise when the coding region of two previously independent genes become joined together, such as by a chromosomal rearrangement or duplication event. Due to the large intronic spans in many coding regions of the human genome, many different DNA breakpoints can lead to similar or the same cancer-associated mRNA or protein fusion. Fusion genes can be a major driver of cancer development. While broad genomic instability that can lead to gene fusions is a hallmark consequence on the path of oncogenesis, gene fusions can also be founding causal drivers of cancer. Many gene fusion events have been classified as clinically-relevant and are targets for diagnostic applications, such as DNAJB1-PRKACA in liver fibrolamellar carcinoma, BCR-ABL1 in myelogenous leukemia, and TMPRSS2-ERG in prostate adenocarcinoma.

Additionally, many clinically-relevant gene fusion events are targets for diagnostic and/or therapeutic applications, such as CD74-ROS1 and EML4-ALK in non-small cell lung cancer.

Given the potential clinical benefits of early detection, there is significant interest in developing highly sensitive and accurate diagnostic assays to detect cancer using these gene fusions as biomarkers. Detecting these fusions at the DNA level in some instances is difficult for two reasons: (1) the exact break points are often not known or (2) the exact break points are known to vary. In some instances, the sequencing space (such as for a target enrichment capture panel) is too large to be practically deployed in high-throughput clinical diagnostics. For some applications, RNA-seq is a more efficient sequencing method for discovering fusion events in new samples.

Control design. A potential challenge to the development of diagnostic assays is the lack of a reliable and renewable sample source harboring gene fusions of interest for use as a positive control in assay development and analytical validation.

An RNA control was designed by considering the following: RNA fusion positive controls do not include enough unique fusions to test modern high-throughput assay; RNA fusion positive controls may not precisely document the RNA fusions present in the pool (e.g., with genomic coordinates); RNA fusion positive controls frequently contain contaminating fusion transcripts that are not documented in the product description, potentially leading to false positives.

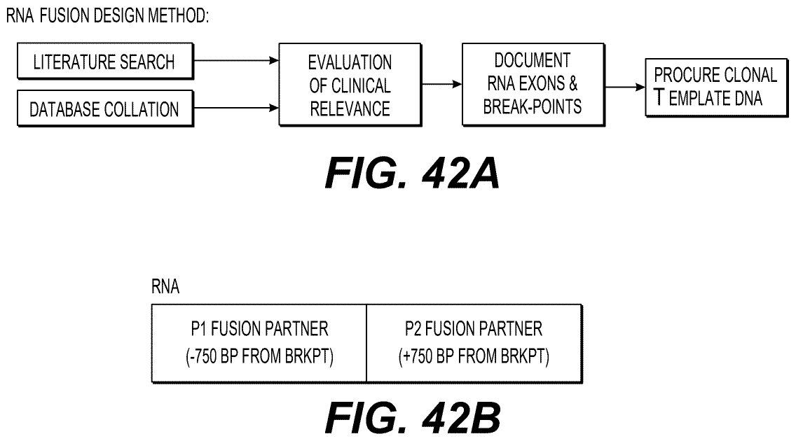

All the RNA fusions within the pan-cancer fusion control were bioinformatically designed and synthetically produced (FIG. 42A). First, the fusion targets to be included were selected by a combination of a literature search curation and collating fusion abundance observations from databases. Next, the fusion constructs were prioritized for inclusion based on their clinical relevance, actionability in diagnostics, or in treatment availability/clinical trial availability. The bioinformatic design unambiguously informs the documentation of the fusions present in the product. Documentation of each fusion contains the left and right HGNC (HUGO Gene Nomenclature Committee), last/first exon number, breakpoints in hg19 or hg38 genomic coordinates associated with it, and additional information where available (e.g., ENSEMBL and Refseq ids). The synthetic fusion RNA products of the control were designed to be uncapped and non-polyadenylated 1,500 nucleotide RNA molecules composed of 750 nt on each side of the fusion breakpoint (where fusion transcript is available, which was in most cases), including UTRs. (FIG. 42B)

Quality control. The RNA fusion controls were quality controlled during their production, both in-line (during production) and as final products. First, all template DNA that served as input to the RNA production was analyzed by NGS to ensure the correct sequence prior to RNA synthesis. Next, post-purification RNA yields were assessed for the individual fusion RNAs. This concentration measurement also allowed for equimolar normalization to be coordinated. Next, once the pool was composed, RNA-seq libraries were prepared and sequenced; coverage, quantitative representation of the fusion sites, and lack of coverage of extraneous sequence were evaluated.

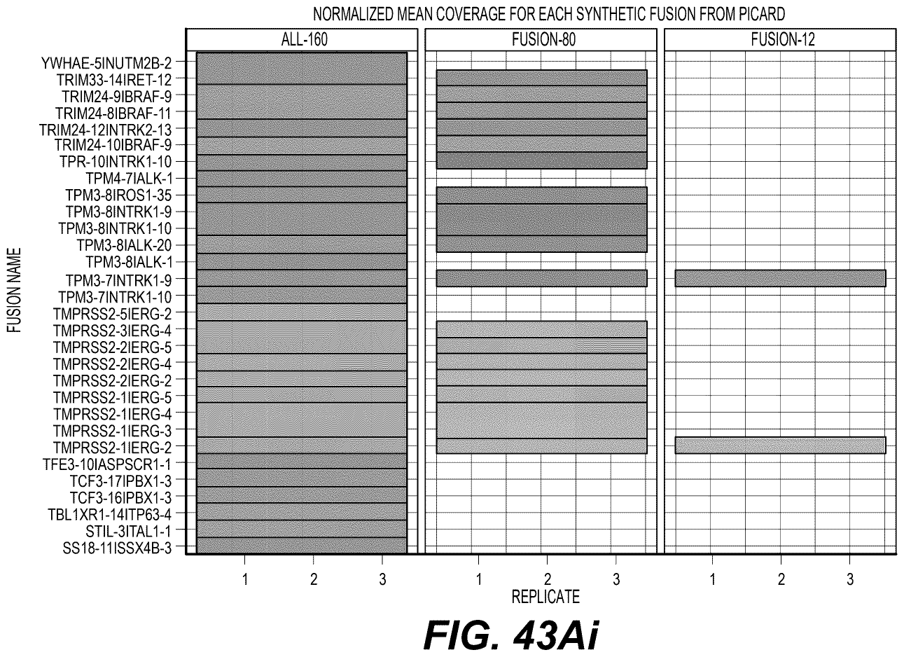

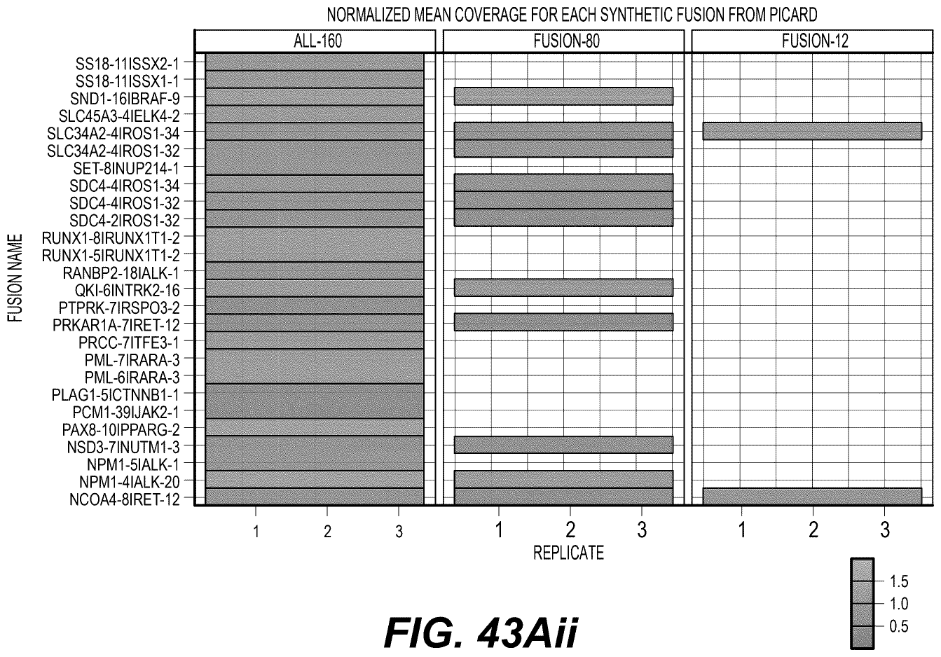

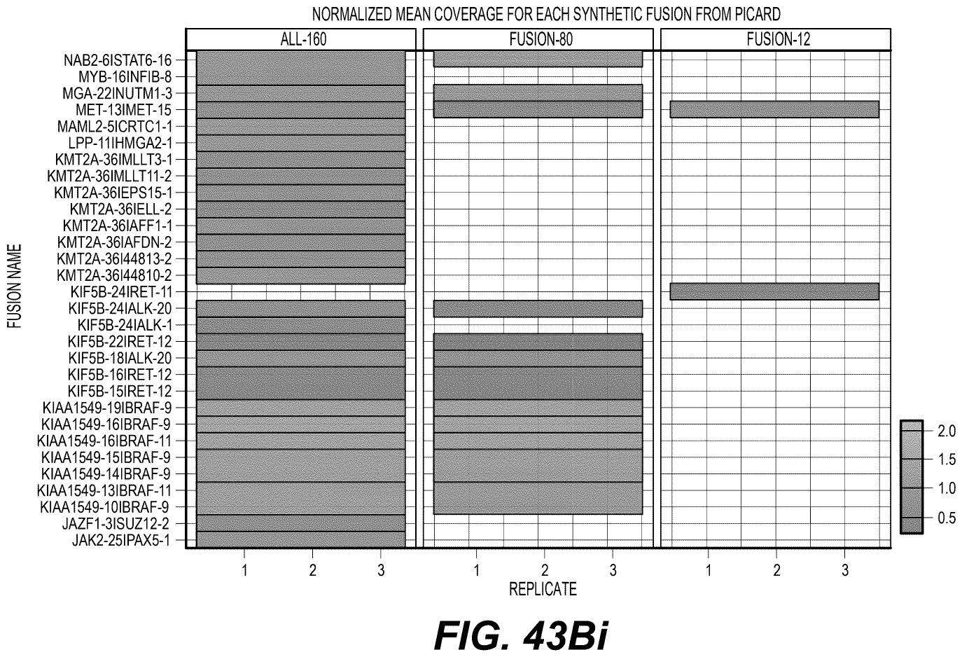

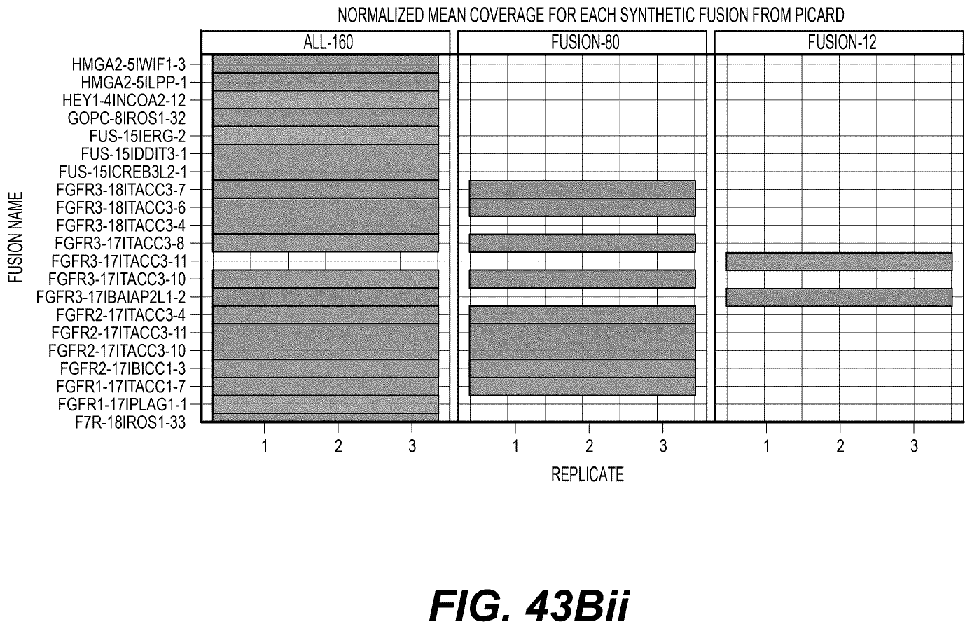

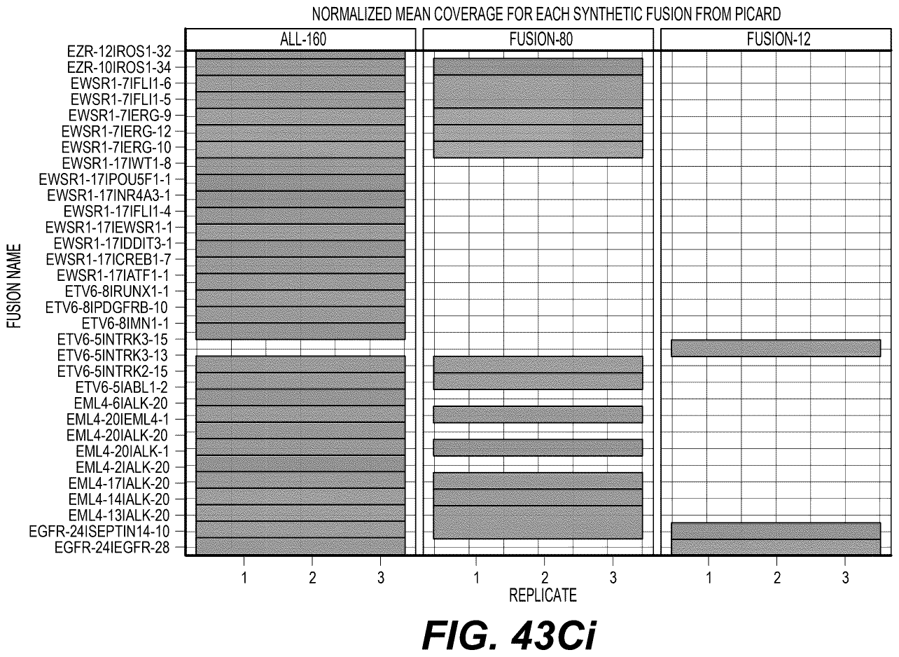

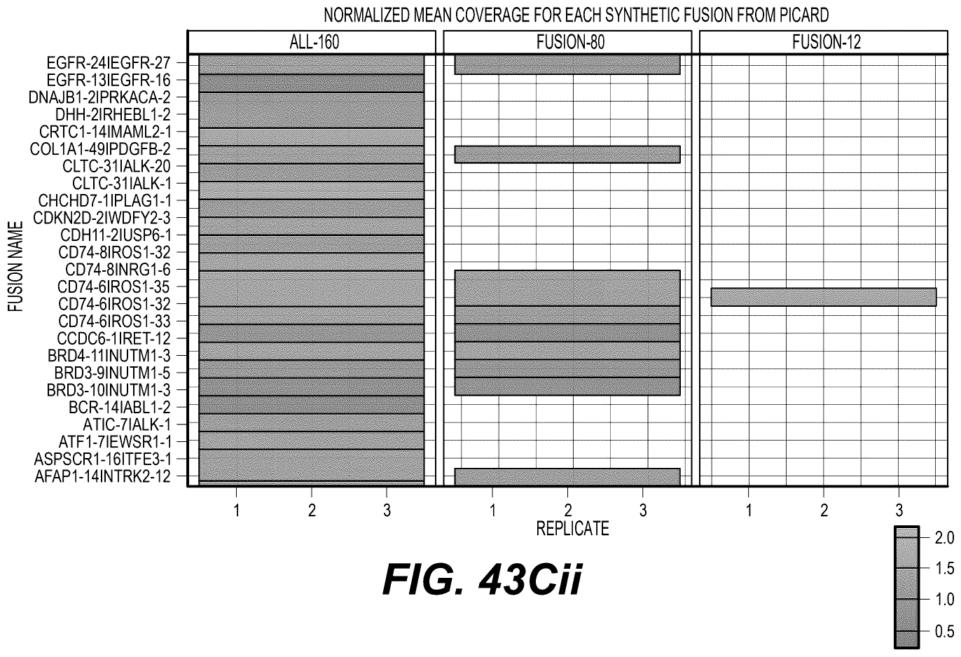

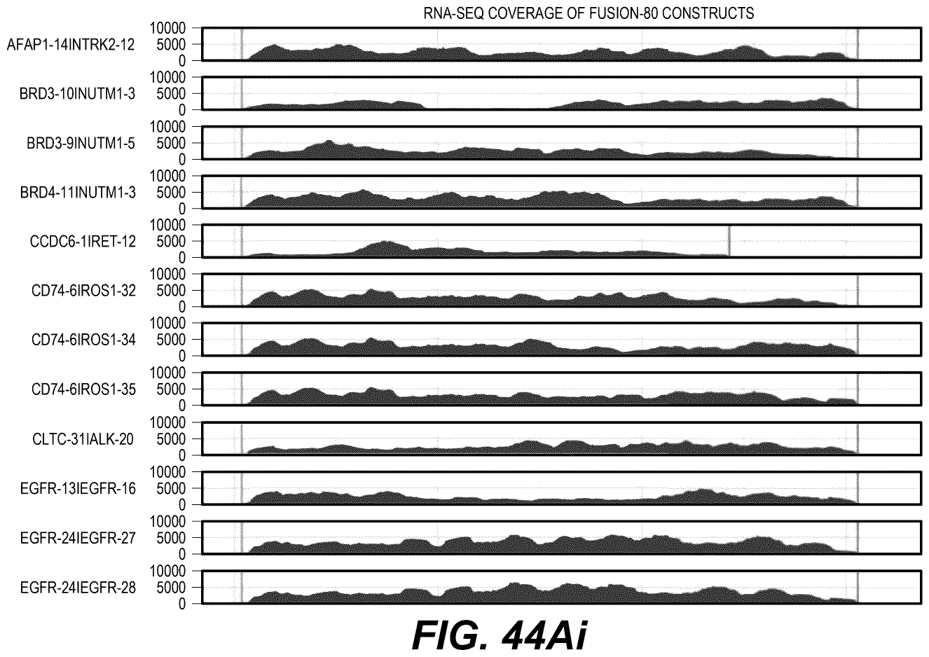

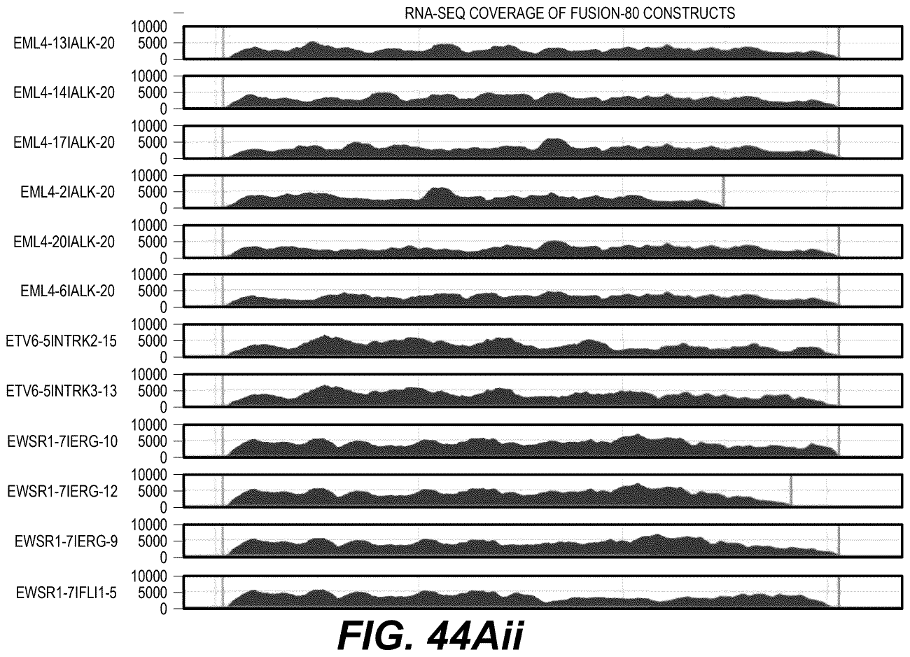

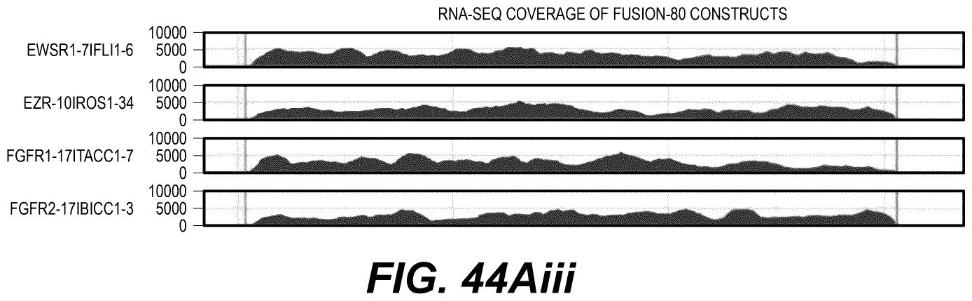

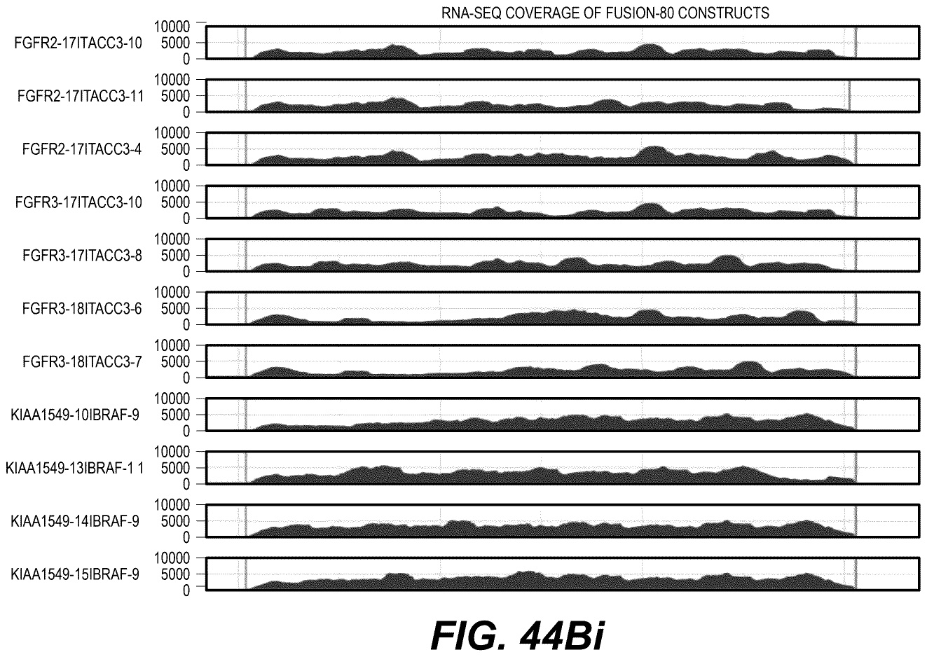

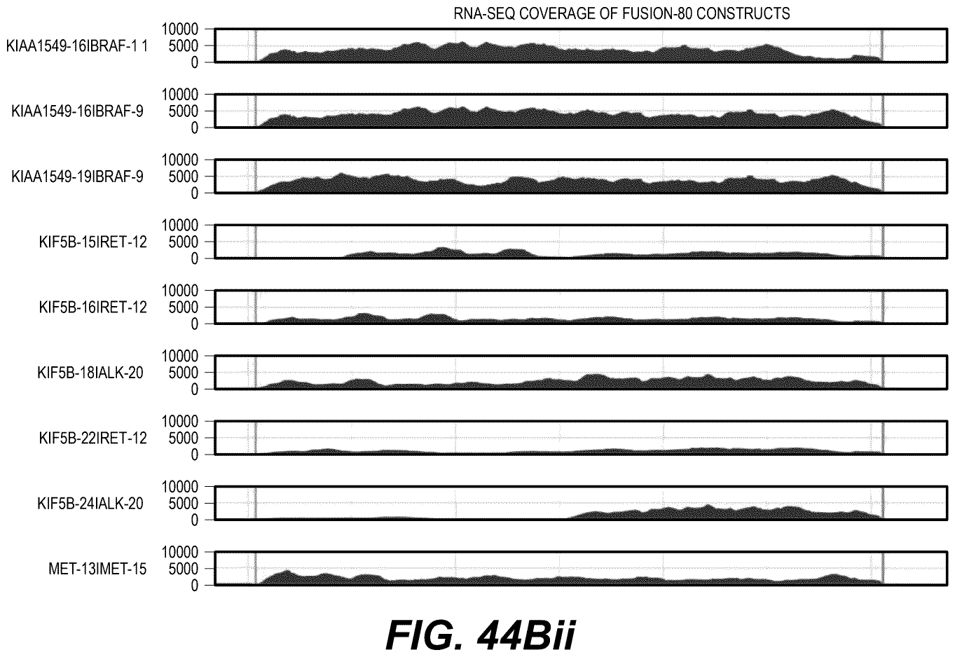

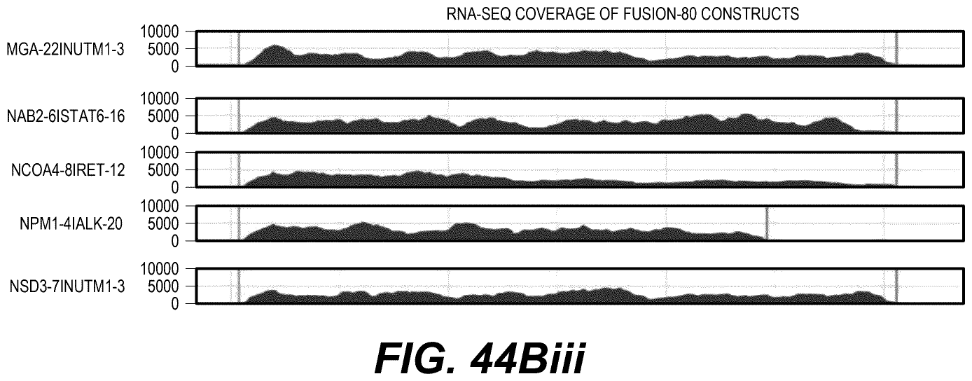

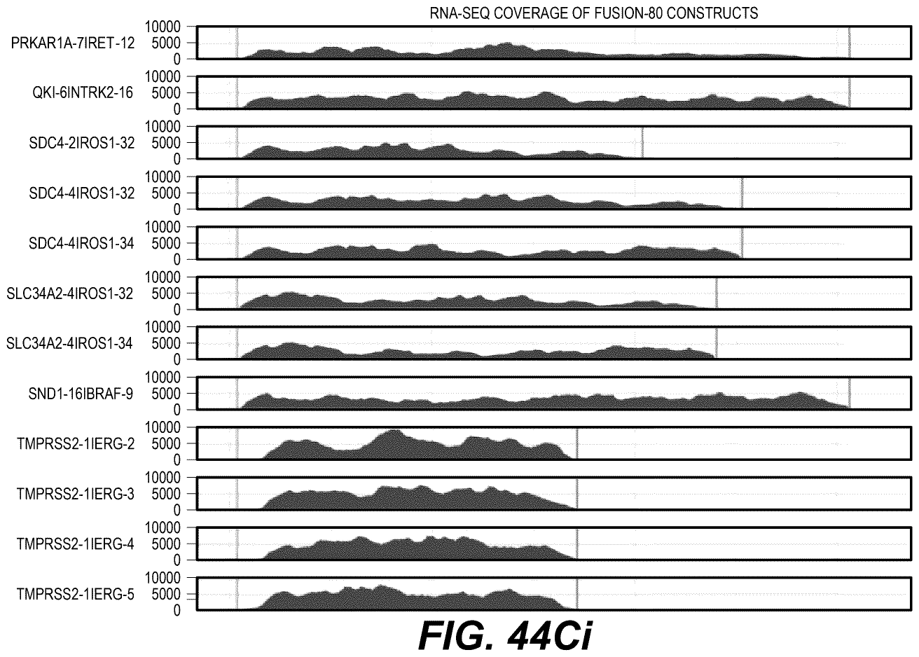

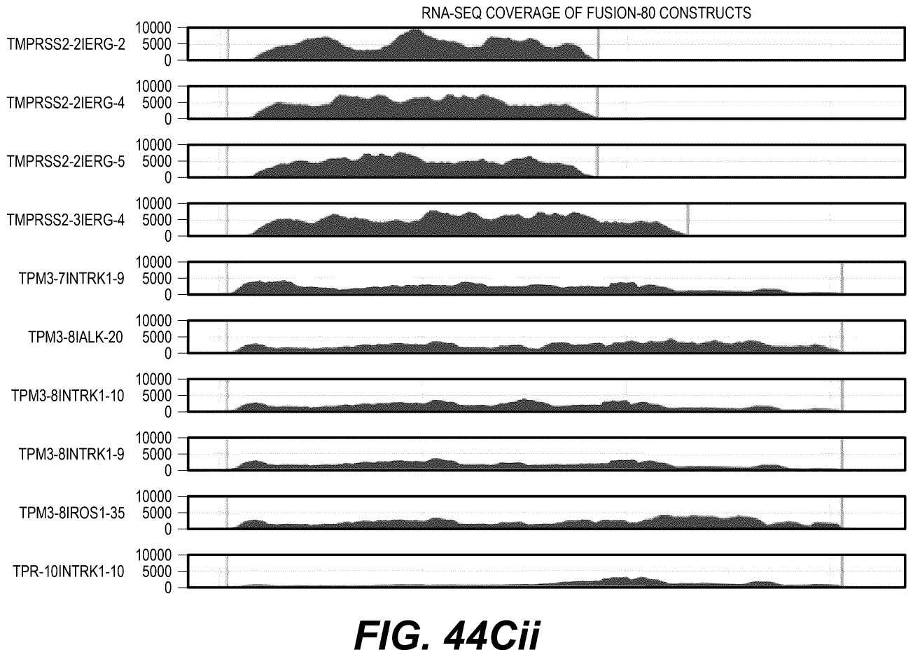

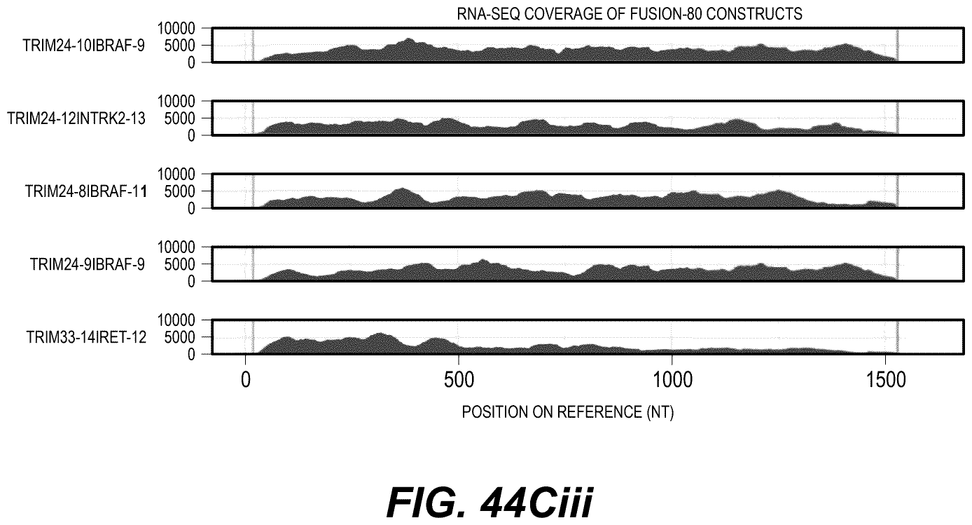

RNA-seq library prep followed by 2×75 paired-end sequencing on an Illumina MiSeq and bwa alignments of the data to the reference templates from which the transcripts were generated indicated that all fusions intended to be present in the control were detected (FIGS. 43Ai-43Cii), and no cross-contamination between configurations was detected. Coverage plots (FIGS. 44Ai-44Ciii) showed that intended transcribed regions are present, whereas regions outside the intended regions were not present. Table 9 below shows recall rates.

TABLE 9

| Sample | n fusions detected | n fusions in config | recall rate (%) |
|---|---|---|---|
| all-160 | 160 | 160 | 100 |
| fusion-80 | 80 | 80 | 100 |
| fusion-12 | 12 | 12 | 100 |

Performance—Dilutions. In order to empirically determine and verify a dilution scheme for the neat pool of fusion RNAs into a background RNA sample, a dilution series in Universal Human Reference RNA (UHR) (Invitrogen, QS0639) in multiple configurations (fusion-12, fusion-80, and fusion-160) was conducted. An RNA-seq library prep kit (with 1000 ng input total RNA) and target enrichment with target enrichment (TE) panel specific for RNA fusions was used. Samples were sequenced on a NextSeq 550 high output kit.

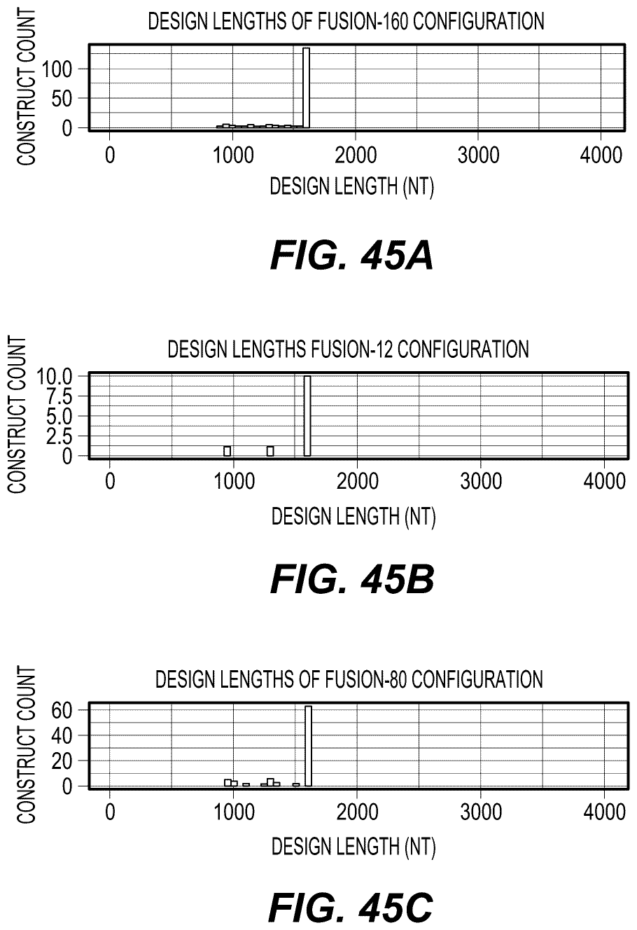

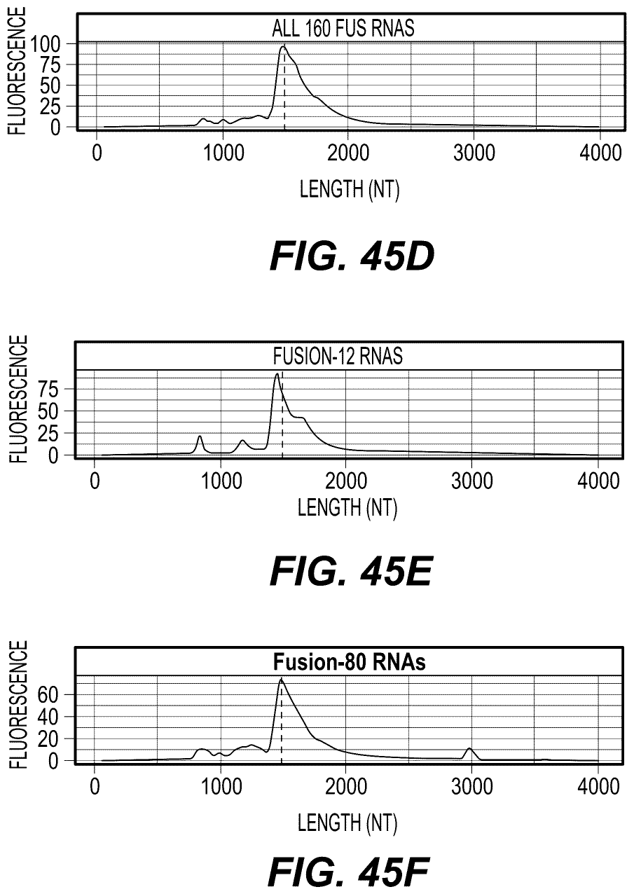

STAR-Fusion was used to detect and quantify fusions (FIGS. 45A-45F) without a priori information of fusion presence/absence or configuration and compared the results to the known construct designs. Additionally, STAR-Fusion results were compared with a direct string search of the exact sequence±15 bp of the breakpoint for each fusion sequence within the raw FASTQ files. STAR-Fusion (Haas 2019) is fusion identifying software that uses the STAR aligner's output of chimeric and discordant reads (and some filtering parameters) to identify fusion RNAs in a complex sample.

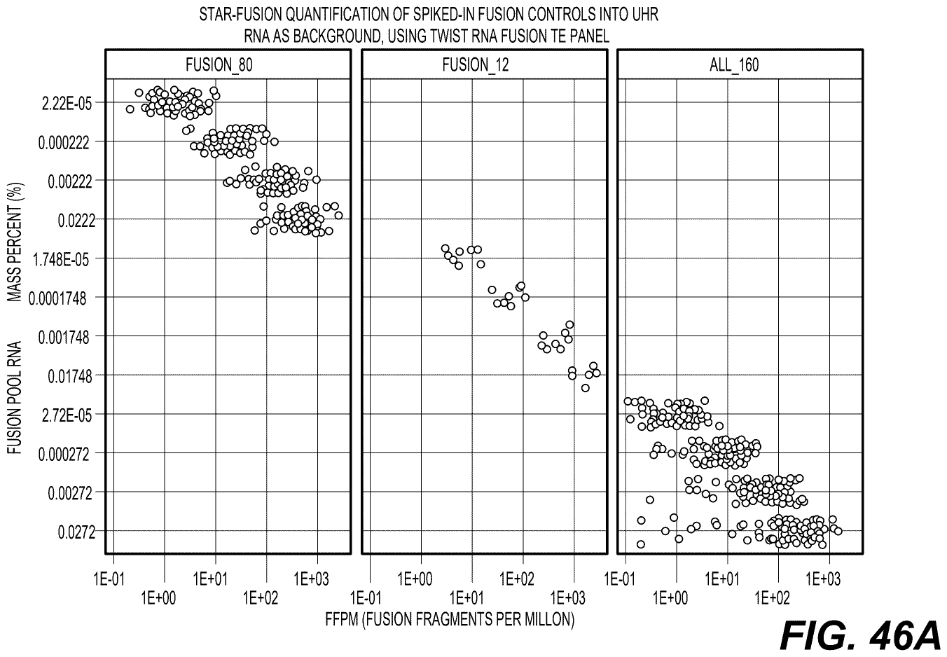

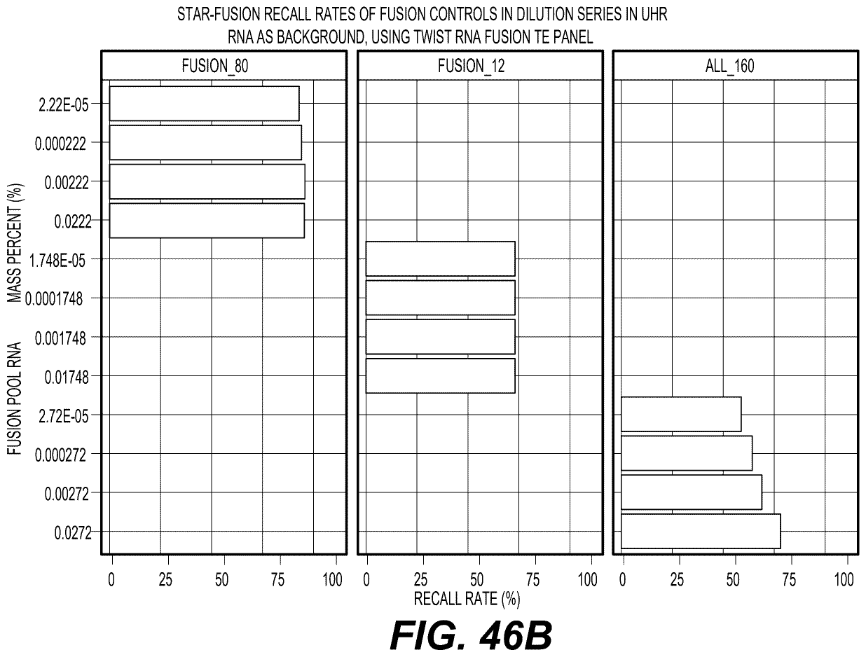

Quantitatively, the mean fusion fragments per million (FFPM) quantities trend down ten-fold with every ten-fold serial dilution; however, the all-160 panel, which has significant fusion content non-overlap with the TE panel used, showed more below-trend points (and more dropout). Without being bound by theory, this may indicate inefficient capture of this subset of the fusion designs. Recall was steady for the fusion-12 configuration and reduced slightly for the fusion-80 (the configuration to which the TE panel was specifically tailored); recall rate decreased for the fusion-160 configuration over the dilution series, due to the lower absolute abundance of each fusion RNA in the mixture, and potentially the configuration of the TE panel used in capture (which did not include probes specifically designed for all fusions in the control). Recall rates were also impacted by limitations of STAR-Fusion to detect exon-skipping fusions independent of the spike-in concentration (FIGS. 46A-46B).

Performance—Fusion Calling. In order to empirically evaluate and verify the standards in realistic use conditions, library preps were conducted on UHR RNA with and without the fusion-80 configuration (0.0022% by mass) of positive control spiked-in. An RNA-seq library prep kit (with 100 ng input total RNA) and TE panel specific for RNA fusions was used. Samples were sequenced on a NextSeq 550 high output kit.

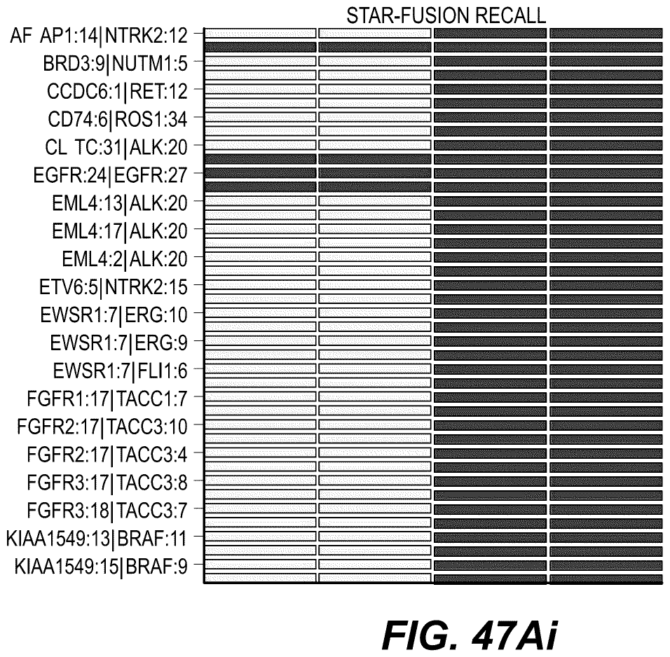

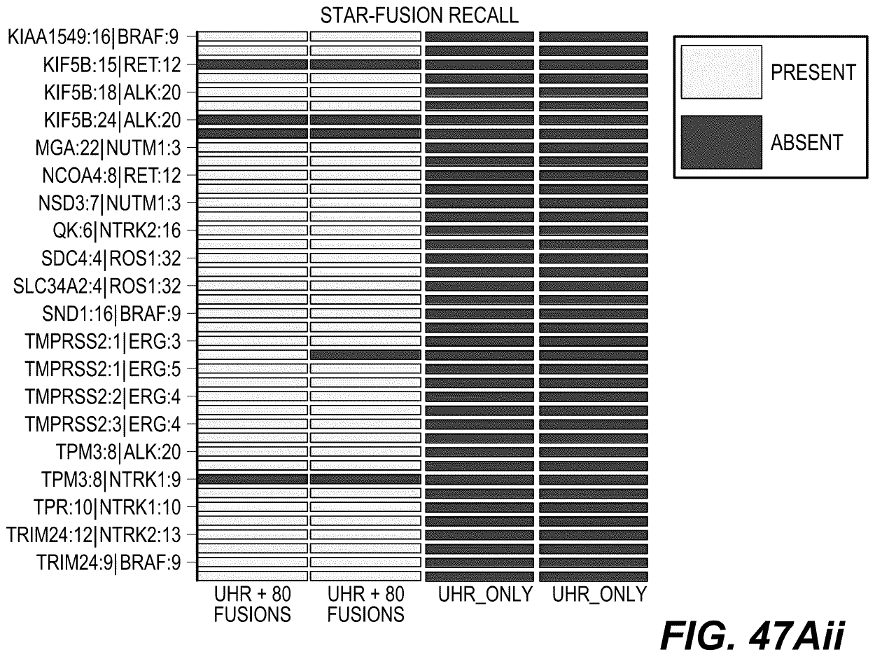

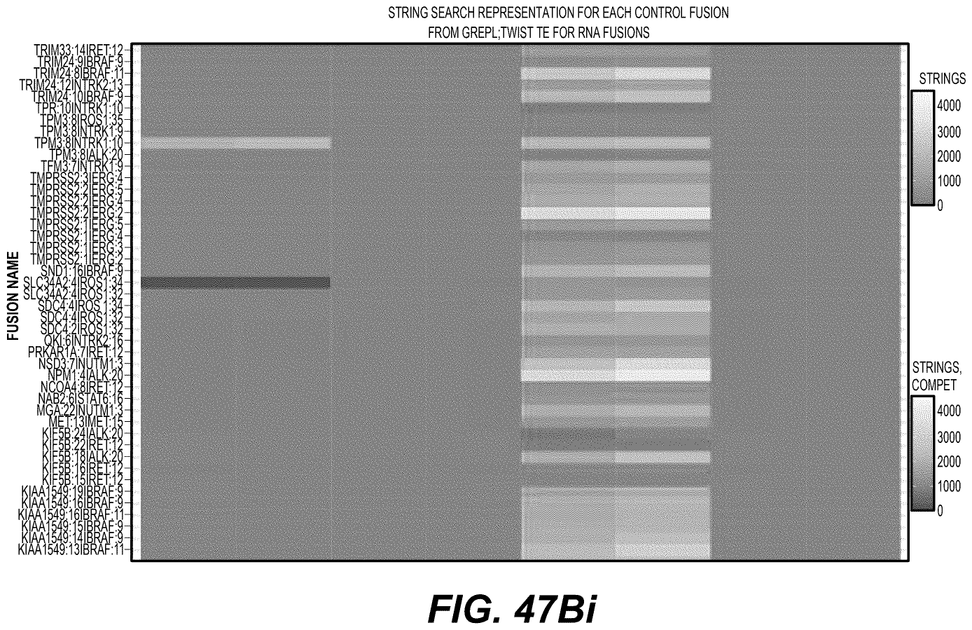

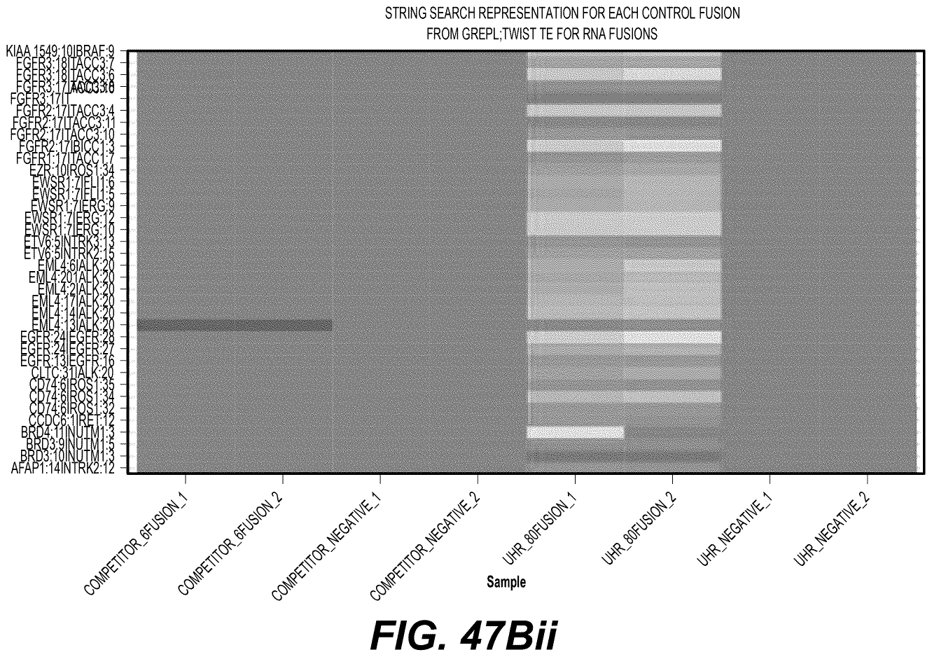

STAR-Fusion called 72 out of the 80 fusions present in the sample as present (FIG. 47Ai and Aii), representing a 90% recall rate. Many of the fusions that were not detected were “exon skipping” fusion events, which can be missed by STAR-Fusion as splice variants, not RNA fusions.

When using string searching (FIG. 47Bi and Bii), 79 out of 80 fusions were detected, a 98.8% recall rate. This was slightly higher than the STAR-Fusion recall rate, which illustrated the variation of bioinformatic pipeline development, the importance of prior knowledge of the exact fusion sequence expected, and the effect of bioinformatic analysis on sensitivity of fusion detection. Furthermore, even with string searching, a third-party 6-fusion standard was only able to identify three of the six fusions using the same bioinformatic methods.

The present disclosure is further described by the following non-limiting items:

Item 1. A synthetic polynucleotide library comprising: a plurality of polynucleotides, wherein the plurality of polynucleotides comprise sequences corresponding to a genetic abnormality in a genome, and wherein the stoichiometry of each polynucleotide of the plurality of polynucleotides is controlled.

Item 2. The library of Item 1, wherein the plurality of polynucleotides comprise DNA.

Item 3. The library of Item 1 or 2, wherein the plurality of polynucleotides comprises at least 100 polynucleotides.

Item 4. The library of Item 1 or 2, wherein the plurality of polynucleotides comprises at least 5000 polynucleotides.

Item 5. The library of Item 1 or 2, wherein the plurality of polynucleotides comprises at least 50,000 polynucleotides.

Item 6. The library of any one of Items 1-5, wherein the plurality of polynucleotides corresponds to ctDNA.

Item 7. The library of any one of Items 1-6, wherein the genetic abnormality is indicative of a disease or condition.

Item 8. The library of Item 7, wherein the disease or condition comprises cancer.

Item 9. The library of Item 8, wherein the disease or condition comprises one or more of breast, ovarian, stomach, bladder, salivary, and lung cancers.

Item 10. The library of any one of Items 1-9, wherein the genetic abnormality comprises an abnormal CNV for at least one gene.

Item 11. The library of Item 10, wherein the genetic abnormality comprises at least a 2 fold increase in copy number.

Item 12. The library of Item 10, wherein the genetic abnormality comprises at least a 10 fold increase in copy number.

Item 13. The library of any one of Items 1-12, wherein the plurality of polynucleotides are organized into clusters.

Item 14. The library of Item 13, wherein the plurality of polynucleotides are tiled as 3-10 polynucleotides per cluster.

Item 15. The library of Item 13 or 14, wherein a cluster includes a polynucleotide tiled 1 base along the gene.

Item 16. The library of any one of Items 13-15, wherein the start position for each cluster is 5-10 bases between clusters.

Item 17. The library of any one of Items 1-16, wherein the library comprises a mean max coverage.

Item 18. The library of Item 17 wherein mean max coverage comprises polynucleotide length*(length covered/(length covered+length skipped)).

Item 19. The library of any one of Items 1-18, wherein the polynucleotides are substantially free of repetitive elements.

Item 20. The library of Item 19, wherein repetitive elements comprise LINE or SINE.

Item 21. The library of any one of Items 1-20, wherein the polynucleotides correspond to exonic regions of the at least one gene.

Item 22. The library of Item 21, wherein the at least one gene comprises ERBB2.

Item 23. The library of any one of Items 1-22, wherein at least 90% of the polynucleotides have an average length of 100-200 bases.

Item 24. The library of any one of Items 1-22, wherein the polynucleotides have an average length of 150-180 bases.

Item 25. The library of any one of Items 1-22, wherein at least 90% of the polynucleotide have a length of 150-180 bases.

Item 26. The library of any one of Items 1-25, wherein the library has a minimum GC content of 20-40%.

Item 27. The library of any one of Items 1-26, wherein the library has a maximum GC content of 60-80%.

Item 28. The library of any one of Items 1-27, wherein the library has an average GC content of 50-70%.

Item 29. The library of any one of Items 1-28, wherein the library has a standard deviation GC content of 0.02-0.06%.

Item 30. The library of any one of Items 1-28, wherein the library has a standard deviation GC content of no more than 0.06%.

Item 31. The library of any one of Items 1-30, wherein library further comprises a second library of polynucleotides having sequences corresponding to one or more of copy number variants (CNVs), single nucleotide variations (SNVs), insertion-deletions (INDELs), and structural variants (SVs).

Item 32. A method for analyzing copy number variation comprising:
(a) pooling a library of any one of Items 1-31 with a donor background polynucleotide library; and (b) analyzing the pool for the one or more genetic abnormalities.

Item 33. The method of Item 32, wherein analyzing comprises use of next generation sequencing, mass array, or ddPCR.

Item 34. The method of Item 32 or 33, wherein step (a) is repeated for various concentrations of the library.

Item 35. The method of any one of Items 32-34, wherein step (a) comprises serial dilutions.

Item 36. The method of Item 32, wherein the library comprises the library of Item 31.

Item 37. The method of Item 36, wherein at least 90% of exons in the donor background polynucleotide library have an increased depth of sequencing by 3× to 5× compared to a library without the second library.

Item 38. A method for preparing the synthetic library of any one of Items 1-31.

Item 39. The method of Item 36, comprising:
(a) designing sequences for the library of polynucleotides, where the sequences comprise a primer region; (b) synthesizing the library of polynucleotides; and (c) cleaving the primer region polynucleotides in the library.

Item 40. The method of Item 39, wherein the method further comprises purifying the polynucleotides.

Item 41. The library of Item 1, wherein the genetic abnormalities are indicative of a disease or condition.

Item 42. The library of Item 40, wherein the disease or condition comprises one or more of Lung Adenocarcinoma, Thyroid Papillary Carcinoma, Leukemia (Acute and Chronic), Prostate Adenocarcinoma, and Ewing's Sarcoma.

Item 43. The library of Item 39 or 42, wherein the genetic abnormalities comprises a fusion.

Item 44. The library of Item 43, wherein the library comprises RNA.

Item 45. The library of Item 44, wherein the genetic abnormalities comprises an RNA fusion.

Item 46. The library of Item 45, wherein the polynucleotides comprise sequences within 2000 bases of the fusion junction.

Item 47. The library of Item 45, wherein the polynucleotides comprise sequences within 750 bases of the fusion junction.

Item 48. The library of Item 45, wherein the polynucleotides comprise sequences within 200-2000 bases of the fusion junction.

Item 49. The library of any one of Items 43-48, wherein the polynucleotides comprise sequences within 2000 bases of the fusion junction relative to the 3′ terminus.

Item 50. The library of any one of Items 43-48, wherein the polynucleotides comprise sequences within 2000 bases of the fusion junction relative to the 5′ terminus.

Item 51. The library of any one of Items 43-50, wherein the RNA fusion is found in at least 2 samples from the COSMIC database.

Item 52. The library of any one of Items 43-50, wherein the RNA fusion is found in at least 10 samples from the COSMIC database.

Item 53. The library of any one of Items 43-50, wherein the RNA fusion is found in at least 100 samples from the COSMIC database.

Item 54. The library of any one of Items 43-53, wherein the library comprises polynucleotides corresponding to at least 20 fusions.

Item 55. The library of any one of Items 43-53, wherein the library comprises polynucleotides corresponding to at least 40 fusions.

Item 56. The library of any one of Items 43-53, wherein the library comprises polynucleotides corresponding to at least 100 fusions.

Item 57. The library of any one of Items 43-53, wherein the library comprises polynucleotides corresponding to at least 150 fusions.

Item 58. The library of Item any one of Items 43-53, wherein the library comprises polynucleotides corresponding to 20-200 fusions.

Item 59. The library of Item 1, wherein the RNA fusion is 500-2000 bases in length.

Item 60. The library of any one of Items 43-59, wherein the RNA fusion comprises a fusion from Table 1.

Item 61. The library of any one of Items 43-60, wherein the RNA fusion comprises a first gene and a second gene.

Item 62. The library of Item 61, wherein the first gene comprises ACTB, ASPSCR1, ATF1, ATIC, BCR, CBFA2T3, CCDC6, CD74, CDH11, CDKN2D, CHCHD7, CLTC, COL1A1, CRTC1, CRTC3, CTNNB1, DHH, DNAJB1, EGFR, EML4, ETV6, EWSR1, EZR, FGFR1, FGFR3, FOXO1, FUS, GOPC, HEY1, HMGA2, JAK2, JAZF1, KIAA1549, KIF5B, KMT2A, LIFR, LPP, MAML2, MET, MN1, MYB, NAB2, NACC2, NCOA4, NPM1, NUP214, PAX3, PAX7, PAX8, PCM1, PLAG1, PML, PRCC, PRKAR1A, PTPRK, RANBP2, RUNX1, SDC4, SET, SLC34A2, SLC45A3, SND1, SS18, STIL, STRN, TAF15, TBL1XR1, TCF3, TFE3, TMPRSS2, TPM3, TPM4, or YWHAE.

Item 63. The library of Item 62, wherein the second gene comprises GLI1, TFE3, EWSR1, ALK, ABL1, GLIS2, RET, NRG1, ROS1, USP6, WDFY2, PLAG1, PDGFB, MAML2, RHEBL1, PRKACA, EGFR, SEPTIN14, EML4, MN1, NTRK3, PDGFRB, RUNX1, ATF1, CREB1, DDIT3, ERG, FEV, FLI1, NR4A3, POU5F1, WT1, TACC1, BAIAP2L1, TACC3, PAX3, CREB3L2, FUS, NCOA2, LPP, WIF1, PAX5, SUZ12, BRAF, AFDN, AFF1, CREBBP, ELL, EPS15, MLLT1, MLLT10, MLLT11, MLLT3, SEPTIN6, SEPTIN9, HMGA2, CRTC1, MET, ETV6, MYB, NFIB, STAT6, NTRK2, FOXO1, PAX8, PPARG, JAK2, CTNNB1, RARA, RSPO3, ETV6, RUNX1T1, NUP214, ELK4, SSX1, SSX2, SSX4B, TAL1, TP63, PBX1, ASPSCR1, NTRK1, or NUTM2B.

Item 64. A method for preparing the synthetic library of any one of Items 39-63.

Item 65. The method of Item 64, comprising: (a) designing sequences for the library of polynucleotides; (b) synthesizing DNA plasmids, wherein each plasmid comprises at least one polynucleotide sequence; (c) digesting plasmids to release DNA fragments comprising the sequences; (d) performing transcription on the DNA fragments to generate the library of polynucleotides.

Item 66. The method of Item 65, wherein the plasmids are digested with a restriction enzyme.

Item 67. The method of Item 66, wherein the restriction enzyme comprises one or more of AatII, AcuI, AflIII, AhdI, AjuI, AlfI, AlwNI, ApaLI, ArsI, AscI, AseI, AsiSI, AvaI, AvrII, BacGI, BamHI, BanII, BciVI, BdaI, Bme1580I, BmrI, Bpu10I, BsaHI, BsaXI, BseYI, BsiEI, BsiHKAI, BsiWI, BsmI, BsmBI, BsmFI, BsoBI, BspDI, BspHI, BsrDI, BsrFI, BssSI, BssSI, BtgZI, BtsI, BtsI, ClaI, CviQI, DraIII, DrdI, EaeI, EarI, Eco57MI, Esp3I, FaqI, FauI, HacII, HgaI, HindIII, Hpy166II, MlyI, MspA1I, NdeI, NruI, NspI, PaeR7I, PciI, PflMI, PleI, PspFI, PspXI, PvuI, RsaI, Sau96I, SfcI, SmaI, SpeI, SspI, StyI, TaqII, TsoI, Tsp45I, TspGWI, TspMI, TstI, XbaI, XhoI, XmaI, and ZraI.

Item 68. The method of any one of Items 65-67, wherein transcription comprises in-vitro transcription.

Item 69. A system for generating a polynucleotide library comprising:
a computing system comprising at least one processor and instructions executable by the at least one processor to perform operations comprising: (a) receiving as input a nucleic acid reference sequence, at least one target region, and one or more design variables; (b)
generating a polynucleotide library by saturating the at least one target region with one or more polynucleotides to generate a polynucleotide library; and (c) generating one or more outputs comprising sequences of the polynucleotide library.

Item 70. The system of Item 69, wherein the input nucleic reference sequence comprises a genome.

Item 71. The system of Item 69, wherein the at least one target region comprises at least one exon.

Item 72. The system of Item 69, wherein the at least one target region comprises a variant.

Item 73. The system of Item 72, wherein the variant comprises a copy number variation (CNV), single nucleotide polymorphism variant (SNV), insertion/deletion (indel), or structural variant (SV).

Item 74. The system of Item 69, wherein the one or more variables comprise polynucleotide length, offset, number of probes, overlap, overhang, target region merges, and tiling depth.

Item 75. The system of Item 69, wherein the target region is smaller than a polynucleotide length, and polynucleotides are generated with 1 base offsets.

Item 76. The system of Item 69, wherein the target region is larger than a polynucleotide length, and polynucleotides are generated such that the entire target region is evenly covered.

Item 77. The system of Item 69, wherein the system further comprises one or more filters.

Item 78. The system of Item 69, wherein the filter is configured to remove duplicate polynucleotide sequences.

Item 79. The system of Item 69, wherein the filter is configured to remove SINE/LINE sequences.

Item 80. The system of Item 69, wherein the one or more outputs comprises one or more log files.

Item 81. The system of Item 69, wherein the one or more outputs comprises a file comprising the regions covered by the polynucleotides.

Item 82. The system of Item 69, wherein the one or more outputs comprises a file, wherein the file comprises sequences from the library.

Item 83. A system for generating a polynucleotide library comprising:
a computing system comprising at least one processor and instructions executable by the at least one processor to perform operations comprising: (a) receiving as input a plurality of sequences from the library of any one of Items 42-82 and one or more variants; a nucleic acid reference sequence, at least one target region, and one or more variables; (b) saturating the at least one target region with one or more polynucleotides to generate a polynucleotide library; and (c) generating one or more outputs comprising sequences of the polynucleotide library. (d) trimming the plurality of sequences around the one or more variants loci; and (e) generating one or more outputs comprising sequences of the polynucleotide library.

Item 84. The system of Item 83, wherein the system further comprises a module for adding primers to each of the sequences in step (c).

Item 85. The system of Item 83, wherein the system further comprises a module for organizing the sequences into clusters.

Item 86. The system of Item 83, wherein the system further comprises a module for organizing the clusters for synthesis on a synthesis device.

Item 87. The system of Item 83, wherein the polynucleotide library comprises approximately a leptokurtic distribution.

Item 88. The system of Item 83, wherein the distance between variants loci is 5-10 bases.

Item 89. The system of Item 83, wherein the distance between variants loci is 7 bases.

Item 90. The system of Item 83, wherein the polynucleotide library comprises sequences representative of cfDNA.

Item 91. A synthetic polynucleotide library comprising: a plurality of polynucleotides, wherein a portion of the polynucleotides comprise methylation, and the plurality of polynucleotides comprises at least one CpG site.

Item 92. The library of Item 91, wherein the plurality of polynucleotides comprise DNA.

Item 93. The library of Item 91, wherein the library comprises at least 24 polynucleotides.

Item 94. The library of Item 91, wherein the library comprises at least 36 polynucleotides.

Item 95. The library of Item 91, wherein the library comprises at least 48 polynucleotides.

Item 96. The library of Item 91, wherein the polynucleotides are 80-350 bases in length.

Item 97. The library of Item 91, wherein the at least one CpG site comprises 0 to 100% methylation.

Item 98. The library of Item 91, wherein the at least one CpG site comprises about 0%, 3%, 6%, 12%, 25%, 50%, 75%, or 100% methylation.

Item 99. The library of Item 91, wherein the at least one CpG site comprises between 1 to 20 CpG sites.

Item 100. The library of Item 91, wherein the at least one CpG site is associated with a disease or condition.

Item 101. The library of Item 91, wherein the at least one CpG site is associated with cancer.

Item 102. The library of Item 91, wherein the portion of the polynucleotides is about 10% to about 90% of the plurality of polynucleotides.

Item 103. The library of Item 91, wherein the plurality of polynucleotides comprise about 30% to about 70% GC content.

Item 104. The library of Item 91, wherein the plurality of polynucleotides comprise a pairwise hamming distance of at least 100 from each other.

Item 105. The library of Item 91, wherein the library further comprises adapters.

Item 106. The library of Item 105, wherein the adapters comprise methyl deoxycytidine adapters.

Item 107. A method for quantifying methylation in a sample comprising: (a) preparing standards from the library of any one of Items 91-106; (b) analyzing one or more samples relative to the standards; and (c) quantifying the degree of methylation in the sample.

Item 108. The method of Item 107, wherein the degree of methylation in the sample comprises a per site methylation rate.

Item 109. The method of Item 107, wherein the standards are prepared by serial dilution.

Item 110. The method of Item 107, wherein preparing the standards comprises mixing the standards with a portion of the sample at one or more concentrations.

Item 111. The method of Item 107, wherein preparing the standards comprises adding adapters, barcodes, or both to the polynucleotides of the library.

Item 112. The method of Item 107, wherein preparing the standards comprises a library conversion.

Item 113. The method of Item 112, wherein the library conversion comprises an enzymatic conversion or a chemical conversion.

Item 114. The method of Item 113, wherein the enzymatic conversion results in increased yields, longer insert sizes, or both compared to a chemical conversion.

Item 115. The method of Item 113, wherein the enzymatic conversion results in uniform coverage across varying GC content compared to a chemical conversion.

Item 116. The method of Item 107, further comprising target enrichment.

Item 117. The method of Item 116, wherein target enrichment takes place before or after a library conversion.

Item 118. A method of preparing the synthetic library of any one of Items 91-106.

Item 119. The method of Item 118, comprising: (a) designing sequences for the library of polynucleotides; (b) synthesizing the library of polynucleotides as one or more pools of polynucleotides; (c) amplifying the one or more pools; (d) methylating the one or more pools; and (c) combining the one or more pools based at least in part on a methylation ratio,
thereby generating the plurality of polynucleotides, wherein a portion of the polynucleotides comprise methylation.

Item 120. The method of Item 119, wherein designing sequences comprises adding an enzyme digestion site to each sequence.

Item 121. The method of Item 120, further comprising exposing the plurality of polynucleotides to an enzyme for quality control.

Item 122. The method of Item 121, wherein the enzyme cleaves the plurality of polynucleotides at the enzyme digestion site.

Item 123. The method of Item 119, wherein methylating the one or more pools comprises methylation by a methyltransferase.

Item 124. The method of Item 119, wherein the portion comprises 0%, 3%, 6%, 12%, 25%, 50%, 75%, or 100% methylation.

Item 125. The method of Item 119, wherein each of the polynucleotides comprise one or more levels of CpG sites.

Item 126. A kit comprising the synthetic library of any one of Items 91-106.

Item 127. The kit of Item 126, further comprising instructions for quantifying methylation in a sample.

Item 128. The kit of Item 126, further comprising packaging for the synthetic library of any one of Items 91-106.

Item 129. The kit of Item 126, wherein the library comprises standards pre-prepared by serial dilution.

Item 130. The kit of Item 126, further comprising reagents for next generation sequencing.

While exemplary and representative embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1. A synthetic polynucleotide library comprising:
a plurality of polynucleotides, wherein the plurality of polynucleotides comprise sequences corresponding to a genetic abnormality in a genome, and wherein stoichiometry of each polynucleotide of the plurality of polynucleotides is controlled.

2. The library of claim 1, wherein the plurality of polynucleotides comprise DNA.

3. The library of claim 1, wherein the plurality of polynucleotides comprises at least 100 polynucleotides.

4. The library of claim 1, wherein the plurality of polynucleotides comprises at least 5000 polynucleotides.

5. The library of claim 1, wherein the plurality of polynucleotides corresponds to ctDNA.

6. The library of claim 1, wherein the genetic abnormality is indicative of a disease or condition.

7. The library of claim 6, wherein the disease or condition comprises a cancer.

8. The library of claim 1, wherein the genetic abnormality comprises an abnormal copy number variant (CNV) for at least one gene.

9. The library of claim 8, wherein the genetic abnormality comprises a CNV of at least a 2 fold increase in gene copy number.

10. The library of claim 8, wherein the genetic abnormality comprises a CNV of at least a 10 fold increase in gene copy number.

11. The library of claim 1, wherein the plurality of polynucleotides are organized into clusters.

12. The library of claim 11, wherein the plurality of polynucleotides are tiled as 3 polynucleotides to 10 polynucleotides per cluster.

13. The library of claim 11, wherein a cluster includes a polynucleotide tiled 1 base along at least one gene.

14. The library of claim 11, wherein a start position for each cluster is 5 bases to 10 bases between clusters.

15. The library of claim 1, wherein the plurality of polynucleotides are substantially free of repetitive elements.

16. The library of claim 1, wherein the genetic abnormality is present in an oncogene or a tumor suppressor gene.

17. The library of claim 1, wherein the genetic abnormality is present in one or more of the following genes in the genome: ABL1, ABL2, AKT1, ALK, APC, AR, ARAF, ARID1A, ATM, ATR, BAP1, BRAF, BRCA1, BRCA2, CCND1, CDC6, CDH1, CDK12, CDK4, CDX2, CTNNB1, DDR2, EGFR, EML4, ERBB2, ERBB3, ERG, ESR1, EZH2, FBXW7, FGFR1, FGFR2, FGFR3, FLT3, FOXA1, FOXL2, GATA3, GNA11, GNAQ, GNAS, HNF1A, HRAS, IDH1, IDH2, JAK2, KDM5C, KDM6A, KIF5B, KIT, KRAS, MAP2K1, MAPK1, MET, MIR4728,ERBB2, MLH1, MPL, MYCN, MYD88, NCOA4, NF1, NF2, NFE2L2, NOTCH1, NPM1, NRAS, PBRM1, PDGFRA, PIK3CA, PTEN, PTPN11, RET, RHEB, RHOA, RIT1, ROS1, SETD2, SMAD4, SMO, SPOP, TERT, TMPRSS2, TP53, TPR, TSC1, and VHL.

18. The library of claim 1, wherein the stoichiometry of each polynucleotide of the plurality of polynucleotides is controlled such that the library comprises a minimum GC content of 20% to 40%.

19. The library of claim 1, wherein the stoichiometry of each polynucleotide of the plurality of polynucleotides is controlled such that the library comprises a maximum GC content of 60% to 80%.

20. The library of claim 1, wherein the stoichiometry of each polynucleotide of the plurality of polynucleotides is controlled such that the library comprises an average GC content of 50% to 70%.


SEQUENCE LISTING (34 sequences)

SEQ ID NO: 1 - DNA, 62 bp, synthetic construct
  source 1..62: mol_type = other DNA
  modified_base 51: mod_base = OTHER; note = thymidine-succinyl hexamide CED phosphoramidite
  modified_base 52: mod_base = OTHER; note = thymidine-succinyl hexamide CED phosphoramidite
agacaatcaaccatttggggtggacagccttgacctctagacttcggcatnntttttttttt

SEQ ID NO: 2 - DNA, 112 bp, synthetic construct
  source 1..112: mol_type = other DNA
  modified_base 101: mod_base = OTHER; note = thymidine-succinyl hexamide CED phosphoramidite
  modified_base 102: mod_base = OTHER; note = thymidine-succinyl hexamide CED phosphoramidite
cgggatccttatcgtcatcgtcgtacagatcccgacccatttgctgtccaccagtcatgctagccataccatgatgatgatgatgatgagaaccccgcatnntttttttttt

SEQ ID NO: 3 - DNA, 19 bp, synthetic construct
  source 1..19: mol_type = other DNA
atgcggggttctcatcatc

SEQ ID NO: 4 - DNA, 20 bp, synthetic construct
  source 1..20: mol_type = other DNA
cgggatccttatcgtcatcg

SEQ ID NO: 5 - DNA, 20 bp, synthetic construct
  source 1..20: mol_type = other DNA
aatgatacggcgaccaccga

SEQ ID NO: 6 - DNA, 24 bp, synthetic construct
  source 1..24: mol_type = other DNA
caagcagaagacggcatacgagat

SEQ ID NO: 7 - DNA, 23 bp, synthetic construct
  source 1..23: mol_type = other DNA
gaagtgccattccgcgctcttca

SEQ ID NO: 8 - DNA, 24 bp, synthetic construct
  source 1..24: mol_type = other DNA
tgaagagcatcgtacagctgctcg

SEQ ID NO: 9 - DNA, 17 bp, synthetic construct
  source 1..17: mol_type = other DNA
ccattccgcgctcttca

SEQ ID NO: 10 - DNA, 19 bp, synthetic construct
  source 1..19: mol_type = other DNA
tgaagagcatcgtacagct

SEQ ID NO: 11 - DNA, 22 bp, synthetic construct
  source 1..22: mol_type = other DNA
gaagtgccattccgcctgacct

SEQ ID NO: 12 - DNA, 24 bp, synthetic construct
  source 1..24: mol_type = other DNA
cgagcagctgtacgatgctcttca

SEQ ID NO: 13 - DNA, 24 bp, synthetic construct
  source 1..24: mol_type = other DNA
cgctgacgatgtcagtgctcttca

SEQ ID NO: 14 - DNA, 23 bp, synthetic construct
  source 1..23: mol_type = other DNA
gaagtgccattccgcgctcttca

SEQ ID NO: 15 - DNA, 24 bp, synthetic construct
  source 1..24: mol_type = other DNA
cgagcagctgtacgatgctcttca

SEQ ID NO: 16 - DNA, 24 bp, synthetic construct
  source 1..24: mol_type = other DNA
tgaagagcatcgtacagctgctcg

SEQ ID NO: 17 - DNA, 17 bp, synthetic construct
  source 1..17: mol_type = other DNA
ccattccgcgctcttca

SEQ ID NO: 18 - DNA, 19 bp, synthetic construct
  source 1..19: mol_type = other DNA
agctgtacgatgctcttca

SEQ ID NO: 19 - DNA, 19 bp, synthetic construct
  source 1..19: mol_type = other DNA
tgaagagcatcgtacagct

SEQ ID NO: 20 - DNA, 18 bp, synthetic construct
  source 1..18: mol_type = other DNA
ccatgtgctcacgtctca

SEQ ID NO: 21 - DNA, 18 bp, synthetic construct
  source 1..18: mol_type = other DNA
agtcaggatgtcgtctcg

SEQ ID NO: 22 - DNA, 18 bp, synthetic construct
  source 1..18: mol_type = other DNA
cgagacgacatcctgact

SEQ ID NO: 23 - DNA, 73 bp, synthetic construct
  source 1..73: mol_type = other DNA
  modified_base 32: mod_base = OTHER; note = uracil
gaagtgccattccgcctgacctgctcttccgtnnnnnnnnnnacggaagagctccgatccacctccgagtcac

SEQ ID NO: 24 - DNA, 73 bp, synthetic construct
  source 1..73: mol_type = other DNA
  modified_base 31: mod_base = OTHER; note = uracil
gtgactcggaggtggatcggagctcttccgtnnnnnnnnnnacggaagagcaggtcaggcggaatggcacttc

SEQ ID NO: 25 - DNA, 72 bp, synthetic construct
  source 1..72: mol_type = other DNA
gaagtgccattccgcctgacctgctcttccgnnnnnnnnnnacggaagagctccgatccacctccgagtcac

SEQ ID NO: 26 - DNA, 72 bp, synthetic construct
  source 1..72: mol_type = other DNA
gtgactcggaggtggatcggagctcttccgnnnnnnnnnnacggaagagcaggtcaggcggaatggcacttc

SEQ ID NO: 27 - DNA, 41 bp, synthetic construct
  source 1..41: mol_type = other DNA
nnnnnnnnnnacggaagagctccgatccacctccgagtcac

SEQ ID NO: 28 - DNA, 42 bp, synthetic construct
  source 1..42: mol_type = other DNA
nnnnnnnnnnacggaagagcaggtcaggcggaatggcacttc

SEQ ID NO: 29 - DNA, 32 bp, synthetic construct
  source 1..32: mol_type = other DNA
  modified_base 32: mod_base = OTHER; note = 3'-deoxy-uridine
gaagtgccattccgcctgacctgctcttccgn

SEQ ID NO: 30 - DNA, 31 bp, synthetic construct
  source 1..31: mol_type = other DNA
  modified_base 31: mod_base = OTHER; note = 3'-deoxy-uridine
gtgactcggaggtggatcggagctcttccgn

SEQ ID NO: 31 - DNA, 32 bp, synthetic construct; identical to SEQ ID NO: 29
  source 1..32: mol_type = other DNA
  modified_base 32: mod_base = OTHER; note = 3'-deoxy-uridine

SEQ ID NO: 32 - DNA, 31 bp, synthetic construct; identical to SEQ ID NO: 30
  source 1..31: mol_type = other DNA
  modified_base 31: mod_base = OTHER; note = 3'-deoxy-uridine

SEQ ID NO: 33 - DNA, 32 bp, synthetic construct; identical to SEQ ID NO: 29
  source 1..32: mol_type = other DNA
  modified_base 32: mod_base = OTHER; note = 3'-deoxy-uridine

SEQ ID NO: 34 - DNA, 31 bp, synthetic construct; identical to SEQ ID NO: 30
  source 1..31: mol_type = other DNA
  modified_base 31: mod_base = OTHER; note = 3'-deoxy-uridine